(19) United States
(12) Patent Application Publication
(10) Pub. No.: US 2011/0310235 A1
(43) Pub. Date: Dec. 22, 2011

(54) DISPLAY DEVICE AND METHOD, RECORDING MEDIUM, TRANSMISSION DEVICE AND METHOD, AND PLAYBACK DEVICE AND METHOD

(76) Inventors: Taiji Sasaki, Osaka (JP); Takahiro Nishi, Nara (JP); Hiroshi Yahata, Osaka (JP)

(21) Appl. No.: 13/201,025

(22) PCT Filed: Dec. 24, 2010
(86) PCT No.: PCT/JP2010/007514

§ 371 Date: Aug. 11, 2011

Related U.S. Application Data
(60) Provisional application No. 61/290,322, filed on Dec. 28, 2009.

(51) Int. Cl. H04N 13/04

(52) U.S. Cl. 348/54; 348/E13.026

(57) ABSTRACT

A device for displaying stereoscopic images on a screen includes a receiving unit, signal processing unit, and display unit. The receiving unit receives stream data including left and right views of stereoscopic images. The signal processing unit alternately extracts left- and right-view frames from the stream data. The display unit displays each frame sent from the signal processing unit for a predetermined time on the screen. The signal processing unit sends the display unit one left-view frame a first number of times and one right-view frame a second number of times during one frame period of the stereoscopic images. The signal processing unit calculates the frame rate at which the display unit displays the left- and right-view frames divided by the frame rate of the stereoscopic images. The signal processing unit sets the first and second numbers of times to different values for one frame period of the stereoscopic images.

### TECHNICAL FIELD

The present invention relates to a technology for displaying stereoscopic, i.e. three-dimensional (3D), video images.

### BACKGROUND ART

In recent years, general interest in 3D video images has been increasing. For example, amusement park attractions that incorporate 3D video images are popular. Furthermore, throughout the country, the number of movie theaters showing 3D movies is increasing. Along with this increased interest in 3D video images, the development of technology that enables playback of 3D video images in the home has also been progressing. There is demand for this technology to store 3D video content on a portable recording medium, such as an optical disc, while maintaining the 3D video content at high image quality. Furthermore, there is demand for the recording medium to be compatible with a two-dimensional (2D) playback device. That is, it is preferable for a 2D playback device to be able to play back 2D video images and a 3D playback device to be able to play back 3D video images from the same 3D video content recorded on the recording medium. Here, a “2D playback device” refers to a conventional playback device that can only play back monoscopic video images, i.e. 2D video images, whereas a “3D playback device” refers to a playback device that can play back 3D video images. Note that in the present description, a 3D playback device is assumed to be able to also play back conventional 2D video images.

FIG. 75 is a schematic diagram illustrating the technology for ensuring compatibility with 2D playback devices for an optical disc on which 3D video content is recorded (see, for example, Patent literature 1). An optical disc PDS stores two types of video streams. One is a 2D/left-view video stream, and the other is a right-view video stream. A “2D/left-view video stream” represents 2D video images to be shown to the left eye of a viewer during 3D playback, i.e. a “left view”. During 2D playback, this stream constitutes the 2D video image. A “right-view video stream” represents 2D video images to be shown to the right eye of the viewer during 3D playback, i.e. a “right view”. The left- and right-view video streams have the same frame rate but different presentation times shifted from each other by half a frame period. For example, when the frame rate of each video stream is 24 fps (frames per second), the frames of the 2D/left-view video stream and the right-view video stream are alternately displayed every 1/48 seconds.

As shown in FIG. 75, each the left-view and right-view video streams are divided into a plurality of extents EX1A-C and EX2A-C respectively on the optical disc PDS. Each extent contains at least one group of pictures (GOP), GOPs being read together by the optical disc drive. Hereinafter, the extents belonging to the 2D/left-view video stream are referred to as “2D/left-view extents”, and the extents belonging to the right-view video stream are referred to as “right-view extents”. The 2D/left-view extents EX1A-C and the right-view extents EX2A-C are alternately arranged on a track TRC of the optical disc PDS. Each two contiguous extents EX1A+EX2A, EX1B+EX2B, and EX1C+EX2C have the same length of playback time. Such an arrangement of extents is referred to as an “interleaved arrangement”. A group of extents recorded in an interleaved arrangement on a recording medium is used both in 3D video playback and 2D video image playback, as described below.

From among the extents recorded on the optical disc PDS, a 2D playback device PL2 causes an optical disc drive DD2 to read only the 2D/left-view extents EX1A-C sequentially from the top, skipping the reading of right-view extents EX2A-C. Furthermore, an image decoder VDC sequentially decodes the extents read by the optical disc drive DD2 into a video frame VFL. In this way, a display device DS2 only displays left views, and viewers can watch normal 2D video images.

A 3D playback device PL3 causes an optical disc drive DD3 to alternately read 2D/left-view extents and right-view extents from the optical disc PDS. When expressed as codes, the extents are read in the order EX1A, EX2A, EX1B, EX2B, EX1C, and EX2C. Furthermore, from among the read extents, those belonging to the 2D/left-view video stream are supplied to a left-video decoder VDL, whereas those belonging to the right-view video stream are supplied to a right-video decoder VDR. The video decoders VDL and VDR alternately decode the video streams into video frames VFL and VFR, respectively. Thus, left views and right views are alternately displayed on a display device DS3. In synchronization with the switching of the views by the display device DS3, shutter glasses SHG cause the left and right lenses to become nontransparent alternately. Consequently, left views are perceived by the left eye of a viewer wearing the shutter glasses SHG, whereas right views are perceived by the right eye of the viewer. A pair of 2D video images (one for a left view and another for a right view) that are alternately displayed on the display device DS3 appear to the viewer as a single 3D video image.

When 3D video content is stored on any recording medium, not only on an optical disc, the above-described interleaved arrangement of extents is used. The recording medium can thus be used both for playback of 2D video images and 3D video images.

### CITATION LIST

### Patent Literature

### [Patent Literature 1]

JP Patent No. 3935507

### SUMMARY OF INVENTION

### Technical Problem

Traditionally, a movie has a frame rate of 24 fps. Similarly, stream data of movie content recorded on a recording medium generally has a frame rate of 24 fps. However, in the case of a television system, the frame rate of such a level is too low to reduce a risk that viewers notice flicker in displayed images. Accordingly, display devices such as television receivers generally convert the frame rate of movie content to a higher value before displaying video images of the movie content. Specifically, a method called “3-2 pulldown” is known for such frame rate conversion.

FIGS. 76A and 76B are schematic views showing 2D video frames, respectively, before and after frame rate conversion by the 3-2 pulldown method. For the convenience of description, the scanning method is assumed to be progressive scan.

With reference to FIG. 76A, before the 3-2 pulldown, a sequence of 2D video frames F_{2D}k (k=1, 2, 3, 4 . . . ) has a frame rate of 24 fps and thus the presentation time per frame is 1/24 seconds.

With reference to FIG. 76B, the 3-2 pulldown causes odd-numbered frames F_{2D}1, F_{2D}3 . . . of the sequence of frames F_{2D}k to be each displayed three times, and causes even-numbered frames F_{2D}2, F_{2D}4 . . . thereof to be each displayed twice. Since the presentation time per frame is set to 1/60 seconds, the sequence of frames F_{2D}k is to be displayed at a frame rate of 60 fps.

Like typical 2D video images, left views and right views of 3D video content have a frame rate of 24 fps. Accordingly, when 3D video images are displayed, the frame rate is converted by the 3-2 pulldown in a manner similar to that when 2D video images are displayed. FIGS. 76C and 76D are schematic views showing 3D video frames, respectively, before and after frame rate conversion by the 3-2 pulldown. For the convenience of description, the scanning method is assumed to be progressive scan. With reference to FIG. 76C, before the 3-2 pull-down, a sequence of 3D video frames F_{3D}k (k=1, 2, 3, 4 . . . ) has a frame rate of 24 fps and thus the presentation time per frame is 1/24 seconds. With reference to FIG. 76D, the 3-2 pulldown causes odd-numbered frames F_{3D}1, F_{3D}3 . . . of the sequence of frames F_{3D}k to be each displayed three times, and causes even-numbered frames F_{3D}2, F_{3D}4 . . . thereof to be each displayed twice. Since the presentation time per frame is set to 1/60 seconds, the frame rate of the sequence of frames F_{3D}k is to be displayed at a frame rate of 60 fps. Note that each of the 3D video frames F_{3D}k actually represents a left-view frame FL and a right-view frame FR that are displayed in turn. FIG. 76E is a schematic view showing left-view frames and right-view frames together constituting 3D video frames after the 3-2 pulldown. With reference to FIG. 76E, during the presentation period of each of the 3D video frames, a left-view frame FL and a right-view frame FR are alternately displayed for 1/120 seconds each.

With reference to FIG. 76E, during the presentation period of each of the odd-numbered 3D video frames F_{3D}1, F_{3D}3 . . . , a total of six left- and right-view frames are displayed. On the other hand, during the presentation period of each of the even-numbered frames F_{3D}2, F_{3D}4 . . . , only a total of four left- and right-view frames are displayed. Although the presentation time of each of the 3D video frames is set to an equal length on the content, each of the odd-numbered frames F_{3D}1, F_{3D}3 . . . actually has a longer presentation time than each of the even-numbered frames F_{3D}2, F_{3D}4 . . . . . More specifically, the presentation time of each of the odd-numbered frames F_{3D}1, F_{3D}3 . . . is 1/120 seconds×6=0.05 seconds, whereas the presentation time of each of the even-numbered frames F_{3D}2, F_{3D}4 . . . is 1/120 seconds×4=approximately 0.03 seconds. Such a difference in presentation time between odd-numbered frames and even-numbered frames of 3D video images makes it difficult to express the motion of the 3D video images more smoothly.

An object of the present invention is to provide a display device for converting the frame rate of 3D video images so that frames of the 3D video images each have an equal length of presentation time, thus capable to express the motion of the 3D video images more smoothly.

### Solution to Problem

A display device according to the present invention is for displaying stereoscopic video images on a screen and has a receiving unit, a signal processing unit, and a display unit.

According to a first aspect of the present invention, the receiving unit receives stream data including left views and right views of the stereoscopic video images. The signal processing unit alternately extracts left-view frames and right-view frames from the stream data and sends the extracted frames. The display unit displays each frame sent from the signal processing unit on the screen for a predetermined time period. In particular, the signal processing unit repeatedly sends the display unit one of the left-view frames a first number of times and one of the right-view frames a second number of times, during one frame period of the stereoscopic video images represented by the stream data. Furthermore, the signal processing unit determines the first number of times and the second number of times based on a first frame rate divided by a second frame rate so that the first number of times differs from the second number of times with respect to at least one frame period of the stereoscopic video images, the first frame rate being a frame rate at which the display unit displays the left-view frames and the right-view frames, and the second frame rate being a frame rate of the stereoscopic video images represented by the stream data.

According to a second aspect of the present invention, the receiving unit receives stream data including left views and right views of the stereoscopic video images and control information. The signal processing unit alternately extracts left-view frames and right-view frames from the stream data and sends the extracted frames. The display unit displays each frame sent from the signal processing unit on the screen for a predetermined time period. The control information includes a display type of each of left-view frames and a display type of each of right-view frames. The display type of each of the left-view frames defines a first number of times indicating the number of times each of the left-view frames is to be repeatedly displayed on the screen for a predetermined time length during one frame period of the stereoscopic video images. The display type of each of the right-view frames defines a second number of times indicating the number of times each of the right-view frames is to be repeatedly displayed on the screen for a predetermined time length during one frame period of the stereoscopic video images. With respect to at least one frame period of the stereoscopic video images, the first number of times is set to be different from the second number of times. The receiving unit repeatedly sends the signal processing unit the left-view frames the first numbers of times defined by the respective display types for the left-view frames. The receiving unit repeatedly sends the signal processing unit the right-view frames the second numbers of times defined by the respective display types for the right-view frames.

### Advantageous Effects of Invention

The display device according to the present invention repeatedly displays a left-view frame and a right-view frame different numbers of times during at least one frame period of stereoscopic video images. In particular, the display device according to the first aspect of the present invention determines the numbers of times based on a ratio of the original frame rate of the stereoscopic video images and the frame rate thereof at which the stereoscopic video images are displayed. On the other hand, the display device according to the second aspect of the present invention determines the numbers of times based on control information. Both the display devices can convert the frame rate so that frames of 3D video images have equal presentation time, and thus can express the motion of the 3D video images more smoothly.

### BRIEF DESCRIPTION OF DRAWINGS

FIG. 1 is a schematic diagram showing a home theater system that uses a recording medium according to Embodiment 1 of the present invention.

FIG. 2 is a functional block diagram showing a structure of a display device 103 shown in FIG. 1.

FIG. 3 is a functional block diagram showing a structure of an HDMI communication unit 211 shown in FIG. 2.

FIG. 4A is a schematic diagram showing a structure of data used to display one 3D video frame, the data included in data transmitted through TMDS data channels CH1-3.

FIGS. 4B-4E are schematic diagrams each showing a pair of a left-view frame and a right-view frame arranged in an active display area VACT×HACT included in the transmission period of one 3D video frame.

FIG. 5 is a flowchart of processing of displaying 3D video images by the display device 103 shown in FIG. 2.

FIG. 6A is a schematic diagram showing a sequence of frames F_{3D}k (k=1, 2, 3, 4 . . . ) of 3D video images having a frame rate=24 fps.

FIG. 6B is a schematic diagram showing a sequence of left-view frames F_{L}k and right-view frames F_{R}k that has a frame rate of 120 fps and is converted from the frame sequence shown in FIG. 6A.

FIG. 7A is a schematic view showing a sequence of frames F_{3D}k (k=1, 2, 3, 4 . . . ) of 3D video images having a frame rate=24 fps.

FIG. 7B is a schematic diagram showing a sequence of left-view frames F_{L}k and right-view frames F_{R}k that has a frame rate of 100 fps and is converted from the frame sequence shown in FIG. 7A.

FIG. 8A is a schematic diagram showing a sequence of frames F_{3D}k (k=1, 2, 3, 4 . . . ) of 3D video images having a frame rate=24 fps.

FIG. 8B is a schematic diagram showing a sequence of left-view frames F_{L}k and right-view frames F_{R}k that has a frame rate of 180 fps and is converted from the frame sequence shown in FIG. 8A.

FIG. 9 is a flowchart of processing of displaying frames F_{3D}k of 3D video images by a signal processing unit 220 shown in FIG. 2.

FIG. 10 is a schematic diagram showing a structure of data recorded on a BD-ROM disc 101 shown in FIG. 1.

FIGS. 11A, 11B, and 11C are views respectively showing lists of elementary streams multiplexed into a main TS, first sub-TS, and second sub-TS recorded on the BD-ROM disc 101 shown in FIG. 1.

FIG. 12 is a schematic diagram showing an arrangement of TS packets in multiplexed stream data 1200.

FIG. 13A is a schematic diagram showing a data structure of a TS header 1301H of each of a sequence of TS packets constituting multiplexed stream data.

FIG. 13B is a schematic diagram showing a format of the TS packet sequence.

FIG. 13C is a schematic diagram of a format of a source packet sequence composed of the TS packet sequence.

FIG. 13D is a schematic diagram of a sector group, in which a sequence of source packets 1302 is contiguously recorded, in the volume area of the BD-ROM disc 101.

FIG. 14 is a schematic diagram showing a data structure of a PG stream 1400.

FIG. 15 is a schematic diagram showing the pictures for a base-view video stream 1501 and a right-view video stream 1502 in order of presentation time.

FIG. 16 is a schematic diagram showing a data structure of a video stream 1600.

FIG. 17 is a schematic diagram showing details on a method for storing a video stream 1701 into a PES packet sequence 1702.

FIG. 18 is a schematic diagram showing correspondence between PTSs and DTSs assigned to each picture in a base-view video stream 1801 and a dependent-view video stream 1802.

FIG. 19 is a schematic diagram showing a data structure of offset metadata 1910 included in a dependent-view video stream 1900.

FIGS. 20A and 20B are schematic diagrams each showing offset controls for a PG plane 2010 and IG plane 2020.

FIG. 20C is a schematic diagram showing a 3D graphics image that a viewer 2030 is made to perceive from 2D graphics images rendered on graphics planes shown in FIGS. 20A and 20B.

FIGS. 21A and 21B are graphs each showing an example of an offset sequence.

FIG. 21C is a schematic diagram showing 3D graphics images reproduced in accordance with the offset sequences shown in FIGS. 20A and 20B.

FIG. 22 is a schematic diagram showing a data structure of a PMT 2210.

FIG. 23 is a schematic diagram showing a physical arrangement of the main TS and one of the first sub-TS and second sub-TS, all of which are shown in FIG. 11, on the BD-ROM disc 101.

FIG. 24A is a schematic diagram showing an arrangement of the main TS 2401 and sub-TS 2402 separately recorded to be contiguous on a BD-ROM disc.

FIG. 24B is a schematic diagram showing an interleaved arrangement of dependent-view data blocks D[0], D[1], D[2], . . . and base-view data blocks B[0], B[1], B[2], . . . recorded alternately on the BD-ROM disc 101 according to Embodiment 1 of the present invention.

FIGS. 24C and 24D are schematic diagrams showing examples of the extent ATC times for a group of dependent-view data blocks D[n] and a group of base-view data blocks B[n] recorded in an interleaved arrangement (n=0, 1, 2).

FIG. 25 is a schematic diagram showing a method to align extent ATC times between contiguous data blocks.

FIG. 26 is a schematic diagram showing a playback path 2601 in 2D playback mode and a playback path 2602 in 3D playback mode for a group of extent blocks 2301-2303 shown in FIG. 23.

FIG. 27 is a block diagram showing a playback processing system in the playback device 102 in 2D playback mode.

FIG. 28A is a graph showing changes in a data amount DA stored in a read buffer 2702, shown in FIG. 27, during operation in 2D playback mode.

FIG. 28B is a schematic diagram showing a correspondence between an extent block 2810 to be played back and a playback path 2820 in 2D playback mode.

FIG. 29 is an example of a correspondence table between jump distances S_{JUMP} and maximum jump times T_{JUMP}_{_{—}}_{MAX} for a BD-ROM disc.

FIG. 30 is a block diagram showing a playback processing system in the playback device 102 in 3D playback mode.

FIGS. 31A and 31B are graphs showing changes in data amounts DA1 and DA2 stored in read buffers RB1 3011 and RB2 3012 shown in FIG. 30, when 3D video images are seamlessly played back from one extent block.

FIG. 31C is a schematic diagram showing a correspondence between an extent block 3110 to be played back and a playback path 3120 in 3D playback mode.

FIG. 32 is a schematic diagram showing a data structure of a first clip information file (01000.clpi) 1031 shown in FIG. 10.

FIG. 33A is a schematic diagram showing a data structure of an entry map 3230 shown in FIG. 32.

FIG. 33B is a schematic diagram showing source packets that are associated with each values of EP_ID 3305 by the entry map 3230, from among a source packet group 3310 belonging to a file 2D 1041 shown in FIG. 10.

FIG. 33C is a schematic diagram showing a data block group D[n], B[n] (n=0, 1, 2, 3 . . . ) on the BD-ROM disc 101 corresponding to the source packet group 3310.

FIG. 34A is a schematic diagram showing a data structure of an extent start point 3242 shown in FIG. 32.

FIG. 34B is a schematic diagram showing a data structure of an extent start point 3420 included in a second clip information file (02000.clpi) 1032 shown in FIG. 10.

FIG. 34C is a schematic diagram showing base-view data blocks B[0], B[1], B[2], . . . extracted by the playback device 102 in 3D playback mode from a first file SS 1045 shown in FIG. 10.

FIG. 34B is a schematic diagram showing a correspondence between SPNs 3422 shown by the extent start point 3420 and dependent-view extents EXT2[0], EXT2[1], . . . belonging to a first file DEP (02000.m2ts) 1042, shown in FIG. 10.

FIG. 34E is a schematic diagram showing a correspondence between an extent SS EXTSS[0] belonging to the first file SS 1045 and extent blocks on the BD-ROM disc 101.

FIG. 35 is a schematic diagram showing a correspondence between one extent block 3500 recorded on the BD-ROM disc 101 and each of the extent block groups in a file 2D 3510, file base 3511, file DEP 3512, and file SS 3520.

FIG. 36 is a schematic diagram showing an example of entry points set in a base-view video stream 3610 and a dependent-view video stream 3620.

FIG. 37 is a schematic diagram showing a data structure of a 2D playlist file (00001.mpls) 1021 shown in FIG. 10.

FIG. 38 is a schematic diagram showing a data structure of playitem information PI #N having a playitem ID=#N (N=1, 2, 3 . . . ).

FIG. 39A is a schematic diagram showing a relation between two playback sections PI #(N−1) and PI #N to be connected when the connection condition is “5” and FIG. 39B shows a relation between the two playback sections when the connection condition is “6”.

FIG. 40 is a schematic diagram showing a correspondence between PTSs indicated by the 2D playlist file (00001.mpls) 1021 shown in FIG. 37 and sections played back from the file 2D (01000.m2ts) 1041.

FIG. 41 is a schematic diagram showing a data structure of a 3D playlist file (00002.mpls) 1022 shown in FIG. 10.

FIG. 42 is a schematic diagram showing an STN table 4205 included in a main path 4101 of the 3D playlist file 1022 shown in FIG. 41.

FIG. 43 is a schematic diagram showing a data structure of the STN table SS 4130 shown in FIG. 41.

FIG. 44 is a schematic diagram showing a correspondence between PTSs indicated by the 3D playlist file (00002.mpls) 1022 shown in FIG. 41 and sections played back from the first file SS (01000.ssif) 1045.

FIG. 45 is a schematic diagram showing a data structure of an index file (index.bdmv) 1011 shown in FIG. 10.

FIG. 46 is a flowchart of processing whereby the playback device 102 selects a playlist file for playback by using six types of determination processes (1)-(6), with reference to the item “title 3” of an index table 4510 shown in FIG. 45.

FIG. 47 is a functional block diagram of a 2D playback device 4700.

FIG. 48 is a list of system parameters (SPRMs) stored in a player variable storage unit 4736 shown in FIG. 47.

FIG. 49 is a flowchart of playback processing by the 2D playback device 4700 shown in FIG. 47.

FIG. 50 is a flowchart of 2D playlist playback processing by a playback control unit 4735 shown in FIG. 47.

FIG. 51 is a functional block diagram of the system target decoder 4723 shown in FIG. 47.

FIG. 52A is a flowchart of processing whereby a PG decoder 5172 shown in FIG. 51 decodes a graphics object from one data entry in the PG stream.

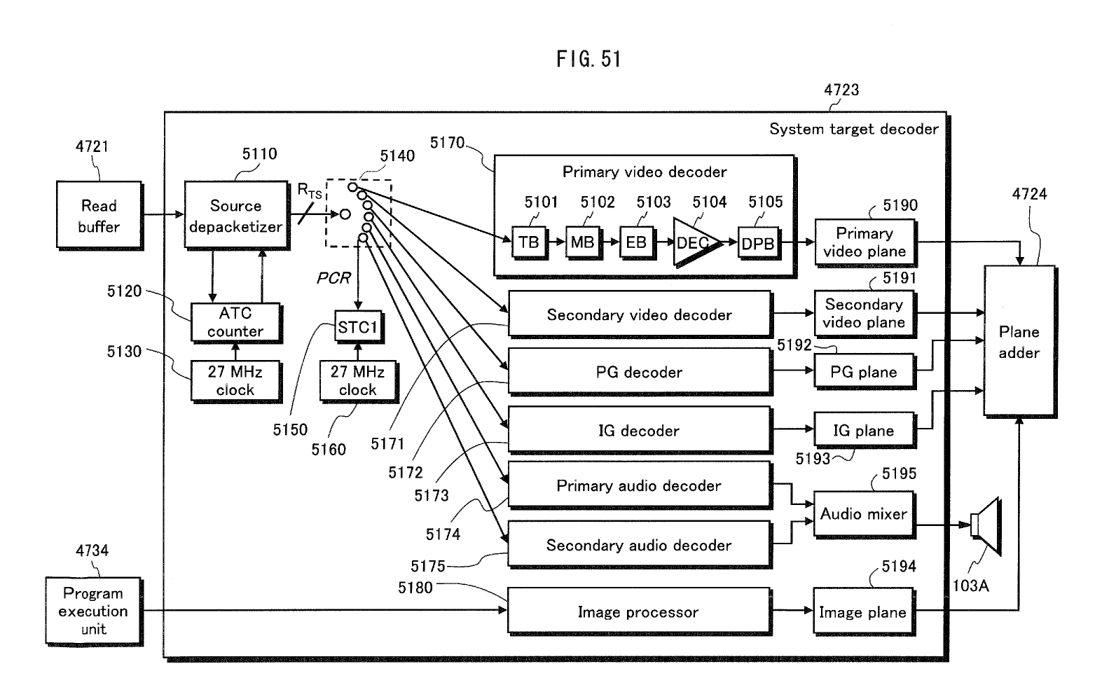

FIGS. 51B-51E are schematic diagrams showing the graphics object changing as the processing proceeds.

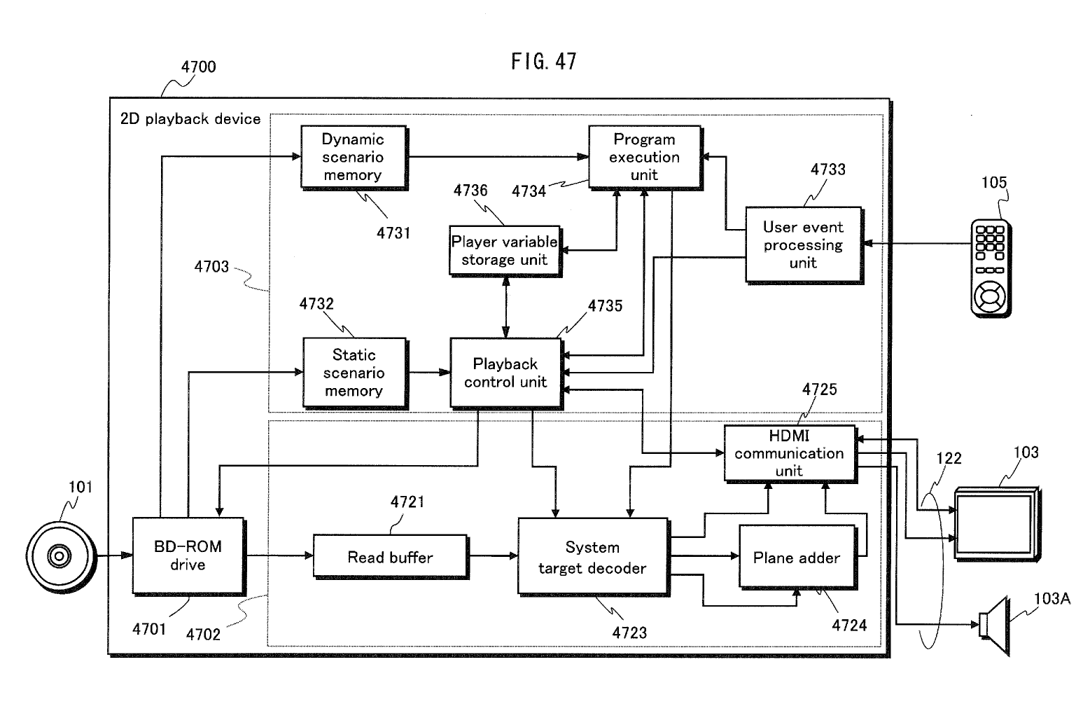

FIG. 53 is a functional block diagram showing a structure of an HDMI communication unit 4725 shown in FIG. 47.

FIG. 54 is a functional block diagram of a 3D playback device 5400.

FIG. 55 is a flowchart of playback processing by the 3D playback device 5400 shown in FIG. 54.

FIG. 56 is a flowchart of 3D playlist playback processing by a playback control unit 5435 shown in FIG. 54.

FIG. 57 is a functional block diagram of a system target decoder 5423 shown in FIG. 54.

FIG. 58 is a functional block diagram of a plane adder 5424 shown in FIG. 54 in 1 plane+offset mode or 1 plane+zero offset mode.

FIG. 59 is a flowchart of offset control by cropping units 5831-5834 shown in FIG. 58.

FIG. 60 are schematic diagrams showing PG planes GP, RGP, and LGP before and after offset control by a second cropping unit 5832 shown in FIG. 58, and the PG plane RGP shown in FIG. 60A is with a left offset, the PG plane GP shown in FIG. 60B is before offset control, the PG plane data LGP shown in FIG. 60C is with a left offset.

FIG. 61 is a partial functional block diagram of the plane adder 5424 in 2 plane mode.

FIG. 62A is a schematic diagram showing VAU #N included in a video stream 6200 (where the letter N denotes an integer greater than or equal to 1).

FIG. 62B is a correspondence table between display types 6202 and display patterns 6203.

FIGS. 62C-62K are schematic diagrams of the respective display patterns.

FIG. 63 is a functional block diagram of a system of processing a primary video stream, included in the system target decoder 5423 according to Embodiment 2.

FIG. 64 is a flowchart of playback processing by the system of the 3D playback device shown in FIG. 63.

FIG. 65A is a schematic diagram showing a sequence of frames F_{3D}k (k=1, 2, 3, 4 . . . ) of 3D video images having a frame rate=24 fps.

FIG. 65B is a schematic diagram showing a sequence of left-view frames F_{L}k and a sequence of right-view frames F_{R}k that are transmitted by the playback device 102.

FIG. 65C is a schematic diagram of a sequence of left-view frames and a sequence of right-view frames that are displayed by the display device 103 at a frame rate=120 fps.

FIG. 66A is a schematic diagram showing a sequence of frames F_{3D}k (k=1, 2, 3, 4 . . . ) of 3D video images having a frame rate=24 fps.

FIG. 66B is a schematic diagram showing top fields TF_{L}k and bottom fields BF_{L}k of left-view frames, and top fields TF_{R}k and bottom fields BF_{R}k of right-view frames; the frames are transmitted by the playback device 102.

FIG. 66C is a schematic diagram showing the top and bottom fields TF_{L}k, BF_{L}k, TF_{R}k, and BF_{R}k that are alternately displayed for 1/120 seconds each by the display device 103.

FIG. 67 is a functional block diagram of a transmission device 6700.

FIG. 68A is a schematic diagram showing a playback path when extent ATC times and playback times of the video stream differ between contiguous base-view and dependent-view data blocks.

FIG. 68B is a schematic diagram showing a playback path when the playback times of the video stream are equal for contiguous base-view and dependent-view data blocks.

FIG. 69 is a functional block diagram of a recording device 6900 according to Embodiment 3 of the present invention.

FIGS. 70A and 70B are schematic diagrams respectively showing a left-view picture and a right-view picture used to display one scene of 3D video images.

FIG. 70C is a schematic diagram showing depth information calculated from these pictures by a video encoder 6902 shown in FIG. 69.

FIG. 71 is a flowchart of a method for recording movie content on a BD-ROM disc using the recording device 6900 shown in FIG. 69.

FIGS. 72A, 72B, and 72C are schematic diagrams illustrating the principle behind playback of 3D video images (stereoscopic video images) in a method using parallax video images.

FIG. 73 is a schematic diagram showing an example of constructing a left-view LVW and a right-view RVW from the combination of a 2D video image MVW and a depth map DPH.

FIG. 74A is a schematic diagram showing a data structure of decoding switch information A050.

FIG. 74B is a schematic diagram showing an example of decoding counters

A010 and A020 allocated to each picture in a base-view video stream A001 and a dependent-view video stream A002.

FIG. 74C is a schematic diagram showing another example of decoding counters A030 and A040 allocated to each picture in the video streams A001 and A002.

FIG. 75 is a schematic diagram illustrating the technology for ensuring the compatibility of an optical disc storing 3D video content with 2D playback devices.

FIGS. 76A and 76B are schematic views showing 2D video frames, respectively, before and after frame rate conversion by the 3-2 pulldown.

FIG. 77A is a schematic diagram showing the presentation time of each of 3D video frames F_{3D}k in content.

FIG. 77B is a schematic diagram showing a sequence of left-view frames F_{L}k and right-view frames F_{R}k (k=1, 2, 3 . . . ) that has a frame rate of 120 fps, and the schematic diagram also shows frame switching periods F_{LR}k and F_{RL}k provided between the frames.

FIG. 77C is a schematic diagram showing periods LSL and LSR during which the shutter glasses 104 controls the left and right lenses to be alternately transparent in sync with the switching periods F_{L}k, F_{R}k, F_{LR}k and F_{RL}k shown in FIG. 77B.

### DESCRIPTION OF EMBODIMENT

The following describes preferred embodiments of the present invention, with reference to the drawings.

### Embodiment 1

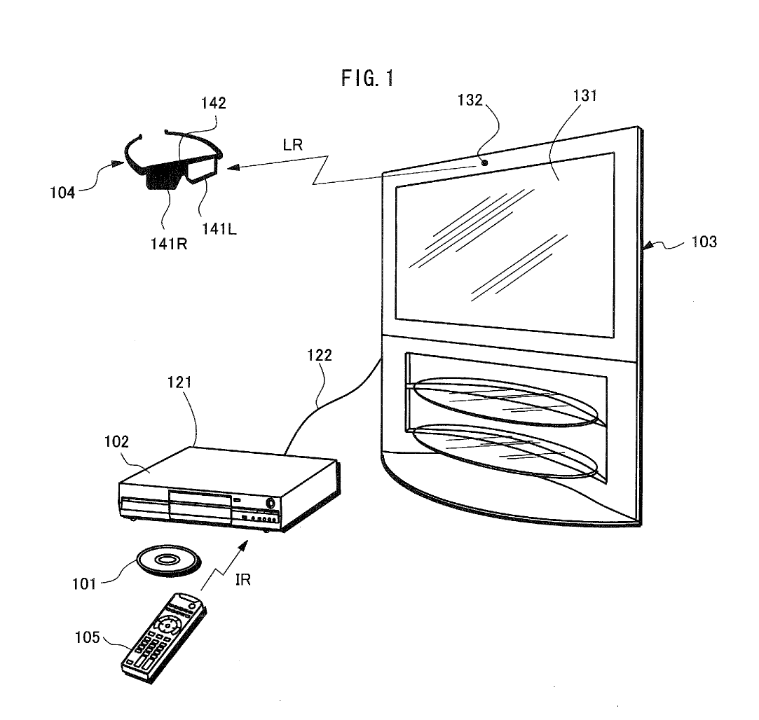

FIG. 1 is a schematic diagram showing a home theater system according to Embodiment 1 of the present invention. This home theater system adopts a 3D video image (stereoscopic video image) playback method that uses parallax video images, and in particular adopts an alternate-frame sequencing method as a display method (see <<Supplementary Explanation>> for details). As shown in FIG. 1, this home theater system includes a recording medium 101, a playback device 102, a display device 103, a pair of shutter glasses 104, and a remote control 105.

The recording medium 101 is a read-only Blu-ray disc (BD)™, i.e. a BD-ROM disc. The recording medium 101 can be a different portable recording medium, such as an optical disc with a different format such as DVD or the like, a removable hard disk drive (HDD), or a semiconductor memory device such as an SD memory card. This recording medium, i.e. the BD-ROM disc 101, stores movie content as 3D video images. This content includes a “left-view video stream” and a “right-view video stream”. The respective video streams represent sequences of left-view frames and of right-view frames of 3D video images. The content mentioned above may further include a “depth-map stream”. The depth-map stream represents a depth map for each frame of 3D video images. These video streams are arranged on the BD-ROM disc 101 in units of data blocks as described below and are accessed using a file structure described below. The left-view or right-view video stream is used by both a 2D playback device and a 3D playback device to play the content back as 2D video images. Conversely, a pair of left-view and right-view video streams, or a pair of a left-view or right-view video stream and a depth-map stream are used by a 3D playback device to play the content back as 3D video images.

A BD-ROM drive 121 is mounted on the playback device 102. The BD-ROM drive 121 is an optical disc drive conforming to the BD-ROM format. The playback device 102 uses the BD-ROM drive 121 to read content from the BD-ROM disc 101. The playback device 102 further decodes the content into video data/audio data. The playback device 102 is a 3D playback device and can play the content back as both 2D video images and as 3D video images. Hereinafter, the operational modes of the playback device 102 when playing back 2D video images and 3D video images are respectively referred to as “2D playback mode” and “3D playback mode”. Video data in 2D playback mode only includes either left-view frames or right-view frames. Video data in 3D playback mode includes both left-view frames and right-view frames.

Note that 3D playback mode is further divided into left/right (L/R) mode and depth mode. In “L/R mode”, pairs of left-view and right-view frames are played back from a combination of the left-view and right-view video streams. In “depth mode”, pairs of left-view and right-view frames are played back from a combination of the depth-map stream with either the left-view stream or right-view video stream. The playback device 102 is provided with an L/R mode. The playback device 102 may be further provided with a depth mode.

The playback device 102 is connected to the display device 103 via a High-Definition Multimedia Interface (HDMI) cable 122. The playback device 102 converts video data/audio data into serial signals in the HDMI format and transmits the signals to the display device 103 through the Transition Minimized Differential Signaling (TMDS) channel in the HDMI cable 122. Only either the left-view or right-view frames are multiplexed into video signal in 2D playback mode. Both left-view and right-view frames are time-multiplexed into video signal in 3D playback mode. Additionally, the playback device 102 exchanges Consumer Electronics Control (CEC) messages with the display device 103 through the CEC line in the HDMI cable 122. The playback device 102 can thus issue an inquiry to the display device 103 as to whether it supports playback of 3D video images. Additionally, the playback device 102 reads Extended Display Identification Data (EDID), which is data representing a response to the inquiry, from the display device 103 through a Display Data Channel (DDC) in the HDMI cable 122. Besides the above, the playback device 102 performs High-bandwidth Digital Content Protection (HDCP) authentication with the display device 103 through the DDC. With the use of a private key obtained as a result of the authentication, the playback device 102 encrypts video data and other data and transmits the encrypted data to the display device 103 via the HDMI cable 122.

The display device 103 is a liquid crystal display. Alternatively, the display device 103 may be another type of flat panel display, such as a plasma display, an organic EL display, etc., or a projector. The display device 103 displays video on the screen 131 in response to a video signal, and causes the built-in speaker to produce audio in response to an audio signal. The display device 103 supports playback of 3D video images. During playback of 2D video images, either the left view or the right view is displayed on the screen 131. During playback of 3D video images, the left view and right view are alternately displayed on the screen 131.

The display device 103 includes a left/right signal transmitting unit 132. The left/right signal transmitting unit 132 transmits a left/right signal LR to the shutter glasses 104 via infrared rays or by radio transmission. The left/right signal LR indicates whether the image currently displayed on the screen 131 is a left-view or a right-view image. During playback of 3D video images, the display device 103 detects switching of frames by distinguishing between a left-view frame and a right-view frame based on a control signal, such as a synchronous signal, or auxiliary data that accompanies a video signal. Furthermore, the display device 103 causes the left/right signal transmitting unit 132 to change the left/right signal LR in sync with the detected switching of frames.

The shutter glasses 104 include two liquid crystal display panels 141L and 141R and a left/right signal receiving unit 142. The liquid crystal display panels 141L and 141R respectively constitute the left and right lens parts. The left/right signal receiving unit 142 receives a left/right signal LR, and in accordance with changes therein, transmits the signal to the left and right liquid crystal display panels 141L and 141R. In response to the signal, each of the liquid crystal display panels 141L and 141R either lets light pass through the entire panel or shuts light out. For example, when the left/right signal LR indicates a left-view display, the liquid crystal display panel 141L for the left eye lets light pass through, while the liquid crystal display panel 141R for the right eye shuts light out. When the left/right signal LR indicates a right-view display, the display panels act oppositely. The two liquid crystal display panels 141L and 141R thus alternately let light pass through in sync with the switching of frames. As a result, when the viewer looks at the screen 131 while wearing the shutter glasses 104, the left view is shown only to the viewer's left eye, and the right view is shown only to the right eye. The viewer is made to perceive the difference between the images seen by each eye as the binocular parallax for the same stereoscopic image, and thus the video image appears to be stereoscopic.

The remote control 105 includes an operation unit and a transmitting unit. The operation unit includes a plurality of buttons. The buttons correspond to each of the functions of the playback device 102 and the display device 103, such as turning the power on or off, starting or stopping playback of the BD-ROM disc 101, etc. The operation unit detects when a user presses a button and conveys identification information for the button to the transmitting unit as a signal. The transmitting unit converts this signal into a signal IR and outputs it via infrared rays or radio transmission to the playback device 102 or the display device 103. On the other hand, the playback device 102 or display device 103 receives this signal IR, determines the button indicated by this signal IR, and executes the function associated with the button. If the function is of the playback device 102 or display device 103, the playback device 102 or display device 103 simply executes the function. If the function is of the other device, the playback device 102 or display device 103 causes the other device to execute the function with the use of, for example, a CEC message. In this way, the user can remotely control both the playback device 102 and the display device 103 with the same remote control 105.

### <Display Device>

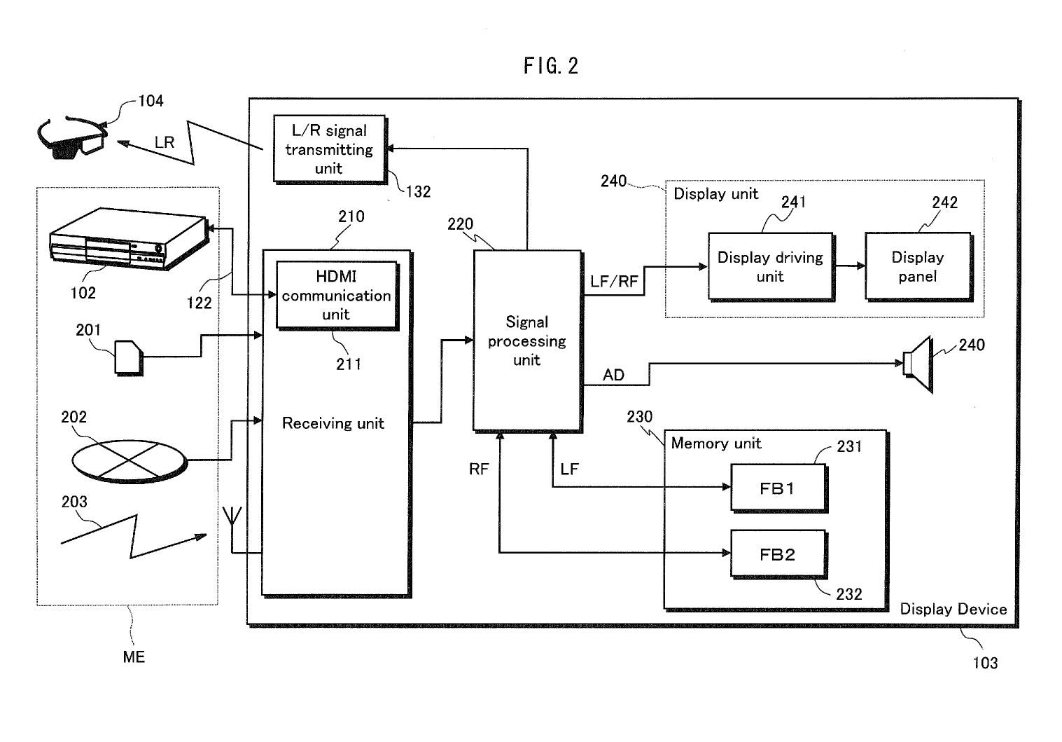

FIG. 2 is a functional block diagram showing a structure of the display device 103 shown in FIG. 1. As shown in FIG. 2, the display device 103 includes a receiving unit 210, a signal processing unit 220, a memory unit 230, a display unit 240 and a speaker 250, in addition to the left/right signal transmitting unit 132.

The receiving unit 210 receives stream data from the playback device 102 and also from any of various media including a memory card 201, an external network 202, and a broadcast wave 203. The stream data includes movie content of 3D video images. In particular, the receiving unit 210 includes an HDMI communication unit 211.

The signal processing unit 220 separates various types of data such as video, audio, graphics, etc., from the stream data, and individually processes the various types of data. Additionally, the signal processing unit 220 temporarily stores left-view frames LF and right-view frames RF to the memory unit 230, passes control signals, such as synchronous signals, accompanying a video signal and auxiliary data to the display unit 240, and sends audio data AD to the speaker 250. The signal processing unit 220 then alternately reads and transmits frames LF and RF from the memory unit 230 to the display unit 240. At this time, the signal processing unit 220 converts the frame rate of the frames to a higher value than the frame rate of 3D video images (=24 fps). In parallel with the transmission of the frames, the signal processing unit 220 issue instructions to the left/right signal transmitting unit 132 to change the left/right signal LR in sync with the switching of frames.

The memory unit 230 is a semiconductor memory device or Hard Disk Drive (HDD) internally provided in the display device 103. Alternatively, the memory unit 230 may be an external HDD connected to the display device 103. The memory unit 230 includes two frame buffers, namely FB1 231 and FB2 232. FB1 231 and FB2 232 are separate memory elements. Alternatively, FB1 231 and FB2 232 may be different areas of a single memory element or HDD. Each of FB1 231 and FB2 232 can store a two-dimensional array of pixel data. Elements of the array correspond one-to-one with pixels of a screen. FB1 231 receives and stores left-view frames LF from the signal processing unit 220, whereas FB2 232 receives and stores right-view frames RF.

The display unit 240 includes a display driving unit 241 and a display panel 242. The display driving unit 241 controls the display panel 242 in response to a control signal from the signal processing unit 220. As a result, left-view frames LF and right-view frames RF are alternately displayed one by one on the screen of the display panel 242 for a predetermined time period. The display panel 242 is a Liquid Crystal Display (LCD) panel. Alternatively, the display panel 242 may be any other types of display panels, such as a plasma display panel or an organic EL display panel. The speaker 250 is a speaker internally provided in the display device 103. Alternatively, the speaker 250 may be an external speaker connected to the display device 103.

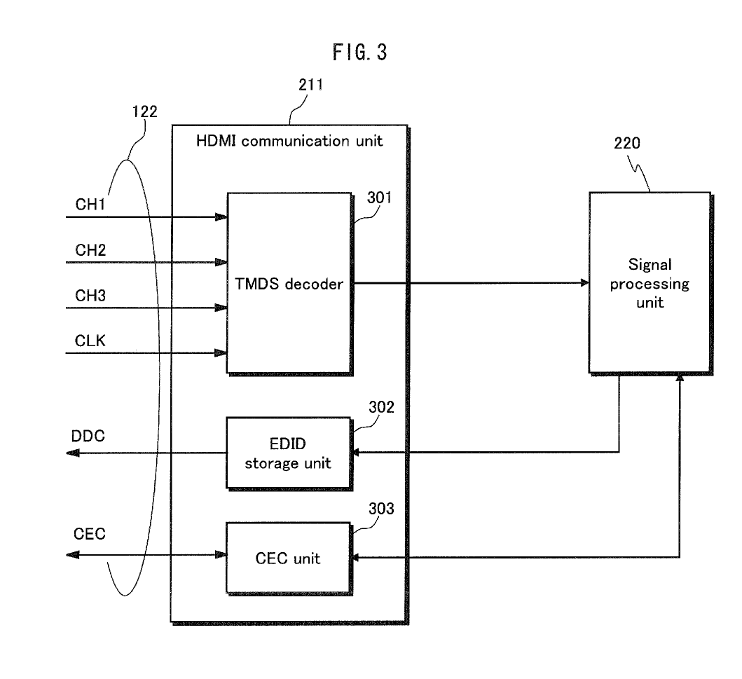

FIG. 3 is a functional block diagram showing a structure of the HDMI communication unit 211. The HDMI communication unit 211 is connected to the playback device 102 with the HDMI cable 122. With the connection, the HDMI communication unit 211 relays data to be exchanged between the playback device 102 and the signal processing unit 220. As shown in FIG. 3, the HDMI communication unit 211 includes a TMDS decoder 301, EDID storage unit 302, and CEC unit 303.

The TMDS decoder 301 receives a serial signal carrying video data, audio data, auxiliary data, and control signals, from the playback device 102 through the TMDS channels CH1, CH2, CH3 and CLK in the HDMI cable 122. The TMDS channels include three data channels CH1, CH2, and CH3 and one clock channel CLK. Each channel is composed of a pair of differential signal lines. During one cycle of the state change of the clock channel CLK, each data channel CH1-CH3 transmits 10 bits. For example, 8-bit pixel data of R, G and B, 4-bit audio data and 4-bit auxiliary data (an info frame), and a 2-bit control signal (containing a horizontal sync signal and a vertical sync signal) are each converted 10-bit data, and then transmitted through each data channel CH1-CH3. The TMDS decoder 301 decodes a sequence of the 10-bit data into video data and other data, and then passes the decoded data to the signal processing unit 220.

The EDID storage unit 302 is a semiconductor memory device internally provided with the HDMI communication unit 211 and connected to the playback device 102 through the display data channel DDC in the HDMI cable 122. The display data channel DDC is composed of a set of three differential signal lines including a ground line. The signal processing unit 220 stores parameters indicating functions, characteristics and states of the display device 103 in the EDID storage unit 302; the parameters are used as EDID. In particular, EDID contains information indicating whether or not the display device 103 has the playback function of 3D video images. In response to a request from the playback device 102, the EDID storage unit 302 supplies EDID through the display data channel DDC. Additionally, the display data channel DDC is used for HDCP authentication performed between the signal processing unit 220 and the playback device 102. The signal processing unit 220 and the playback device 102 share a single key through the HDCP authentication process. The playback device 102 encrypts video data and audio data with the shared key, whereas the signal processing unit 220 decrypts encrypted data into the video data and audio data with the shared key.

The CEC unit 303 exchanges CEC messages with the playback device 102 via a CEC line CEC in the HDMI cable 122. The CEC line CEC is composed of a single signal line. In particular, the CEC unit 303 receives a CEC message indicating information that the playback device 102 receives from the remote control 105 and notifies the signal processing unit 220 of the received CEC message. Reversely, the CEC unit 303 converts information received by the signal processing unit 220 from the remote control 105 into a CEC message and issues the CEC message to the playback device 102.

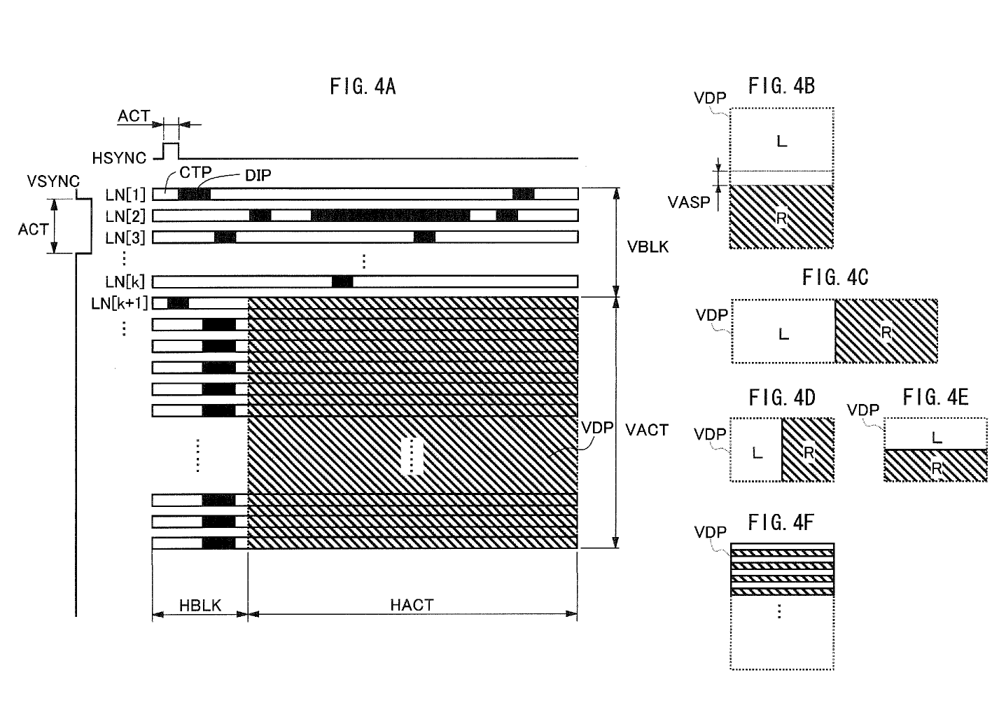

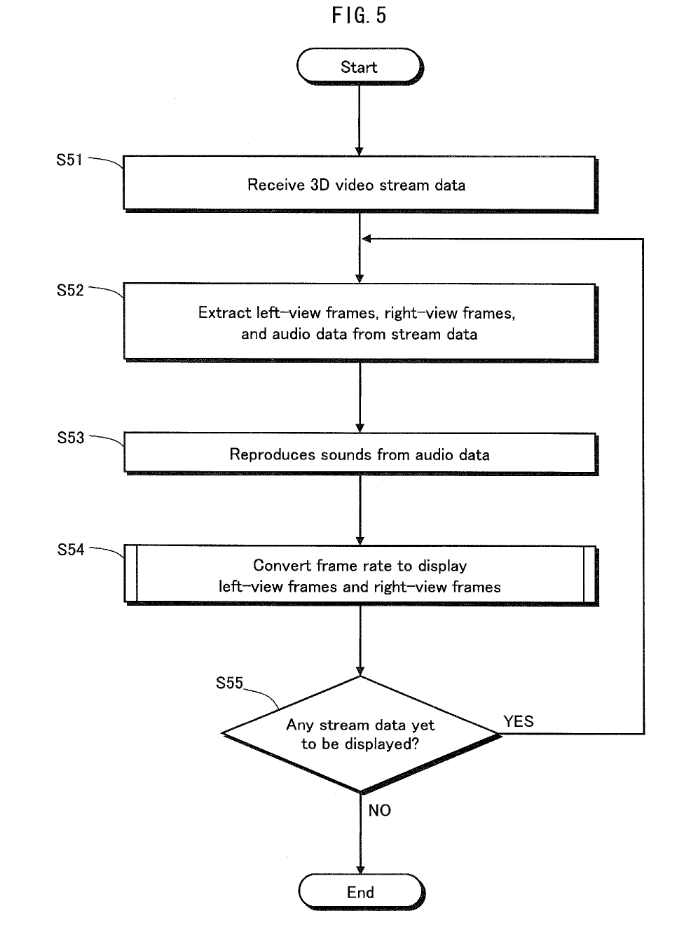

FIG. 4A is a schematic diagram showing a structure of data used to display one frame of 3D video; the data is included in data transmitted through the TMDS data channels CH1-CH3. With reference to FIG. 4A, horizontally long rectangles LN[1], LN[2], LN[3] . . . each represent a fixed-length data sequence called a “line”. Data used for displaying one 3D video frame is converted into a plurality of lines LN[1], LN[2], LN[3] . . . and sequentially transmitted line by line, starting from the top line shown in FIG. 4A. Each line is a sequence of a predetermined number of 8-bit (=1-byte) data pieces and sequentially transmitted, starting from the top data piece that corresponds to the left side shown in FIG. 4A. With further reference to FIG. 4A, the transmission period of each line is classified into the following three types: a control period CTP (represented by an open rectangle); a data-island period DIP (represented by a solid rectangle); and a video-data period VDP (represented by a hatched rectangle). In a control period CTP, a horizontal synchronous signal HSYNC, a vertical synchronous signal VSYNC, and other control signals are transmitted. In a data-island period DIP, audio data and auxiliary data are mainly transmitted. In a video-data period VDP, video data, especially pixel data, is transmitted. As shown in FIG. 4A, k lines from the top line LN[1] to the k-th line LN[k] (the letter k denotes an integer greater than or equal to 1) do not include any video-data period VDP and constitute a vertical blanking period VBLK. The remaining lines LN[k+1] . . . each include a video-data period VDP and constitute a vertical active period VACT. A vertical synchronous signal VSYNC stays active only during the first few lines LN[1], LN[2], LN[3] . . . in the vertical blanking period VBLK to indicate the transmission start of a new 3D video frame. In the vertical active period VACT, the top portion of each line does not include a video-data period VDP and constitutes a horizontal blanking period HBLK, and the remaining portion of each line only includes a video-data period VDP and constitutes a horizontal active period HACT. The horizontal synchronous signal VSYNC stays active only during the control periods CTP at the tops of the lines LN[1], LN[2], LN[3] . . . to indicate the respective transmission starts of the lines. A portion shared by the vertical active period VACT and the horizontal active period HACT is an active display area VACT×HACT and includes a pair of a left-view frame and a right-view frame that together constitutes one 3D video frame.

FIGS. 4B-4E are schematic diagrams each showing the types of arrangements of a left-view frame and a right-view frame in the active display area VACT×HACT shown in FIG. 4A. Each dashed rectangle VDP shown in the figures represents the active display area VACT×HACT. Each hatched portion shown in the figures represents the transmission period of a right-view frame. FIG. 4B illustrates a “frame packing method”. In this method, the number of lines constituting a vertical active period VACT is set to more than twice the number of lines constituting one 2D video frame. The left-view frame L is arranged in the first half of the active display area VACT×HACT, i.e. the upper portion of FIG. 4B, and the right-view frame R is arranged in the last half of the active display area, i.e. the lower portion of FIG. 4B. In addition, an active space VASP is provided between the frames L and R. The number of lines in the active space VASP equal to the number of lines in the vertical blanking period VBLK. The playback device 102 fills the active space VASP with fixed pixel data. On the other hand, the signal processing unit 220 ignores the pixel data in the active space VASP. FIG. 4C illustrates a “side-by-side method (full)”. In this method, the number of pixels constituting the horizontal active period HACT is set to twice the number of pixels in one 2D video frame. The first half of the horizontal active period HACT in each line includes a left-view frame L, whereas the last half thereof includes a right-view frame R. FIG. 4D illustrates a “side-by-side method (half)”. Unlike the active display area shown in FIG. 4C, the horizontal active period HACT is equal in number of pixels to one 2D video frame. The horizontal resolution of each of the left-view frame L and the right-view frame R is compressed by half, and then the left-view frame L is arranged in the first half of the horizontal active period HACT in each line and the right-view frame R is arranged in the last half thereof. FIG. 4E illustrates a “top-bottom method” (also referred to as over-under method). Unlike the active display area shown in FIG. 4B, the vertical active period VACT is equal in number of lines to one 2D video frame. The vertical resolution of each of the left-view frame L and the right-view frame is compressed by half, and then the left-view frame L is arranged in the first half of the vertical active period VACT and the right-view frame R is arranged in the last half thereof. FIG. 4F illustrates a “line alternative method.” Odd-numbered lines in the vertical active period VACT include a left-view frame, whereas even-numbered lines therein include a right-view frame. In this method, the number of lines constituting a vertical active period VACT is set to twice the number of lines constituting one 2D video frame.

FIG. 5 is a flowchart of processing of displaying 3D video images by the display device 103 shown in FIG. 2. This processing is triggered by receipt of a display request for 3D video images from a transmission source of stream data carrying the 3D video images, such as the playback device 102.

In step S51, the receiving unit 210 receives the stream data from the transmission source described above. In the case, for example, where the transmission source is the playback device 102, the HDMI communication unit 211 receives the stream data through the TMDS data channels CH1-CH3 after the transmission of EDID and HDCP authentication. Thereafter, processing proceeds to step S52.

In step S52, the signal processing unit 220 separates various types of data from the stream data, such as video, audio, graphics, etc. Additionally, the signal processing unit 220 temporarily stores left-view frames LF and right-view frames RF into the memory unit 230, passes a vertical synchronous signal VSYNC, a horizontal synchronous signal HSYNC, and other control signals along with auxiliary data to the display unit 240, and transmits audio data AD to the speaker 250. Thereafter, processing proceeds to step S53.

In step S53, the speaker 250 reproduces sounds from the audio data AD. In parallel with the above step, processing proceeds to step S54.

In step S54, the signal processing unit 220 alternately reads the frames LF and RF from FB1 231 and FB2 232 in the memory unit 230 and transmits the read frames to the display unit 240. At this time, the signal processing unit 220 converts the frame rate to a higher value than the frame rate of 3D video images (=24 fps), such as 100 fps, 120 fps, or 180 fps. In the display unit 240, the display driving unit 241 controls the display panel 242 according to a control signal received from the signal processing unit 220. This allows the left-view frames LF and right-view frames RF to alternately appear one by one on the screen of the display panel 242 for a predetermined time period, such as 1/100 seconds, 1/120 seconds, or 1/180 seconds. In addition, the signal processing unit 220 controls the left/right signal transmitting unit 132 to change the left/right signal LR in sync with the switching of the frames. In accordance with the change of the left/right signal, the shutter glasses 104 alternately cause the left and right liquid crystal display panels 141L and 141R to be transparent. As a result, a viewer watching the screen 131 through the shutter glasses 104 perceives a pair of a left-view frame LF and a right-view frame RF as a single 3D video frame. Thereafter, processing proceeds to step S55.

In step S55, the signal processing unit 220 checks whether or not the memory unit 230 still holds any stream data yet to be displayed. If any stream data is left, processing is repeated from step S52. If no stream data is left, processing terminates.

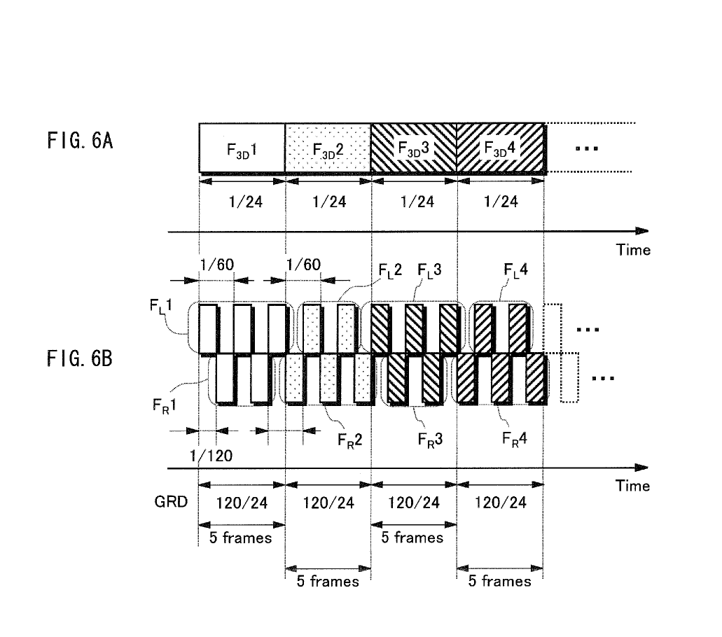

FIG. 6 are schematic diagrams showing a sequence of left-view frames F_{L}k and right-view frames F_{R}k that has a frame rate of 120 fps and is converted from the sequence of 3D video frames F_{3D}k (k=1, 3, 4) that has a frame rate=24 fps. As shown in FIG. 6A, the presentation time per 3D video frame F_{3D}k in content is set to 1/24 seconds. When alternately displaying the left-view frames F_{L}k and right-view frames F_{R}k for 1/120 seconds each based on the 3D video frames F_{3D}k, the signal processing unit 220 repeatedly transmits the frames in a manner shown in FIG. 6B. First, the first left-view frame F_{L}1 is repeatedly transmitted three times and the first right-view frame F_{R}1 is repeatedly transmitted twice; the transmission of the first left-view frame F_{L}1 is alternated with the transmission of the first right-view frame F_{R}1. Next, the second left-view frame F_{L}2 is repeatedly transmitted twice and the second right-view frame F_{R}2 is repeatedly transmitted three times; the transmission of the second left-view frame F_{L}2 is alternated with the transmission of the second right-view frame F_{R}2. Subsequently, the third left-view frame F_{L}3 is repeatedly transmitted three times and the third right-view frame F_{R}3 is repeatedly transmitted twice; the transmission of the third left-view frame F_{L}3 is alternated with the transmission of the third right-view frame F_{R}3. Then, the fourth left-view frame F_{L}4 is repeatedly transmitted twice and the fourth right-view frame F_{R}4 is repeatedly transmitted three times; the transmission of the fourth left-view frame F_{L}4 is alternated with the transmission of the fourth right-view frame F_{R}4. Thereafter, the subsequent frames are repeatedly transmitted in a similar manner. In this case, during the presentation period of each 3D video frame F_{3D}k, one of a left-view frame F_{L}k and a right-view frame F_{R}k is presented three times while the other is presented only two times. Thus, the number of display is different between the left-view frame F_{L}k and the right-view frame F_{R}k. However, a viewer sees as if a 3D video frame F_{3D}k is switched to the next frame each time five left-view frames F_{L}k and right-view frames F_{R}k are transmitted in total. That is, the presentation time of any 3D video frame F_{3D}k is equal to 1/120 seconds×5 frames≈0.42 seconds. In this way, any 3D video frame has equal presentation time, and therefore the motion of 3D video images can be more smoothly expressed.

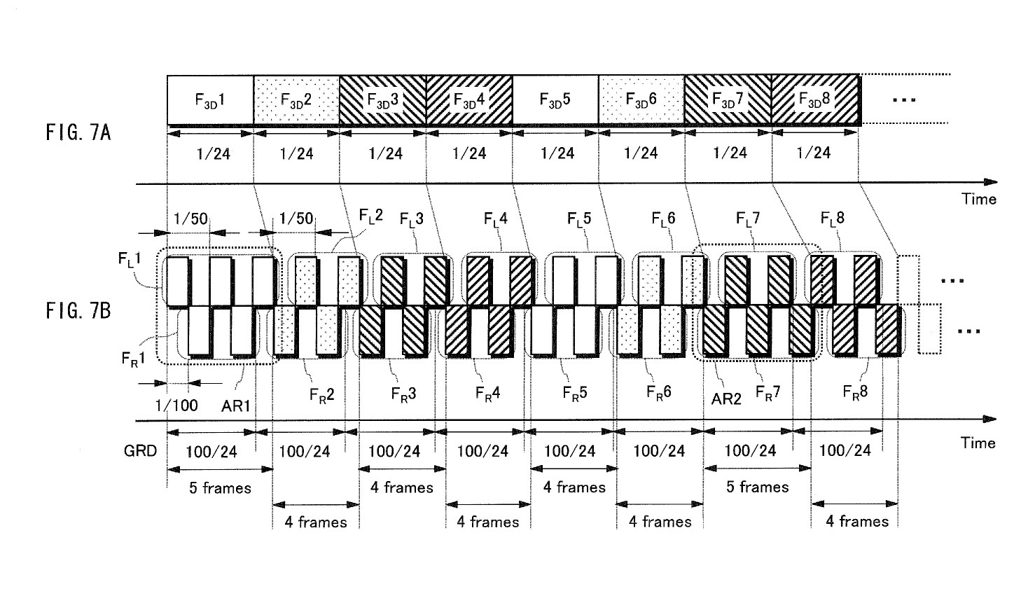

FIG. 7 are schematic diagrams showing a sequence of left-view frames F_{L}k and right-view frames F_{R}k that has a frame rate of 100 fps and is converted from the sequence of 3D video frames F_{3D}k (k=1, 2, . . . 7, 8) that has a frame rate=24 fps. As shown in FIG. 7A, the presentation time per 3D video frame F_{3D}k in content is set to 1/24 seconds. When alternately displaying the left-view frames F_{L}k and the right-view frames F_{L}k for 1/100 seconds each based on the 3D video frames F_{3D}k, the signal processing unit 220 repeatedly transmits the frames in a manner shown in FIG. 7B. First, the first left-view frame F_{L}1 is repeatedly transmitted three times and the first right-view frame F_{R}1 is repeatedly transmitted twice; the transmission of the first left-view frame F_{L}1 is alternated with the transmission of the first right-view frame F_{R}1. Next, the second left-view frame F_{L}2 is repeatedly transmitted twice and the second right-view frame F_{R}2 is repeatedly transmitted twice; the transmission of the second left-view frame F_{L}2 is alternated with the transmission of the second right-view frame F_{R}2. Thereafter, each of the third to sixth left-view frames F_{L}3 is repeatedly transmitted twice and each of the third to sixth right-view frames F_{R}3 is repeatedly transmitted twice; the transmission of the left-view frames F_{L}3-6 is alternated with the transmission of the right-view frames F_{R}3-6. Next, the seventh left-view frame F_{L}7 is repeatedly transmitted twice and the seventh right-view frame F_{R}7 is repeatedly transmitted three times; the transmission of the seventh left-view frame F_{L}7 is alternated with the transmission of the seventh right-view frame F_{R}7. Subsequently, the 8^{th} to 12^{th} left-view frames F_{L}k and right-view frames F_{R}k (k=8 . . . 12) are each repeatedly transmitted twice; the transmission of the left-view frames F_{L}8-12 is alternated with the transmission of the right-view frames F_{R}8-12. Thereafter, similar transmission processing is repeated for every twelve frames, i.e. every 1/100 seconds×{(3+2)+(2+2)×5+(2+3)+(2+2)×5}=0.5 seconds. In that case, a specific presentation period of a 3D video frame F_{3D}k occurs every 0.25 seconds as described below. As shown in areas AR1 and AR2 enclosed by bold dashed lines in FIG. 7B, during the specific presentation period, one of a left-view frame F_{L}k and a right-view frame F_{R}k is displayed three times, whereas the other is displayed only twice. As shown in FIG. 7B, each of the first 3D video frame F_{3D}1 and the seventh 3D video frame F_{3D}7 has presentation time of 1/100 seconds×5 frames=0.05 seconds, which is longer than the presentation time of each of the remaining frames F_{3D}k (k=2, 3 . . . 6, 8), i.e. 1/100 seconds×4 frames=0.04 seconds. However, the difference in presentation time is reduced to as short as the presentation time of one left-view or right-view frame, which is 1/100 seconds=0.01 seconds, and accordingly a viewer can hardly notice the difference in presentation time between adjacent 3D video frames F_{3D}k. In this way, any 3D video frame has substantially equal presentation time, and therefore the motion of 3D video images can be more smoothly expressed.

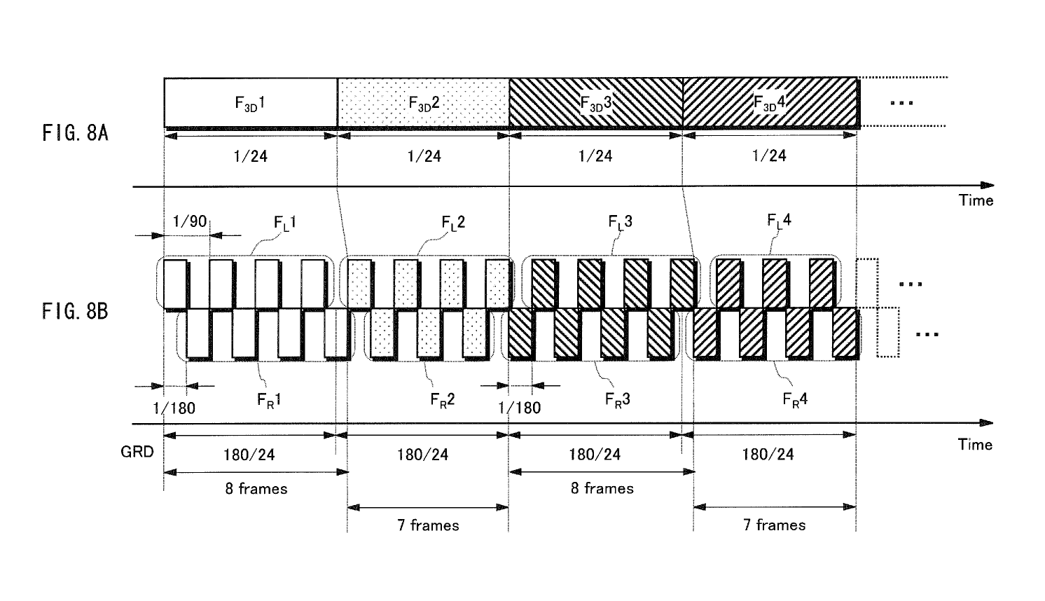

FIG. 8 are schematic diagrams showing a sequence of left-view frames F_{L}k and right-view frames F_{R}k that has a frame rate of 180 fps and is converted from a sequence of 3D video frames F_{3D}k (k=1, 2, 3, 4, . . . ) that has a frame rate=24 fps. As shown in FIG. 8A, the presentation time per 3D video frame F_{3D}k in content is set to 1/24 seconds. When alternately displaying left-view frames F_{L}k and right-view frames F_{R}k for 1/180 seconds each based on the sequence of the 3D video frames F_{3D}k, the signal processing unit 220 repeatedly transmits the frames in a manner shown in FIG. 8B. First, the first left-view frame F_{L}1 is repeatedly transmitted four times and the first right-view frame F_{R}1 is repeatedly transmitted four times; the transmission of the first left-view frame F_{L}1 is alternated with the transmission of the first right-view frame F_{R}1. Next, the second left-view frame F_{L}2 is repeatedly transmitted four times and the second right-view frame FR2 is repeatedly transmitted three times; the transmission of the second left-view frame F_{L}2 is alternated with the transmission of the second right-view frame F_{R}2. Subsequently, the third left-view frame F_{L}3 is repeatedly transmitted four times and the third right-view frame F_{R}3 is repeatedly transmitted four times; the transmission of the third left-view frame F_{L}3 is alternated with the transmission of the third right-view frame F_{R}3. Then, the fourth left-view frame F_{L}4 is repeatedly transmitted three times and the fourth right-view frame F_{R}4 is repeatedly transmitted four times; the transmission of the fourth left-view frame F_{L}4 is alternated with the transmission of the fourth right-view frame F_{R}4. Regarding the fifth and subsequent frames, similar transmission processing is repeated for every four frames, i.e. every 1/180 seconds×{(4+4)+(4+3)+(4+4)+(3+4)}≈0.17 seconds. In that case, as shown in FIG. 8B, during the presentation period of each of odd-numbered 3D video frames F_{3D}1 and F_{3D}3, each of a left-view frame F_{L}k and a right-view frame F_{R}k is displayed four times. In contrast, during the presentation period of each of even-numbered 3D video frames F_{3D}2 and F_{3D}4, one of a left-view frame F_{L}k and a right-view frame F_{R}k is displayed four times while the other is displayed only three times. As a result, each of the odd-numbered 3D video frames F_{3D}1 and F_{3D}3 has presentation time of 1/180 seconds×8 frames≈0.044 seconds, which is longer than the presentation time of each of the even-numbered frames F_{3D}2 and F_{3D}4, i.e. 1/180 seconds×7 frames≈0.039 seconds. However, the difference in presentation time is reduced to as short as the presentation time of one left-view or right-view frame, which is 1/180 seconds≈0.006 seconds, and accordingly a viewer can hardly notice the difference in presentation time between adjacent 3D video frames F_{3D}k. In this way, any 3D video frame has substantially equal presentation time, and therefore the motion of 3D video images can be more smoothly expressed.

The numbers of times for repeatedly displaying a left-view frame and a right-view frame during the presentation period of each 3D video frame shown in FIGS. 6B, 7B, and 8B may be provided to the signal processing unit 220 in advance. Alternatively, the signal processing unit 220 may use the following processing to switch 3D video frames F_{3D}k to be displayed. First, the signal processing unit 220 sets one of values 120/24=5, 100/24≈4.2 and 180/24=7.5 as a “switching grid” GRD. Those values are target frame rates 120 fps, 100 fps, and 180 fps divided by 24 fps, which is the frame rate of 3D video images. Next, the signal processing unit 220 monitors the total number of times left-view and right-view frames are displayed since the start of displaying the first left-view frame F_{L}1. Each time the total number exceeds an integral multiple of the switching grid GRD, the signal processing unit 220 switches from a current 3D video frame to the next frame. More specifically, in FIG. 6B, a current 3D video frame F_{3D}k is replaced with the next frame F_{3D}(k+1) each time the total number of times left-view and right-view frames are displayed, which has been counted since the display of the first left-view frame F_{L}1, reaches an integral multiple of the switching GRD=120/24, i.e. 5, 10, 15, . . . . In FIG. 7B, a current 3D video frame F_{3D}k is replaced with the next frame F_{3D}(k+1) each time the total number of times left-view and right-view frames are displayed reaches an integral multiple of the switching GRD=100/24, i.e. 4.2, 8.3, 12.5, . . . . In FIG. 8B, a current 3D video frame F_{3D}k is replaced with the next frame F_{3D}(k+1) each time the total number of times left-view and right-view frames are displayed reaches an integral multiple of the switching GRD=180/24, i.e. 7.5, 15, 22.5, . . . .

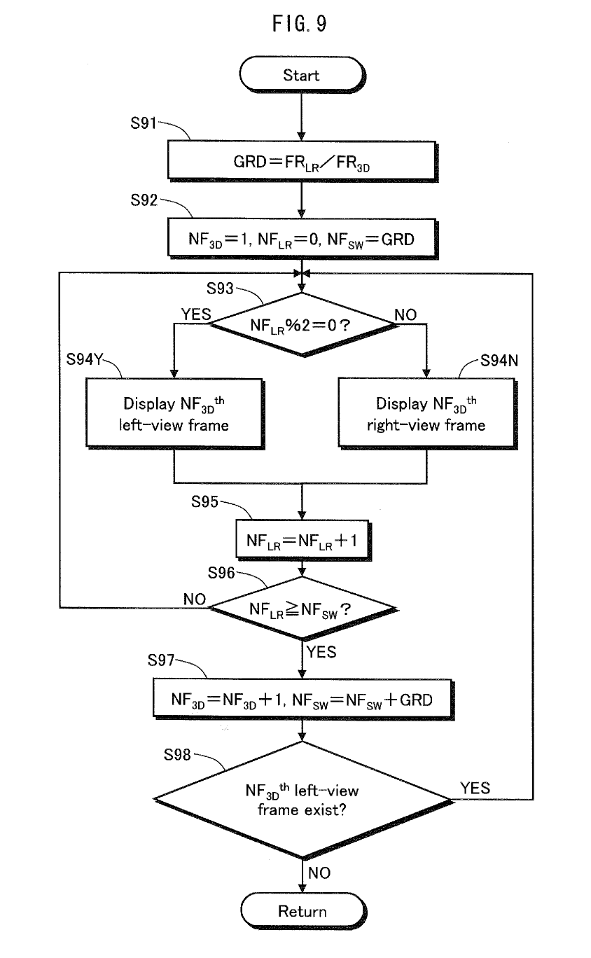

FIG. 9 is a flowchart of processing of displaying 3D video frames F_{3D}k by using the above-described processing performed by the signal processing unit 220. This processing begins when the signal processing unit 220 receives stream data from the receiving unit 210.

In step S91, the signal processing unit 220 sets the switching grid GRD to one of the values (=5, 4.2, and 7.5) respectively obtained by dividing the target frame rates FR_{LR} (=120 fps, 100 fps, and 180 fps) by the frame rate FR_{3D}(=24 fps): GRD=FR_{LR}/FR_{3D}. Thereafter, processing proceeds to step S92.

In step S92, the signal processing unit 220 initializes a 3D video frame number NF_{3D} to “1” and left-view/right-view frame number NF_{LR} to “0”: NF_{3D}=1, NF_{LR}=0. Note that the 3D video frame number NF_{3D} indicates the number of a frame to be currently displayed; the 3D video frames F_{3D}k shown in FIGS. 6A, 7A, and 8A are numbered from their top frame. On the other hand, the left-view/right-view frame number NF_{LR} indicates the total number of frames having been displayed so far among the left-view and right-view frames F_{L}k/F_{R}k shown in FIGS. 6B, 7B, and 8B. Furthermore, the signal processing unit 220 sets a frame number NF_{SW} indicating a frame to be replaced to the value of the switching grid GRD: N_{LRSW}=GRD. Thereafter, processing proceeds to step S93.

In step S93, the signal processing unit 220 determines whether the left-view/right-view frame number NF_{LR} is even or odd. If the left-view/right-view frame number NFLR is even, processing proceeds to step S94Y. If the left-view/right-view frame number NR_{LR} is odd, processing proceeds to step S94N.

In step S94Y, the signal processing unit 220 transfers a specific one of left-view frames each constituting a 3D video frame from FB1 231 to the display unit 240, so that the transferred frame is displayed on the display unit 240. The left-view frames are numbered from their top frame. The specific left-view frame has a number equal to the 3D video frame number NF_{3D}. Thereafter, processing proceeds to step S95.

In step S94N, the signal processing unit 220 transfers a specific one of right-view frames each constituting a 3D video frame from FB2 232 to the display unit 240, so that the transferred frame is displayed on the display unit 240. The right-view frames are numbered from their top frame. The specific right-view frame has a number equal to the 3D video frame number NF_{3D}. Thereafter, processing proceeds to step S95.

In step S95, the signal processing unit 220 increments the left-view/right-view frame number NF_{LR} by “1”: NF_{LR}=NF_{LR}+1. Thereafter, processing proceeds to step S96.

In step S96, the signal processing unit 220 determines whether the left-view/right-view frame number NF_{LR} is greater than or equal to the frame number N_{FSW} indicating a frame to be replaced. When the former number NF_{LR} is equal to or greater than the latter number N_{FSW}, processing proceeds to step S97. When the former number NF_{LR} is less than the latter number N_{FSW}, processing is repeated from step S93.

In step S97, the signal processing unit 220 increments the 3D video frame number NF_{3D} by “1”: NF_{3D}=NF_{3D}+1. The signal processing unit 220 also increments the frame number N_{FSW} indicating a frame to be replaced, by the value of the switching grid GRD: N_{FSW}=N_{FSW}+GRD. Thereafter, processing proceeds to step S98.

In step S98, the signal processing unit 220 determines whether or not FB1 231 stores the specific one of the left-view frames each constituting a 3D video frame, i.e. the left-view frame having the number equal to the 3D video frame number NF_{3D}. If FB1 231 stores the specific left-view frame, processing is repeated from step S93. If not, processing terminates.

As shown in FIGS. 6-8, the display device according to Embodiment 1 of the present invention reduces the difference in presentation time between individual 3D video frames to the presentation time per left-view or right-view frame. Consequently, the difference is not readily noticeable to viewers. In this way, the display device can ensure substantially equal presentation time of each 3D video frame, and therefore can express the motion of 3D video images more smoothly.

<Data Structure of the BD-ROM Disc>

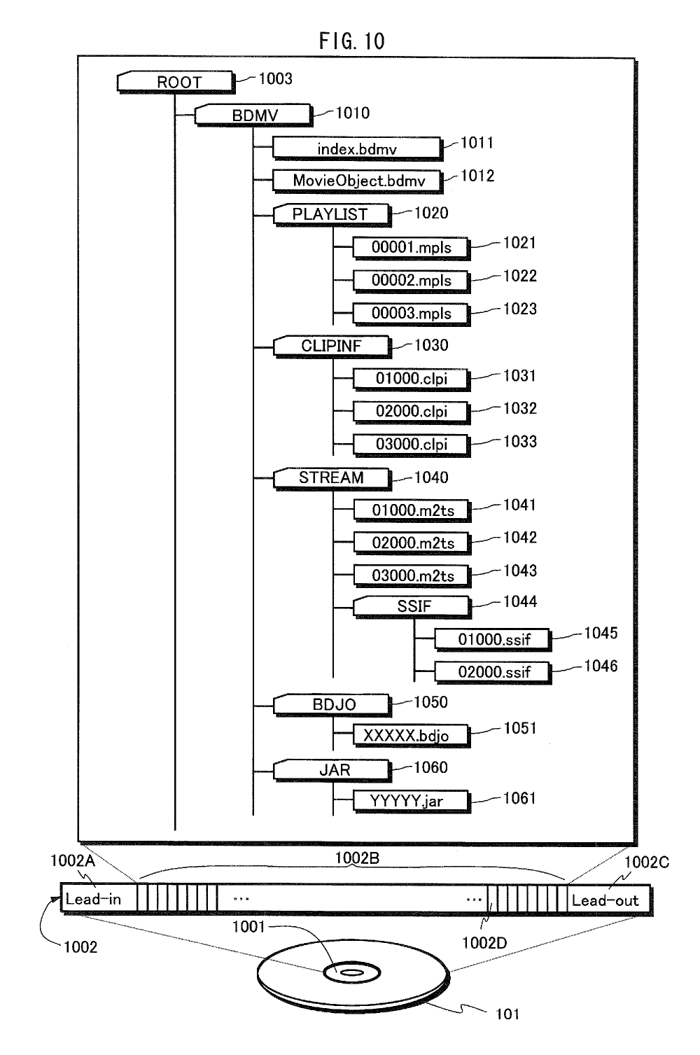

FIG. 10 is a schematic diagram showing a data structure of the BD-ROM disc 101. As shown in FIG. 10, a Burst Cutting Area (BCA) 1001 is provided at the innermost part of the data recording area on the BD-ROM disc 101. Only the BD-ROM drive 121 is permitted to access the BCA, and access by application programs is prohibited. The BCA 1001 can thus be used as technology for copyright protection. In the data recording area outside of the BCA 1001, tracks spiral from the inner to the outer circumference. In FIG. 10, a track 1002 is schematically extended in a transverse direction. The left side represents the inner circumferential part of the disc 101, and the right side represents the outer circumferential part. As shown in FIG. 10, the track 1002 contains a lead-in area 1002A, a volume area 1002B, and a lead-out area 1002C in order from the inner circumference. The lead-in area 1002A is provided immediately on the outside edge of the BCA 1001. The lead-in area 1002A includes information necessary for the BD-ROM drive 121 to access the volume area 1002B, such as the size, the physical address, etc. of the data recorded in the volume area 1002B. The lead-out area 1002C is provided on the outermost circumferential part of the data recording area and indicates the end of the volume area 1002B. The volume area 1002B includes application data such as video images, audio, etc.

The volume area 1002B is divided into small areas 1002D called “sectors”. The sectors have a common size, for example 2048 bytes. Each sector 1002D is consecutively assigned a serial number in order from the top of the volume area 1002B. These serial numbers are called logical block numbers (LBN) and are used in logical addresses on the BD-ROM disc 101. During reading of data from the BD-ROM disc 101, data to be read is specified through designation of the LBN for the destination sector. The volume area 1002B can thus be accessed in units of sectors. Furthermore, on the BD-ROM disc 101, logical addresses are substantially the same as physical addresses. In particular, in an area where the LBNs are consecutive, the physical addresses are also substantially consecutive. Accordingly, the BD-ROM drive 121 can consecutively read data from sectors having consecutive LBNs without making the optical pickup perform a seek.

The data recorded in the volume area 1002B is managed under a predetermined file system. Universal Disc Format (UDF) is adopted as this file system. Alternatively, the file system may be ISO9660. The data recorded on the volume area 1002B is represented in a directory/file format in accordance with the file system (see the <<Supplementary Explanation>> for details). In other words, the data is accessible in units of directories or files.

### <<Directory/File Structure on BD-ROM Disc>>

FIG. 10 further shows the directory/file structure of the data stored in the volume area 1002B on the BD-ROM disc 101. As shown in FIG. 10, in this directory/file structure, a BD movie (BDMV) directory 1010 is located directly below a ROOT directory 1003. Below the BDMV directory 1010 are an index file (index.bdmv) 1011 and a movie object file (MovieObject.bdmv) 1012.

The index file 1011 contains information for managing as a whole the content recorded on the BD-ROM disc 101. In particular, this information includes both information to make the playback device 102 recognize the content, as well as an index table. The index table is a correspondence table between a title constituting the content and a program to control the operation of the playback device 102. This program is called an “object”. Object types are a movie object and a BD-J (BD Java™) object.

The movie object file 1012 generally stores a plurality of movie objects. Each movie object includes a sequence of navigation commands. A navigation command is a control command causing the playback device 102 to execute playback processes similar to general DVD players. Types of navigation commands are, for example, a read-out command to read out a playlist file corresponding to a title, a playback command to play back stream data from an AV stream file indicated by a playlist file, and a transition command to make a transition to another title. Navigation commands are written in an interpreted language and are deciphered by an interpreter, i.e. a job control program, included in the playback device 102, thus making the control unit execute the desired job. A navigation command is composed of an opcode and an operand. The opcode describes the type of operation that the playback device 102 is to execute, such as bunching, playing back, or calculating a title, etc. The operand indicates identification information targeted by the operation such as the title number, etc. The control unit of the playback device 102 calls a movie object in response, for example, to a user operation and executes navigation commands included in the called movie object in the order of the sequence. In a manner similar to general DVD players, the playback device 102 first displays a menu on the display device 103 to allow the user to select a command. The playback device 102 then executes playback start/stop of a title, switches to another title, etc. in response to the selected command, thereby dynamically changing the progress of video playback.

As shown in FIG. 10, the BDMV directory 1010 further contains a playlist (PLAYLIST) directory 1020, a clip information (CLIPINF) directory 1030, a stream (STREAM) directory 1040, a BD-J object (BDJO: BD Java Object) directory 1050, and a Java archive (JAR: Java Archive) directory 1060.

Three types of AV stream files, (01000.m2ts) 1041, (02000.m2ts) 1042, and (03000.m2ts) 1043, as well as a Stereoscopic Interleaved File (SSIF) directory 1044 are located directly under the STREAM directory 1040. Two types of AV stream files, (01000.ssif) 1045 and (02000.ssif) 1046 are located directly under the SSIF directory 1044.

An “AV stream file” refers to a file, from among actual video content recorded on the BD-ROM disc 101, that complies with the file format determined by the file system. Such actual video content generally refers to stream data in which different types of stream data representing video, audio, subtitles, etc., i.e. elementary streams, have been multiplexed. This multiplexed stream data can be broadly divided into two types: a main transport stream (TS) and a sub-TS. A “main TS” is multiplexed stream data that includes a base-view video stream as a primary video stream. A “base-view video stream” is a video stream that can be played back independently and that represents 2D video images. A “sub-TS” is multiplexed stream data that includes a dependent-view video stream as a primary video stream. A “dependent-view video stream” is a video stream that requires a base-view video stream for playback and represents 3D video images by being combined with the base-view video stream. The types of dependent-view video streams are a right-view video stream, left-view video stream, and depth-map stream. When a playback device in L/R mode uses the 2D video images represented by the base-view video stream as the left view of 3D video images, the “right-view video stream” is used as a video stream representing the right view of the 3D video images. The reverse is true for a “left-view video stream”. When the 2D video images represented by the base-view video stream are used by a playback device in depth mode to project 3D video images on a virtual 2D screen, the “depth-map stream” is used as stream data representing a depth map for the 3D video image. In particular, the depth-map stream that is used when the base-view video stream represents the left view of 3D video images is referred to as a “left-view depth-map stream”, and the depth-map stream that is used when the base-view video stream represents the right view is referred to as a “right-view depth-map stream”.

Depending on the type of multiplexed stream data stored therein, AV stream files are divided into three types: file 2D, file dependent (hereinafter, abbreviated as “file DEP”), and interleaved file (hereinafter, abbreviated as “file SS”). A “file 2D” is an AV stream file for playback of 2D video images in 2D playback mode and includes a main TS. A “file DEP” is an AV stream file that includes a sub-TS. A “file SS” is an AV stream file that includes a main TS and a sub-TS representing the same 3D video images. In particular, a file SS shares its main TS with a certain file 2D and shares its sub-TS with a certain file DEP. In other words, in the file system on the BD-ROM disc 101, a main TS can be accessed by both a file SS and a file 2D, and a sub TS can be accessed by both a file SS and a file DEP. This setup, whereby a sequence of data recorded on the BD-ROM disc 101 is common to different files and can be accessed by all of the files, is referred to as “file cross-link”.

In the example shown in FIG. 10, the first AV stream file (01000.m2ts) 1041 is a file 2D, the second AV stream file (02000.m2ts) 1042 and the third AV stream file (03000.m2ts) 1043 are both a file DEP. In this way, files 2D and files DEP are located directly below the STREAM directory 1040. The first AV stream file, i.e. the base-view video stream that is included in the file 2D 1041, represents the left view of 3D video images. The second AV stream file, i.e. the dependent-view video stream that is included in the first file DEP 1042 represents a right view of the 3D video images. The third AV stream file, i.e. the dependent-view video stream that is included in the second file DEP 1043 is a depth-map stream.

In the example shown in FIG. 10, the fourth AV stream file (01000.ssif) 1045 and the fifth AV stream file (02000.ssif) 1046 are both a file SS. In this way, files SS are located directly below the SSIF directory 1044. The fourth AV stream file, i.e. the first file SS 1045, shares a main TS, and in particular a base-view video stream, with the file 2D 1041 and shares a sub-TS, in particular a right-view video stream, with the first file DEP 1042. The fifth AV stream file, i.e. the second file SS 1046, shares a main TS, and in particular a base-view video stream, with the file 2D 1041 and shares a sub-TS, in particular a depth-map stream, with the second file DEP 1043.

Three types of clip information files, (01000.clpi) 1031, (02000.clpi) 1032, and (03000.clpi) 1033 are located in the CLIPINF directory 1030. A “clip information file” is a file associated on a one-to-one basis with a file 2D and file DEP and in particular contains an entry map for each file. An “entry map” is a correspondence table between the presentation time for each scene represented by the file 2D or file DEP and the address within each file at which the scene is recorded. Among the clip information files, a clip information file associated with a file 2D is referred to as a “2D clip information file”, and a clip information file associated with a file DEP is referred to as a “dependent-view clip information file”. When a file DEP includes a right-view video stream, a dependent-view clip information file associated with the file DEP is referred to as a “right-view clip information file”. When a file DEP includes a depth-map stream, a dependent-view clip information file associated with the file DEP is referred to as a “depth map clip information file”. In the example shown in FIG. 10, the first clip information file (01000.clpi) 1031 is a 2D clip information file and is associated with the file 2D 1041. The second clip information file (02000.clpi) 1032 is a right-view clip information file and is associated with the first file DEP 1042. The third clip information file (03000.clpi) 1033 is a depth map clip information file and is associated with the second file DEP 1043.

Three types of playlist files, (00001.mpls) 1021, (00002.mpls) 1022, and (00003.mpls) 1023 are located in the PLAYLIST directory 1020. A “playlist file” is a file that specifies the playback path of an AV stream file, i.e. the part of an AV stream file for playback, and the order of playback. The types of playlist files are a 2D playlist file and a 3D playlist file. A “2D playlist file” specifies the playback path of a file 2D. A “3D playlist file” specifies, for a playback device in 2D playback mode, the playback path of a file 2D, and for a playback device in 3D playback mode, the playback path of a file SS. As shown in the example in FIG. 10, the first playlist file (00001.mpls) 1021 is a 2D playlist file and specifies the playback path of the file 2D 1041. The second playlist file (00002.mpls) 1022 is a 3D playlist file that specifies, for a playback device in 2D playback mode, the playback path of the file 2D 1041, and for a playback device in L/R mode, the playback path of the first file SS 1045. The third playlist file (00003.mpls) 1023 is a 3D playlist file that specifies, for a playback device in 2D playback mode, the playback path of the file 2D 1041, and for a playback device in depth mode, the playback path of the second file SS 1046.

A BD-J object file (XXXXX.bdjo) 1051 is located in the BDJO directory 1050. The BD-J object file 1051 includes a single BD-J object. The BD-J object is a bytecode program to cause a Java virtual machine implemented on the playback device 102 to play back a title and render graphics images. The BD-J object is written in a compiler language such as Java or the like. The BD-J object includes an application management table and identification information for the playlist file to which is referred. The “application management table” is a list of the Java application programs to be executed by the Java virtual machine and their period of execution, i.e. lifecycle. The “identification information of the playlist file to which is referred” identifies a playlist file that corresponds to a title to be played back. The Java virtual machine calls a BD-J object in response to a user operation or an application program and executes the Java application program according to the application management table included in the BD-J object. Consequently, the playback device 102 dynamically changes the progress of the video for each title played back, or causes the display device 103 to display graphics images independently of the title video.

A JAR file (YYYYY.jar) 1061 is located in the JAR directory 1060. The JAR directory 1061 generally includes a plurality of actual Java application programs to be executed in accordance with the application management table shown in the BD-J object. A “Java application program” is a bytecode program written in a compiler language such as Java or the like, as is the BD-J object. Types of Java application programs include programs causing the Java virtual machine to perform playback of a title and programs causing the Java virtual machine to render graphics images. The JAR file 1061 is a Java archive file, and when it is read by the playback device 102, it is unarchived in internal memory. In this way, a Java application program is stored in memory.

### <<Structure of Multiplexed Stream Data>>

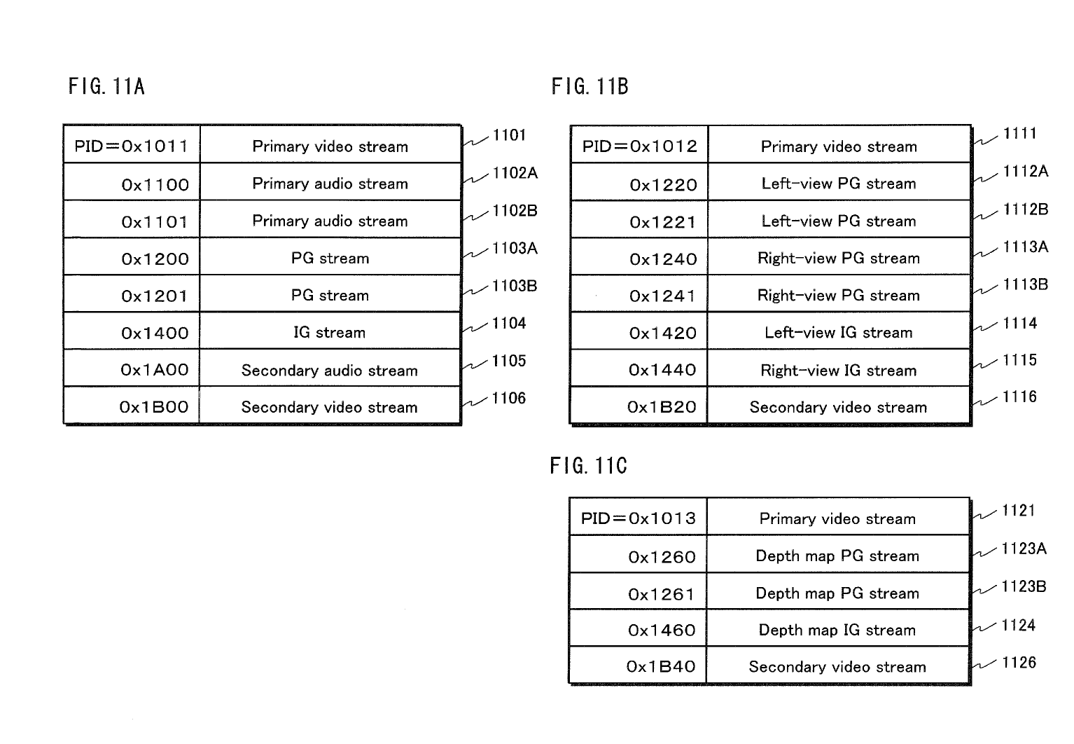

FIG. 11A is a list of elementary streams multiplexed into a main TS on the BD-ROM disc 101. The main TS is a digital stream in MPEG-2 Transport Stream (TS) format and includes the file 2D 1041 shown in FIG. 10. As shown in FIG. 11A, the main TS includes a primary video stream 1101 and primary audio streams 1102A and 1102B. The main TS may additionally include presentation graphics (PG) streams 1103A and 1103B, an interactive graphics (IG) stream 1104, a secondary audio stream 1105, and a secondary video stream 1106.

The primary video stream 1101 represents primary video of a movie and a secondary video stream 1106 represents secondary video. The primary video is the main video pertaining to the content, such as the main feature of a movie, and is displayed on the entire screen, for example. On the other hand, the secondary video is displayed on the screen simultaneously with the primary video with the use, for example, of a picture-in-picture method, so that the secondary video images are displayed in a smaller window within the primary video images. The primary video stream 1101 and the secondary video stream 1106 are both a base-view video stream. Each of the video streams 1101 and 1106 is encoded by a video compression encoding method, such as MPEG-2, MPEG-4 AVC, or SMPTE VC-1.

The primary audio streams 1102A and 1102B represent the primary audio of the movie. In this case, the two primary audio streams 1102A and 1102B are in different languages. The secondary audio stream 1105 represents secondary audio to be mixed with the primary audio, such as sound effects accompanying operation of an interactive screen. Each of the audio streams 1102A, 1102B, and 1105 is encoded by a method such as AC-3, Dolby Digital Plus (“Dolby Digital” is a registered trademark), Meridian Lossless Packing™ (MLP), Digital Theater System™ (DTS), DTS-HD, or linear Pulse Code Modulation (PCM).

Each of the PG streams 1103A and 1103B represents graphics images, such as subtitles formed by graphics, to be displayed superimposed on the video images represented by the primary video stream 1101. The two PG streams 1103A and 1103B represent, for example, subtitles in a different language. The IG stream 1104 represents Graphical User Interface (GUI) graphics elements, and the arrangement thereof, for constructing an interactive screen on the screen 131 in the display device 103.

The elementary streams 1101-1106 are identified by packet identifiers (PIDs). PIDs are assigned, for example, as follows. Since one main TS includes only one primary video stream, the primary video stream 1101 is assigned a hexadecimal value of 0x1011. When up to 32 other elementary streams can be multiplexed by type into one main TS, the primary audio streams 1102A and 1102B are each assigned any value from 0x1100 to 0x111F. The PG streams 1103A and 1103B are each assigned any value from 0x1200 to 0x121F. The IG stream 1104 is assigned any value from 0x1400 to 0x141F. The secondary audio stream 1105 is assigned any value from 0x1A00 to 0x1A1F. The secondary video stream 1106 is assigned any value from 0x1B00 to 0x1B1F.

FIG. 11B is a list of elementary streams multiplexed into a first sub-TS on the BD-ROM disc 101. The first sub-TS is multiplexed stream data in MPEG-2 TS format and is included in the first file DEP 1042 shown in FIG. 10. As shown in FIG. 11B, the first sub-TS includes a primary video stream 1111. Additionally, the first sub-TS may include left-view PG streams 1112A and 1112B, right-view PG streams 1113A and 1113B, left-view IG stream 1114, right-view IG stream 1115, and secondary video stream 1116. The primary video stream 1111 is a right-view video stream. When the primary video stream 1101 in the main TS represents the left view of 3D video images, the primary video stream 1111 represents the right view of the 3D video images. The pairs of left-view and right-view PG streams 1112A+1113A and 1112B+1113B represent the left view and right view of graphics images, such as subtitles, when these graphics images are displayed as 3D video images. The pair of left-view and right-view IG streams 1114 and 1115 represents the left view and right view of graphics images for an interactive screen when these graphics images are displayed as 3D video images. When the secondary video stream 1106 in the main TS represents the left view of 3D video images, the secondary video stream 1116 is a right-view video stream and represents the right view of the 3D video images.

PIDs are assigned to the elementary streams 1111-1116 as follows, for example. A PID of 0x1012 is assigned to the primary video stream 1111. When up to 32 other elementary streams can be multiplexed by type into one sub-TS, the left-view PG streams 1112A and 1112B are assigned any value from 0x1220 to 0x123F, and the right-view PG streams 1113A and 1113B are assigned any value from 0x1240 to 0x125F. The left-view IG stream 1114 is assigned any value from 0x1420 to 0x143F, and the right-view IG stream 1115 is assigned any value from 0x1440 to 0x145F. The secondary video stream 1116 is assigned any value from 0x1B20 to 0x1B3F.

FIG. 11C is a list of elementary streams multiplexed into a second sub-TS on the BD-ROM disc 101. The second sub-TS is multiplexed stream data in MPEG-2 TS format and is included in the second file DEP 1043 shown in FIG. 10. As shown in FIG. 11C, the second sub-TS includes a primary video stream 1121. Additionally, the second sub-TS may include depth map PG streams 1123A and 1123B, a depth map IG stream 1124 and a secondary video stream 1126. The primary video stream 1121 is a depth-map stream and represents 3D video images in combination with the primary video stream 1101 in the main TS. When the 2D video images represented by the PG streams 1103A and 1103B in the main TS are used to project 3D video images on a virtual 2D screen, the depth map PG streams 1123A and 1123B are each used as the PG streams representing a depth map for the 3D video images. When the 2D video images represented by the IG stream 1104 in the main TS are used to project 3D video images on a virtual 2D screen, the depth map IG stream 1124 is used as the IG stream representing a depth map for the 3D video images. The secondary video stream 1126 is a depth-map stream and represents 3D video images in combination with the secondary video stream 1106 in the main TS.

PIDs are assigned to the elementary streams 1121-1126 as follows, for example. A PID of 0x1013 is assigned to the primary video stream 1121. When up to 32 other elementary streams can be multiplexed by type into one sub-TS, the depth map PG streams 1123A and 1123B are assigned any value from 0x1260 to 0x127F. The depth map IG stream 1124 is assigned any value from 0x1460 to 0x147F. The secondary video stream 1126 is assigned any value from 0x1B40 to 0x1B5F.

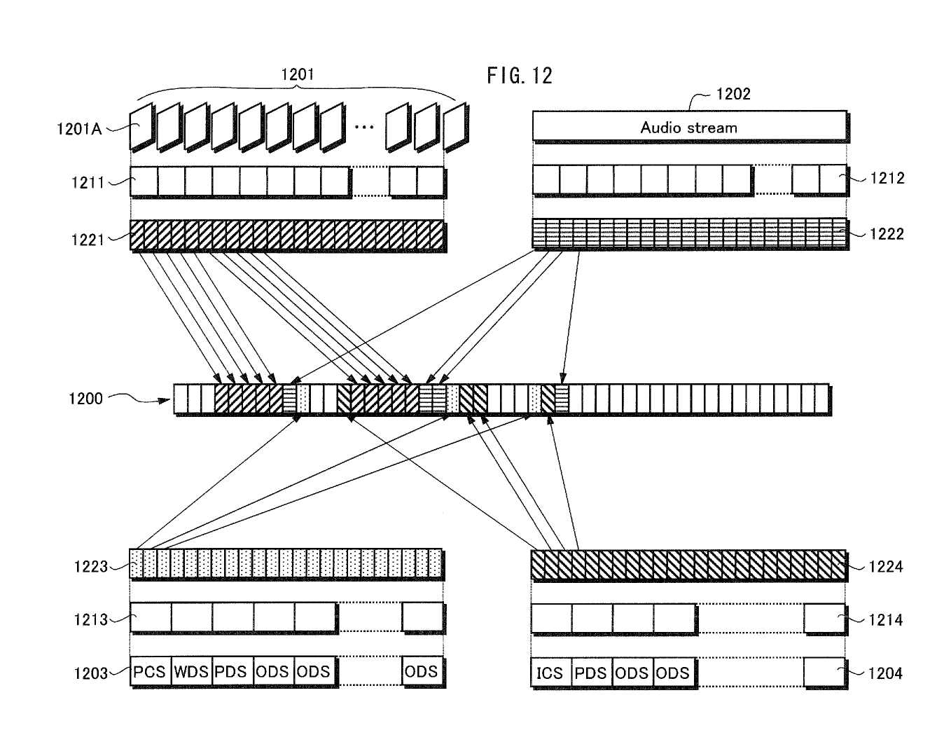

FIG. 12 is a schematic diagram showing the arrangement of TS packets in the multiplexed stream data 1200. The main TS and sub-TS share this packet structure. In the multiplexed stream data 1200, the elementary streams 1201, 1202, 1203, and 1204 are respectively converted into TS packet sequences 1221, 1222, 1223, and 1224. For example, in the video stream 1201, each frame 1201A or each field is first converted into one Packetized Elementary Stream (PES) packet 1211. Next, each PES packet 1211 is generally converted into a plurality of TS packets 1221. Similarly, the audio stream 1202, PG stream 1203, and IG stream 1204 are respectively first converted into PES packet sequences 1212, 1213, and 1214, after which they are converted into TS packet sequences 1222, 1223, and 1224. Finally, the TS packets 1221, 1222, 1223, and 1224 obtained from the elementary streams 1201, 1202, 1203, and 1204 are time-multiplexed into one piece of stream data, i.e. the main TS 1200.

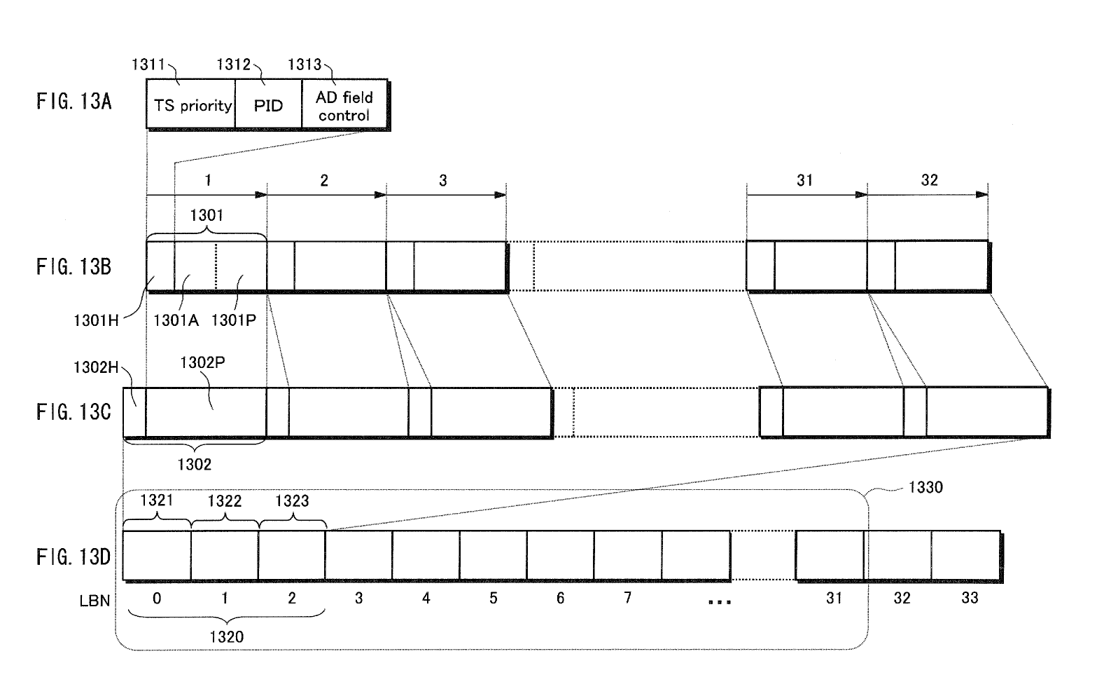

FIG. 13B is a schematic diagram showing a TS packet sequence constituting multiplexed stream data. Each TS packet 1301 is 188 bytes long. As shown in FIG. 13B, each TS packet 1301 includes a TS header 1301H and either, or both, a TS payload 1301P and an adaptation field (hereinafter abbreviated as “AD field”) 1301A. The TS payload 1301P and AD field 1301A together constitute a 184 byte long data area. The TS payload 1301P is used as a storage area for a PES packet. The PES packets 1211-1214 shown in FIG. 12 are typically divided into a plurality of parts, and each part is stored in a different TS payload 1301P. The AD field 1301A is an area for storing stuffing bytes (i.e. dummy data) when the amount of data in the TS payload 1301P does not reach 184 bytes. Additionally, when the TS packet 1301 is, for example, a PCR as described below, the AD field 1301A is used to store such information. The TS header 1301H is a four-byte long data area.

FIG. 13A is a schematic diagram showing the data structure of a TS header 1301H. As shown in FIG. 13A, the TS header 1301H includes TS priority (transport priority) 1311, PID 1312, and AD field control (adaptation field control) 1313. The PID 1312 indicates the PID for the elementary stream whose data is stored in the TS payload 1301P of the TS packet 1301 containing the PID 1312. The TS priority 1311 indicates the priority level of the TS packet 1301 among the TS packets that share the PID 1312 having the same value. The AD field control 1313 indicates whether the TS packet 1301 contains an AD field 1301A and/or a TS payload 1301P. For example, if the AD field control 1313 indicates “1”, then the TS packet 1301 does not include an AD field 1301A but includes a TS payload 1301P. If the AD field control 1313 indicates “2”, then the reverse is true. If the AD field control 1313 indicates “3”, then the TS packet 1301 includes both an AD field 1301A and a TS payload 1301P.

FIG. 13C is a schematic diagram showing the formation of a source packet sequence composed of the TS packet sequence for multiplexed stream data. As shown in FIG. 13C, each source packet 1302 is 192 bytes long and includes one TS packet 1301 and a four-byte long header (TP_Extra_Header) 1302H both shown in FIG. 13B. When the TS packet 1301 is recorded on the BD-ROM disc 101, a source packet 1302 is constituted by attaching a header 1302H to the TS packet 1301. The header 1302H includes an ATS (Arrival_Time_Stamp). The “ATS” is time information used as follows. When a source packet 1302 is sent from the BD-ROM disc 101 to a system target decoder in the playback device 102, the TS packet 1302P is extracted from the source packet 1302 and transferred to a PID filter in the system target decoder. The ATS in the header 1302H indicates the time at which this transfer is to begin. The “system target decoder” is a device that decodes multiplexed stream data one elementary stream at a time. Details regarding the system target decoder and its use of the ATS are provided below.

FIG. 13D is a schematic diagram of a sector group, in which a series of source packets 1302 are contiguously recorded, in the volume area 1002B of the BD-ROM disc 101. As shown in FIG. 13D, 32 source packets 1302 are recorded at a time as a sequence in three contiguous sectors 1321, 1322, and 1323. This is because the data amount for 32 source packets, i.e. 192 bytes×32=6144 bytes, is the same as the total size of three sectors, i.e. 2048 bytes×3=6144 bytes. Hereinafter, 32 source packets 1302 that are recorded in this way in three contiguous sectors 1321, 1322, and 1323 are referred to as an “aligned unit” 1320. The playback device 102 reads source packets 1302 from the BD-ROM disc 101 by each aligned unit 1320, i.e. 32 source packets at a time. Also, the sector group 1321, 1322, 1323, . . . is divided into 32 pieces in order from the top, and each forms one error correction code block 1330. The BD-ROM drive 121 performs error correction processing for each ECC block 1330.

### <<Data Structure of PG Stream>>

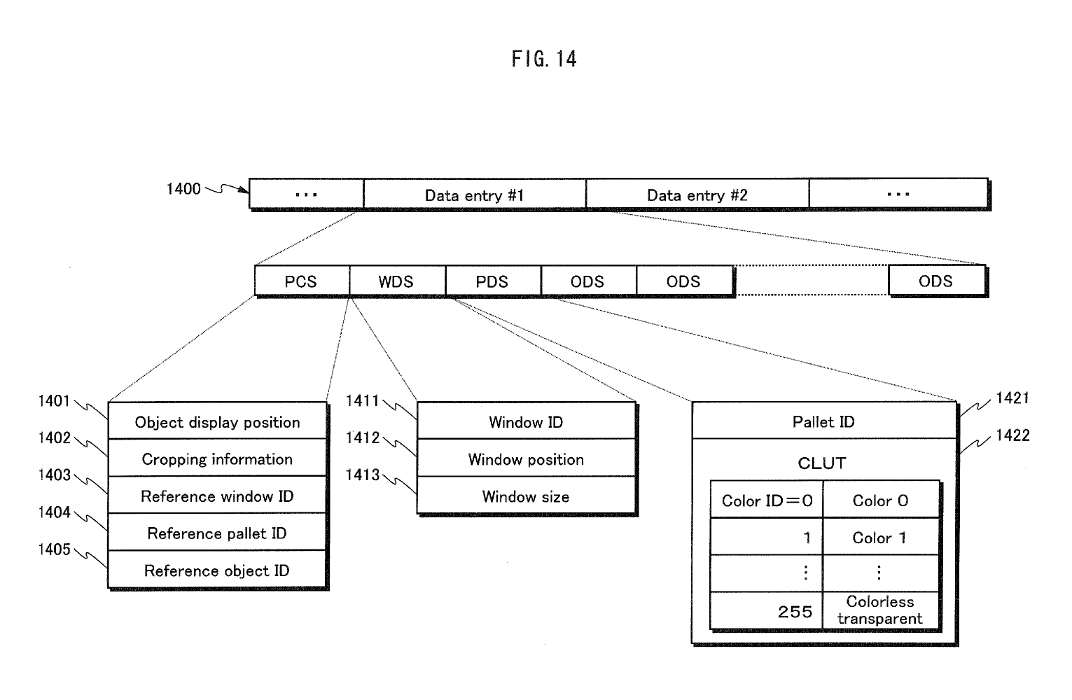

FIG. 14 is a schematic diagram showing a data structure of a PG stream 1400. As shown in FIG. 14, the PG stream 1400 includes a plurality of data entries #1, #2 . . . . . Each data entry represents a display set in the PG stream 1400 and is composed of data necessary for the playback device 102 to construct one graphics plane. A “graphics plane” refers to plane data generated from graphics data representing a 2D graphics image. In addition, “plane data” is a two-dimensional array of pixel data. The size of the array is the same as the resolution of the video frame. A set of pixel data is formed by a combination of a chromatic coordinate value and an α value (opaqueness). The chromatic coordinate value is expressed as an RGB value or a YCrCb value. Types of graphics planes include a PG plane, IG plane, image plane, and On-Screen Display (OSD) plane. An PG plane is generated from a PG stream included in the main TS. An IG plane is generated from an IG stream included in the main TS. An image plane is generated in accordance with a BD-J object. An OSD plane is generated in accordance with firmware in the playback device 102.

Referring again to FIG. 14, each data entry includes a plurality of functional segments. The functional segments include a Presentation Control Segment (PCS), Window Define Segment (WDS), Pallet Define Segment (PDS), and Object Define Segment (ODS) in the stated order.

The WDS defines a rectangular region inside the graphics plane, i.e. a window. In particular, the WDS includes a window ID 1411, window position 1412, and window size 1413. The window ID 1411 is identification information (ID) of the WDS. The window position 1412 indicates the position, such as the coordinates defining the top left corner, of the window on the graphics plane. The window size 1413 indicates the height and width of the window.

The PDS defines the correspondence between a predetermined type of color ID and a chromatic coordinate value (for example, luminance Y, red-difference Cr, blue-difference Cb, opaqueness α). In particular, the PDS includes a pallet ID 1421 and a Color Look-up Table (CLUT) 1422. The pallet ID 1421 is an ID of the PDS. The CLUT 1422 is a list of colors used for rendering graphics objects. In the CLUT 1422, up to 256 colors can be registered and color IDs ranging from “0” to “255” are assigned to different colors. Note that the color ID=255 is always assigned to “colorless transparent”.

Generally, a plurality of ODSs together represent one graphics object. A “graphics object” is data that represents a graphics image by the correspondence between pixel codes and color IDs. The graphics object is compressed by the run-length coding method and then divided into parts, which are then distributed to each ODS. Each ODS further includes an object ID, namely an ID of the graphics object.

The PCS shows details of a display set that belongs to the same data entry, and in particular defines a display composition that uses graphics objects. Types of display composition include Cut-In/Out, Fade-In/Out, Color Change, Scroll, and Wipe-In/Out. In particular, the PCS includes an object display position 1401, cropping information 1402, reference window ID 1403, reference pallet ID 1404, and reference object ID 1405. The object display position 1401 indicates a position in the graphics plane at which the graphics object is to be displayed, by, for example, coordinates defining the top left corner of an area in which the graphics object is to be displayed. The cropping information 1402 indicates the range of a rectangular part that is to be cut out of the graphics object by the cropping process. The range is defined, for example, by the coordinates of the top left corner, height, and width. The part is actually rendered at a position indicated by the object display position 1401. The reference window ID 1403, reference pallet ID 1404, and reference object ID 1405 indicate IDs of the WDS, PDS, and graphics object that are to be referred to in the graphics object rendering process, respectively. The content provider indicates the display composition to the playback device 102 by using these parameters in the PCS. This allows the playback device 102 to realize a display effect whereby “a certain subtitle gradually disappears, and the next subtitle is displayed”, for example.

### <<Data Structure of IG Stream>>

Referring yet again to FIG. 12, the IG stream 1204 includes an Interactive Composition Segment (ICS), PDS, and ODS. The PDS and ODS are the same functional segments as included in the PG stream 1203. In particular, a graphics object that includes an ODS represents a GUI graphics element, such as a button, pop-up menu, etc., that forms an interactive screen. An ICS defines interactive operations that use these graphics objects. Specifically, an ICS defines one of the normal, selected, and active states that each graphics object, such as a button, pop-up menu, etc. can take in response to user operations. An ICS also includes button information. Button information includes a command that the playback device is to perform when the user performs an operation of confirming entry on the button or the like.

### <<Data Structure of Video Stream>>

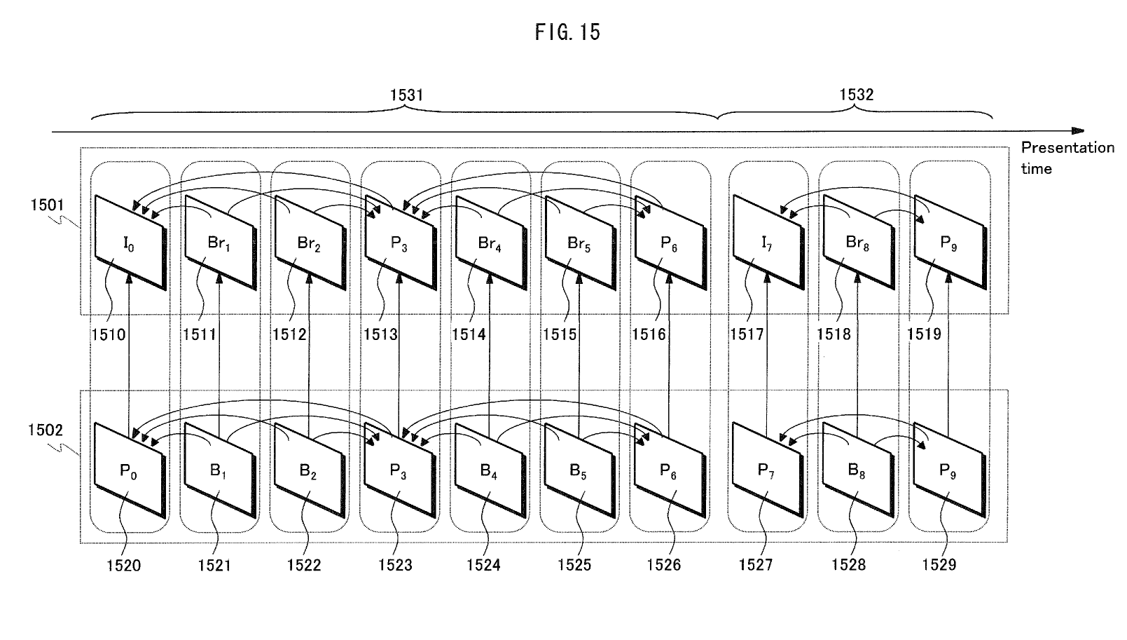

FIG. 15 is a schematic diagram showing the pictures for a base-view video stream 1501 and a right-view video stream 1502 in order of presentation time. As shown in FIG. 15, the base-view video stream 1501 includes pictures 1510, 1511, 1512, . . . , 1519 (hereinafter “base-view pictures”), and the right-view video stream 1502 includes pictures 1520, 1521, 1522, . . . , 1529 (hereinafter “right-view pictures”).

Each of the pictures 1510-1519 and 1520-1529 represents one frame or one field and is compressed by a video compression encoding method, such as MPEG-2, MPEG-4 AVC, etc.

This compression of each picture uses the spatial or temporal redundancy of that picture. Here, picture encoding that only uses the picture's spatial redundancy is referred to as “intra-picture encoding”. On the other hand, picture encoding that uses temporal redundancy, i.e. the similarity between data for a plurality of pictures displayed sequentially, is referred to as “inter-picture predictive encoding”. In inter-picture predictive encoding, first, a picture earlier or later in presentation time is assigned to the picture to be encoded as a reference picture. Next, a motion vector is detected between the picture to be encoded and the reference picture, and then motion compensation is performed using the motion vector. Furthermore, the difference value between the picture after the motion compensation and the picture to be encoded is sought, and spatial redundancy is removed using the difference value. In this way, the amount of data for each picture is compressed.

As shown in FIG. 15, the base-view pictures 1510-1519 are typically divided into a plurality of GOPs 1531 and 1532. A “GOP” refers to a sequence of pictures having an I (Intra) picture at the top of the sequence. An “I (Intra) picture refers to a picture compressed by intra-picture encoding. A GOP typically includes P (Predictive) pictures and B (Bidirectionally Predictive) pictures, in addition to the I picture. Here “P picture” refers to a picture compressed by the inter-picture predictive encoding by using one reference picture, which is either I picture or another P picture whose presentation time is before the presentation time of the picture to be compressed. On the other hand, “B picture” refers to a picture compressed by the inter-picture predictive encoding by using two reference pictures, each of which is either I picture or another P picture whose presentation time is before or after the presentation time of the picture to be compressed. Furthermore, B pictures that are used as a reference picture for other pictures in inter-picture predictive encoding are particularly referred to as “Br (reference B) pictures”.

In the example shown in FIG. 15, the base-view pictures in the GOPs 1531 and 1532 are compressed in the following order. In the first GOP 1531, the top base-view picture is compressed as I₀ picture 1510. The subscripted number indicates the serial number allotted to each picture in order of presentation time. Next, the fourth base-view picture is compressed as P₃ picture 1513 using L picture 1510 as a reference picture. Each arrow shown in FIG. 15 indicates that the picture at the head of the arrow is a reference picture for the picture at the tail of the arrow. Next, the second and third base-view pictures are respectively compressed as Br₁ picture 1511 and Br₂ picture 1512, using both L picture 1510 and P₃ picture 1513 as reference pictures. Furthermore, the seventh base-view picture is compressed as P₆ picture 1516 using P₃ picture 1513 as a reference picture. Next, the fourth and fifth base-view pictures are respectively compressed as Br₄ picture 1514 and Br₅ picture 1515, using both P₃ picture 1513 and P₆ picture 1516 as reference pictures. Similarly, in the second GOP 1532, the top base-view picture is first compressed as I₇ picture 1517. Next, the third base-view picture is compressed as P₉ picture 1519 using I₇ picture 1517 as a reference picture. Subsequently, the second base-view picture is compressed as Br₈ picture 1518 using both I₇ picture 1517 and P₉ picture 1519 as reference pictures.

In the base-view video stream 1501, each GOP 1531 and 1532 always contains an I picture at the top, and thus base-view pictures can be decoded GOP by GOP. For example, in the first GOP 1531, the I₀ picture 1510 is first decoded independently. Next, the P₃ picture 1513 is decoded using the decoded I₀ picture 1510. Then, the Br₁ picture 1511 and Br₂ picture 1512 are decoded using both the decoded I₀ picture 1510 and P₃ picture 1513. The subsequent picture group 1514, 1515, . . . is similarly decoded. In this way, the base-view video stream 1501 can be decoded independently and furthermore can be randomly accessed in units of GOPs.

As further shown in FIG. 15, the right-view pictures 1520-1529 are compressed by inter-picture predictive encoding. However, the encoding method differs from the encoding method for the base-view pictures 1510-1519, since in addition to redundancy in the temporal redundancy of video images, redundancy between the left and right-video images is also used. Specifically, as shown by the arrows in FIG. 15, the reference picture for each of the right-view pictures 1520-1529 is selected not only from the right-view video stream 1502 but also from the base-view video stream 1501. In particular, the presentation time is substantially the same for each of the right-view pictures 1520-1529 and the corresponding base-view picture selected as a reference picture. These pictures represent a pair of a right view and a left view for the same scene of a 3D video image, i.e. a parallax video image. The right-view pictures 1520-1529 and the base-view pictures 1510-1519 are thus in one-to-one correspondence. In particular, the GOP structure is the same between these pictures.

In the example shown in FIG. 15, the top right-view picture in the first GOP 1531 is compressed as P₀ picture 1520 using L picture 1510 in the base-view video stream 1501 as a reference picture. These pictures 1510 and 1520 represent the left view and right view of the top frame in the 3D video images. Next, the fourth right-view picture is compressed as P₃ picture 1523 using P₃ picture 1513 in the base-view video stream 1501 and P₀ picture 1520 as reference pictures. Next, the second right-view picture is compressed as B₁ picture 1521, using Br₁ picture 1511 in the base-view video stream 1501 in addition to P₀ picture 1520 and P₃ picture 1523 as reference pictures. Similarly, the third right-view picture is compressed as B₂ picture 1522, using Br₂ picture 1512 in the base-view video stream 1501 in addition to P₀ picture 1520 and P₃ picture 1530 as reference pictures. For each of the remaining right-view pictures 1524-1529, a base-view picture with a presentation time substantially the same as the right-view picture is similarly used as a reference picture.

The revised standards for MPEG-4 AVC/H.264, called Multiview Video Coding (MVC), are known as a video compression encoding method that makes use of correlation between left and right-video images as described above. MVC was created in July of 2008 by the Joint Video Team (JVT), a joint project between ISO/IEC MPEG and ITU-T VCEG, and is a standard for collectively encoding video that can be seen from a plurality of perspectives. With MVC, not only is temporal similarity in video images used for inter-video predictive encoding, but so is similarity between video images from differing perspectives. This type of predictive encoding has a higher video compression ratio than predictive encoding that individually compresses data of video images seen from each perspective.

As described above, a base-view picture is used as a reference picture for compression of each of the right-view pictures 1520-1529. Therefore, unlike the base-view video stream 1501, the right-view video stream 1502 cannot be decoded independently. On the other hand, however, the difference between parallax video images is generally very small; that is, the correlation between the left view and the right view is high. Accordingly, the right-view pictures generally have a significantly higher compression rate than the base-view pictures, meaning that the amount of data is significantly smaller.

Although not shown in FIG. 15, the depth-map stream includes a plurality of depth maps. The depth maps are in one-to-one correspondence with the base-view pictures and each represent a depth map for one frame or one field of a 2D video image represented by the corresponding base-view picture. The depth maps are compressed by a video compression encoding method, such as MPEG-2, MPEG-4 AVC, etc., in the same way as the base-view pictures. In particular, inter-picture predictive encoding is used in this encoding method. In other words, each depth map is compressed using another depth map as a reference picture. Furthermore, the depth-map stream is divided into units of GOPs in the same way as the base-view video stream, and each GOP always contains an I picture at the top. Accordingly, depth maps can be decoded GOP by GOP. However, since a depth map itself is only information representing the depth of each part of a 2D video image pixel by pixel, the depth-map stream cannot be used independently for playback of video images. The depth-map stream is compressed by the same video compression encoding method as that used to compress the right-view video stream. For example, if the right-view video stream is encoded in MVC format, the depth-map stream is also encoded in MVC format. In this case, during playback of 3D video images, the playback device 102 can smoothly switch between L/R mode and depth mode, while maintaining a constant encoding method.

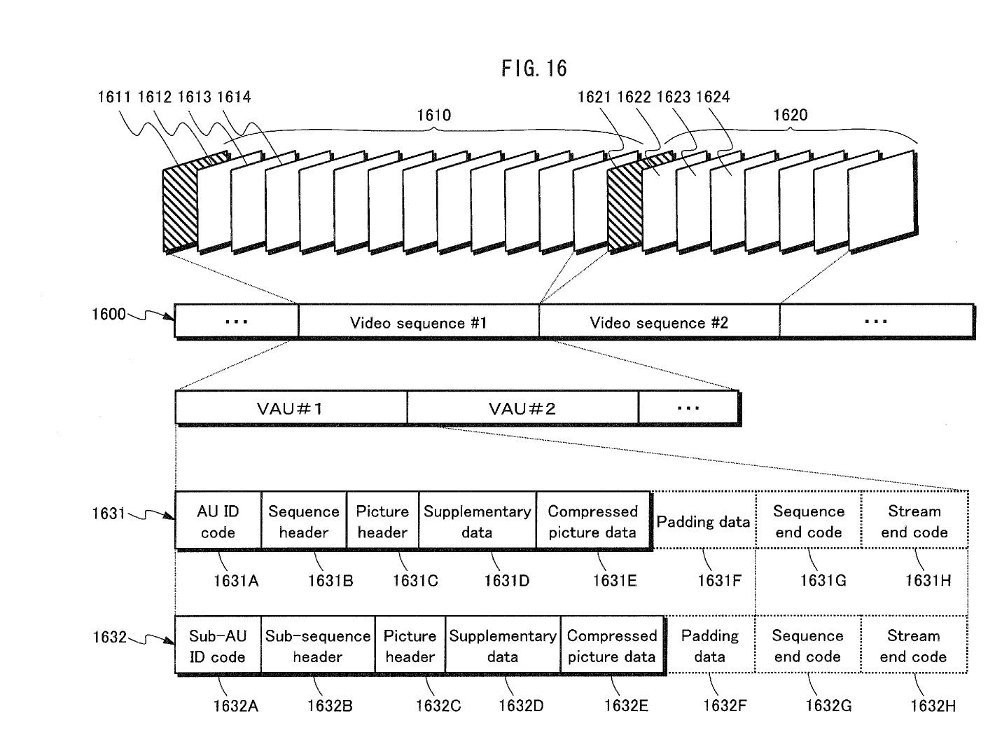

FIG. 16 is a schematic diagram showing details on a data structure of a video stream 1600. This data structure is substantially the same for the base-view video stream and the dependent-view video stream. As shown in FIG. 16, the video stream 1600 is typically composed of a plurality of video sequences #1, #2 . . . . . A “video sequence” is a combination of pictures 1611, 1612, 1613, 1614, . . . that constitute a single GOP 1610 and to which additional information, such as a header, has been individually attached. The combination of this additional information and a picture is referred to as a “video access unit (VAU)”. That is, in the GOPs 1610 and 1620, a single VAU #1, #2, . . . is formed for each picture. Each picture can be read from the video stream 1600 in units of VAUs.

FIG. 16 further shows the structure of VAU #1 1631 located at the top of each video sequence in the base-view video stream. The VAU #1 1631 includes an access unit (AU) identification code 1631A, sequence header 1631B, picture header 1631C, supplementary data 1631D, and compressed picture data 1631E. Except for not including a sequence header 1631B, VAUs from the second VAU #2 onward have the same structure as VAU #1 1631. The AU identification code 1631A is a predetermined code indicating the top of the VAU #1 1631. The sequence header 1631B, also called a GOP header, includes an identification number for the video sequence #1 which includes the VAU #1 1631. The sequence header 1631B further includes information shared by the whole GOP 1610, e.g. resolution, frame rate, aspect ratio, and bit rate. The picture header 1631C indicates its own identification number, the identification number for the video sequence #1, and information necessary for decoding the picture, such as the type of encoding method. The supplementary data 1631D includes additional information regarding matters other than the decoding of the picture, for example closed caption text information, information on the GOP structure, and time code information. In particular, the supplementary data 1631D includes decoding switch information, described below (see <<Supplementary Explanation>> for detail). The compressed picture data 1631E includes a base-view picture. Additionally, the VAU #1 1631 may include any or all of padding data 1631F, a sequence end code 1631G, and a stream end code 1631H as necessary. The padding data 1631F is dummy data. By adjusting the size of the padding data 1631F in conjunction with the size of the compressed picture data 1631E, the bit rate of the VAU #1 1631 can be maintained at a predetermined value. The sequence end code 1631G indicates that the VAU #1 1631 is located at the end of the video sequence #1. The stream end code 1631H indicates the end of the base-view video stream 1600.

FIG. 16 also shows the structure of a VAU #1 1632 located at the top of each video sequence in the dependent-view video stream. The VAU #1 1632 includes a sub-AU identification code 1632A, sub-sequence header 1632B, picture header 1632C, supplementary data 1632D, and compressed picture data 1632E. Except for not including a sub-sequence header 1632B, VAUs from the second VAU #2 onward have the same structure as VAU #1 1632. The sub-AU identification code 1632A is a predetermined code indicating the top of the VAU #1 1632. The sub-sequence header 1632B includes an identification number for the video sequence #1 which includes the VAU #1 1632. The sub-sequence header 1632B further includes information shared by the whole GOP 1610, e.g. resolution, frame rate, aspect ratio, and bit rate. These values are the same as the values set for the corresponding GOP in the base-view video stream, i.e. the values shown by the sequence header 1631B in the VAU #1 1631. The picture header 1632C indicates its own identification number, the identification number for the video sequence #1, and information necessary for decoding the picture, such as the type of encoding method. The supplementary data 1632D includes only offset metadata (details of which will be described later). Here, the supplementary data 1632D that includes only offset metadata is one type of supplementary data, and there is another type of supplementary data that includes additional information regarding matters other than the decoding of the picture, for example, closed caption text information, information on the GOP structure, time code information, and decoding switch information. Therefore, VAU #1 1632 may further include one or more pieces of other supplementary data, in addition to the supplementary data 1632D. The compressed picture data 1632E includes a dependent-view picture. Additionally, the VAU #1 1632 may include any or all of padding data 1632F, a sequence end code 1632G, and a stream end code 1631H as necessary. The padding data 1632F is dummy data. By adjusting the size of the padding data 1632F in conjunction with the size of the compressed picture data 1631E, the bit rate of the VAU #1 1631 can be maintained at a predetermined value. The sequence end code 1632G indicates that the VAU #1 1631 is located at the end of the video sequence #1. The stream end code 1632H indicates the end of the dependent-view video stream 1600.

The specific content of each component in a VAU differs according to the encoding method of the video stream 1600. For example, when the encoding method is MPEG-4 AVC or MVC, the components in the VAUs shown in FIG. 16 are composed of a single Network Abstraction Layer (NAL) unit. Specifically, the AU identification code 1631A, sequence header 1631B, picture header 1631C, supplementary data 1631D, compressed picture data 1631E, padding data 1631F, sequence end code 1631G, and stream end code 1631H respectively correspond to an Access Unit (AU) delimiter, Sequence Parameter Set (SPS), Picture Parameter Set (PPS), Supplemental Enhancement Information (SEI), View Component, Filler Data, End of Sequence, and End of Stream. In particular, in the VAU #1 1632, the supplementary data 1632D including the offset metadata is composed of one NAL unit, wherein the NAL unit does not include any data other than the offset metadata.

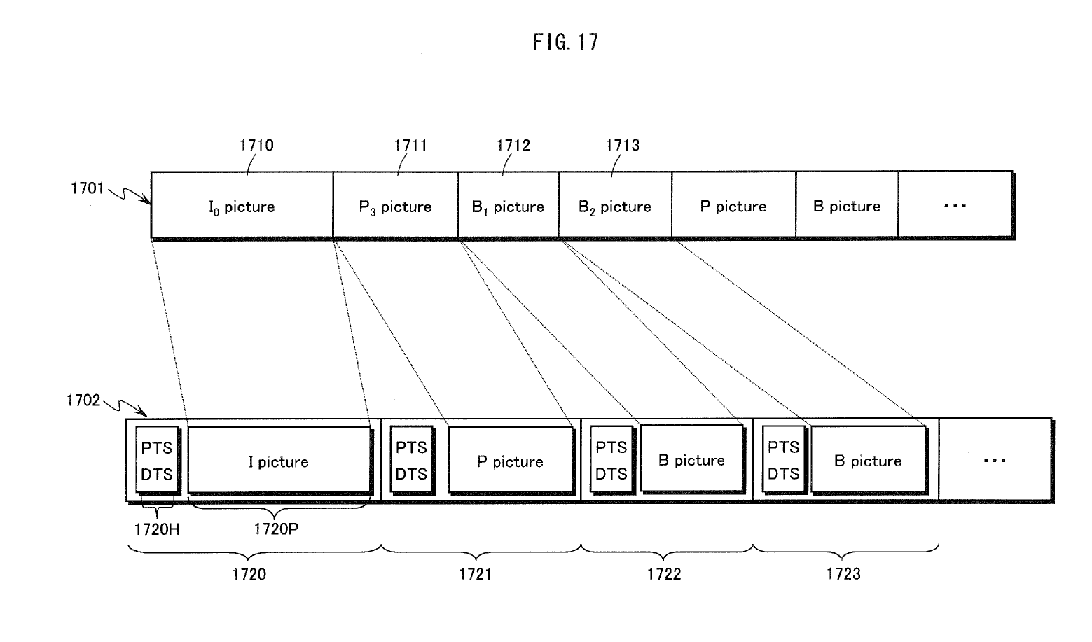

FIG. 17 is a schematic diagram showing details on a method for storing a video stream 1701 into a PES packet sequence 1702. This storage method is the same for the base-view video stream and the dependent-view video stream. As shown in FIG. 17, in the actual video stream 1701, pictures are multiplexed in the order of encoding, not in the order of presentation time. For example, in the VAUs in the base-view video stream, as shown in FIG. 17, I₀ picture 1710, P₃ picture 1711, B₁ picture 1712, B₂ picture 1713 . . . are stored in order from the top. The subscripted number indicates the serial number allotted to each picture in order of presentation time. Note that I₀ picture 1710 is used as a reference picture for encoding P₃ picture 1711, and both L picture 1710 and P₃ picture 1711 are used as reference pictures for encoding B₁ picture 1712 and B₂ picture 1713. Each of these VAUs is stored as a different PES packet 1720, 1721, 1722, 1723 . . . . . Each PES packet 1720 . . . includes a PES payload 1720P and a PES header 1720H. Each VAU is stored in a PES payload 1720P. Each PES header 1720H includes a presentation time (Presentation Time-Stamp, or PTS), and a decoding time (Decoding Time-Stamp, or DTS) for the picture stored in the PES payload 1720P in the same PES packet 1720.

As with the video stream 1701 shown in FIG. 17, the other elementary streams shown in FIGS. 11 and 12 are stored in PES payloads in a sequence of PES packets. Furthermore, the PES header in each PES packet includes the PTS for the data stored in the PES payload for the PES packet.

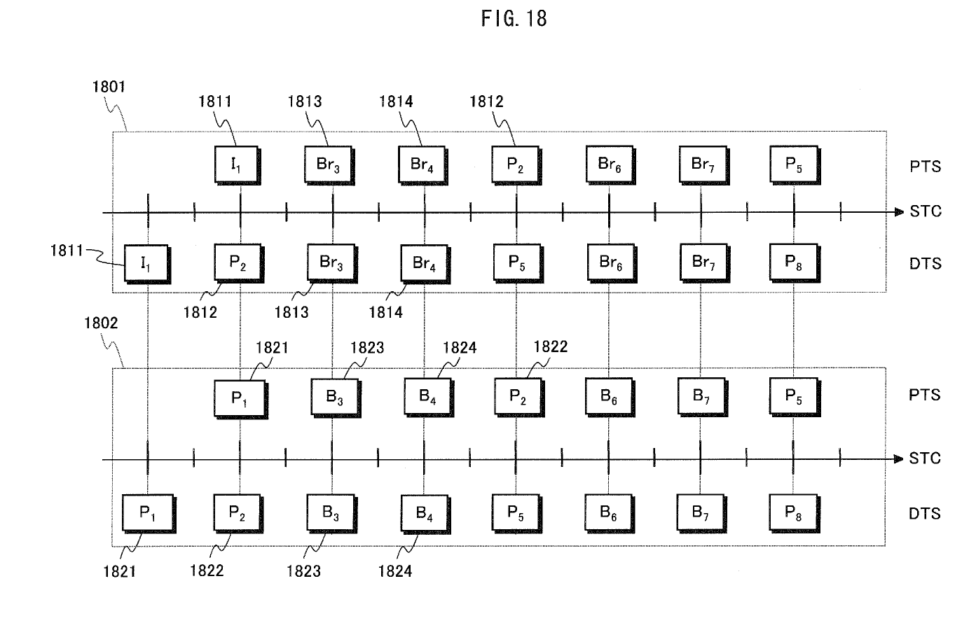

FIG. 18 is a schematic diagram showing correspondence between PTSs and DTSs assigned to each picture in a base-view video stream 1801 and a dependent-view video stream 1802. As shown in FIG. 18, between the video streams 1801 and 1802, the same PTSs and DTSs are assigned to a pair of pictures representing the same frame or field in a 3D video image. For example, the top frame or field in the 3D video image is rendered from a combination of I₁ picture 1811 in the base-view video stream 1801 and P₁ picture 1821 in the dependent-view video stream 1802. Accordingly, the PTS and DTS for these two pictures 1811 and 1821 are the same. The subscripted numbers indicate the serial number allotted to each picture in the order of DTSs. Also, when the dependent-view video stream 1802 is a depth-map stream, P₁ picture 1821 is replaced by an I picture representing a depth map for the I₁ picture 1811. Similarly, the PTS and DTS for the pair of second pictures in the video streams 1801 and 1802, i.e. P₂ pictures 1812 and 1822, are the same. The PTS and DTS are both the same for the pair of third pictures in the video streams 1801 and 1802, i.e. Brₐ picture 1813 and B₃ picture 1823. The same is also true for the pair Br₄ picture 1814 and B₄ picture 1824.

A pair of VAUs that include pictures for which the PTS and DTS are the same between the base-view video stream 1801 and the dependent-view video stream 1802 is called a “3D VAU”. Using the allocation of PTSs and DTSs shown in FIG. 18, it is easy to cause the decoder in the playback device 102 in 3D playback mode to process the base-view video stream 1801 and the dependent-view video stream 1802 in parallel in units of 3D VAUs. In this way, the decoder definitely processes a pair of pictures representing the same frame or field in a 3D video image in parallel. Furthermore, the sequence header in the 3D VAU at the top of each GOP includes the same resolution, the same frame rate, and the same aspect ratio. In particular, this frame rate is equal to the value when the base-view video stream 1801 is decoded independently in 2D playback mode.

### <<Offset Metadata>>

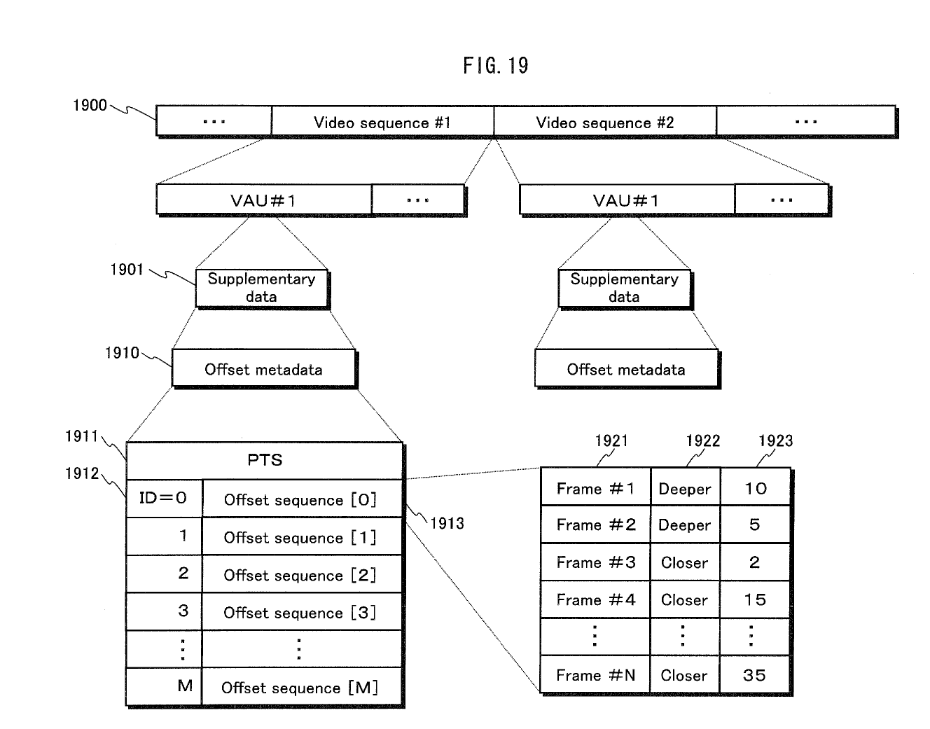

FIG. 19 is a schematic diagram showing a data structure of offset metadata 1910 included in a dependent-view video stream 1900. As shown in FIG. 19, the offset metadata 1910 is stored in the supplementary data 1901 of VAU #1 located at the top of each video sequence (i.e. each GOP). As shown in FIG. 19, the offset metadata 1910 includes a PTS 1911, offset sequence ID 1912, and offset sequence 1913. The PTS 1911 is the same as a PTS of a frame represented by compressed picture data in VAU #1, namely a PTS of the first frame of each GOP.

The offset sequence IDs 1912 are serial numbers 0, 1, 2, . . . , M allotted in order to the offset sequences 1913. The letter M represents an integer greater than or equal to 1 and indicates the total number of offset sequences 1913. An offset sequence ID 1912 is allocated to the graphics plane and a secondary video plane to be combined in a video plane. In this way, an offset sequence 1913 is associated with each piece of plane data. A “video plane” refers to plane data generated from a picture included in a video sequence, i.e. to a two-dimensional array of pixel data. The size of the array is the same as the resolution of the video frame. A set of pixel data is formed by a combination of a chromatic coordinate value (an RGB value or a YCrCb value) and an α value.

Each offset sequence 1913 is a correspondence table between frame numbers 1921 and offset information 1922 and 1923. Frame numbers 1921 are serial numbers 1, 2, . . . , N allocated in order of presentation to frames #1, #2, . . . , #N represented by a single video sequence (for example, video sequence #1). The letter N represents an integer greater than or equal to “1” and indicates the total number of frames included in the video sequence. The pieces of offset information 1922 and 1923 are control information defining offset control for a single piece of plane data.

Note that “offset control” refers to a process to provide left and right offsets for the horizontal coordinates in a graphics plane (or secondary video plane) and combine the resulting planes respectively with the left-view video plane and right-view video plane. A “left-view/right-view video plane” refers to a video plane that represents a left view/right view and is generated from a combination of the base-view video stream and the dependent-view video stream. “Providing horizontal offsets to a graphics plane” refers to horizontally shifting each piece of pixel data in the graphics plane. From a single graphics plane, this generates a pair of graphics planes representing a left view and a right view. The presentation position of each element in the 2D graphics images played back from this pair of planes is shifted to the left or right from the original presentation position. The viewer is made to perceive a pair of a left view and a right view as a single 3D graphics image due to the binocular parallax produced by these shifts. The same holds with respect to images represented by the secondary video plane.

An offset is determined by a direction and a size. Therefore, as shown in FIG. 19, each piece of offset information includes an offset direction 1922 and offset value 1923. The offset direction 1922 indicates whether a 3D graphics image is closer to the viewer than the screen or further back. Whether the presentation position in the left view and the right view is shifted to the left or to the right from the original presentation position of the 2D graphics image depends on the value of the offset direction 1922. The offset value 1923 indicates the number of horizontal pixels of the distance between the original presentation position of the 2D graphics image and the presentation position of each of the left view and the right view.

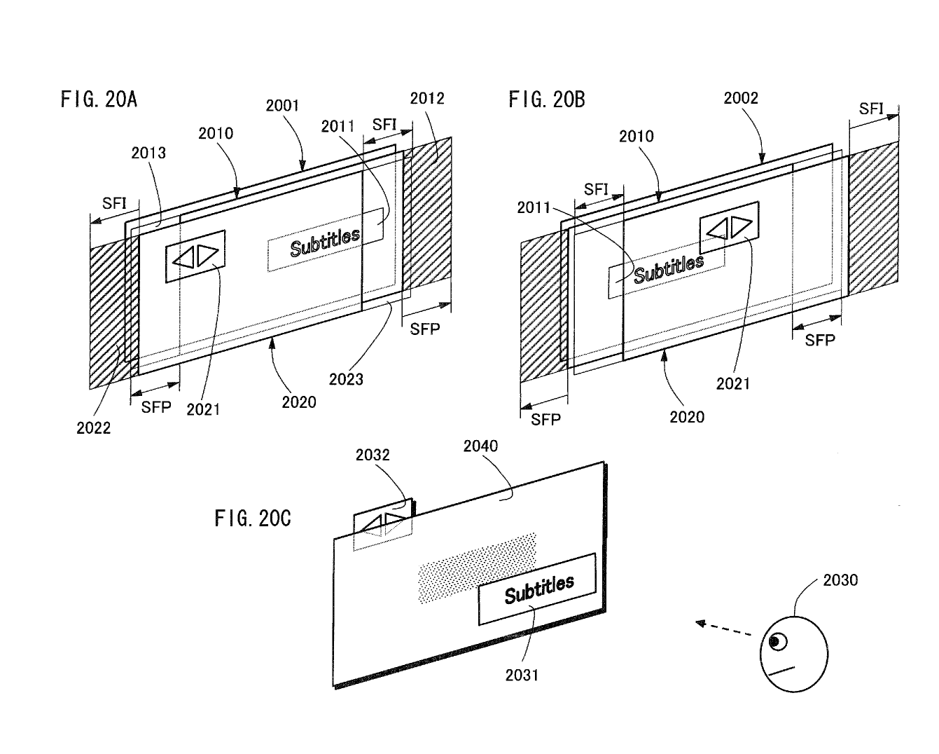

FIGS. 20A and 20B are schematic diagrams showing offset controls for a PG plane 2010 and IG plane 2020, respectively. Via these offset controls, two types of graphics planes, 2010 and 2020, are respectively combined with the left-view video plane 2001 and the right-view video plane 2002. In the following description, it is assumed that a subtitle 2011 indicated by the PG plane 2010 is displayed closer than the screen, and a button 2021 indicated by the IG plane 2020 is displayed further back than the screen.

As shown in FIG. 20A, a right offset is provided to the PG plane 2010. Specifically, the position of each piece of pixel data in the PG plane 2010 is first shifted to the right (virtually) from the corresponding position of the pixel data in the left-view video plane 2001 by a number of pixels SFP equal to the offset value. Next, a strip 2012 (virtually) protruding from the right edge of the range of the left-view video plane 2001 is “cut off” from the right edge of the PG plane 2010. In other words, the pixel data for this region 2012 is discarded. Conversely, a transparent strip 2013 is added to the left edge of the PG plane 2010. The width of this strip 2013 is the width of the strip 2012 at the right edge; i.e. the width is the same as the offset value SFP. A PG plane representing the left view is thus generated from the PG plane 2010 and combined with the left-view video plane 2001. In particular, in this left-view PG plane, the presentation position of the subtitle 2011 is shifted to the right from the original presentation position by the offset value SFP.

Conversely, a left offset is provided to the IG plane 2020. Specifically, the position of each piece of pixel data in the IG plane 2020 is first shifted to the left (virtually) from the corresponding position of the pixel data in the left-view video plane 2001 by a number of pixels SFI equal to the offset value. Next, a strip 2022 (virtually) protruding from the left edge of the range of the left-view video plane 2010 is cut off from the left edge of the IG plane 2020. Conversely, a transparent strip 2023 is added to the right edge of the IG plane 2020. The width of this strip 2023 is the width of the strip 2022 at the left edge; i.e. the width is the same as the offset value SFI. An IG plane representing the left view is thus generated from the IG plane 2020 and combined with the left-view video plane 2001. In particular, in this left-view IG plane, the presentation position of the button 2021 is shifted to the left from the original presentation position by the offset value SFI.

As shown in FIG. 20B, a left offset is provided to the PG plane 2010, and a right offset is added to the IG plane 2020. In other words, the above operations are performed in reverse for the PG plane 2010 and the IG plane 2020. As a result, plane data representing the right view is generated from the plane data 2010 and 2020 and combined with the right-view video plane 2020. In particular, in the right-view PG plane, the presentation position of the subtitle 2011 is shifted to the left from the original presentation position by the offset value SFP. On the other hand, in the right-view IG plane, the presentation position of the button 2021 is shifted to the right from the original presentation position by the offset value SFI.

FIG. 20C is a schematic diagram showing 3D graphics images that a viewer 2030 is made to perceive from 2D graphics images represented by graphics planes shown in FIGS. 20A and 20B. When the 2D graphics images represented by these graphics planes are alternately displayed on the screen 2040, the viewer 2030 perceives the subtitle 2031 to be closer than the screen 2040 and the button 2032 to be further back than the screen 2040, as shown in FIG. 20C. The distance between the 3D graphics images 2031 and 2032 and the screen 2040 can be adjusted via the offset values SFP and SFI.

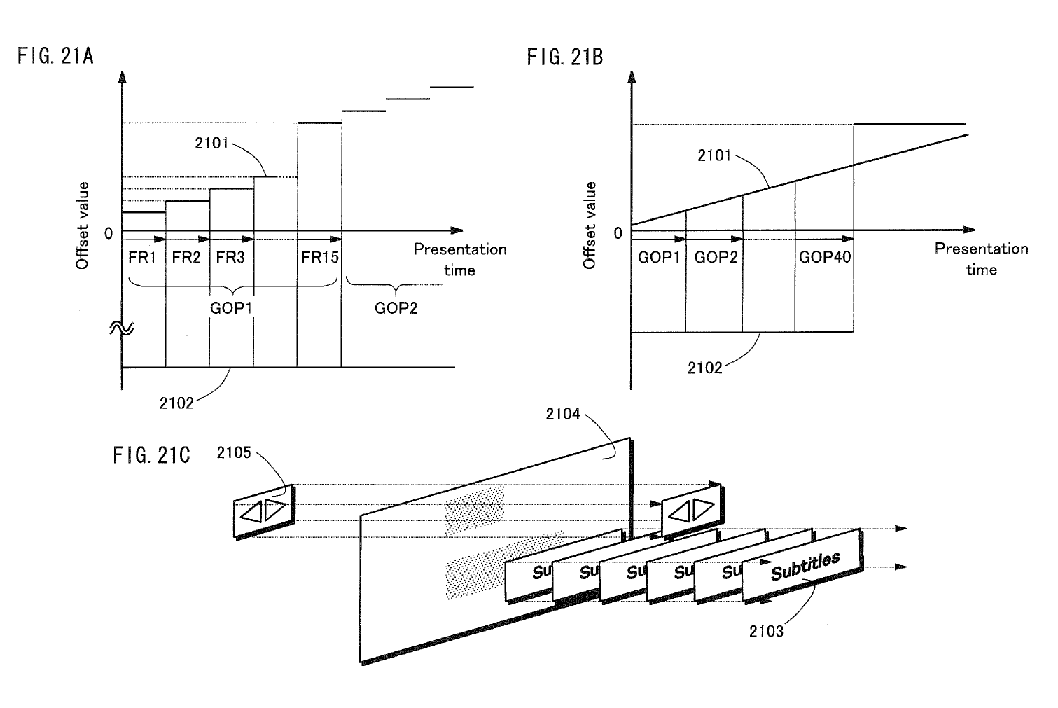

FIGS. 21A and 21B are graphs showing examples of offset sequences. In these graphs, the offset value is positive when the offset direction is toward the viewer from the screen. FIG. 21A is an enlargement of the graph for the presentation period GOP1 of the first GOP in FIG. 21B. As shown in FIG. 21A, the stepwise line 2101 shows offset values for the offset sequence with an offset sequence ID equaling 0, i.e. offset sequence [0]. On the other hand, the horizontal line 2102 shows offset values for the offset sequence with an offset sequence ID equaling 1, i.e. offset sequence [1]. The offset value 2101 of the offset sequence [0] increases stepwise during the presentation period GOP1 of the first GOP in the order of frames FR1, FR2, FR3, . . . , FR15, . . . . . As shown in FIG. 21B, the stepwise increase in the offset value 2101 similarly continues in the presentation periods GOP2, GOP3, . . . , GOP40, . . . for the second and subsequent GOPs. The amount of increase per frame is sufficiently small for the offset value 2101 in FIG. 21B to appear to increase continually as a line. On the other hand, the offset value 2102 in offset sequence [1] is maintained constant during the presentation period GOP1 of the first GOP. As shown in FIG. 21B, the offset value 2102 increases to a positive value at the end of the presentation period GOP40 for the 40^{th} GOP. Offset values may thus exhibit discontinuous change.

FIG. 21C is a schematic diagram showing 3D graphics images reproduced in accordance with the offset sequences shown in FIGS. 21A and 21B. When the subtitle 3D video image 2103 is displayed in accordance with the offset sequence [0], the 3D video image 2103 appears to start from right in front of the screen 2104 and gradually approach the viewer. On the other hand, when the button 3D video image 2105 is displayed in accordance with the offset sequence [1], the 3D video image 2105 appears to suddenly jump from a fixed position behind the screen 2104 to in front of the screen 2104. As described, the patterns by which offset values increase and decrease frame by frame are changed in a variety of ways from one offset sequence to another. Individual changes in the depth of a plurality of 3D graphics images can thereby be represented in a variety of ways.

### <<Other Ts Packets Included in AV Stream File>>

The types of TS packets that may be included in an AV stream file includes, in addition to those converted from the elementary streams shown in FIG. 12, Program Association Table (PAT), Program Map Table (PMT), and Program Clock Reference (PCR). The PCR, PMT, and PAT are specified by the European Digital Broadcasting Standard and are intended to regulate the partial transport stream constituting a single program. By using PCR, PMT, and PAT, the AV stream file can also be regulated in the same way as the partial transport stream. Specifically, the PAT shows the PID of a PMT included in the same AV stream file. The PID of the PAT itself is 0. The PMT includes the PIDs for the elementary streams representing video, audio, subtitles, etc. included in the same AV stream file, as well as the attribute information for the elementary streams. The PMT also includes various descriptors relating to the AV stream file. The descriptors particularly include copy control information showing whether copying of the AV stream file is permitted or not. The PCR includes information indicating the value of a system time clock (STC) to be associated with the ATS assigned to the PCR itself. The “STC” referred to here is a clock used as a reference for the PTS and the DTS by a decoder in the playback device 102. This decoder uses the PCR to synchronize the STC with the ATC.

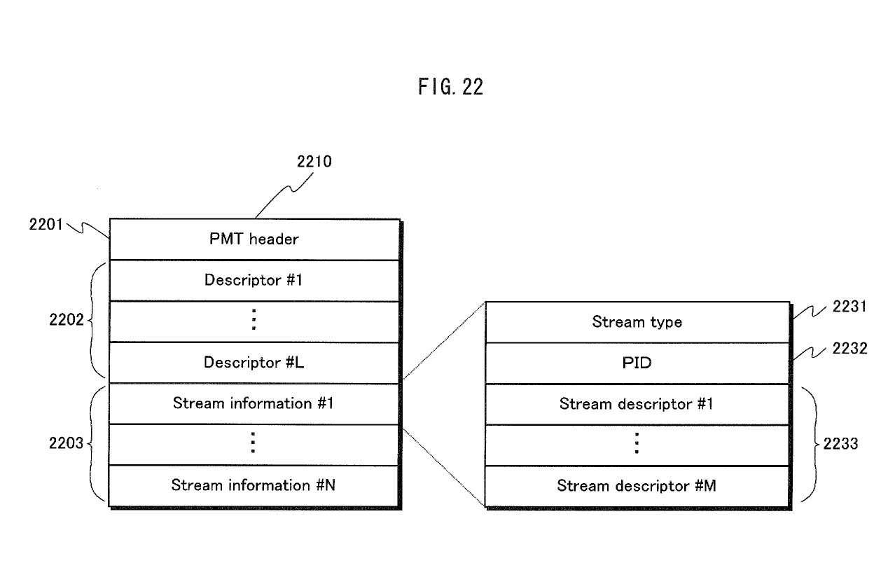

FIG. 22 is a schematic diagram showing a data structure of a PMT 2210. The PMT 2210 includes a PMT header 2201, descriptors 2202, and pieces of stream information 2203. The PMT header 2201 indicates the length of data, etc. stored in the PMT 2210. Each descriptor 2202 relates to the entire AV stream file that includes the PMT 2210. The copy control information is included in one of the descriptors 2202. Each piece of stream information 2203 relates to one of the elementary streams included in the AV stream file and is assigned to a different elementary stream. Each piece of stream information 2203 includes a stream type 2231, a PID 2232, and stream descriptors 2233. The stream type 2231 includes identification information for the codec used for compressing the elementary stream. The PID 2232 indicates the PID of the elementary stream. The stream descriptors 2233 include attribute information of the elementary stream, such as a frame rate and an aspect ratio.

By using PCR, PMT, and PAT, the decoder in the playback device 102 can be made to process the AV stream file in the same way as the partial transport stream in the European Digital Broadcasting Standard. In this way, it is possible to ensure compatibility between a playback device for the BD-ROM disc 101 and a terminal device conforming to the European Digital Broadcasting Standard.

### <<Interleaved Arrangement of Multiplexed Stream Data>>

For seamless playback of 3D video images, the physical arrangement of the base-view video stream and dependent-view video stream on the BD-ROM disc 101 is important. This “seamless playback” refers to playing back video and audio from multiplexed stream data without interruption.

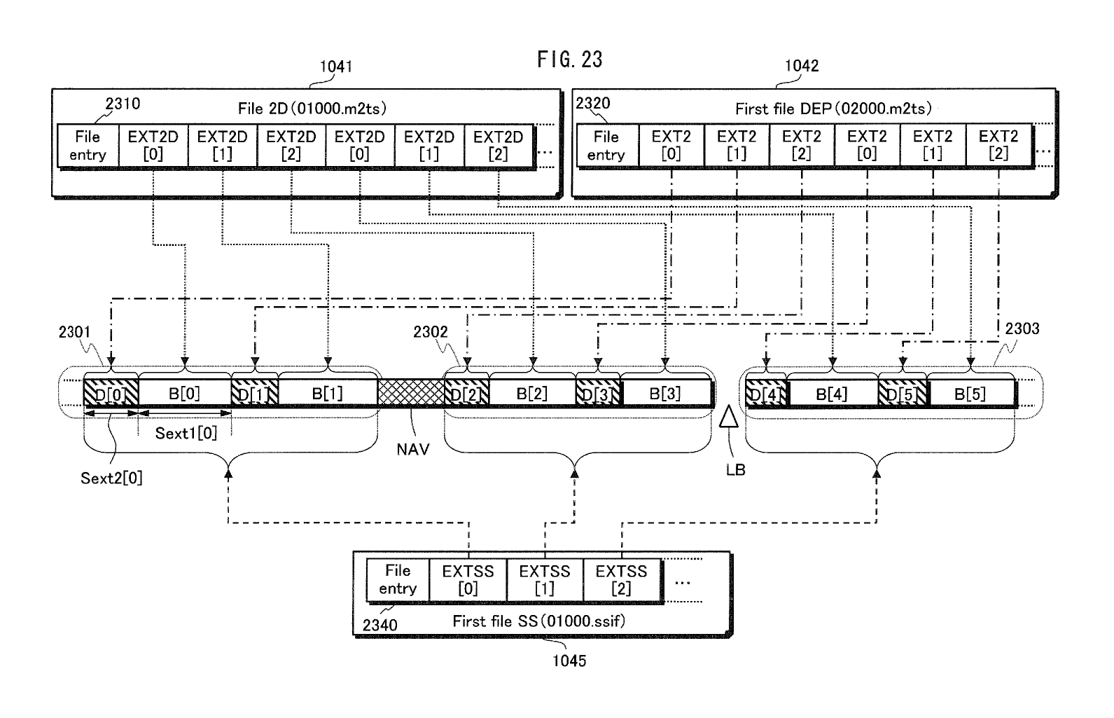

FIG. 23 is a schematic diagram showing a physical arrangement on the BD-ROM disc 101 of the main TS and first sub-TS shown in FIG. 11. Note that the second sub-TS may be recoded instead of the first sub-TS. As shown in FIG. 23, the respective TSs are divided into a plurality of data blocks D[n], B[n] (n=0, 1, 2, 3, . . . ) and arranged on the BD-ROM disc 101. A “data block” refers to a sequence of data recorded on a contiguous area on the BD-ROM disc 101, i.e. a plurality of physically contiguous sectors. Since physical addresses and logical addresses on the BD-ROM disc 101 are substantially the same, the LBNs within each data block are also continuous. Accordingly, the BD-ROM drive 121 can continuously read a data block without causing the optical pickup to perform a seek. Hereinafter, data blocks B[n] belonging to a main TS are referred to as “base-view data blocks”, and data blocks D[n] belonging to a sub-TS are referred to as “dependent-view data blocks”. In particular, data blocks belonging to the first sub-TS are referred to as “right-view data blocks”, and the data blocks belonging to the second sub-TS are referred to as “depth-map data blocks”.

In the file system on the BD-ROM disc 101, each data block B[n] and D[n] can be accessed as one extent in the files 2D or the files DEP. In other words, the logical address for each data block can be known from the file entry of a file 2D or a file DEP.

In the example shown in FIG. 23, the file entry 2310 in the file 2D (01000.m2ts) 1041 indicates the sizes of the base-view data blocks B[n] and the LBNs of their tops. Accordingly, the base-view data blocks B[n] can be accessed as extents EXT2D[n] in the file 2D 1041. Hereinafter, the extents EXT2D[n] belonging to the file 2D 1041 are referred to as “2D extents”. On the other hand, the file entry 2320 of the file DEP (02000.m2ts) 1042 indicates the sizes of the dependent-view data blocks D[n] and the LBNs of their tops. Accordingly, each dependent-view data block D[n] is a right-view data block and can be accessed as an extent EXT2[n] in the first file DEP 1042. Hereinafter, the extents EXT2[n] belonging to the file DEP 1042 are referred to as “right-view extents”. Accordingly, in the case where the dependent-view data block D[n] is a depth-map data block, each depth-map data block can also be accessed as an extent in the second file DEP (03000.m2ts) 1043. Hereinafter, the extents belonging to the second file DEP 1043 are referred to as “depth-map extents”. Furthermore, extents belonging to a specific file DEP, such as the right-view extents and depth-map extents, are collectively referred to as “dependent-view extents”.

As shown in FIG. 23, a data block group is recorded continuously along a track on the BD-ROM disc 101. Furthermore, the base-view data blocks B[n] and the dependent-view data blocks D[n] are arranged alternately one by one. This type of arrangement of a data block group is referred to as an “interleaved arrangement”. In particular, one series of data blocks recorded in an interleaved arrangement is referred to as an “extent block”. Three extent blocks 2301, 2302, and 2303 are shown in FIG. 23. As shown in the first two extent blocks 2301 and 2302, a storage area NAV for data other than multiplexed stream data exists between the extent blocks, thus separating the extent blocks. Also, when the BD-ROM disc 101 is a multi-layer disc, i.e. when the BD-ROM disc 101 includes a plurality of recording layers, the extent blocks may also separated by a layer boundary LB between the recording layers, as in the second and third extent blocks 2302 and 2303. In this way, one series of multiplexed stream data is generally arranged so as to be divided into a plurality of extent blocks. In this case, for the playback device 102 to seamlessly play back video images from the multiplexed stream data, it is necessary for video images to be played back from the extent blocks to be seamlessly connected. Hereinafter, processing required by the playback device 102 for that purpose is referred to as “seamless connection between extent blocks”.

The extent blocks 2301-2303 according to Embodiment 1 of the present invention have the two types of data blocks, D[n] and B[n] that are equal in total number. In particular, the extent ATC times are the same between the (n+1)^{th} pair of data blocks D[n] and B[n]. Hereinafter, such a pair of data blocks is referred to as an “extent pair”. In this context, an “Arrival Time Clock (ATC)” refers to a clock that acts as a standard for an ATS. The “extent ATC time” represents the range of the ATS assigned to source packets in one data block, i.e. the difference between the ATS of the source packet at the top of the data block and the ATS of the source packet at the top of the next data block. The difference is equal to the ATC value indicating the time required for the playback device 102 to transfer all of the source packets in the data block from the read buffer to the system target decoder. The “read buffer” is a buffer memory in the playback device 102 where data blocks read from the BD-ROM disc 101 are temporarily stored before being transmitted to the system target decoder. Details on the read buffer are provided later. In the example shown in FIG. 23, since three extent blocks 2301-2303 are connected together seamlessly, the extent ATC times are the same between the extent pairs D[n], B[n] (n=0, 1, 2, . . . ).

The VAUs located at the top of each extent pair D[n] and B[n] belongs to the same 3D VAU, and in particular include the top picture of the GOP representing the same 3D video image. In FIG. 23, for example, the top of the right-view data block D[n] includes a P picture for the right-view video stream, and the top of the base-view data block B[n] includes an I picture for the base-view video stream. The P picture for the right-view video stream represents the right view when the 2D video image represented by the I picture in the base-view video stream is used as the left view. In particular, the P picture, as shown in FIG. 15, is compressed using the I picture as a reference picture. Accordingly, the playback device 102 in 3D playback mode can start playback of 3D video images from any extent pair D[n] and B[n]. That is to say, processing that requires random access of video streams, such as interrupt playback, is possible.

In the interleaved arrangement according to Embodiment 1 of the present invention, in any extent pair D[n] and B[n], the dependent-view data block D[n] is located before the base-view data block B[n]. This is because the amount of data is generally smaller in the dependent-view data block D[n] than the base-view data block B[n], i.e. the bit rate is lower. In FIG. 23, for example, the picture included in the (n+1)^{th} right-view data block D[n] is compressed, as shown in FIG. 15, using the picture included in the (n+1)^{th} base-view data block B[n] as a reference picture. Accordingly, the size Sext2[n] of the right-view data block D[n] is equal to or less than the size S_{EXT1}[n] of the base-view data block B[n]: S_{EXT2}[n]≦S_{EXT1}[n]. On the other hand, the amount of data per pixel in the depth map, i.e. the number of bits of the depth value, is in general smaller than the amount of data per pixel of the base-view picture, i.e. the sum of the number of bits of the chromatic coordinate value and the α value (opaqueness). Furthermore, as shown in FIGS. 11A and 11B, unlike the second sub-TS, the main TS includes other elementary streams, such as a primary audio stream, in addition to the primary video stream. Accordingly, the size S_{EXT3}[n] of the right-view data block D[n] is equal to or less than the size S_{EXT1}[n] of the base-view data block B[n]: S_{EXT3}[n]≦S_{EXT1}[n].

[Significance of Dividing Multiplexed Stream Data into Data Blocks]

In order to play 3D video images back seamlessly from the BD-ROM disc 101, the playback device 102 has to process the main TS and sub-TS in parallel. The read buffer capacity usable in such processing, however, is generally limited. In particular, there is a limit to the amount of data that can be continuously read into the read buffer from the BD-ROM disc 101. Accordingly, the playback device 102 has to read sections of the main TS and sub-TS with the same extent ATC time by dividing the sections.

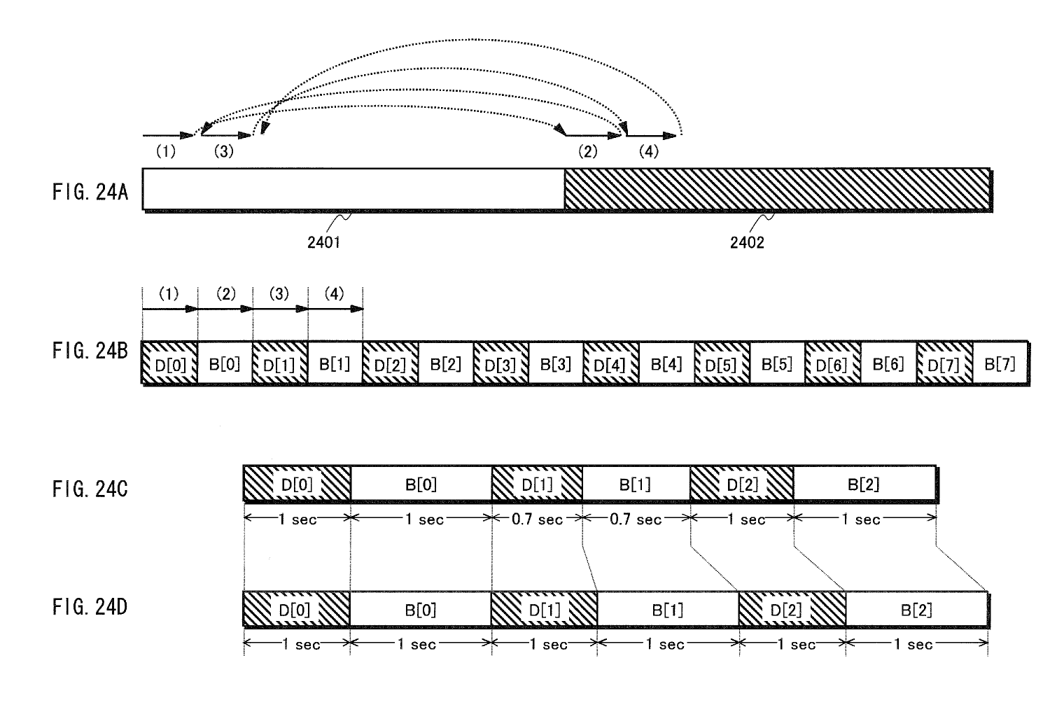

FIG. 24A is a schematic diagram showing the arrangement of the main TS 2401 and sub-TS 2402 recorded separately and contiguously on a BD-ROM disc. When the playback device 102 processes the main TS 2401 and sub-TS 2402 in parallel, as shown by the arrows (1)-(4) on the solid lines in FIG. 24A, the BD-ROM drive 121 alternately reads sections of the main TS 2401 and the sub-TS 2402 that have the same extent ATC time. At this time, as shown by the arrows in the dashed lines in FIG. 24A, during read processing the BD-ROM drive 121 has to make a large change in the area to be read on the BD-ROM disc. For example, after the top section of the main TS 2401 shown by arrow (1) is read, the BD-ROM drive 121 temporarily stops the read operation by the optical pickup and increases the rotation speed of the BD-ROM disc. In this way, the BD-ROM drive 121 rapidly moves the sector on the BD-ROM disc on which the top section of the sub-TS 2402 shown by arrow (2) is recorded to the position of the optical pickup. This operation to temporarily stop reading by the optical pickup and, while reading is stopped, position the optical pickup above the next area to be read is referred to as a “jump”. The dashed lines with an arrow shown in FIG. 24A indicate the range of the jumps necessary during read processing. During each jump period, read processing by the optical pickup stops, and only decoding processing by the decoder progresses. Since the jump is excessive in the example shown in FIG. 24A, it is difficult to cause read processing to keep up with decoding processing. As a result, it is difficult to stably maintain seamless playback.

FIG. 24B is a schematic diagram showing an arrangement of dependent-view data blocks D[0], D[1], D[2], . . . and base-view data blocks B[0], B[1], B[2], . . . recorded alternately on the BD-ROM disc 101 according to Embodiment 1 of the present invention. As shown in FIG. 24B, the main TS and sub-TS are divided into a plurality of data blocks and are arranged alternately. In this case, during playback of 3D video images, the playback device 102 reads data blocks D[0], B[0], D[1], B[1] . . . in order from the top, as shown by arrows (1)-(4) in FIG. 24B. By simply reading these data blocks in order, the playback device 102 can smoothly read the main TS and sub-TS alternately. In particular, since no jump occurs during read processing, seamless playback of 3D video images can be stably maintained.

[Significance of Providing Contiguous Data Blocks with the Same Extent ATC Time]

FIG. 24C is a schematic diagram showing an example of the extent ATC times for a dependent-view data block group D[n] and a base-view data block group B[n] recorded in an interleaved arrangement (n=0, 1, 2). As shown in FIG. 24C, the extent ATC time is the same in each pair between the dependent-view data block D[n] and the immediately subsequent base-view data block B[n]. For example, the extent ATC time is equal to one second for each of D[0] and B[0] in the top data block pair. Accordingly, when the data blocks D[0] and B[0] are read by the read buffer in the playback device 102, all of the TS packets therein are sent from the read buffer to the system target decoder in the same one-second interval. Similarly, since the extent ATC time is equal to 0.7 seconds for each of D[1] and B[1] in the second data block pair, all of the TS packets in each data block are transmitted from the read buffer to the system target decoder in the same 0.7-second interval.

FIG. 24D is a schematic diagram showing another example of the extent ATC times for a dependent-view data block group D[n] and a base-view data block group B[n] recorded in an interleaved arrangement. As shown in FIG. 24D, the extent ATC times in all of the data blocks D[n] and B[n] are equal to one second. Accordingly, in the same one-second interval in which any of the data blocks D[n] and B[n] are read by the read buffer in the playback device 102, all of the TS packets in each of those data blocks are transmitted from the read buffer to the system target decoder.

As described above, the compression rate of the dependent-view data blocks is generally higher than the compression rate of the base-view data blocks. Accordingly, decoding processing of the dependent-view data blocks is generally slower than decoding processing of the base-view data blocks. On the other hand, when the extent ATC times are equal, the dependent-view data blocks generally have a smaller amount of data than the base-view data blocks. Therefore, when the extent ATC times are the same between contiguous data blocks as in FIGS. 24C and 24D, the speed at which the data to be decoded is provided to the system target decoder can easily be maintained uniformly with the speed of processing by the decoder. In other words, the system target decoder facilitates synchronization between the decoding processing of the base-view data blocks and the decoding processing of the dependent-view data blocks, particularly in interrupt playback.

### [Method to Align Extent ATC Times]

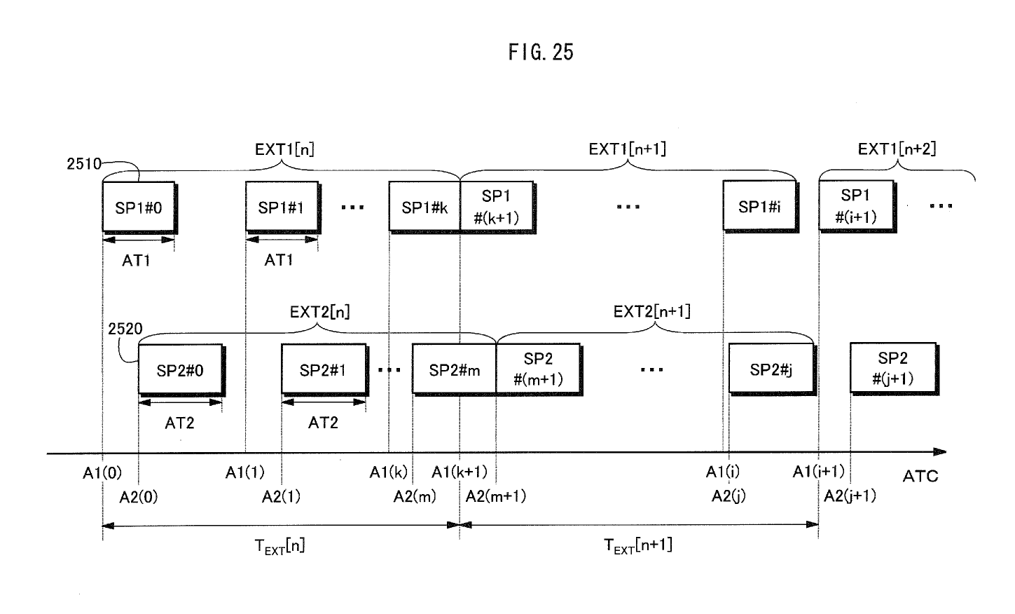

FIG. 25 is a schematic diagram showing a method to align extent ATC times between contiguous data blocks. First, ATSs along the same ATC time axis are assigned to source packets stored in a base-view data block (hereinafter, abbreviated asSP1) and source packets stored in a dependent-view data block (hereinafter, abbreviated as SP2). As shown in FIG. 25, the rectangles 2510 and 2520 respectively represent SP1 #p (p=0, 1, . . . , k, k+1, . . . , i, i+1) and SP2 #q (q=0, 1, . . . , m, m+1, . . . , j, j+1). These rectangles 2510 and 2520 are arranged in order along the time axis by the ATS of each source packet. Each of the positions A1(p) and A2(q) of the top of the rectangles 2510 and 2520 represents the value of the ATS of the source packet. The lengths AT1 and AT2 of the rectangles 2510 and 2520 each represent the amount of time needed for the 3D playback device to transfer one source packet from the read buffer to the system target decoder.

SP1 transferred from the read buffer to the system target decoder during the time from the ATS A1(0) of SP1 #0 until the extent ATC time T_{EXT}[n] has elapsed, i.e. SP1 #0, 1, 2, . . . , k, are stored in the (n+1)^{th} base-view data block EXT1[n] in one base-view data block. Similarly, SP1 transferred from the read buffer to the system target decoder during the time from the ATS A1(k+1) of SP1 #(k+1) until the extent ATC time T_{EXT}[n+1] has elapsed, i.e. SP1 #(k+1), . . . , i, are stored in the (n+2)^{th} base-view data block EXT1[n+1].

On the other hand, SP2 to be stored in the (n+1)^{th} dependent-view data block EXT2[n] is selected as follows. First, the extent ATC time T_{EXT}[n] is added to the ATS A1(0) of SP1 #0. That is, ATS of SP1 #(k+1), A1(k+1)=A1(0)+T_{EXT}[n], is sought. Next, SP2 #0, 1, m, are selected; Transfer of each of these SP2 from the read buffer to the system target decoder begins during the period from ATS A1(0) of SP1 #0 until ATS A1(k+1) of SP1 #(k+1). Accordingly, the top SP2, i.e. ATS A2(0) of SP2 #0, is always equal to or greater than the top SP1, i.e. ATS A1(0) of SP1 #0: A2(0)≧A1(0). Furthermore, the ATS of the last SP2, i.e. ATS A2(m) of SP2 #m, is less than ATS A1(k+1) of SP1 #(k+1): A2(m)≦A1(k+1). In this context, completion of transfer of SP2 #m may be at or after ATS A1 (k+1) of SP1 #(k+1).

On the other hand, SP2 to be stored in the (n+2)^{th} dependent-view data block EXT2[n+1] is selected as follows. First, ATS A1(i+1)=A1(k+1)+T_{EXT}[n+1] is sought as the ATS of SP1 #(i+1) located at the top of the (n+3)^{th} base-view data block EXT1[n+2]. Next, SP2 #(m+1)−SP2 #j are selected. Transfer of each of these SP2 from the read buffer to the system target decoder begins during the period from ATS A1 (k+1) of SP1 #(k+1) until ATS A1 (i+1) of SP1 #(i+1). Accordingly, the top SP2, i.e. ATS A2(m+1) of SP2 #(m+1), is always equal to or greater than the top SP1, i.e. ATS A1(k+1) of SP1 #(k+1): A2(m+1)≧A1(k+1). Furthermore, the ATS A2(j) of the last SP2#j is equal to less than ATS A1(i+1) of SP1 #(i+1) located at the top of the next base-view data block EXT1[n+2]: A2(j)≦A1(i+1).

### [Significance of Placing Smaller-Data-Amount Data Blocks First]

When reading a data block located at the top or at the playback start position of each extent block, the playback device 102 in 3D playback mode first reads the entirety of the data block into the read buffer. The data block is not transferred to the system target decoder during that period. After finishing reading the data block, the playback device 102 transfers the data block to the system target decoder in parallel with the next data block. This processing is called “preloading”.

The technical significance of preloading is as follows. First, in L/R mode, base-view data blocks are necessary for decoding the dependent-view data blocks. Therefore, to maintain the buffer at the minimum necessary capacity for storing the decoded data until output processing, it is preferable to simultaneously provide the data blocks to the system target decoder to be decoded. In depth mode, processing is necessary to generate a pair of video planes representing parallax images from a pair of a decoded base-view picture and a decoded depth map. Accordingly, to maintain the buffer at the minimum necessary capacity for storing the decoded data until this processing, it is preferable to provide the base-view data blocks simultaneously with the depth map data blocks to the system target decoder to be decoded. Therefore, preloading causes the entirety of the data block at the top of an extent block or at the playback start position to be read into the read buffer in advance. This enables the data block and the following data block to be transferred simultaneously from the read buffer to the system target decoder and decoded. Furthermore, the subsequent extent pairs can also be simultaneously decoded by the system target decoder.

In preloading, the entirety of the data block that is read first is stored in the read buffer. Accordingly, the read buffer requires at least a capacity equal to the size of the data block. To maintain the capacity of the read buffer at a minimum, the size of the data block to be preloaded should be as small as possible. Meanwhile, in random access, such as interrupt playback, any extent pair may be selected as the playback start position. Therefore, in any extent pair, the data block having a smaller data amount is placed before the other data block. This enables the minimum capacity to be maintained in the read buffer.

### <<Cross-Linking of AV Stream Files to Data Blocks>>

For the data block group shown in FIG. 23, the AV stream files are cross-linked as follows. The file entry 2340 of the first file SS (01000.ssif) 1045 considers each extent block 2301-2303 to each be one extent, indicating the size of each and the LBN of the top thereof. Accordingly, the extent blocks 2301-2303 can be accessed as the extents EXTSS[0], EXTSS[1], and EXTSS[2] of the first file SS SS1045. Hereinafter, the extents EXTSS[0], EXTSS[1], and EXTSS[2] belonging to the first file SS 1045 are referred to as the “extents SS”. Each of the extents SS EXTSS[0], EXTSS[1], and EXTSS[2] share the base-view data blocks B[n] with the file 2D 1041 and share the right-view data blocks D[n] with the first file DEP 1042.

### <<Playback Path for Extent Block Group>>

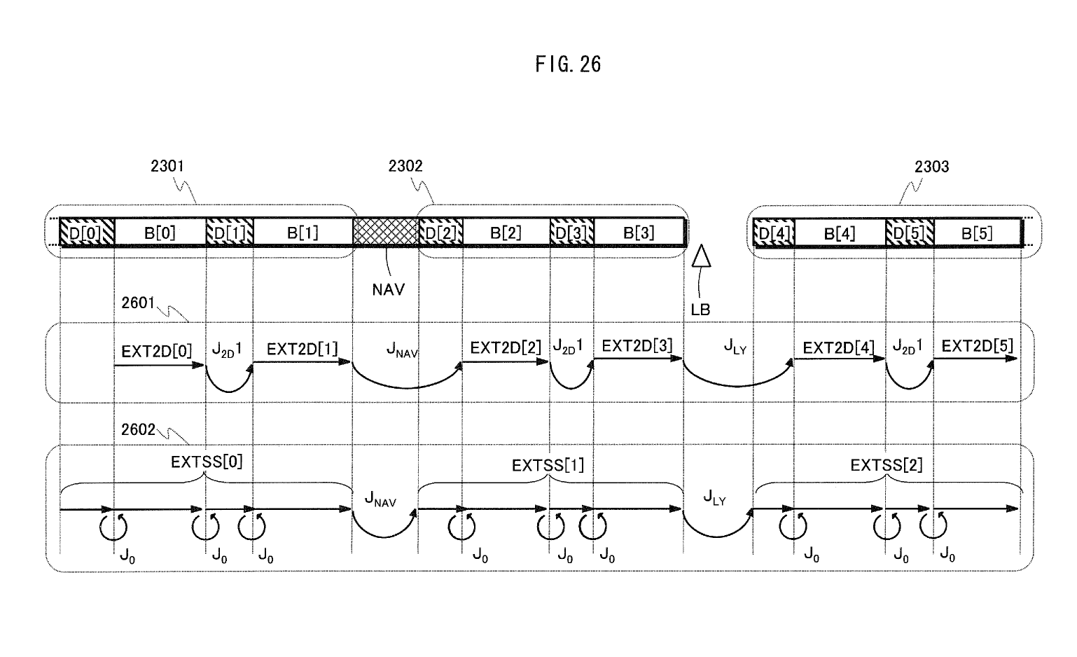

FIG. 26 is a schematic diagram showing a playback path 2601 in 2D playback mode for an extent block group 2301-2303. The playback device 102 in 2D playback mode plays back the file 2D 1041. Accordingly, as indicated by the playback path 2601 in 2D playback mode, the base-view data blocks B[n] (n=0, 1, 2, . . . ) are read in order from the extent blocks 2301-2303 each as a 2D extent EXT2D[n]. Specifically, first, the top base-view data block B[0] is read from the top extent block 2301, then reading of the immediately subsequent right-view data block D[0] is skipped by a first jump J2D. Next, the second base-view data block B[1] is read, and then reading of the immediately subsequent data NAV and right-view data block D[1] is skipped by a second jump J_{NAV}. Subsequently, reading of the base-view data blocks and jumps are repeated similarly in the second and subsequent extent blocks 2302 and 2303.

A jump J_{LY} occurring between the second extent block 2302 and the third extent block 2303 is a long jump across the layer boundary LB. The term “long jump” is a collective term for jumps with a long seek time and specifically refers to (i) a jump caused by switching recording layers and (ii) a jump with a distance that exceeds a predetermined threshold value. The term “jump distance” refers to the length of the area on the BD-ROM disc 101 whose reading is skipped during a jump period. A jump distance is normally expressed as the number of sectors of the corresponding section. The threshold value mentioned regarding the long jump (ii) above is specified, for example, as 40000 sectors in the BD-ROM standard. This threshold value, however, depends on the type of BD-ROM disc and on the BD-ROM drive's read processing capability. In particular, long jumps include focus jumps and track jumps. A “focus jump” is a jump caused by switching recording layers, and includes processing to change the focus distance of the optical pickup. A “track jump” includes processing to move the optical pickup in a radial direction along the BD-ROM disc 101.

FIG. 26 is a schematic diagram showing a playback path 2602 in L/R mode for the extent block group 2301-2303. The playback device 102 in L/R mode plays back the first file SS 1045. Accordingly, as indicated by the playback path 2602 in L/R mode, the extent blocks 2301, 2302, and 2303 are read in order as the extents SS EXTSS[0], EXTSS[1], and EXTSS[2]. Specifically, the data blocks D[0], B[0], D[1] and B[1] are first sequentially read from the top extent block 2301, then reading of the immediately subsequent data NAV is skipped by a first jump J_{NAV}. Next, the data blocks D[2], . . . , B[3] are sequentially read from the second extent block 2302. Immediately thereafter, a long jump J_{LY} occurs at the same time as switching the recording layer. Next, the data blocks D[4], B[4], . . . are sequentially read from the third extent block 2303.

When reading the extent blocks 2301-2303 as extents of the first file SS 1045, the playback device 102 reads the top LBN of the extents SS EXTSS[0], EXTSS[1], . . . and the size thereof, from the file entry 2340 in the first file SS 1045 and then outputs the LBNs and sizes to the BD-ROM drive 121. The BD-ROM drive 121 continuously reads data having the input size from the input LBN. In such processing, control of the BD-ROM drive 121 is easier than processing to read the data block groups as the extents in the first file DEP 1042 and the file 2D 1041 for the following reasons (A) and (B): (A) the playback device 102 may refer in order to extents using a file entry in one location, and (B) since the total number of extents to be read substantially halves, the total number of pairs of an LBN and a size that need to be output to the BD-ROM drive 121 halves. However, after the playback device 102 has read the extents SS EXTSS[0], EXTSS[1], . . . , it needs to separate each into a right-view data block and a base-view data block and output them to the decoder. The clip information file is used for this separation processing. Details are provided below.

As shown in FIG. 23, when actually reading the extent blocks 2301-2303, the BD-ROM drive 121 performs a zero sector transition J0 in the time from the end of a data block to the top of the next data block. A “zero sector transition” is a movement of the optical pickup between two contiguous data blocks. During a period in which a zero sector transition is performed (hereinafter referred to as a “zero sector transition period”), the optical pickup temporarily suspends its read operation and waits. In this sense, the zero sector transition is considered “a jump in which the jump distance is equal to 0 sectors”. The length of the zero sector transition period, that is, the zero sector transition time period, may include, in addition to the time for shifting the position of the optical pickup via revolution of the BD-ROM disc 101, overhead caused by error correction processing. Note that “Overhead caused by error correction processing” refers to excess time caused by performing error correction processing twice using an ECC block when the boundary between ECC blocks does not match the boundary between two data blocks. A whole ECC block is necessary for error correction processing. Accordingly, when two contiguous data blocks share a single ECC block, the whole ECC block is read and used for error correction processing during reading of either data block. As a result, each time one of these data blocks is read, a maximum of 32 sectors of excess data is additionally read. The overhead caused by error correction processing is evaluated as the total time for reading the excess data: (32 sectors×2048 bytes/sector×8 bits/byte×2 instances)/(read rate bits/second). Note that each data block may be configured in ECC block units. In that case, the size of each data block is equal to an integral multiple of ECC blocks, and therefore the overhead caused by error correction processing may be removed from the zero sector transition time.

### <<Data Block Size>>

Each data block is configured in aligned units. In particular, the size of each data block is equal to a multiple of the size of an aligned unit (=6144 bytes=approximately 6 KB). In that case, a boundary between data blocks coincides with a boundary between sectors, so that BD-ROM drive is ensured to read any data blocks reliably contiguously without causing fragmentation.

As shown in FIG. 23, to ensure seamless playback of both 2D video images and 3D video images from these extent blocks 2301-2303, the sizes of each data block and each extent block 2301-2303 should meet the following conditions [1] and [2].

### [1] Condition in 2D Playback Mode

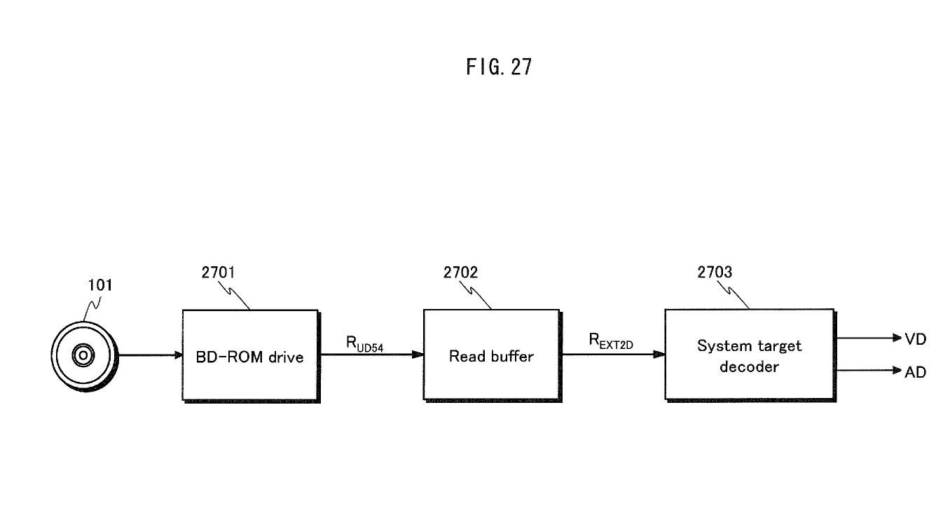

FIG. 27 is a block diagram showing a playback processing system in the playback device 102 in 2D playback mode. As shown in FIG. 27, this playback processing system includes a BD-ROM drive 2701, read buffer 2702, and system target decoder 2703. The BD-ROM drive 2701 reads 2D extents from the BD-ROM disc 101 and transfers the 2D extents to the read buffer 2702 at a read rate R_{UD54}. The read buffer 2702 is a buffer memory provided within the playback device 102 and receives 2D extents from the BD-ROM drive 2701 and stores the received extents therein. The system target decoder 2703 reads source packets from each 2D extent stored in the read buffer 2702 at a mean transfer rate R_{EXT2D} and decodes the source packets into video data VD and audio data AD.

The mean transfer rate R_{EXT2D} equals 192/188 times the mean rate of processing by the system target decoder 2703 to extract TS packets from each source packet buffered in the read buffer 2702. In this case, the coefficient 192/188 is the ratio of bytes in a source packet to bytes in a TS packet. The mean transfer rate R_{EXT2D} is conventionally represented in bits/second and specifically equals the value of the size of a 2D extent expressed in bits divided by the extent ATC time. The “size of an extent expressed in bits” is the number of source packets in the extent multiplied by the number of bits per source packet (=192 bytes×8 bits/byte). In general, this mean transfer rate R_{EXT2D} is different for each 2D extent. The maximum value R_{MAX2D} of the mean transfer rate R_{EXT2D} equals 192/188 times the system rate R_{TS} for the file 2D. The “system rate” refers to the maximum rate of processing by the system target decoder 2703 to process TS packets. The system rate R_{TS} is generally expressed in bits/second (bps) and thus equal to eight times the main TS recording rate, which is generally expressed in bytes/second (Bps).

The mean transfer rate R_{EXT2D} is evaluated as follows. First, the extent ATC time is calculated in the following manner. In the example shown in FIG. 25, the extent ATC time T_{EXT}[n] of the (n+1)^{th} base-view data block EXT1 [n] is represented by the following equation, which uses the difference between the ATS A1(0) of the SP1 #0 and the ATS A1(k+1) of the SP1 #(k+1) located at the top of the (n+2)^{th} base-view data block EXT1[n+¹]: T_{EXT}[n]=(A1(k+1)−A1(0)+WA)/T_{ATC}. Note that the wraparound value WA represents the sum of the count values each truncated when wraparound occurs during the period when the ATC is counted from the ATS A1(0) of SP1#0 to the ATS A1(k+1) of SP1#(k+1). That is, the wraparound value WA is equal to the number of wraparound during the period multiplied by the count value held when wraparound occurs. For example, in the case where the ATC is counted by a 30-bit counter, the wraparound value WA is equal to 230. On the other hand, the constant T_{ATC} represents the ATC cycle and equals to 27 MHz, for example: T_{ATC}=27×10⁶. Next, the size of a 2D extent is calculated in the following manner. In the example shown in FIG. 25, the size S_{EXT1}[n] of the (n+1)^{th} base-view data block EXT1[n] is equal to the data amount of all the source packets stored in the data block, i.e. SP1 #0, 1 . . . k, and therefore is equal to 192×(k+1)×8 bits. Finally, the size S_{EXT1}[n] of the base-view data block EXT1[n] divided by the extent ATC time T_{EXT}[n] is evaluated as the mean transfer rate R_{EXT2D}[n]: R_{EXT2D}[n]=S_{EXT1}[n]/T_{EXT}[n].

In order to ensure accurate calculation of the extent ATC time in the above evaluation, the size of each 2D extent may be equal to a specific multiple of a source packet length. Furthermore, when a 2D extent includes a greater number of source packets than the specific multiple, the extent ATC time of the 2D extent may be calculated in the following manner. First, the specific multiple is subtracted from the total number of source packets, and then the resulting difference is multiplied by the transfer time of one source packet (=188×8/system rate). Next, the extent ATC time corresponding to the specific multiple is added to the product calculated above. Finally, the sum is determined as the extent ATC time of the 2D extent of the interest.

Alternatively, the extent ATC time may be calculated in the following manner. First, for one 2D extent, the time interval from the ATS of the top source packet to the ATS of the last source packet is obtained. Then, the transfer time per source packet is added to the time interval. Finally, the sum is determined as the extent ATC time of the 2D extent of the interest. Specifically, in the example shown in FIG. 25, the extent ATC time T_{EXT}[n] of the (n+1)^{th} base-view data block EXT1 [n] is represented by the following equation, which uses the difference between the ATS A1(0) of the SP1 #0 and the ATS A1(k) of the SP1 #k located at the end of that data block EXT1[n]: T_{EXT}[n]=(A1(k)−A1(0)+WA)/T_{ATC}+188×8/R_{TS1}. Note that the wraparound value WA represents the sum of the count values each truncated when wraparound occurs while the ATC is counted from the ATS A1(0) of SP1 #0 to the ATS A1(k) of SP1 #k. On the other hand, the second term in the right-hand side of the above equation is the length of a TS packet (=188 byte×8 bits/byte) divided by the system rate R_{TS2} and is equal to the time required to transfer one TS packet from the read buffer to the system target decoder. The above calculation of extent ATC time does not require reference to the next extent and therefore the extent ATC time can be calculated even when there is no next extent. In addition, when there is a next extent, the calculation of extent ATC time is simplified.

The read rate R_{UD54} is conventionally expressed in bits/second and is set at a higher value, e.g. 54 Mbps, than the maximum value R_{MAX2D} of the mean transfer rate R_{EXT2D}: R_{UD54}>R_{MAX2D}. This prevents underflow in the read buffer 2702 due to decoding processing by the system target decoder 2703 while the BD-ROM drive 2701 is reading a 2D extent from the BD-ROM disc 101.

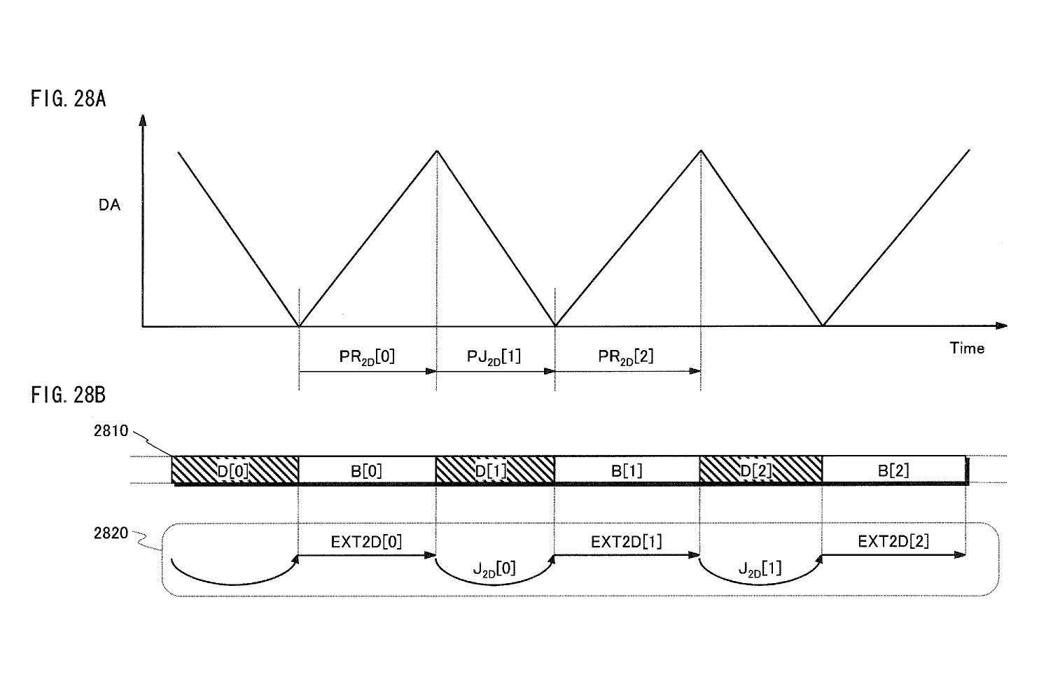

FIG. 28A is a graph showing the change in the data amount DA stored in the read buffer 2702 during operation in 2D playback mode. FIG. 28B is a schematic diagram showing the correspondence between an extent block 2810 for playback and a playback path 2820 in 2D playback mode. As shown in FIG. 28B, in accordance with the playback path 2820, the base-view data blocks Bn (n=0, 1, 2, . . . ) in the extent block 2810 are each read as one 2D extent EXT2D[n] from the BD-ROM disc 101 into the read buffer 2702. As shown in FIG. 28A, during the read period PR_{2D}[n] for each 2D extent EXT2D[n], the stored data amount DA increases at a rate equal to R_{UD54}−R_{EXT2D}[n], the difference between the read rate R_{UD54} and the mean transfer rate R_{EXT2D}[n]. A jump J_{2D}[n], however, occurs between two contiguous 2D extents EXT2D[n−1] and EXT2D[n]. Since the reading of two contiguous dependent-view data blocks Dn is skipped during the corresponding jump period PJ_{2D}[n], reading of data from the BD-ROM disc 101 is interrupted. Accordingly, the stored data amount DA decreases at a mean transfer rate R_{EXT2D}[n] during each jump period PJ_{2D}[n].

Reading and transfer operations by the BD-ROM drive 2701 are not actually performed continuously, as suggested by the graph in FIG. 28A, but rather intermittently. During the read period PR2D[n] for each 2D extent, this prevents the stored data amount DA from exceeding the capacity of the read buffer 2702, i.e. overflow in the read buffer 2702. Accordingly, the graph in FIG. 28A represents what is actually a step-wise increase or decrease as an approximated straight increase.

In order to play back 2D video images seamlessly from the extent block 2810 shown in FIG. 28B, the following conditions should be met. Accordingly, the size S_{EXT2D}[n] of each 2D extent EXT2D[n] should be equal to or greater than a predetermined lower limit. This lower limit is referred to as the “minimum extent size”. Next, the distance between 2D extents should be equal to or greater than predetermined upper limit.

### [1-1] Minimum Extent Size of 2D Extent.

While data is continuously provided from the read buffer 2702 to the system target decoder 2703 during each jump period PJ_{2D}[n], continual outputted from the system target decoder 2703 needs to be ensured. To do so, the size of a 2D extent should meet the following condition 1.

The size S_{EXT2D}[n] of each 2D extent EXT2D[n] is the same as the data amount transferred from the read buffer 2702 to the system target decoder 2703 from the read period PR_{2D}[n] through the next jump period PJ_{2D}[n+1]. If this is the case, then as shown in FIG. 28A, the stored data amount DA at the end of the jump period PJ_{2D}[n+1] does not fall below the value at the start of the read period PR_{2D}[n]. In other words, during each jump period PJ_{2D}[n], data is continuously provided from the read buffer 2702 to the system target decoder 2703. In particular, underflow does not occur in the read buffer 2702. In this case, the length of the read period PR_{2D}[n] equals SEXT2D[n]/R_{UD}54, the value obtained by dividing the size SEXT2D[n] of a 2D extent EXT2D[n] by the read rate R_{UD}54. That is, the condition 1 indicates the following. The minimum extent size of each 2D extent EXT2D[n] is expressed in the right-hand side of Expression 1.

$${S}_{EXT 2 D} [ n ] \geq ( \frac{{S}_{EXT 2 D} [ n ]}{{R}_{UD 54}} + {T}_{JUMP - 2 D} [ n ] ) \times {R}_{EXT 2 D} [ n ] \\ ∴ {S}_{EXT 2 D} [ n ] \geq CEI ( L \frac{{R}_{EXT 2 D} [ n ]}{8} \times \frac{{R}_{UD 54}}{{R}_{UD 54} - {R}_{EXT 2 D} [ n ]} \times {T}_{JUMP - 2 D} [ n ] ) \qquad [ Expression 1 ]$$

In Expression 1, the jump time T_{JUMP-2D}[n] represents the length of the jump period PJ_{2D}[n] in seconds. The read rate R_{UD}54 and the mean transfer rate R_{EXT2D} are both expressed in bits per second. Accordingly, in Expression 1, the mean transfer rate R_{EXT2D} is divided by 8 to convert the size S_{EXT2D}[n] of the 2D extent from bits to bytes. That is, the size S_{EXT2D}[n] of the 2D extent is expressed in bytes. The function CEIL( ) is an operation to round up fractional numbers after the decimal point of the value in parentheses.

### [1-2] Distance Between 2D Extents

Since the capacity of the read buffer 2702 is limited, the maximum value of the jump period T_{JUMP-2D}[n] is limited. In other words, even if the stored data amount DA immediately before a jump period PJ_{2D}[n] is the maximum capacity of the read buffer 2702, if the jump time T_{JUMP-2D}[n] is too long, the stored data amount DA will reach zero during the jump period PJ_{2D}[n], and there is a danger of underflow occurring in the read buffer 2702. Hereinafter, the time for the stored data amount DA to decrease from the maximum capacity of the read buffer 2702 to zero while data supply from the BD-ROM disc 101 to the read buffer 2702 has stopped, that is, the maximum value of the jump time T_{JUMP-2D} that guarantees seamless playback, is referred to as the “maximum jump time T_{JUMP}_{_{—}}_{MAX}”

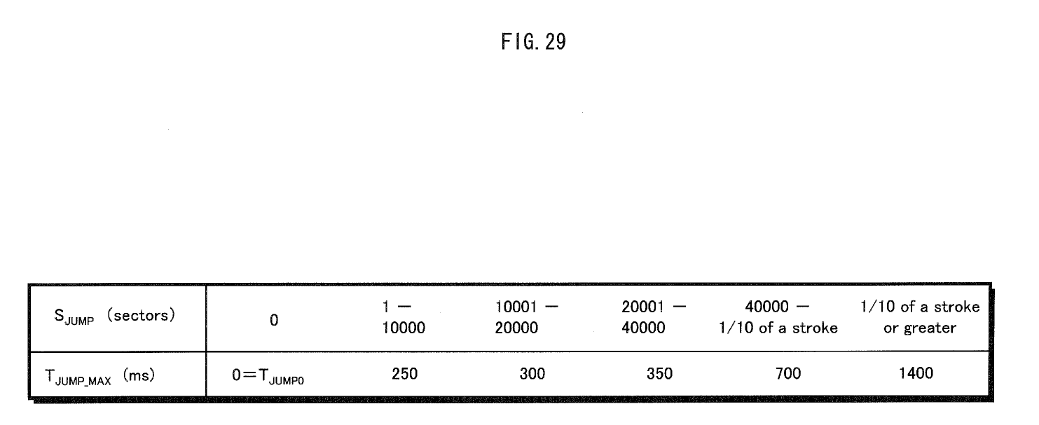

In standards of optical discs, the correspondence between jump distances and maximum jump times is determined from the access speed of the optical disc drive and other factors. FIG. 29 is an example of a correspondence table between jump distances S_{JUMP} and maximum jump times T_{JUMP}_{_{—}}_{MAX} for a BD-ROM disc. As shown in FIG. 29, jump distances S_{JUMP} are represented in units of sectors, and maximum jump times T_{JUMP}_{_{—}}_{MAX} are represented in milliseconds. One sector equals 2048 bytes. When a JUMP distance S_{JUMP} is zero sectors or is within a range of 1-10000 sectors, 10001-20000 sectors, 20001-40000 sectors, 40001 sectors- 1/10 of a stroke, and 1/10 of a stroke or greater, the corresponding maximum JUMP time T_{JUMP}_{_{—}}_{MAX} is 0 ms, 200 ms, 300 ms, 350 ms, 700 ms, and 1400 ms, respectively. When the jump distance S_{JUMP} equals zero sectors, the maximum jump time T_{JUMP}_{_{—}}_{MAX} equals a zero sector transition time T_{JUMP0}. In the example in FIG. 29, the zero sector transition time T_{JUMP0} is considered to be zero milliseconds.

Based on the above considerations, the jump time T_{JUMP-2D}[n] to be substituted into Expression 1 is the maximum jump time T_{JUMP}_{_{—}}_{MAX} specified for each jump distance by BD-ROM disc standards. Specifically, in the table of FIG. 29, the maximum jump time T_{JUMP}_{_{—}}_{MAX} corresponding to the jump distance S_{JUMP} between the contiguous 2D extents EXT2D[n] and EXT2D[n+1] is substituted into Expression 1 as the jump time T_{JUMP-2D}[n]. This jump distance S_{JUMP} equals the number of sectors from the end of the (n+1)^{th} 2D extent EXT2D[n] to the top of the (n+2)^{th} 2D extent EXT2D[n+1].

Since the jump time T_{JUMP-2D}[n] for the jump J_{2D}[n] between two 2D extents EXT2D[n] and EXT2D[n+1] is limited to the maximum jump time T_{JUMP}_{_{—}}_{MAX}, the jump distance S_{JUMP}, i.e. the distance between the two 2D extents EXT2D[n] and EXT2D[n+1], is also limited. For example, when the jump time T_{JUMP-2D}[n] is limited to the maximum jump time T_{JUMP}_{_{—}}_{MAX}=700 ms or less, the jump distance S_{JUMP} between 2D extents EXT2D[n] and EXT2D[n+1] is permitted to be 1/10 of a stroke (=about 1.2 GB) at maximum. When the jump time T_{JUMP} equals a maximum jump time T_{JUMP}_{_{—}}_{MAX}, the jump distance S_{JUMP} reaches a maximum value, referred to as the “maximum jump distance S_{JUMP}_{_{—}}_{MAX}”. For seamless playback of 2D video images, the distance between 2D extents needs to be equal to or less than the maximum jump distance S_{JUMP}_{_{—}}_{MAX}.

Within each extent block, the distance between 2D extents equals the size of a dependent-view data block. Accordingly, the size of the dependent-view data block is limited to the maximum jump distance S_{JUMP}_{_{—}}_{MAX} or less. Specifically, when the maximum jump time T_{JUMP}_{_{—}}_{MAX} between 2D extents is limited to the minimum value 200 ms specified in FIG. 29, then the size of a dependent-view data block is limited to the corresponding maximum jump distance S_{JUMP}_{_{—}}_{MAX}=10000 sectors (=about 19.5 MB) or less.

When seamlessly playing back two extent blocks arranged on different recording layers, a long jump occurs from the end of the earlier extent block to the top of the later extent block. This long jump is caused by an operation, such as a focus jump, to switch the recording layer. Accordingly, in addition to the maximum jump time T_{JUMP}_{_{—}}_{MAX} specified in the table in FIG. 29, the time required for this long jump further includes a “layer switching time”, which is the time necessary for an operation to switch the recording layer. This “layer switching time” is, for example, 350 ms. Note that the (n+1)^{th} 2D extent EXT2D[n] is located at the end of the extent block to be read earlier, and the (n+2)^{th} 2D extent EXT2D[n+1] is located at the top of the extent block to be read later. As a result, in Expression 1, which the size of the (n+1)^{th} 2D extent EXT2D[n] should satisfy, the jump time T_{JUMP-2D}[n] is determined by the sum of two parameters TJ[n] and TL[n]: T_{JUMP-2D}[n]=TJ[n]+TL[n]. The first parameter TJ[n] represents the maximum JUMP time T_{JUMP}_{_{—}}_{MAX} specified for the JUMP distance S_{JUMP} of the long jump according to BD-ROM disc standards. This maximum jump time T_{JUMP}_{_{—}}_{MAX} equals the value, in the table in FIG. 29, corresponding to the number of sectors from the end of the (n+1)^{th} 2D extent EXT2D[n] to the top of the (n+2)^{th} 2D extent EXT2D[n+1]. The second parameter TL[n] represents the layer switching time, for example 350 ms. Accordingly, the distance between two 2D extents EXT2D[n] and EXT2D[n+1] is limited to being equal to or less than the maximum jump distance S_{JUMP}_{_{—}}_{MAX} corresponding, in the table in FIG. 29, to the maximum jump time T_{JUMP}_{_{—}}_{MAX} of the long jump minus the layer switching time. For example, when the jump time T_{JUMP-2D}[n] is limited to the maximum jump time T_{JUMP}_{_{—}}_{MAX}=700 ms or less, the maximum jump distance S_{JUMP}_{_{—}}_{MAX} between 2D extents EXT2D[n] and EXT2D[n+1] is 40000 sectors (=about 78.1 MB).

### [2] Condition in 3D Playback Mode

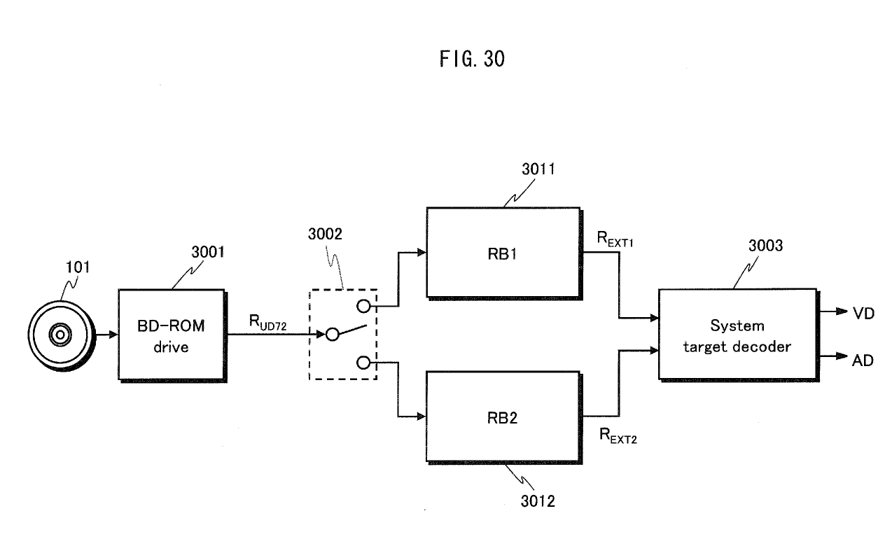

FIG. 30 is a block diagram showing the playback processing system in the playback device 102 in 3D playback mode. As shown in FIG. 30, this playback processing system includes a BD-ROM drive 3001, switch 3002, a pair of read buffers 3011 and 3012, and system target decoder 3003. The BD-ROM drive 3001 reads extents SS from the BD-ROM disc 101 and transfers the extents SS to the switch 3002 at a read rate R_{UD72}. The switch 3002 separates extents SS into base-view data blocks and dependent-view data blocks. Details of the separation processing are provided below. The first read buffer 3011 and the second read buffer 3012 (hereinafter, abbreviated as RB1 and RB2, respectively) are each a buffer memory in the playback device 102 and stores data blocks separated by the switch 3002. The RB1 3011 stores base-view data blocks, whereas the RB2 3012 stores dependent-view data blocks. The system target decoder 3003 reads source packets from the base-view data blocks stored in the RB1 3011 at a base-view transfer rate R_{EXT1} and reads source packets from the dependent-view data blocks stored in the RB2 3012 at a dependent-view transfer rate R_{EXT2}. The system target decoder 3003 also decodes pairs of read base-view data blocks and dependent-view data blocks into video data VD and audio data AD.

The base-view transfer rate R_{EXT1} equals 192/188 times the mean rate of processing by the system target decoder 3003 to extract TS packets from each source packet buffered in the RB1 3011. The maximum value R_{MAX1} of the base-view transfer rate R_{EXT1} equals 192/188 times the system rate R_{TS1} for the file 2D: R_{MAX1}=R_{TS1}×192/188. The system rate R_{TS1} is generally expressed in bits/second (bps) and thus equal to eight times the main TS recording rate, which is generally expressed in bytes/second (Bps). The dependent-view transfer rate R_{EXT2} equals 192/188 times the mean rate of processing by the system target decoder 3003 to extract TS packets from each source packet buffered in the RB2 3012. The maximum value R_{MAX2} of the dependent-view transfer rate R_{EXT2} equals 192/188 times the system rate R_{TS2} for the file DEP: R_{MAX2}=R_{TS2}×192/188. The system rate R_{TS2} is generally expressed in bits/second (bps) and thus equal to eight times the main TS recording rate, which is generally expressed in bytes/second (Bps). The transfer rates R_{EXT1} and R_{EXT2} are conventionally represented in bits/second and specifically equal the value of the size of each data block expressed in bits divided by the extent ATC time. The extent ATC time equals the time required to transfer all of the source packets in the data block from the RB1 3011 or RB2 3012 to the system target decoder 3003. Similarly to the mean transfer rate for 2D extents R_{EXT2D}, the base-view transfer rate R_{EXT1} and the dependent-view transfer rate R_{EXT2} are each evaluated as the ratio of the value of the data block size to the extent ATC time: R_{EXT1}[•]=S_{EXT1}[•]/T_{EXT}[•] and R_{EXT2}[•]=S_{EXT2}[•]/T_{EXT}[•].

The read rate R_{UD72} is conventionally expressed in bits/second and is set at a higher value, e.g. 72 Mbps, than the maximum value R_{MAX1} of the transfer rate R_{EXT1}, and the maximum value R_{MAX2} of the transfer rate R_{EXT2}: R_{UD72}>R_{MAX1} and R_{UD72}>R_{MAX2}. This prevents underflow in the RB1 3011 and RB2 3012 due to decoding processing by the system target decoder 3003 while the BD-ROM drive 3001 is reading an extent SS from the BD-ROM disc 101.

[2-1] Seamless Connection within Extent Block

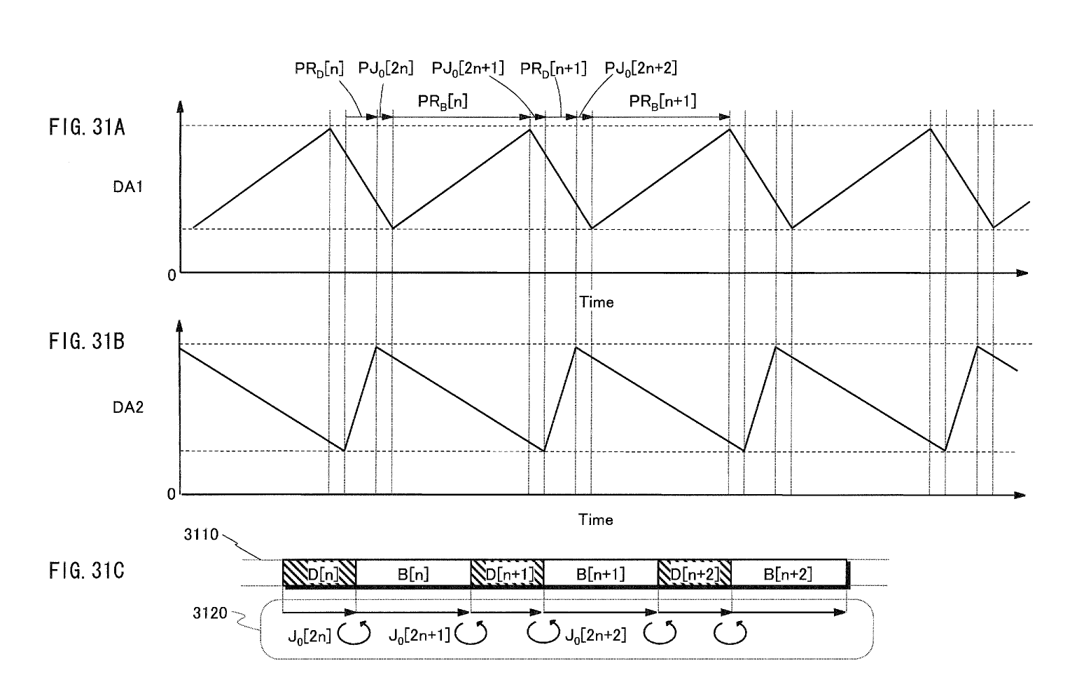

FIGS. 31A and 31B are graphs showing changes in data amounts DA1 and DA2 stored in RB1 3011 and RB2 3012 when 3D video images are played back seamlessly from a single extent block. FIG. 31C is a schematic diagram showing a correspondence between the extent block 3110 and a playback path 3120 in 3D playback mode. As shown in FIG. 30C, in accordance with the playback path 3120, the entire extent block 3110 is read all at once as one extent SS. Subsequently, the switch 3002 separates the extent SS into dependent-view data blocks D[k] and base-view data blocks B[k] (k= . . . n, n+1, n+2, . . . ). [0206]

Reading and transfer operations by the BD-ROM drive 3001 are not actually performed continuously, as suggested by the graphs in FIGS. 31A and 31B, but rather intermittently. During the read periods PRD[k] and PRB[k] for the data blocks D[k], B[k], this prevents overflow in the RB1 3011 and RB2 3012. Accordingly, the graphs in FIGS. 31A and 31B represent what is actually a step-wise increase or decrease as an approximated straight increase.

As shown in FIGS. 31A and 31B, during the read period PR_{D}[n] of the (n+1)^{th} dependent-view data block D[n], the stored data amount DA2 in the RB2 3012 increases at a rate equal to R_{UD72} R_{EXT2}[n], which is the difference between the read rate R_{UD72} and the dependent-view transfer rate R_{EXT2}[n], whereas the stored data amount DA1 in the RB1 3011 decreases at the base-view transfer rate R_{EXT1}[n−1]. As shown in FIG. 31C, a zero sector transition J₀[2n] occurs from the (n+1)^{th} dependent-view data block D[n] to the (n+1)^{th} base-view data block B[n]. As shown in FIGS. 31A and 31B, during the zero sector transition period PJ₀[n], the stored data amount DA1 in the RB1 3011 continues to decrease at the base-view transfer rate R_{EXT1}[n−1], whereas the stored data amount DA2 in the RB2 3012 decreases at the dependent-view transfer rate R_{EXT2}[n].

As shown in FIGS. 31A and 31B, during the read period PR_{B}[n] of the (n+1)^{th} base-view data block B[n], the stored data amount DA1 in the RB1 3011 increases at a rate equal to R_{UD72} R_{EXT1} [n], which is the difference between the read rate R_{UD72} and the base-view transfer rate R_{EXT1}[n]. On the other hand, the stored data amount DA2 in the RB2 3012 continues to decrease at the dependent-view transfer rate R_{EXT2}[n]. As further shown in FIG. 31C, a zero sector transition J₀[2n+1] occurs from the base-view data block B[n] to the next dependent-view data block D[n+1]. As shown in FIGS. 31A and 31B, during the zero sector transition period PJ₀[2n+1], the stored data amount DA1 in the RB1 3011 decreases at the base-view transfer rate R_{EXT1} [n], and the stored data amount DA2 in the RB2 3012 continues to decrease at the dependent-view transfer rate R_{EXT2}[n].

In order to play back 3D video images seamlessly from one extent block 2310, the size of each of the data blocks B[n] and D[n] belonging to that extent block should satisfy the following conditions [2] and [3].

The size S_{EXT1}[n] of the (n+1)^{th} base-view data block B[n] is at least equal to the data amount transferred from the RB 1 3011 to the system target decoder 3003 during the time from the corresponding read period PR_{B}[n] until immediately before the read period PR_{B}[n+1] of the next base-view data block B[n+1]. In this case, as shown in FIG. 31A, immediately before the read period PR_{B}[n+1] of the next base-view data block B[n+1], the stored data amount DA1 in the RB1 3011 does not fall below the amount immediately before the read period PR_{B}[n] of the (n+1)^{th} base-view data block B[n]. The length of the read period PR_{B}[n] of the (n+1)^{th} base-view data block B[n] equals S_{EXT1}[n]/R_{UD72}, which is the value obtained by dividing the size S_{EXT1}[n] of this base-view data block B[n] by the read rate R_{UD72}. On the other hand, the length of the read period PR_{D}[n+1] of the (n+2)^{th} dependent-view data block D[n+1] equals S_{EXT}2[n+1]/R_{UD72}, which is the value obtained by dividing the size S_{EXT2}[n+1] of this dependent-view data block D[n+1] by the read rate R_{UD72}. That is, the condition 2 indicates the following. The minimum extent size of the base-view data block B[n] is expressed in the right-hand side of Expression 2.

$${S}_{EXT 1} [ n ] \geq ( \frac{{S}_{EXT 1} [ n ]}{{R}_{UD 72}} + {T}_{JUMP 0} [ 2 n + 1 ] + \frac{{S}_{EXT 2} [ n + 1 ]}{{R}_{UD 72}} + {T}_{JUMP 0} [ 2 n + 2 ] ) \times {R}_{EXT 1} [ n ] \\ ∴ {S}_{EXT 1} [ n ] \geq CEI \{ L \frac{{R}_{EXT 1} [ n ]}{8} \times \frac{{R}_{UD 72}}{{R}_{UD 72} - {R}_{EXT 1} [ n ]} \times ( {T}_{JUMP 0} [ 2 n + 1 ] + 8 \times \frac{{S}_{EXT 2} [ n + 1 ]}{{R}_{UD 72}} + {T}_{JUMP 0} [ 2 n + 2 ] ) \} \\ {S}_{EXT 1} [ n ] \geq CEI ( {LR}_{EXT 1} [ n ] \times \frac{{S}_{EXT 2} [ n + 1 ]}{{R}_{UD 72} - {R}_{EXT 1} [ n ]} ) \\ ( where {T}_{JUMP 0} [ k ] = 0 is true ) \qquad [ Expression 2 ]$$

The size S_{EXT2}[n] of the (n+1)^{th} dependent-view data block D[n] is at least equal to the data amount transferred from the RB2 3012 to the system target decoder 3003 during the time from the corresponding read period PR_{D}[n] until immediately before the read period PR_{D}[n+1] of the next dependent-view data block D[n+1].

In this case, as shown in FIG. 31B, immediately before the read period PR_{D}[n+1] of the next dependent-view data block D[n+1], the stored data amount DA2 in the RB2 3012 does not fall below the amount immediately before the read period PR_{D}[n] of the (n+1)^{th} dependent-view data block D[n]. The length of the read period PR_{D}[n] of the (n+1)^{h} dependent-view data block D[n] equals S_{EXT2}[n]/R_{UD72}, which is the value obtained by dividing the size S_{EXT2}[n] of this dependent-view data block D[n] by the read rate R_{UD72}. That is, the condition 3 indicates the following. The minimum extent size of the dependent-view data block D[n] is expressed in the right-hand side of Expression 3.

$${S}_{EXT 2} [ n ] \geq ( \frac{{S}_{EXT 2} [ n ]}{{R}_{UD 72}} + {T}_{JUMP 0} [ 2 n ] + \frac{{S}_{EXT 1} [ n ]}{{R}_{UD 72}} + {T}_{JUMP 0} [ 2 n + 1 ] ) \times {R}_{EXT 2} [ n ] \\ ∴ {S}_{EXT 2} [ n ] \geq CEIL \{ \frac{{R}_{EXT 2} [ n ]}{8} \times \frac{{R}_{UD 72}}{{R}_{UD 72} - {R}_{EXT 2} [ n ]} \times ( {T}_{JUMP 0} [ 2 n ] + 8 \times \frac{{S}_{EXT 1} [ n ]}{{R}_{UD 72}} + {T}_{JUMP 0} [ 2 n + 1 ] ) \} \\ {S}_{EXT 2} [ n ] \geq CEI ( {LR}_{EXT 2} [ n ] \times \frac{{S}_{EXT 1} [ n ]}{{R}_{UD 72} - {R}_{EXT 2} [ n ]} ) \\ ( where {T}_{JUMP 0} [ k ] = 0 is true ) \qquad [ Expression 3 ]$$

[2-2] Seamless Connection within Extent Block

As shown in FIG. 23, the extent blocks 2301-2303 are generally separated from each other by a layer boundary LB or a recording area NAV for other data. Such extent blocks separated in the above manner are seamlessly connected as long as a sufficient amount of data is ensured to be stored each of the RB1 3011 and RB2 3012 during the time one extent block is read. In particular, unlike the graphs shown in FIGS. 31A and 31B, at the time immediately before the read periods PR_{B}[n+1] and PR_{D}[n+1] for the (n+2)^{th} data blocks B[n+1] and D[n+1], the data amount DA1 in the RB1 3011 as well as the data amount DA2 in the RB2 3012 should remain slightly more than the data amount stored immediately before the read periods PR_{B}[n] and PR_{D}[n] for the (n+1)^{th} data blocks B[n] and D[n]. This is realized, for example, by adjusting the size of each data block to be slightly larger than the minimum extent size given by the right-hand side of each of Expressions 2 and 3. With the above arrangement, the RB1 3011 and RB2 3012 are both ensured to store a sufficient amount of data at the time when the end of one extent block is read.

### <<Clip Information File>>

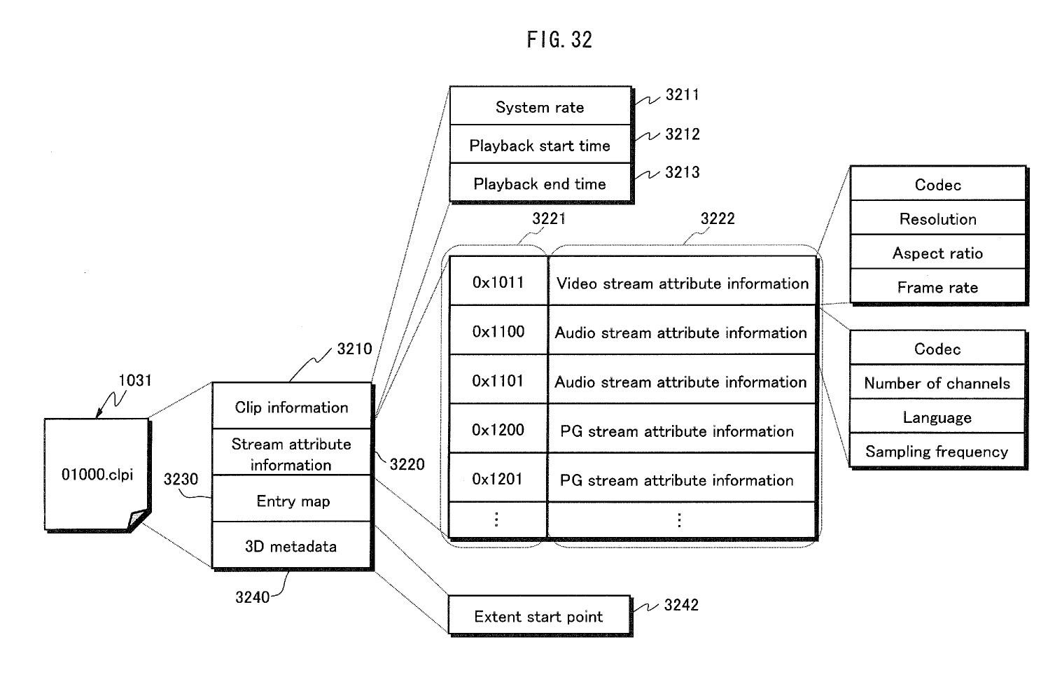

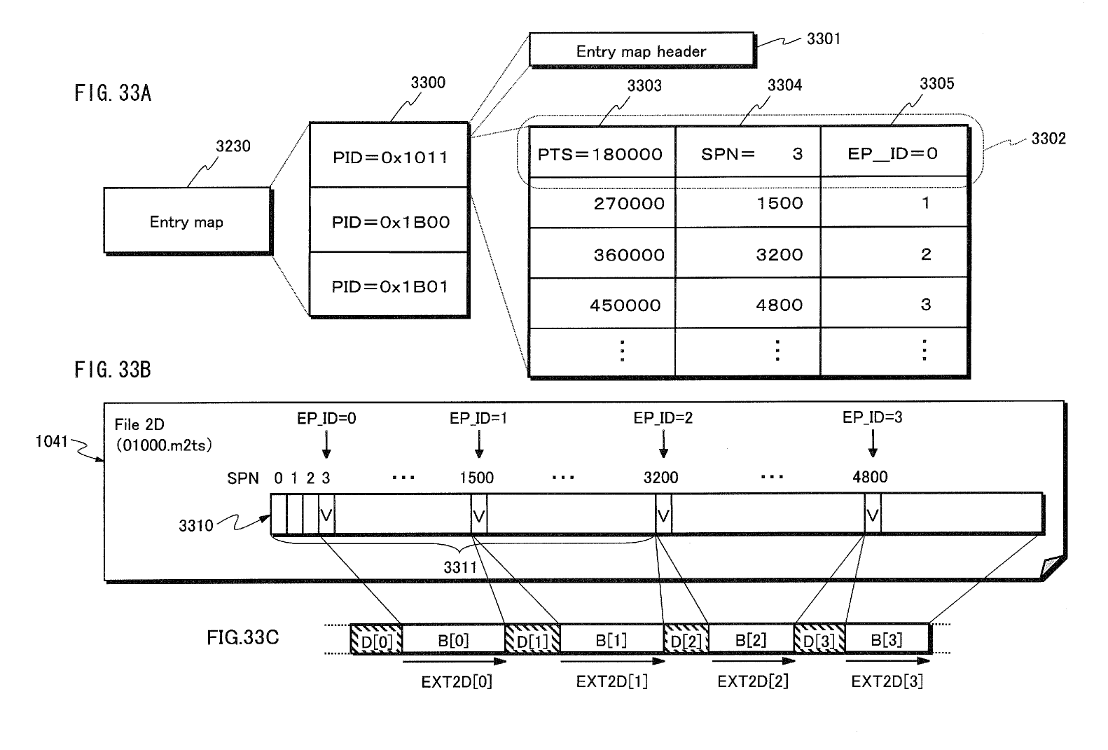

FIG. 32 is a schematic diagram showing a data structure of a first clip information file (01000.clpi), i.e. the 2D clip information file 1031. Each of the dependent-view clip information files (02000.clip and 03000.clpi) 1032 and 1033 also has the same data structure. Below, the data structure common to all clip information files is described, first using the data structure of the 2D clip information file 1031 as an example. Afterwards, the differences in data structure between a 2D clip information file and a dependent-view clip information file are described.

As shown in FIG. 32, the 2D clip information file 1031 includes clip information 3210, stream attribute information 3220, an entry map 3230, and 3D metadata 3240. The 3D metadata 3240 includes extent start points 3242.

As shown in FIG. 32, the clip information 3210 includes a system rate 3211, a playback start time 3212, and a playback end time 3213. The system rate 3211 specifies a system rate R_{TS} for the file 2D (01000.m2ts) 1041. As shown in FIG. 27, the playback device 102 in 2D playback mode transfers “TS packets” belonging to the file 2D 1041 from the read buffer 2702 to the system target decoder 2703. Therefore, the interval between ATSs of the source packets in the file 2D 1041 is set so that the transfer rate for TS packets is limited to the system rate R_{TS} or lower. The playback start time 3212 indicates the PTS of the VAU located at the top of the file 2D 1041, e.g. the PTS of the top video frame. The playback end time 3212 indicates the value of the STC delayed a predetermined time from the PTS of the VAU located at the end of the file 2D 1041, e.g. the sum of the PTS of the last video frame and the playback time of one frame.

As shown in FIG. 32, the stream attribute information 3220 is a correspondence table between the PID 3221 for each elementary stream included in the file 2D 1041 and a corresponding piece of attribute information 3222. Each piece of attribute information 3222 is different for a video stream, audio stream, PG stream, and IG stream. For example, the attribute information corresponding to the PID 0x1011 for the primary video stream includes a codec type used for the compression of the video stream, as well as a resolution, aspect ratio, and frame rate for each picture constituting the video stream. On the other hand, the attribute information corresponding to the PID 0x1100 for the primary audio stream includes a codec type used for compressing the audio stream, a number of channels included in the audio stream, language, and sampling frequency. The playback device 102 uses this attribute information 3222 to initialize the decoder.

### [Entry Map]

FIG. 33A is a schematic diagram showing a data structure of an entry map 3230. As shown in FIG. 33A, the entry map 3230 includes tables 3300. There is the same number of tables 3300 as there are video streams multiplexed into the main TS, and tables are assigned one-by-one to each video stream. In FIG. 33A, each table 3300 is distinguished by the PID of the video stream to which it is assigned. Each table 3300 includes an entry map header 3301 and an entry point 3302. The entry map header 3301 includes the PID corresponding to the table 3300 and the total number of entry points 3302 included in the table 3300. An entry point 3302 associates each pair of a PTS 3303 and source packet number (SPN) 3304 with one of individually differing entry points ID (EP_ID) 3305. The PTS 3303 is equivalent to the PTS for one of the I pictures included in the video stream for the PID indicated by the entry map header 3301. The SPN 3304 is equivalent to the SPN for the top of the source packet group stored in the corresponding I picture. The “SPN” is a serial number assigned in order from the top to the source packets belonging to one AV stream file. The SPN is used as the address for each source packet in the AV stream file. In the entry map 3230 in the 2D clip information file 1031, the SPN refers to the number assigned to the source packet group belonging to the file 2D 241, i.e. the group of source packets carrying the main TS. Accordingly, the entry point 3302 expresses the correspondence between the PTS and the address, i.e. the SPN, of each I picture included in the file 2D 1041.

An entry point 3302 does not need to be set for all of the I pictures in the file 2D 1041. However, when an I picture is located at the top of a GOP, and the TS packet that includes the top of that I picture is located at the top of a 2D extent, an entry point 3302 has to be set for that I picture.

FIG. 33B is a schematic diagram showing source packets in a source packet group 3310 belonging to a file 2D 1041 that are associated with each EP_ID 3305 by the entry map 3230. FIG. 33C is a schematic diagram showing a data block group D[n], B[n] (n=0, 1, 2, 3, . . . ) on the BD-ROM disc 101 corresponding to the source packet group 3310. When playing back 2D video images from the file 2D 1041, the playback device 102 uses the entry map 3230 to specify, from the PTS of a specific frame representing an arbitrary scene, the SPN of the source packet that includes the specific frame. Specifically, when for example a PTS=360000 is indicated as the PTS for a specific entry point for the playback start position, the playback device 102 first retrieves the SPN=3200 allocated to this PTS in the entry map 3230. Next, the playback device 102 first calculates the product of the value of the SPN and 192 bytes, which is the data amount per source packet, and then calculates the quotient obtained by dividing the product by 2048 bytes, which is the data amount per sector: SPN×192/2048. As can be understood from FIGS. 13C and 13D, the quotient is equal to the total number of sectors recorded in the main TS prior to the source packet to which the SPN is assigned. In the example shown in FIG. 33B, this quotient (3200×192/2048=300) is equal to the total number of sectors on which the source packets 3311 are recorded from SPN 0 through 3199. Next, the playback device 102 refers to the file entry in the file 2D 1041 and specifies the LBN of the (total number+1)^{th} sector, counting from the top of the sector groups in which 2D extent groups are recorded. In the example shown in FIG. 33C, within the sector groups in which the base-view data blocks B[0], B[1], B[2], . . . which can be accessed as 2D extents EXT2D[0], EXT2D[1], EXT2D[2], . . . are recorded, the LBN of the 301^{st} sector counting from the top is specified. The playback device 102 indicates this LBN to the BD-ROM drive. In this way, base-view data block groups are read as aligned units in order from the sector for this LBN. Furthermore, from the first aligned unit that is read in, the playback device 102 selects the source packet indicated by the entry point for the playback start position and then extracts and decodes an I picture. From then on, subsequent pictures are decoded in order referring to already decoded pictures. In this way, the playback device 102 can play back 2D video images from the file 2D 1041 from a specified PTS onwards.

Furthermore, the entry map 3230 is useful for efficient processing during trickplay such as fast forward, reverse, etc. For example, the playback device 102 in 2D playback mode first refers to the entry map 3230 to read SPNs starting at the playback start position, e.g. to read SPN=3200, 4800, . . . in order from the entry points EP_ID=2, 3, . . . that include PTSs starting at PTS=360000. Next, the playback device 102 refers to the file entry in the file 2D 1041 to specify the LBN of the sectors corresponding to each SPN. The playback device 102 then indicates each LBN to the BD-ROM drive. Aligned units are thus read from the sector for each LBN. Furthermore, from each aligned unit, the playback device 102 selects the source packet indicated by each entry point and then extracts and decodes an I picture. The playback device 102 can thus selectively play back an I picture from the file 2D 1041 without analyzing the 2D extent group EXT2D[n] itself.

### [Extent Start Point]

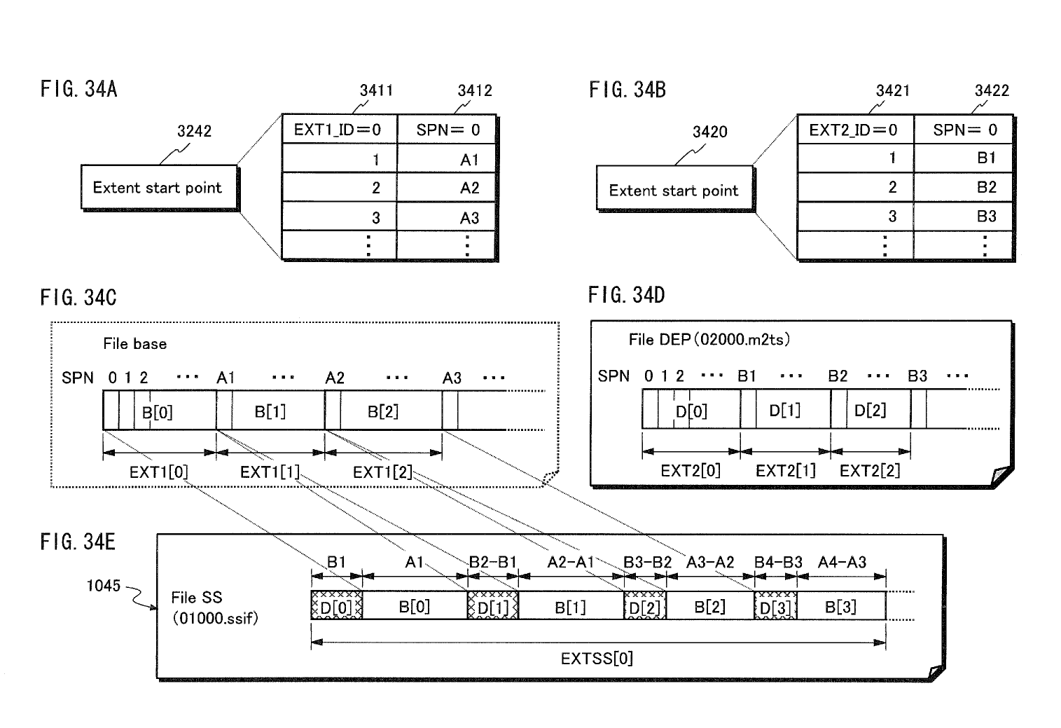

FIG. 34A is a schematic diagram showing a data structure of extent start points 3242. As shown in FIG. 34A, an “extent start point (Extent_Start_Point)” 3242 includes base-view extent IDs (EXT1_ID) 3411 and SPNs 3412. The EXT1_IDs 3411 are serial numbers assigned consecutively from the top to the base-view data blocks belonging to the first file SS (01000.ssif) 1045. One SPN 3412 is assigned to each EXT1_ID 3411 and is the same as the SPN for the source packet located at the top of the base-view data block identified by the EXT1_ID 3411. This SPN is a serial number assigned from the top to the source packets included in the base-view data block group belonging to the first file SS 1045.

In the extent blocks 2301-2303 shown in FIG. 23, the file 2D 1041 and the first file SS 1045 share the base-view data blocks B[0], B[1], B[2], . . . in common. However, data block groups placed at locations requiring a long jump, such as at boundaries between recording layers, generally include base-view data blocks belonging to only one of the file 2D 1041 or the first file SS 1045. Accordingly, the SPN 3412 that indicates the extent start point 3242 generally differs from the SPN for the source packet located at the top of the 2D extent belonging to the file 2D 1041.

FIG. 34B is a schematic diagram showing a data structure of extent start points 3420 included in a second clip information file (02000.clpi), i.e. dependent-view clip information file 1032. As shown in FIG. 34B, the extent start point 3420 includes dependent-view extent IDs (EXT2_ID) 3421 and SPNs 3422. The EXT2_IDs 3421 are serial numbers assigned from the top to the dependent-view data blocks belonging to the first file SS 1045. One SPN 3422 is assigned to each EXT2_ID 3421 and is the same as the SPN for the source packet located at the top of the dependent-view data block identified by the EXT2_ID 3421. This SPN is a serial number assigned in order from the top to the source packets included in the dependent-view data block group belonging to the first file SS 1045.

FIG. 34D is a schematic diagram representing correspondence between dependent-view extents EXT2[0], EXT2[1], . . . belonging to the first file DEP (02000.m2ts) 1042 and the SPNs 3422 shown by the extent start points 3420. As shown in FIG. 23, the first file DEP 1042 and the first file SS 1045 share dependent-view data blocks in common. Accordingly, as shown in FIG. 34D, each SPN 3422 shown by the extent start points 3420 is the same as the SPN for the source packet located at the top of each dependent-view extent EXT2[0], EXT2[1], . . . .

As described below, the extent start point 3242 in the 2D clip information file 1031 and the extent start point 3420 in the dependent-view clip information file 1032 are used to detect the boundary between data blocks included in each extent SS during playback of 3D video images from the first file SS 1045.

FIG. 34E is a schematic diagram showing an example of correspondence between an extent SS EXTSS[0] belonging to the first file SS 1045 and an extent block on the BD-ROM disc 101. As shown in FIG. 34E, the extent block includes data block groups D[n] and B[n] (n=0, 1, 2, . . . ) in an interleaved arrangement. Note that the following description is also true for other arrangements. The extent block can be accessed as a single extent SS EXTSS[0]. Furthermore, in the extent SS EXTSS[0], the number of source packets included in the (n+1)^{th} base-view data block B[n] is, at the extent start point 3242, the same as the difference A(n+1)—An between SPNs corresponding to EXT1_ID=n+1 and n. In this case, A0=0. On the other hand, the number of source packets included in the dependent-view data block D[n+1] is, in the extent start point 3420, the same as the difference B(n+1)-Bn between SPNs corresponding to EXT2_ID=n+1 and n. In this case, B0=0.

When playing back 3D video images from the first file SS 1045A, the playback device 102 in 3D playback mode refers to the entry maps and the extent start points 3242 and 3420 respectively found in the clip information files 1031 and 1032. By doing this, the playback device 102 specifies, from the PTS for a frame representing the right view of an arbitrary scene, the LBN for the sector on which a dependent-view data block that is necessary for constructing the frame is recorded. Specifically, the playback device 102 first retrieves the SPN associated with the PTS from the entry map in the dependent-view clip information file 1032, for example. It is assumed that the source packet indicated by the SPN is included in the third dependent-view extent EXT2[2] in the first file DEP 1042, i.e. in the dependent-view data block D[2]. Next, the playback device 102 retrieves “B2”, the largest SPN before the target SPN, from among the SPNs 3422 shown by the extent start points 3420 in the dependent-view clip information file 1032. The playback device 102 also retrieves the corresponding EXT2_ID=“2”. Then the playback device 102 retrieves the value “A2” for the SPN 3412 corresponding to the EXT1_ID, which is the same as the EXT2_ID=“2”, from the extent start points 3242 in the 2D clip information file 1031. The playback device 102 further seeks the sum B2+A2 of the retrieved SPNs. As can be seen from FIG. 34E, this sum B2+A2 is equal to the total number of source packets included in the data blocks located before the third dependent-view data block D[2] among the data blocks included in the extent SS EXTSS[0]. Accordingly, this sum B2+A2 multiplied by 192 bytes, which is the data amount per source packet, and divided by 2048 bytes, which is the data amount per sector, i.e. (B2+A2)×192/2048, is equal to the number of sectors from the top of the extent SS EXTSS[0] until immediately before the third dependent-view data block D[2]. Using this quotient, the LBN for the sector on which the top of the dependent-view data block D[2] is recorded can be specified by referencing the file entry for the first file SS 1045.

After specifying the LBN via the above-described procedure, the playback device 102 indicates the LBN to the BD-ROM drive. In this way, the portion of the extent SS EXTSS[0] recorded starting with the sector for this LBN, i.e. the data block group D[2], B[2], D[3], B[3], . . . starting from the third right-view data block D[2], is read as aligned units.

The playback device 102 further refers to the extent start points 3242 and 3420 to extract dependent-view data blocks and base-view data blocks alternately from the read extents SS. For example, assume that the data block group D[n], B[n] (n=0, 1, 2, . . . ) is read in order from the extent SS EXTSS[0] shown in FIG. 34E. The playback device 102 first extracts B1 source packets from the top of the extent SS EXTSS[0] as the first dependent-view data block D[0]. Next, the playback device 102 extracts the B1^{th} source packet and the subsequent (A1−1) source packets, i.e. a total of A1 source packets, as the first base-view data block B[0]. The playback device 102 then extracts the (B1+A1)^{th} source packet and the subsequent (B2−B1−1) source packets, i.e. a total of (B2−B1) source packets, as the second dependent-view data block D[1]. The playback device 102 further extracts the (A1+B2)^{th} source packet and the subsequent (A2−A1−1) source packets, i.e. a total of (A2−A1) source packets, as the second base-view data block B[1]. Thereafter, the playback device 102 thus continues to detect the boundary between data blocks in the extent SS based on the number of read source packets, thereby alternately extracting dependent-view and base-view data blocks. The extracted base-view and dependent-view data blocks are transmitted to the system target decoder to be decoded in parallel.

In this way, the playback device 102 in 3D playback mode can play back 3D video images from the first file SS 1045 starting at a specific PTS. As a result, the playback device 102 can in fact benefit from the above-described advantages (A) and (B) regarding control of the BD-ROM drive.

### <<File Base>>

FIG. 34C is a schematic diagram representing the base-view data blocks B[0], B[1], B[2], . . . extracted from the first file SS 1045 by the playback device 102 in 3D playback mode. As shown in FIG. 34C, when allocating SPNs in order from the top to a source packet group included in the base-view data block B[n] (n=0, 1, 2, . . . ), the SPN of the source packet located at the top of the data block B[n] is equal to the SPN 3412 indicating the extent start point 3242. The base-view data block group extracted from a single file SS by referring to extent start points, like the base-view data block group B[n], is referred to as a “file base”. Furthermore, the base-view data blocks included in a file base are referred to as “base-view extents”. As shown in FIG. 34E, each base-view extent EXT1[0], EXT1[1], . . . is referred to with use of the extent start points 3242 and 3420 in a clip information file.

A base-view extent EXT1[n] shares the same base-view data block B[n] with a 2D extent EXT2D[n]. Accordingly, the file base includes the same main TS as the file 2D. Unlike the 2D extent EXT2D[n], however, the base-view extent EXT1 [n] is not referred to by any file entry. As described above, the base-view extent EXT1[n] is extracted from the extent SS EXTSS[•] in the file SS with use of the extent start point in the clip information file. The file base thus differs from a conventional file by not including a file entry and by needing an extent start point as a reference for a base-view extent. In this sense, the file base is a “virtual file”. In particular, the file base is not recognized by the file system and does not appear in the directory/file structure shown in FIG. 10.

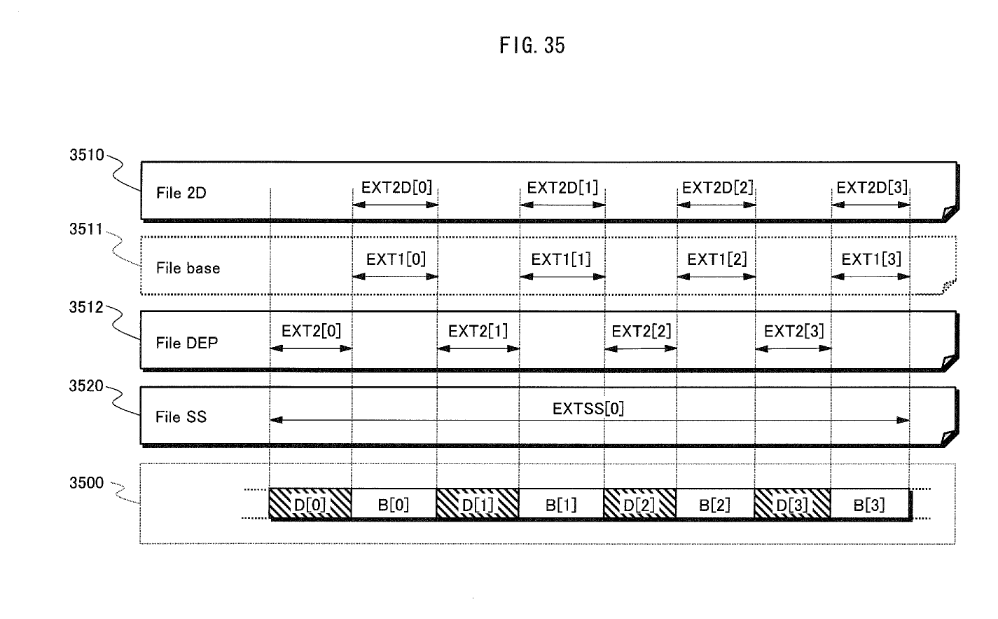

FIG. 35 is a schematic diagram showing correspondence between a single extent block 3500 recorded on the BD-ROM disc 101 and each of the extent block groups in a file 2D 3510, file base 3511, file DEP 3512, and file SS 3520. As shown in FIG. 35, the extent block 3500 includes the dependent-view data blocks D[n] and the base-view data blocks B[n] (n=0, 1, 2, 3, . . . ). The base-view data block B[n] belongs to the file 2D 3510 as the 2D extent EXT2D[n]. The dependent-view data block D[n] belongs to the file DEP 3512 as the dependent-view extent EXT2[n]. The entirety of the extent block 3500 belongs to the file SS 3520 as one extent SS EXTSS[0]. Accordingly, the extent SS EXTSS[0] shares the base-view data block B[n] in common with the 2D extent EXT2D[n] and shares the dependent-view data block D[n] with the dependent-view extent EXT2[n]. After being read into the playback device 102, the extent SS EXTSS[0] is separated into the dependent-view data block D[n] and the base-view data block B[n]. These base-view data blocks B[n] belong to the file base 3511 as the base-view extents EXT1[n]. The boundary in the extent SS EXTSS [0] between the base-view extent EXT1 [n] and the dependent-view extent EXT2[n] is specified with use of the extent start point in the clip information file corresponding to each of the file 2D 3510 and the file DEP 3512.

### <<Dependent-View Clip Information File>>

The dependent-view clip information file has the same data structure as the 2D clip information file shown in FIGS. 32 and 33. Accordingly, the following description covers the differences between the dependent-view clip information file and the 2D clip information file. Details on the similarities can be found in the above description.

A dependent-view clip information file differs from a 2D clip information file mainly in the following three points: (i) conditions are placed on the stream attribute information; (ii) conditions are placed on the entry points; and 3D metadata does not include any offset table.

(i) When the base-view video stream and the dependent-view video stream are to be used for playback of 3D video images by the playback device 102 in L/R mode, as shown in FIG. 15, the dependent-view video stream is compressed using the base-view video stream. At this point, the video stream attributes of the dependent-view video stream become equivalent to the base-view video stream. The video stream attribute information for the base-view video stream is associated with PID=0x1011 in the stream attribute information 3220 in the 2D clip information file. On the other hand, the video stream attribute information for the dependent-view video stream is associated with PID=0x1012 or 0x1013 in the stream attribute information in the dependent-view clip information file. Accordingly, the items shown in FIG. 32, i.e. the codec, resolution, aspect ratio, and frame rate, have to match between these two pieces of video stream attribute information. If the codec type matches, then a reference relationship between pictures in the base-view video stream and the dependent-view video stream is established during coding, and thus each picture can be decoded. If the resolution, aspect ratio, and frame rate all match, then on-screen display of the left and right videos can be synchronized. Therefore, these videos can be shown as 3D video images without making the viewer feel uncomfortable.

(ii) The entry map in the dependent-view clip information file includes a table allocated to the dependent-view video stream. Like the table 3300 shown in FIG. 33A, this table includes an entry map header and entry points. The entry map header indicates the PID for the dependent-view video stream allocated to the table, i.e. either 0x1012 or 0x1013. In each entry point, a pair of a PTS and an SPN is associated with a single EP_ID. The PTS for each entry point is the same as the PTS for the top picture in one of the GOPs included in the dependent-view video stream. The SPN for each entry point is the same as the top SPN of the source packet group stored in the picture indicated by the PTS belonging to the same entry point. This SPN refers to a serial number assigned consecutively from the top to the source packet group belonging to the file DEP, i.e. the source packet group constituting the sub-TS. The PTS for each entry point has to match the PTS, within the entry map in the 2D clip information file, for the entry point in the table allotted to the base-view video stream. In other words, whenever an entry point is set to the top of a source packet group that includes one of a set of pictures included in the same 3D VAU, an entry point always has to be set to the top of the source packet group that includes the other picture.

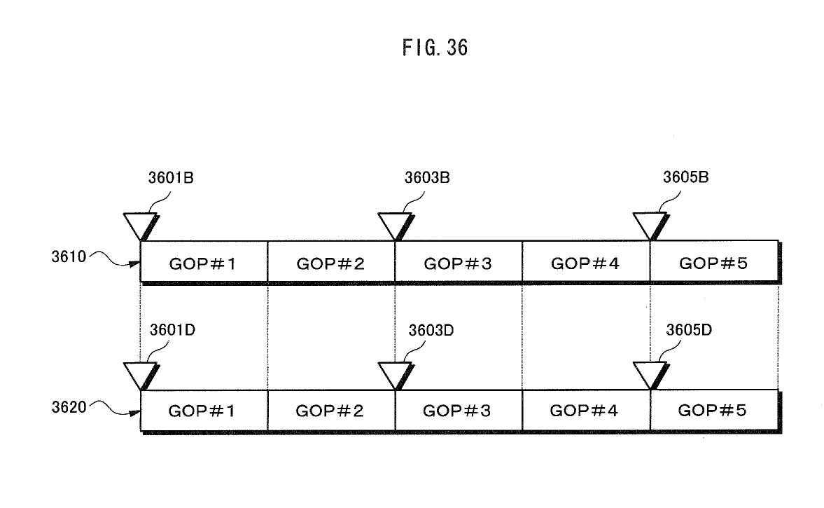

FIG. 36 is a schematic diagram showing an example of entry points set in a base-view video stream 3610 and a dependent-view video stream 3620. In the two video streams 3610 and 3620, GOPs that are the same number from the top represent video for the same playback period. As shown in FIG. 36, in the base-view video stream 3610, entry points 3601B, 3603B, and 3605B are set to the top of the odd-numbered GOPs as counted from the top, i.e. GOP #1, GOP #3, and GOP #5. Accordingly, in the dependent-view video stream 3620 as well, entry points 3601D, 3603D, and 3605D are set to the top of the odd-numbered GOPs as counted from the top, i.e. GOP #1, GOP #3, and GOP #5. In this case, when the playback device 102 begins playback of 3D video images from GOP #3, for example, it can immediately calculate the address of the playback start position in the file SS from the SPN of the corresponding entry points 3603B and 3603D. In particular, when both entry points 3603B and 3603D are set to the top of a data block, then as can be understood from FIG. 34E, the sum of the SPNs of the entry points 3603B and 3603D equals the SPN of the playback start position within the file SS. As described with reference to FIG. 34E, from this number of source packets, it is possible to calculate the LBN of the sector on which the part of the file SS for the playback start position is recorded. In this way, even during playback of 3D video images, it is possible to improve response speed for processing that requires random access to the video stream, such as interrupt playback or the like.

### <<2D Playlist File>>

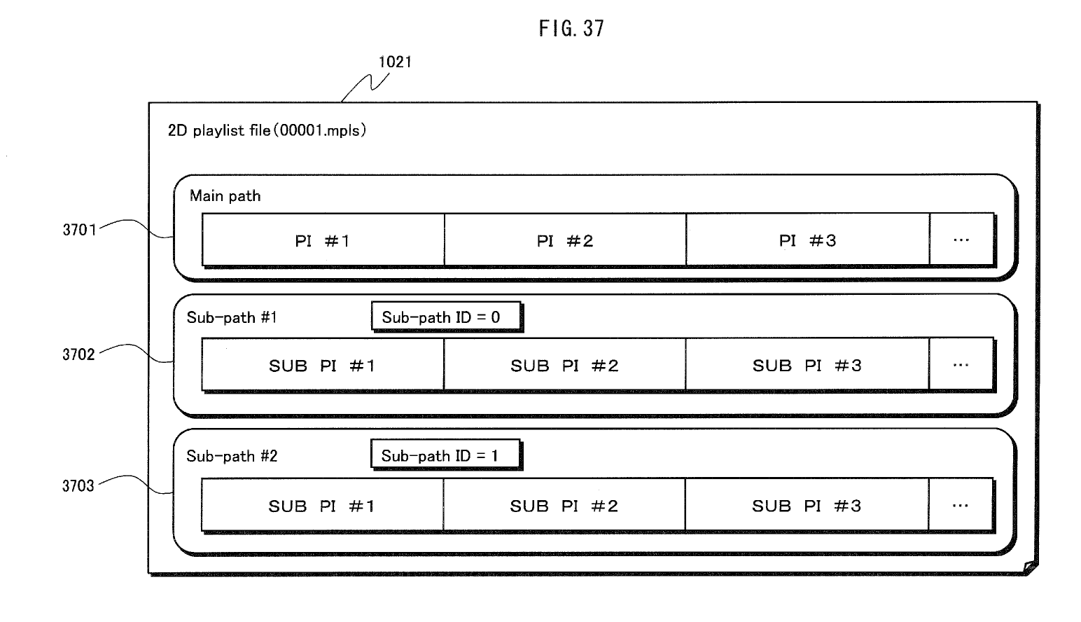

FIG. 37 is a schematic diagram showing a data structure of a 2D playlist file. The first playlist file (00001.mpls) 1021 shown in FIG. 10 has this data structure. As shown in FIG. 37, the 2D playlist file 1021 includes a main path 3701 and two sub-paths 3702 and 3703.

The main path 3701 is a sequence of playitem information pieces (hereinafter, abbreviated as PI) that defines the main playback path for the file 2D 1041, i.e. the section for playback and the section's playback order. Each PI is identified with a unique playitem ID=#N (N=1, 2, 3, . . . ). Each PI #N defines a different playback section along the main playback path with a pair of PTSs. One of the PTSs in the pair represents the start time (In-Time) of the playback section, and the other represents the end time (Out-Time). Furthermore, the order of the PIs in the main path 3701 represents the order of corresponding playback sections in the playback path.

Each of the sub-paths 3702 and 3703 is a sequence of sub-playitem information pieces (hereinafter, abbreviated as SUB_PI) that defines a playback path that can be associated in parallel with the main playback path for the file 2D 1041. Such a playback path indicates a different section of the file 2D 1041 than is represented by the main path 3701, or is a section of stream data multiplexed into another file 2D, along with the corresponding playback order. The stream data indicated by the playback path represents other 2D video images to be played back simultaneously with 2D video images played back from the file 2D 1041 in accordance with the main path 3701. These other 2D video images include, for example, secondary video images in a picture-in-picture format, a browser window, a pop-up menu, or subtitles. Serial numbers “0” and “1” are assigned to the sub-paths 3702 and 3703 in the order of registration in the 2D playlist file 1021. These serial numbers are used as sub-path IDs to identify the sub-paths 3702 and 3703. In the sub-paths 3702 and 3703, each SUB_PI is identified by a unique sub-playitem ID=#M (M=1, 2, 3, . . . ). Each SUB_PI #M defines a different playback section along the playback path with a pair of PTSs. One of the PTSs in the pair represents the playback start time of the playback section, and the other represents the playback end time. Furthermore, the order of the SUB_PIs in the sub-paths 3702 and 3703 represents the order of corresponding playback sections in the playback path.

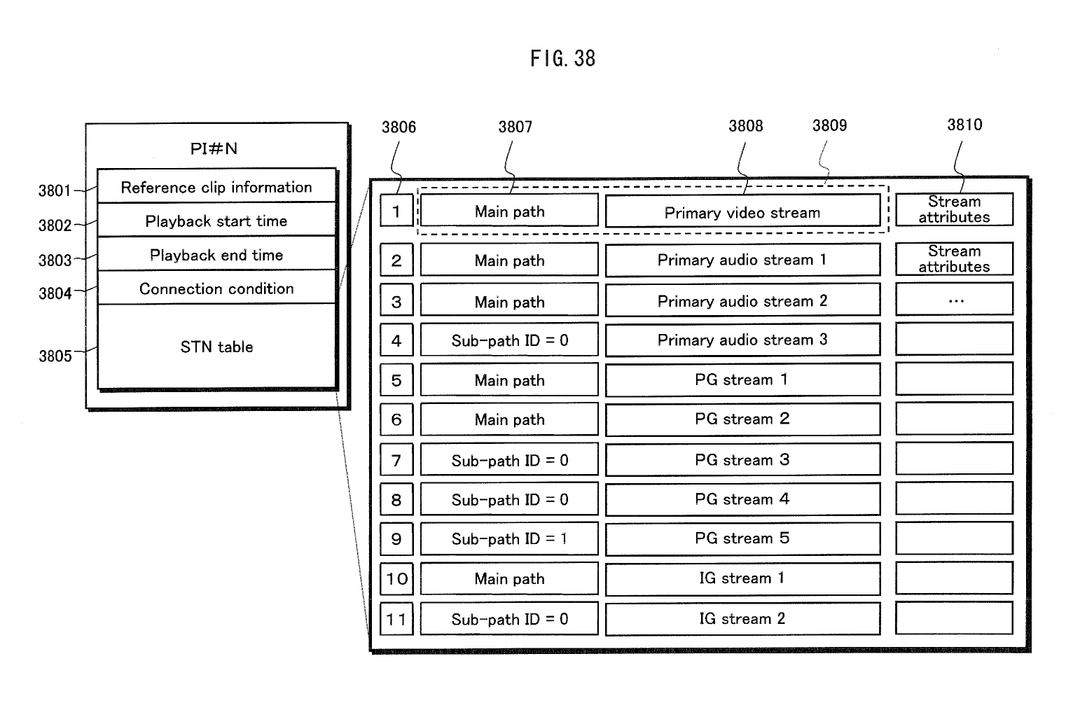

FIG. 38 is a schematic diagram showing a data structure of PI #N. As shown in FIG. 38, a PI #N includes a piece of reference clip information 3801, playback start time (In_Time) 3802, playback end time (Out_Time) 3803, connection condition 3804, and stream selection table (hereinafter abbreviated as “STN table” (stream number table)) 3805. The reference clip information 3801 is information for identifying the 2D clip information file 1031. The playback start time 3802 and playback end time 3803 respectively indicate PTSs for the top and the end of the section for playback of the file 2D 1041. The connection condition 3804 specifies a condition for connecting video in the playback section specified by a playback start time 3802 and a playback end time 3803 to video in the playback section specified by the previous PI #(N−1). The STN table 3805 is a list of elementary streams that can be selected from the file 2D 1041 by the decoder in the playback device 102 from the playback start time 3802 until the playback end time 3803.

The data structure of a SUB_PI is the same as the data structure of the PI shown in FIG. 38 insofar as it includes reference clip information, a playback start time, and a playback end time. In particular, the playback start time and playback end time of a SUB_PI are expressed as values along the same time axis as a PI. The SUB_PI further includes an “SP connection condition” field. The SP connection condition has the same meaning as a PI connection condition.

### [Connection Condition]

The connection condition (hereinafter abbreviated as “CC”) 3804 can for example be assigned three types of values, “1”, “5”, and “6”. When the CC 3804 is “1”, the video to be played back from the section of the file 2D 1041 specified by the PI #N does not need to be seamlessly connected to the video played back from the section of the file 2D 1041 specified by the immediately preceding PI #(N−1). On the other hand, when the CC 3804 indicates “5” or “6”, both video images need to be seamlessly connected.

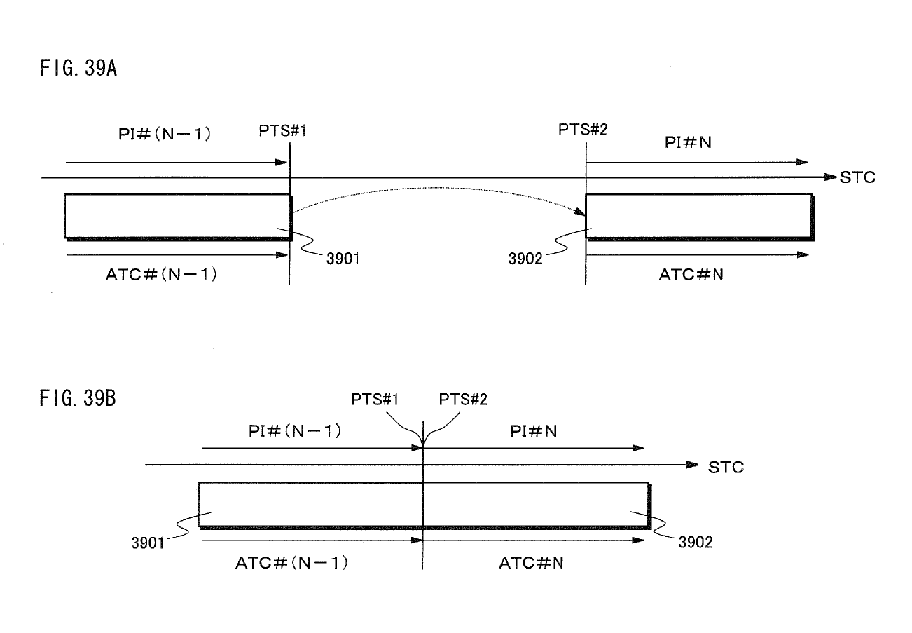

FIGS. 39A and 39B are schematic diagrams showing correspondence between two playback sections PI #(N−1) and PI #N that are to be connected when CC is “5” or “6”. In this case, the PI #(N−1) specifies a first section 3901 in the file 2D 1041, and the PI #N specifies a second section 3902 in the file 2D 1041. As shown in FIG. 39A, when the CC 5 indicates “5”, the STCs of the two PIs, PI #(N -1) and PI #N, may be noncontiguous. That is, the PTS #1 at the end of the first section 3901 and the PTS #2 at the top of the second section 3902 may be noncontiguous. Several constraint conditions, however, need to be satisfied. For example, the first section 3901 and second section 3902 need to be created so that the decoder can smoothly continue to decode data even when the second section 3902 is supplied to the decoder contiguously after the first section 3901. Furthermore, the last frame of the audio stream contained in the first section 3901 needs to overlap the top frame of the audio stream contained in the second section 3902. On the other hand, as shown in FIG. 39B, when the CC indicates “6”, the first section 3901 and the second section 3902 need to be able to be handled as successive sections for the decoder to duly decode. That is, STCs and ATCs need to be contiguous between the first section 3901 and the second section 3902. Similarly, when the SP connection condition is “5” or “6”, STCs and ATCs both need to be contiguous between sections of the file 2D specified by two contiguous SUB_PIs.

### [STN Table]

Referring again to FIG. 38, the STN table 3805 is an array of stream registration information. Note that “stream registration information” is information listing the individual elementary streams that can be selected for playback from the main TS between the playback start time 3802 and playback end time 3803. The stream number (STN) 3806 is a serial number allocated individually to stream registration information and is used by the playback device 102 to identify each elementary stream. The STN 3806 further indicates priority for selection among elementary streams of the same type. The stream registration information includes a stream entry 3809 and stream attribute information 3810. The stream entry 3809 includes stream path information 3807 and stream identification information 3808. The stream path information 3807 is information indicating the file 2D to which the selected elementary stream belongs. For example, if the stream path information 3807 indicates “main path”, the file 2D corresponds to the 2D clip information file indicated by reference clip information 3801. On the other hand, if the stream path information 3807 indicates “sub-path ID=1”, the file 2D to which the selected elementary stream belongs corresponds to the 2D clip information file indicated by the reference clip information of the SUB_PI included in the sub-path with a sub-path ID=1. The playback start time and playback end time specified by this SUB_PI are both included in the interval from the playback start time 3802 until the playback end time 3803 specified by the PI included in the STN table 3805. The stream identification information 3808 indicates the PID for the elementary stream multiplexed into the file 2D specified by the stream path information 3807. The elementary stream indicated by this PID can be selected from the playback start time 3802 until the playback end time 3803. The stream attribute information 3810 indicates attribute information for each elementary stream. For example, the attribute information for each of an audio stream, PG stream, and IG stream indicates a language type of the stream.

[Playback of 2D Video Images in Accordance with a 2D Playlist File]

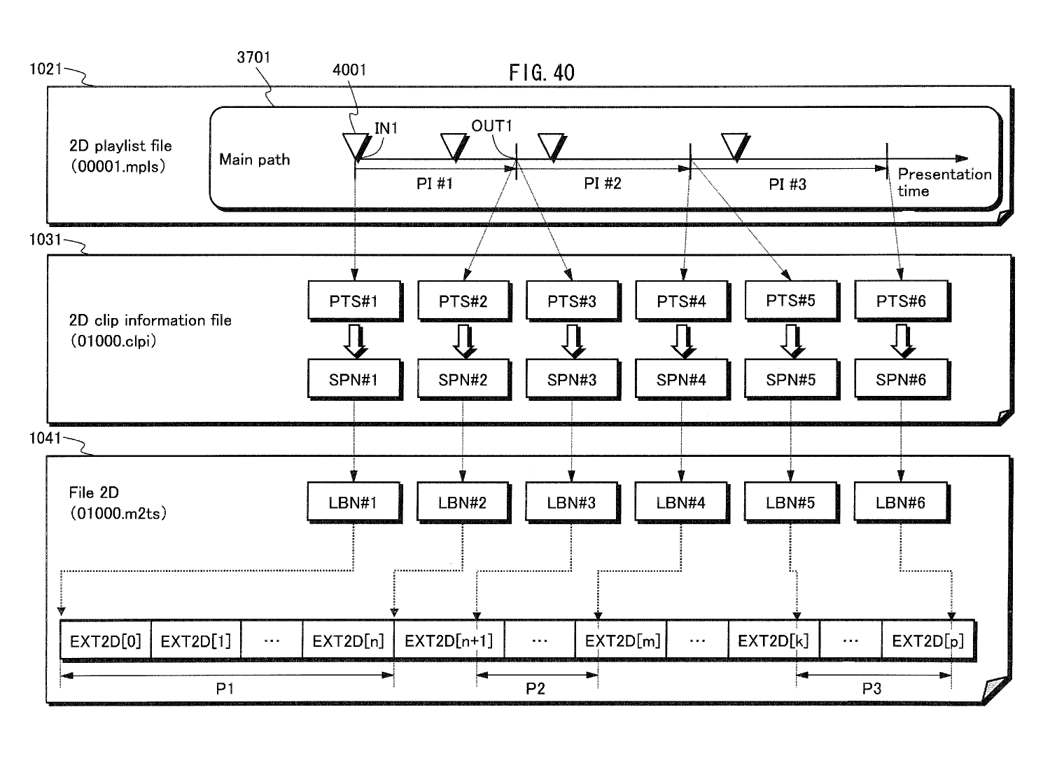

FIG. 40 is a schematic diagram showing correspondence between the PTSs indicated by the 2D playlist file (00001.mpls) 1021 and the sections played back from the file 2D (01000.m2ts) 1041. As shown in FIG. 40, in the main path 3701 in the 2D playlist file 1021, the PI #1 specifies a PTS #1, which indicates a playback start time IN1, and a PTS #2, which indicates a playback end time OUT1. The reference clip information for the PI #1 indicates the 2D clip information file (01000.clpi) 1031. When playing back 2D video images in accordance with the 2D playlist file 1021, the playback device 102 first reads the PTS #1 and PTS #2 from the PI #1. Next, with reference to the entry map of the 2D clip information file 1031, the playback device 102 retrieves the SPN #1 and the SPN #2 corresponding, in the file 2D 1041, to the PTS #1 and the PTS #2. The playback device 102 then calculates the corresponding numbers of sectors from the SPN #1 and SPN #2. Furthermore, the playback device 102 refers to these numbers of sectors and the file entry for the file 2D 1041 to specify the LBN #1 and LBN #2 at the top and end, respectively, of the sector group P1 on which the 2D extent group EXT2D[0], . . . , EXT2D[n] to be played back is recorded. Calculation of the numbers of sectors and specification of the LBNs are as per the description of FIG. 33. Finally, the playback device 102 indicates the range from LBN #1 to LBN #2 to the BD-ROM drive 121. The source packet group belonging to the 2D extent group EXT2D[0], . . . , EXT2D[n] is thus read from the sector group P1 in this range. Similarly, the pair PTS #3 and PTS #4 indicated by the PI #2 are first converted into a pair of SPN #3 and SPN #4 by referring to the entry map in the 2D clip information file 1031. Then, referring to the file entry for the file 2D 1041, the pair of SPN #3 and SPN #4 are converted into a pair of LBN #3 and LBN #4. Furthermore, a source packet group belonging to the 2D extent group is read from the sector group P2 in a range from the LBN #3 to the LBN #4. Conversion of a pair of PTS #5 and PTS #6 indicated by the PI #3 to a pair of SPN #5 and SPN #6, conversion of the pair of SPN #5 and SPN #6 to a pair of LBN #5 and LBN #6, and reading of a source packet group from the sector group P3 in a range from the LBN #5 to the LBN #6 are similarly performed. The playback device 102 thus plays back 2D video images from the file 2D 1041 in accordance with the main path 3701 in the 2D playlist file 1021.

The 2D playlist file 1021 may include an entry mark 4001. The entry mark 4001 indicates a time point in the main path 3701 at which playback is actually to start. For example, as shown in FIG. 40, a plurality of entry marks 4001 can be set for the PI #1. The entry mark 4001 is particularly used for searching for a playback start position during random access. For example, when the 2D playlist file 1021 specifies a playback path for a movie title, the entry marks 4001 are assigned to the top of each chapter. Consequently, the playback device 102 can play back the movie title by chapters.

### <<3D Playlist File>>

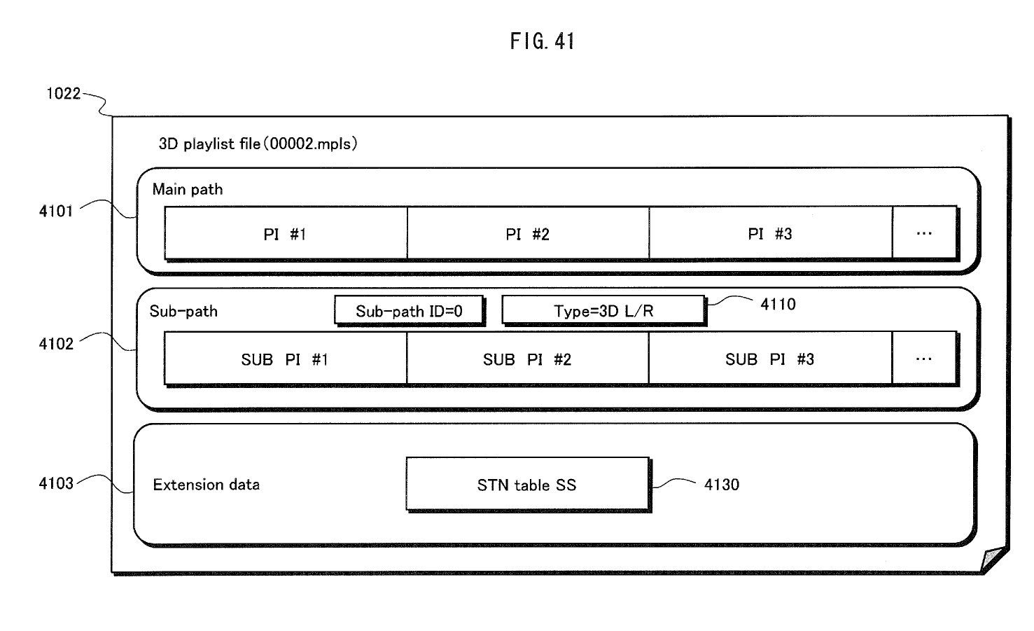

FIG. 41 is a schematic diagram showing a data structure of a 3D playlist file. The second playlist file (00002.mpls) 1022 shown in FIG. 10 has this data structure. The same holds with respect to the second playlist file (00003.mpls) 1023. As shown in FIG. 41, the 3D playlist file 1022 includes a main path 4101, sub-path 4102, and extension data 4103.

The main path 4101 specifies the playback path of the main TS shown in FIG. 11A. Accordingly, the main path 4101 is substantially the same as the main path 3701 for the 2D playlist file 1021 shown in FIG. 37. In other words, the playback device 102 in 2D playback mode can play back 2D video images from the file 2D 1041 in accordance with the main path 4101 in the 3D playlist file 1022. On the other hand, the main path 4101 differs from the main path 3701 shown in FIG. 37 in the following respect. That is, when an STN is associated with a PID in a graphics stream, the STN table for each PI allocates an offset sequence ID to the STN.

The sub-path 4102 specifies the playback path for a sub-TS shown in FIGS. 11B and 11C, i.e. the playback path for the first file DEP 1042 or the second file DEP 1043. The data structure of the sub-path 4102 is the same as the data structure of the sub-paths 3702 and 3703 in the 2D playlist file 1041 shown in FIG. 37. Accordingly, details on this similar data structure can be found in the description of FIG. 37, in particular details on the data structure of the SUB_PI.

The SUB_PI #N (N=1, 2, 3, . . . ) in the sub-path 4102 are in one-to-one correspondence with the PI #N in the main path 4101. Furthermore, the playback start time and playback end time specified by each SUB_PI #N are the same as the playback start time and playback end time specified by the corresponding PI #N. The sub-path 4102 additionally includes a sub-path type 4110. The “sub-path type” generally indicates whether playback processing should be synchronized between the main path and the sub-path. In the 3D playlist file 1022, the sub-path type 4110 in particular indicates the type of the 3D playback mode, i.e. the type of the dependent-view video stream to be played back in accordance with the sub-path 4102. In FIG. 41, the value of the sub-path type 4110 is “3D L/R”, thus indicating that the 3D playback mode is L/R mode, i.e. that the right-view video stream is to be played back. On the other hand, a value of “3D depth” for the sub-path type 4110 indicates that the 3D playback mode is depth mode, i.e. that the depth-map stream is to be played back. When the playback device 102 in 3D playback mode detects that the value of the sub-path type 4110 is “3D L/R” or “3D depth”, the playback device 102 synchronizes playback processing that conforms to the main path 4101 with playback processing that conforms to the sub-path 4102.

Extension data 4103 is interpreted only by the playback device 102 in 3D playback mode; the playback device 102 in 2D playback mode ignores the extension data 4103. In particular, the extension data 4103 includes an extension stream selection table 4130. The “extension stream selection table (STN_table_SS)” (hereinafter abbreviated as “STN table SS”) is an array of stream registration information to be added to the STN tables indicated by each PI in the main path 4101 during 3D playback mode. This stream registration information indicates elementary streams that can be selected for playback from the sub TS.

### [STN Table]

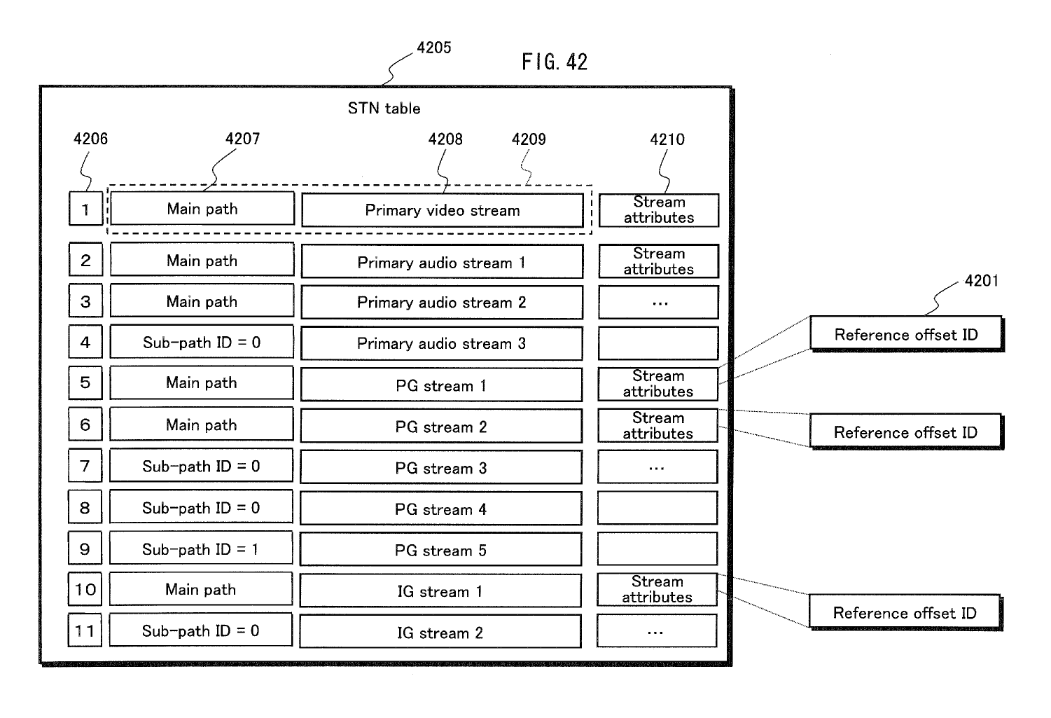

FIG. 42 is a schematic diagram showing an STN table 4205 included in a main path 4101 of the 3D playlist file 1022. As shown in FIG. 42, the stream identification information 4208 allocated to STN 4206 with the value from “5” to “11” indicates PIDs for a PG stream or IG stream. In this case, the stream attribute information 4210 allocated to the same STN further includes a reference offset ID (stream_ref_offset_id) 4201. In the file DEP 1042, as shown in FIG. 19, offset metadata 1910 is placed in VAU #1 of each video sequence. The reference offset ID 4201 is the same as one of the offset sequence IDs 1912 included in the offset metadata 1910. In other words, the reference offset ID 4101 defines the offset sequence that should be associated with each of the STNs 5, 6, . . . , 11 from among the plurality of offset sequences included in the offset metadata 1910.

### [STN Table SS]

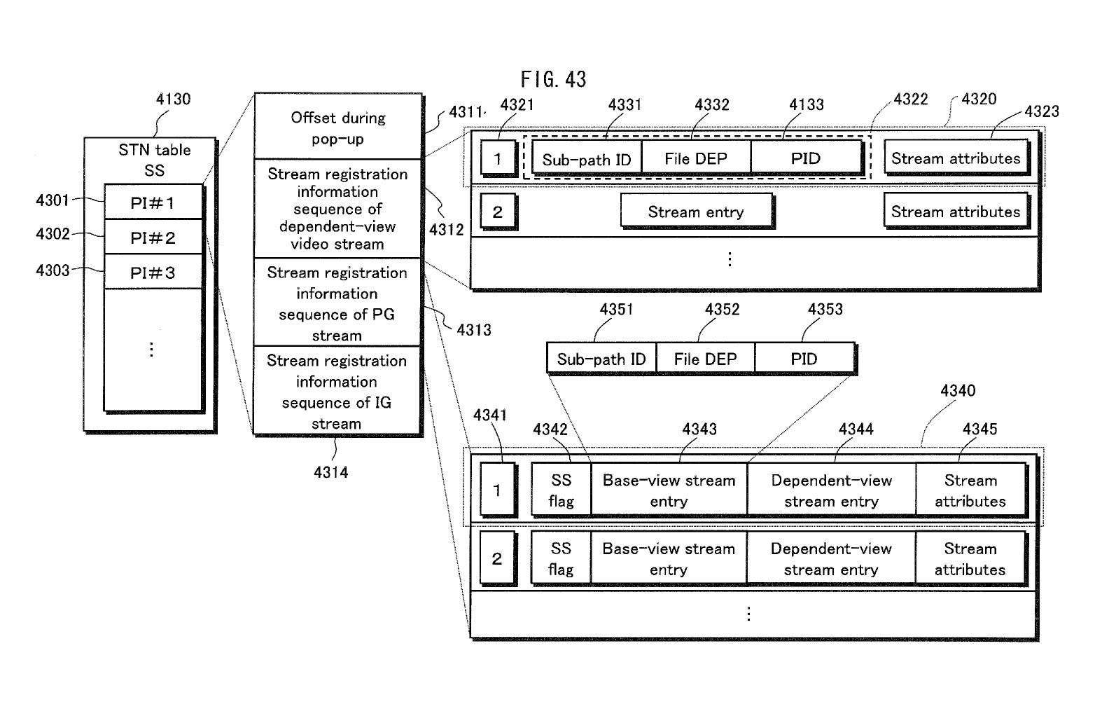

FIG. 43 is a schematic diagram showing a data structure of the STN table SS 4130. As shown in FIG. 43, an STN table SS 4130 includes stream registration information sequences 4301, 4302, 4303, . . . . . The stream registration information sequences 4301, 4302, 4303, . . . individually correspond to the PI #1, PI #2, PI #3, . . . in the main path 4101. The playback device 102 in 3D playback mode uses the stream registration information sequences 4301, . . . in combination with the stream registration information sequences included in the STN tables in the corresponding PIs. The stream registration information sequence 4301 corresponding to each PI includes an offset during pop-up (Fixed_offset_during_Popup) 4311, stream registration information sequence 4312 for the dependent-view video stream, stream registration information sequence 4313 for the PG stream, and stream registration information sequence 4314 for the IG stream.

The offset during pop-up 4311 indicates whether a pop-up menu is played back from the IG stream. The playback device 102 in 3D playback mode changes the presentation mode of the video plane and the PG plane in accordance with the value of the offset 4311. There are two types of presentation modes for the video plane: base-view (B)—dependent-view (D) presentation mode and B-B presentation mode. There are three types of presentation modes for the PG plane and IG plane: 2 plane mode, 1 plane+offset mode, and 1 plane+zero offset mode. For example, when the value of the offset during pop-up 4311 is “0”, a pop-up menu is not played back from the IG stream. At this point, B-D presentation mode is selected as the video plane presentation mode, and either 2 plane mode or 1 plane+offset mode is selected as the presentation mode for the PG plane. On the other hand, when the value of the offset during pop-up 4311 is “1”, a pop-up menu is played back from the IG stream. At this point, B-B presentation mode is selected as the video plane presentation mode, and 1 plane+zero offset mode is selected as the presentation mode for the PG plane.

In “B-D presentation mode”, the playback device 102 alternately outputs plane data decoded from the left-view video stream and right-view video stream. Accordingly, since left-view and right-view frames rendered on the video plane are alternately displayed on the screen of the display device 103, the viewer perceives these frames as 3D video images. In “B-B presentation mode”, the playback device 102 outputs plane data decoded only from the base-view video stream twice for a frame while maintaining the operation mode in 3D playback mode (in particular, maintaining the frame rate at the value for 3D playback, e.g. 48 frames/second). Accordingly, only either left-view frames or right-view frames are rendered on the video plane and thus displayed on the screen of the display device 103. Therefore, the viewer perceives these frames simply as 2D graphics images.

In an example shown in FIGS. 11B and 11C, a sub-TS may include both the base-view and dependent-view graphics streams. In this case, the playback device 102 in “2 plane mode” decodes and alternately outputs left-view and right-view graphics plane data from the respective graphics streams. In “1 plane+offset mode”, the playback device 102 generates, via offset control, a pair of left-view and right-view graphics planes from the graphics stream in the main TS and alternately outputs these graphics planes. In any of the modes, left-view and right-view graphics planes are alternately displayed on the screen of the display device 103, and thus the viewer perceives these frames as 3D graphics images. In “1 plane+zero offset mode”, the playback device 102 temporarily stops offset control and outputs a graphics plane decoded from the graphics stream in the main TS twice for a frame while maintaining the operation mode in 3D playback mode. Accordingly, only either the left-view or right-view graphics planes are displayed on the screen of the display device 103, and thus the viewer perceives these planes simply as 2D graphics images.

The playback device 102 in 3D playback mode refers to the offset during pop-up 4311 for each PI and selects B-B presentation mode and 1 plane+zero offset mode when a pop-up menu is played back from an IG stream. While a pop-up menu is displayed, other 3D video images are thus temporarily changed to 2D video images. This improves the visibility and usability of the pop-up menu.

The stream registration information sequence 4312 for the dependent-view video stream, the stream registration information sequence 4313 for the PG stream, the stream registration information sequence 4314 for the IG stream each include stream registration information indicating the dependent-view video stream, PG stream and IG stream that can be selected for playback from the sub-TS. These stream registration information sequences 4312, 4313, and 4314 are used in combination with the stream registration information sequences, included in the STN table of the corresponding PI, that indicate base-view video stream, PG stream, and IG stream. When reading a piece of stream registration information from an STN table, the playback device 102 in 3D playback mode automatically also reads the stream registration information sequence, located in the STN table SS, that has been combined with the piece of stream registration information. When simply switching from 2D playback mode to 3D playback mode, the playback device 102 can thus maintain already recognized STNs and stream attributes such as language.

The stream registration information sequence 4312 of the dependent-view video stream generally includes a plurality of pieces of stream registration information (SS_dependet_view_block) 4320. These are the same in number as the pieces of stream registration information in the corresponding PI that indicate the base-view video stream. Each piece of stream registration information 4320 includes an STN 4321, stream entry 4322, and stream attribute information 4323. The STN 4321 is a serial number assigned individually to pieces of stream registration information 4320 and is the same as the STN of the piece of stream registration information, located in the corresponding PI, with which the piece of stream registration information 4320 is combined. The stream entry 4322 includes sub-path ID reference information (ref_to_Subpath_id) 4331, stream file reference information (ref_to_subClip_entry_id) 4332, and a PID (ref_to_stream_PID_subclip) 4333. The sub-path ID reference information 4331 indicates the sub-path ID of the sub-path that specifies the playback path of the dependent-view video stream. The stream file reference information 4332 is information to identify the file DEP storing this dependent-view video stream. The PID 4333 is the PID for this dependent-view video stream. The stream attribute information 4323 includes attributes for this dependent-view video stream, such as frame rate, resolution, and video format. In particular, these attributes are the same as those for the base-view video stream shown by the piece of stream registration information, located in the corresponding PI, with which each piece of stream registration information is combined.

The stream registration information sequence 4313 of the PG stream generally includes a plurality of pieces of stream registration information 4340. These are the same in number as the pieces of stream registration information in the corresponding PI that indicate the PG stream. Each piece of stream registration information 4340 includes an STN 4341, stereoscopic flag (is_SS_PG) 4342, base-view stream entry (stream_entry_for_base_view) 4343, dependent-view stream entry (stream_entry_for_dependent_view) 4344, and stream attribute information 4345. The STN 4341 is a serial number assigned individually to pieces of stream registration information 4340 and is the same as the STN of the piece of stream registration information, located in the corresponding PI, with which the piece of stream registration information 4340 is combined. The stereoscopic flag 4342 indicates “whether PG streams of both the base-view and dependent-view (for example, left-view and right-view) are included on a BD-ROM disc 101”. If the stereoscopic flag 4342 is ON, both PG streams are included in the sub-TS. Accordingly, the playback device 102 reads all of the fields in the base-view stream entry 4343, the dependent-view stream entry 4344, and the stream attribute information 4345. If the stereoscopic flag 4342 is OFF, the playback device 102 ignores all of these fields 4343-4345. Both the base-view stream entry 4343 and the dependent-view stream entry 4344 include sub-path ID reference information 4351, stream file reference information 4352, and PIDs 4353. The sub-path ID reference information 4351 indicates the sub-path IDs of the sub-paths that specify the playback paths of the base-view and dependent-view PG streams. The stream file reference information 4352 is information to identify the file DEP storing the PG streams. The PIDs 4353 are the PIDs for the PG streams. The stream attribute information 4345 includes attributes for the PG streams, such as language type. The stream registration information sequence 4314 of the IG stream also has a similar data structure.

[Playback of 3D Video Images in Accordance with 3D Playlist File]

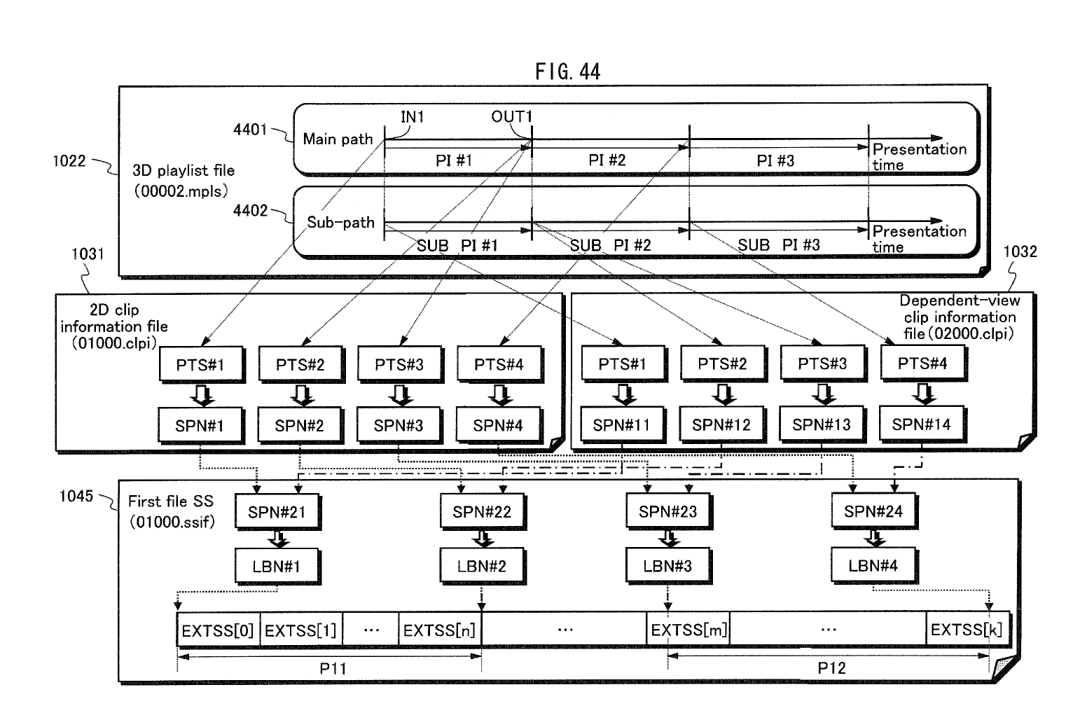

FIG. 44 is a schematic diagram showing correspondence between PTSs indicated by the 3D playlist file (00002.mpls) 1022 and sections played back from the first file SS (01000.ssif) 1045. As shown in FIG. 44, in the main path 4101 in the 3D playlist file 1022, the PI #1 specifies a PTS #1, which indicates a playback start time IN1, and a PTS #2, which indicates a playback end time OUT1. The reference clip information for the PI #1 indicates the 2D clip information file (01000.clpi) 1031. The sub-path 3902 specifies the PTS #1 and PTS #2 having the same SUB_PI #1 as the PI #1. The reference clip information for the SUB_PI #1 indicates the dependent-view clip information file (02000.clpi) 1032.

When playing back 3D video images in accordance with the 3D playlist file 1022, the playback device 102 first reads PTS #1 and PTS #2 from the PI #1 and SUB_PI #1. Next, the playback device 102 refers to the entry map in the 2D clip information file 1031 to retrieve from the file 2D 1041 the SPN #1 and SPN #2 that correspond to the PTS #1 and PTS #2. In parallel, the playback device 102 refers to the entry map in the dependent-view clip information file 1032 to retrieve from the first file DEP 1042 the SPN #11 and SPN #12 that correspond to the PTS #1 and PTS #2. As described with reference to FIG. 34E, the playback device 102 then uses the extent start points 3242 and 3420 in the clip information files 1031 and 1032 to calculate, from SPN #1 and SPN #11, the number of source packets SPN #21 from the top of the first file SS 1045 to the playback start position. Similarly, the playback device 102 calculates, from SPN #2 and SPN #12, the number of source packets SPN #22 from the top of the first file SS 1045 to the playback end position. The playback device 102 further calculates the numbers of sectors corresponding to the SPN #21 and SPN #22. Next, the playback device 102 refers to these numbers of sectors and the file entry of the first file SS 1045 to specify the LBN #1 and LBN #2 at the top and end, respectively, of the sector group P11 on which the extent SS group EXTSS[0], . . . , EXTSS[n] to be played back is recorded. Calculation of the numbers of sectors and specification of the LBNs are as per the description of FIG. 34E. Finally, the playback device 102 indicates the range from LBN #1 to LBN #2 to the BD-ROM drive 121. The source packet group belonging to the extent SS group EXTSS[0], . . . , EXTSS[n] is thus read from the sector group P11 in this range. Similarly, the pair PTS #3 and PTS #4 indicated by the PI #2 and SUB_PI #2 are first converted into a pair of SPN #3 and SPN #4 and a pair of SPN #13 and SPN #14 by referring to the entry maps in the clip information files 231 and 232. Next, the number of source packets SPN #23 from the top of the first file SS 1045 to the playback start position is calculated from SPN #3 and SPN #13. Then, the number of source packets SPN #24 from the top of the first file SS 1045 to the playback end position is calculated from SPN #4 and SPN #14. Next, referring to the file entry for the first file SS 1045, the pair of SPN #23 and SPN #24 are converted into a pair of LBN #3 and LBN #4. Thereafter, a source packet group belonging to the extent SS group is read from the sector group P12 in a range from the LBN #3 to the LBN #4.

In parallel with the above-described read processing, as described with reference to FIG. 34E, the playback device 102 refers to the extent start points 3242 and 3420 in the clip information files 1031 and 1032 to extract base-view extents and dependent-view extents from each extent SS and decode the base-view and dependent-view extents in parallel. The playback device 102 can thus play back 3D video images from the first file SS 1045 in accordance with the 3D playlist file 1022.

### <<Index File>>

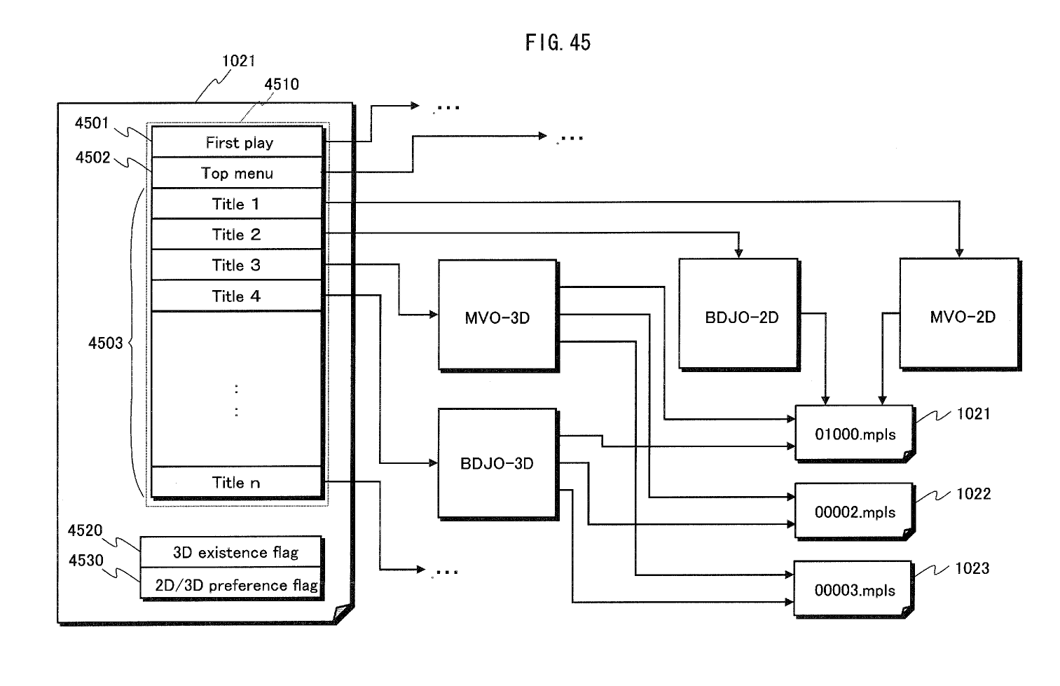

FIG. 45 is a schematic diagram showing a data structure of an index file (index.bdmv) 1011 shown in FIG. 10. As shown in FIG. 45, the index file 1011 includes an index table 4510, 3D existence flag 4520, and 2D/3D preference flag 4530.

The index table 4510 stores the items “first play” 4501, “top menu” 4502, and “title k” 4503 (k=1, 2, . . . , n; the letter n represents an integer greater than or equal to 1). Each item is associated with either a movie object MVO-2D, MVO-3D, . . . , or a BD-J object BDJO-2D, BDJO-3D, . . . . Each time a title or a menu is called in response to a user operation or an application program, a control unit in the playback device 102 refers to a corresponding item in the index table 4510. Furthermore, the control unit calls an object associated with the item from the BD-ROM disc 101 and accordingly executes a variety of processes. Specifically, the item “first play” 4501 specifies an object to be called when the BD-ROM disc 101 is loaded into the BD-ROM drive 121. The item “top menu” 4502 specifies an object for displaying a menu on the display device 103 when a command “go back to menu” is input, for example, by user operation. In the items “title k” 4503, the titles that constitute the content on the BD-ROM disc 101 are individually allocated. For example, when a title for playback is specified by user operation, in the item “title k” in which the title is allocated, the object for playing back video images from the AV stream file corresponding to the title is specified.

In the example shown in FIG. 45, the items “title 1” and “title 2” are allocated to titles of 2D video images. The movie object MVO-2D associated with the item “title 1” includes a group of commands related to playback processes for 2D video images to be performed using the 2D playlist file (00001.mpls) 1021. When the playback device 102 refers to the item “title 1”, then in accordance with the movie object MVO-2D, the 2D playlist file 1021 is read from the BD-ROM disc 101, and playback processes for 2D video images are executed in accordance with the playback path specified therein. The BD-J object BDJO-2D associated with the item “title 2” includes an application management table related to playback processes for 2D video images to be performed using the 2D playlist file 1021. When the playback device 102 refers to the item “title 2”, then in accordance with the application management table in the BD-J object BDJO-2D, a Java application program is called from the JAR file 1061 and executed. In this way, the 2D playlist file 1021 is read from the BD-ROM disc 101, and playback processes for 2D video images are executed in accordance with the playback path specified therein.

Furthermore, in the example shown in FIG. 45, the items “title 3” and “title 4” are allocated to titles of 3D video images. The movie object MVO-3D associated with the item “title 3” includes, in addition to a group of commands related to playback processes for 2D video images to be performed using the 2D playlist file 1021, a group of commands related to playback processes for 3D video images to be performed using either 3D playlist file (00002.mpls) 1022 or (00003.mpls) 1023. In the BD-J object BDJO-3D associated with the item “title 4” the application management table specifies, in addition to a Java application program related to playback processes for 2D video images to be performed using the 2D playlist file 1021, a Java application program related to playback processes for 3D video images to be performed using either 3D playlist file 1022 or 1023.

The 3D existence flag 4520 shows whether or not 3D video image content is recorded on the BD-ROM disc 101. When the BD-ROM disc 101 is inserted into the BD-ROM drive 121, the playback device 102 first checks the 3D existence flag 4520. When the 3D existence flag 4520 is ON, the playback device 102 exchanges CEC messages with the display device 103 via the HDMI cable 122 to inquire as to whether or not the display device 103 supports playback of 3D video images. In order to make the inquiry, the playback device 102 needs to perform HDCP authentication on the display device 103. On the other hand, when the 3D existence flag 4520 is OFF, the playback device 102 does not need to select 3D playback mode, and thus promptly proceeds in 2D playback mode without performing HDCP authentication on the display device 103. By skipping HDCP authentication in the above manner, the time between insertion of the BD-ROM disc 101 and the start of playback of 2D video images is shortened.

The 2D/3D preference flag 4530 indicates whether playback of 3D video images should be prioritized when both the playback device and the display device support playback of both 2D video images and 3D video images. The 2D/3D preference flag 4530 is set by the content provider. When the 3D existence flag 4520 in the BD-ROM disc 101 is ON, the playback device 102 then additionally checks the 2D/3D preference flag 4530. When the 2D/3D preference flag 4530 is ON, playback of 3D video images takes priority, and thus the playback device 102 does not make the user select the playback mode. Rather, playback device 102 performs HDCP authentication without displaying a playback mode selection screen on the display device 103. Based on the authentication result, the playback device 102 operates in either 2D playback mode or 3D playback mode. When it is determined that the display device 103 supports playback of 3D video images, the playback device 102 immediately starts operating in 3D playback mode. This makes it possible to avoid delays in starting up caused by processing to switch from 2D playback mode to 3D playback mode, such as switching frame rates, etc.

[Selection of Playlist File when Selecting 3D Video Title]

In the example shown in FIG. 45, when the playback device 102 refers to item “title 3” in the index table 4510, the following determination processes are performed in accordance with the movie object MVO-3D: (1) whether the 3D existence flag 4520 is ON or OFF; (2) whether the playback device 102 itself supports playback of 3D video images or not; (3) whether the 2D/3D preference flag 4530 is ON or OFF; (4) whether the user has selected 3D playback mode or not; (5) whether the display device 103 supports playback of 3D video images or not; and (6) whether the 3D playback mode of the playback device 102 is in L/R mode or depth mode. Next, in accordance with the results of these determinations, the playback device 102 selects one of the playlist files 1021-1023 for playback. On the other hand, when the playback device 102 refers to item “title 4”, a Java application program is called from the JAR file 1061, in accordance with the application management table in the BD-J object BDJO-3D, and executed. The above-described determination processes (1)-(6) are thus performed, and a playlist file is then selected in accordance with the results of determination.

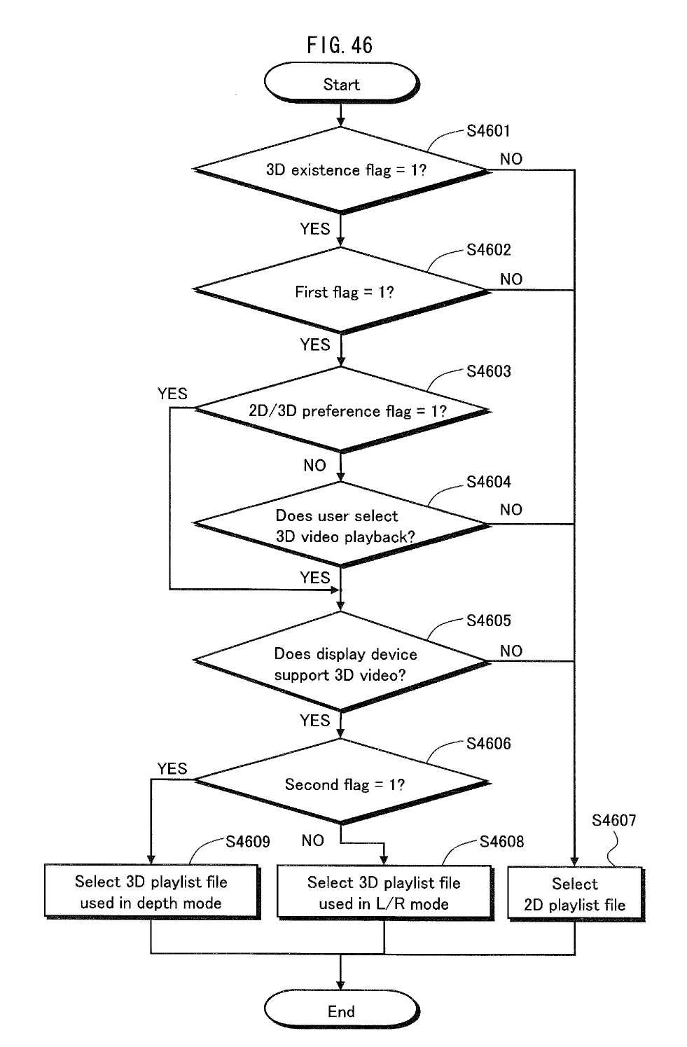

FIG. 46 is a flowchart of selection processing for a playlist file to be played back using the above determination processes (1)-(6). For this selection processing, it is assumed that the playback device 102 includes a first flag and a second flag.

The first flag indicates whether or not the playback device 102 supports playback of 3D video images. For example, a value of “0” for the first flag indicates that the playback device 102 only supports playback of 2D video images, whereas “1” indicates support of 3D video images as well. The second flag indicates whether or not the 3D playback mode is L/R mode or depth mode. For example, a value of “0” for the second flag indicates that the 3D playback mode is L/R mode, whereas “1” indicates depth mode. Furthermore, the respective values of the 3D existence flag 4520 and 2D/3D preference flag 4530 are set to “1” when these flags are ON, and to “0” when these flags are OFF.

In step S4601, the playback device 102 checks the value of the 3D existence flag 4520. If the value is “1”, processing proceeds to step S4602. If the value is “0”, processing proceeds to step S4607.

In step S4602, the 3D playback mode may be selected because the 3D existence flag 4520 is ON. Therefore, the playback device 102 checks the value of the first flag. If the value is “1”, processing proceeds to step S4603. If the value is “0”, processing proceeds to step S4607.

In step S4603, the first flag is ON, which means that the playback device 102 supports playback of 3D video images. The playback device 102 further checks the value of the 2D/3D preference flag 4530. If the value is “0”, processing proceeds to step S4604. If the value is “1”, processing proceeds to step S4605.

In step S4604, playback of 3D video images is not prioritized because the 2D/3D preference flag 4530 is OFF. Therefore, the playback device 102 displays a menu on the display device 103 for the user to select either 2D playback mode or 3D playback mode. If the user selects 3D playback mode via operation of a remote control 105 or the like, processing proceeds to step S4605, whereas if the user selects 2D playback mode, processing proceeds to step S4607.

In step S4605, playback of 3D video images is prioritized or 3D playback mode is selected in advance by the user. Therefore, the playback device 102 performs HDCP authentication to check whether the display device 103 supports playback of 3D video images. If the display device 103 supports playback of 3D video images, processing proceeds to step S4606. If the display device 103 does not support playback of 3D video images, processing proceeds to step S4607.

In step S4606, it is determined to start the 3D playback mode. Therefore, the playback device 102 checks the value of the second flag. If the value is “0”, processing proceeds to step S4608. If the value is “1”, processing proceeds to step S4609.

In step S4607, it is determined to start the 2D playback mode. Therefore, the playback device 102 selects for playback the 2D playlist file 1021. Note that, at this time, the playback device 102 may cause the display device 103 to display the reason why playback of 3D video images was not selected. Processing then terminates.

In step S4608, the playback device 102 starts up in L/R mode. That is, the playback device 102 selects for playback the 3D playlist file 1022 used in L/R mode. Processing then terminates.

In step S4609, the playback device 102 starts up in depth mode. That is, the playback device 102 selects for playback the 3D playlist file 1023 used in depth mode. Processing then terminates.

<Structure of 2D Playback Device>

When playing back 2D video image content from the BD-ROM disc 101 in 2D playback mode, the playback device 102 operates as a 2D playback device. FIG. 47 is a functional block diagram of a 2D playback device 4700. As shown in FIG. 47, the 2D playback device 4700 includes a BD-ROM drive 4701, playback unit 4702, and control unit 4703. The playback unit 4702 includes a read buffer 4721, system target decoder 4723, plane adder 4724, and HDMI communication unit 4725. The control unit 4703 includes a dynamic scenario memory 4731, static scenario memory 4732, user event processing unit 4733, program execution unit 4734, playback control unit 4735, and player variable storage unit 4736. The playback unit 4702 and the control unit 4703 are each implemented on a different integrated circuit, but may alternatively be implemented on a single integrated circuit. Alternatively, the units may be integrated into a single integrated circuit.

When the BD-ROM disc 101 is loaded into the BD-ROM drive 4701, the BD-ROM drive 4701 radiates laser light to the disc 101 and detects change in the reflected light. Furthermore, using the change in the amount of reflected light, the BD-ROM drive 4701 reads data recorded on the disc 101. Specifically, the BD-ROM drive 4701 has an optical pickup, i.e. an optical head. The optical head has a semiconductor laser, collimate lens, beam splitter, objective lens, collecting lens, and optical detector. A beam of light radiated from the semiconductor laser sequentially passes through the collimate lens, beam splitter, and objective lens to be collected on a recording layer of the disc 101. The collected beam is reflected and diffracted by the recording layer. The reflected and diffracted light passes through the objective lens, the beam splitter, and the collecting lens, and is collected onto the optical detector. The optical detector generates a playback signal at a level in accordance with the amount of collected light. Furthermore, data is decoded from the playback signal.

The BD-ROM drive 4701 reads data from the BD-ROM disc 101 based on a request from the playback control unit 4735. Out of the read data, the extents in the file 2D, i.e. the 2D extents, are transferred to the read buffer 4721; dynamic scenario information is transferred to the dynamic scenario memory 4731; and static scenario information is transferred to the static scenario memory 4732. Note that “dynamic scenario information” includes an index file, movie object file, and BD-J object file. On the other hand, “static scenario information” includes a 2D playlist file and a 2D clip information file.

The read buffer 4721, dynamic scenario memory 4731, and static scenario memory 4732 are each a buffer memory. The read buffer 4721 is implemented using an area of a memory element included in the playback unit 4702. The dynamic scenario memory 4731 and static scenario memory 4732 are each implemented using a memory element included in the control unit 4703. Alternatively, different areas in a single memory element may be used as part or all of these buffer memories 4721, 4731, and 4732. The read buffer 4721 stores 2D extents, the dynamic scenario memory 4731 stores dynamic scenario information, and the static scenario memory 4732 stores static scenario information.

The system target decoder 4723 reads 2D extents from the read buffer 4721 in units of source packets and demultiplexes the 2D extents. The system target decoder 4723 then decodes each of the elementary streams obtained by the demultiplexing. At this point, information necessary for decoding each elementary stream, such as the type of codec and attributes of the stream, is transferred in advance from the playback control unit 4735 to the system target decoder 4723. After decoding, the system target decoder 4723 converts the VAUs of the decoded primary video stream, secondary video stream, IG stream, and PG stream into primary video plane, secondary video plane, IG plane, and PG plane to output to the plane adder 4724. In particular, the system target decoder 4723 sends each primary video plane at the intervals of 1/24 seconds. On the other hand, the system target decoder 4723 mixes the decoded primary audio stream and secondary audio stream and transmits the resultant data to an audio output device, such as an internal speaker 103A of the display device 103. In addition, the system target decoder 4723 receives graphics data from the program execution unit 4734. The graphics data is used for rendering graphics elements for a GUI, such as a menu, on the screen and is in a raster data format such as JPEG and PNG. The system target decoder 4723 converts the graphics data into image plane and outputs the image plane to the plane adder 4724. Details on the system target decoder 4723 are provided below.

The plane adder 4724 receives the primary video plane, secondary video plane, IG plane, PG plane, and image plane from the system target decoder 4723 and superimposes these planes to generate one combined video frame or field. The video plane thus superimposed is output to the HDMI communication unit 4725 at the intervals of 1/24 seconds, in particular.

The HDMI communication unit 4725 receives the video data thus combined from the plane adder 4724, receives audio data from the system target decoder 4723, and receives control data from the playback control unit 4735. Furthermore, the HDMI communication unit 4725 converts the received data into serial signals in the HDMI format and transmits the thus converted signals to the display device 103 through the TMDS channel in the HDMI cable 122. In particular, the HDMI communication unit 4725 generates the serial signals in the format shown in FIG. 5A. In the format, the respective video planes are output at intervals of 1/24 seconds. According to the serial signals, the display device 103 displays video represented by the video data and produces audio output represented by the audio data from the speaker 103A. On the other hand, the HDMI communication unit 4725 exchanges CEC messages with the display device 103 via the CEC line available within the HDMI cable 122 and reads EDID from the display device 103 via the display data channel available within the HDMI cable 122. Details of the HDMI communication unit 4725 are provided below.

The user event processing unit 4733 detects a user operation via the remote control 105 or the front panel of the playback device 102. Based on the user operation, the user event processing unit 4733 requests the program execution unit 4734 or the playback control unit 4735 to perform processing. For example, when a user instructs to display a pop-up menu by pushing a button on the remote control 105, the user event processing unit 4733 detects the push and identifies the button. The user event processing unit 4733 further requests the program execution unit 4734 to execute a command corresponding to the button, i.e. a command to display the pop-up menu. On the other hand, when a user pushes a fast-forward or a rewind button on the remote control 105, the user event processing unit 4733 detects the push and identifies the button. The user event processing unit 4733 then requests the playback control unit 4735 to fast-forward or rewind the playlist currently being played back.

The program execution unit 4734 is a processor that reads programs from movie object files and BD-J object files stored in the dynamic scenario memory 4731 and executes these programs. Furthermore, the program execution unit 4734 performs the following operations in accordance with the programs: (1) the program execution unit 4734 orders the playback control unit 4735 to perform playlist playback processing; and (2) the program execution unit 4734 generates graphics data for a menu or game as PNG or JPEG raster data and transfers the generated data to the system target decoder 4523 where the received data is combined with other video data. Via program design, specific details on these processes can be designed relatively flexibly. In other words, during the authoring process of the BD-ROM disc 101, the nature of these processes is determined while programming the movie object files and BD-J object files.

The playback control unit 4735 controls transfer of different types of data, such as 2D extents, an index file, etc. from the BD-ROM disc 101 to the read buffer 4721, dynamic scenario memory 4731, and static scenario memory 4732. A file system managing the directory file structure shown in FIG. 10 is used for this control. The playback control unit 4735 provides a file name of the file to be retrieved to the file system using a system call for opening files and search the directory/file structure for the file. When the file retrieval is successful, the file system first transfers the file entry for the target file to memory in the playback control unit 4735 and a File Control Block (FCB) is generated in the memory. Subsequently, the file system returns a file handle for the target file to the playback control unit 4735. The playback control unit 4735 then presents the file handle to the BD-ROM drive 4701. In response, the BD-ROM drive 4701 transfers the target file from the BD-ROM disc 101 to the respective buffer memories 4721, 4731, and 4732.

The playback control unit 4735 decodes the file 2D to output video data and audio data by controlling the BD-ROM drive 4701 and the system target decoder 4723. Specifically, the playback control unit 4735 first reads a 2D playlist file from the static scenario memory 4732, in response to an instruction from the program execution unit 4734 or a request from the user event processing unit 4733, and interprets the content of the file. In accordance with the interpreted content, particularly with the playback path, the playback control unit 4735 then specifies a file 2D to be played back and instructs the BD-ROM drive 4701 and the system target decoder 4723 to read and decode this file. Such playback processing based on a playlist file is called “playlist playback processing”.

In addition, the playback control unit 4735 sets various types of player variables in the player variable storage unit 4736 using the static scenario information. With reference to the player variables, the playback control unit 4735 further specifies to the system target decoder 4723 elementary streams to be decoded and provides the information necessary for decoding the elementary streams.

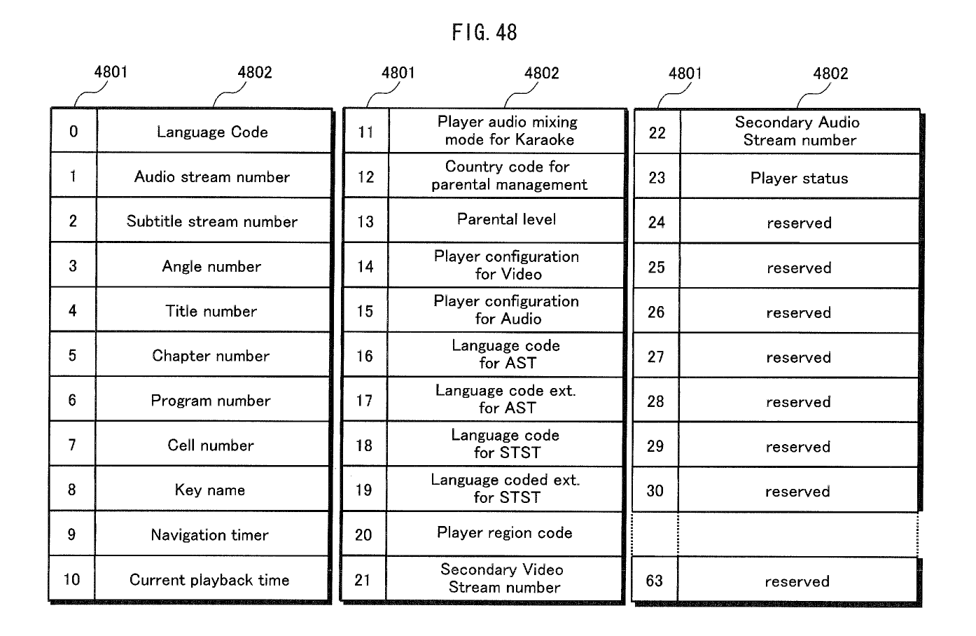

The player variable storage unit 4736 is composed of a group of registers for storing player variables. Types of player variables include system parameters (SPRM) and general parameters (GPRM). An SPRM indicates the status of the playback device 102. FIG. 48 is a list of SPRMs. As shown in FIG. 48, each SPRM is assigned a serial number 4801, and each serial number 4801 is associated with a unique variable value 4802. In one example, there are total of 64 SPRMs and each indicates the following meaning. Here, the numbers in parentheses indicate the serial numbers 4801.

SPRM(0): Language code

SPRM(1): Primary audio stream number

SPRM(2): Subtitle stream number

SPRM(3): Angle number

SPRM(4): Title number

SPRM(5): Chapter number

SPRM(6): Program number

SPRM(7): Cell number

SPRM(8): Key name

SPRM(9): Navigation timer

SPRM(10): Current playback time

SPRM(11): Player audio mixing mode for karaoke

SPRM(12): Country code for parental management

SPRM(13): Parental level

SPRM(14): Player configuration for video

SPRM(15): Player configuration for audio

SPRM(16): Language code for audio stream

SPRM(17): Language code extension for audio stream

SPRM(18): Language code for subtitle stream

SPRM(19): Language code extension for subtitle stream

SPRM(20): Player region code

SPRM(21): Secondary video stream number

SPRM(22): Secondary audio stream number

SPRM(23): Player status

SPRM(24)-SPRM(63): Reserved

The SPRM(10) indicates the PTS of the picture currently being decoded and is updated every time a picture is decoded and written into the primary video plane memory. Accordingly, the current playback point can be known by referring to the SPRM(10).

The parental level in SPRM(13) indicates a predetermined restricted age of a viewer permitted to use the playback device 102 and is used for parental control of viewing of titles recorded on the BD-ROM disc 101. A user of the playback device 102 sets the value of the SPRM(13) via, for example, an OSD of the playback device 102. “Parental control” refers to restricting viewing of a title in accordance with the viewer's age. The following is an example of how the playback device 102 performs parental control. The playback device 102 first reads, from the BD-ROM disc 101, the age for which viewing of a title is permitted and compares this age with the value of the SPRM(13). The restricted age indicates the minimum age of viewers permitted to view a corresponding title. If the restricted age is equal to or less than the value of the SPRM(13), the playback device 102 continues with playback of the title. If the restricted age is greater than the value of the SPRM(13), the playback device 102 stops playback of the title.

The language code for audio stream in SPRM(16) and the language code for subtitle stream in SPRM(18) show default language codes of the playback device 102. These codes may be changed by a user with use of the OSD or the like of the playback device 102, or the codes may be changed by an application program via the program execution unit 4734. For example, if the SPRM(16) shows “English”, then during playback processing of a playlist, the playback control unit 4735 first searches the STN table in the PI showing the current playback section, i.e. the current PI, for a stream entry having the language code for “English”. The playback control unit 4735 then extracts the PID from the stream identification information of the stream entry and transmits the extracted PID to the system target decoder 4723. As a result, an audio stream having the PID is selected and decoded by the system target decoder 4723. These processes can be executed by the playback control unit 4735 with use of the movie object file or the BD-J object file.

During playback processing, the playback control unit 4735 updates the player variables in accordance with the status of playback. In particular, the playback control unit 4735 updates the SPRM(1), SPRM(2), SPRM(21), and SPRM(22). These SPRM respectively show, in the stated order, the STN of the audio stream, subtitle stream, secondary video stream, and secondary audio stream that are currently being processed. For example, suppose that the SPRM(1) has been changed by the program execution unit 4734. In this case, the playback control unit 4735 first refers to the STN shown by the new SPRM(1) and retrieves the stream entry that includes this STN from the STN table in the current PI. The playback control unit 4735 then extracts the PID from the stream identification information of the stream entry and transmits the extracted PID to the system target decoder 4723. As a result, an audio stream having the PID is selected and decoded by the system target decoder 4723. This is how the audio stream to be played back is switched. The subtitle stream and the secondary video stream to be played back can be similarly switched.

<Playback Processing of 2D Playback Device>

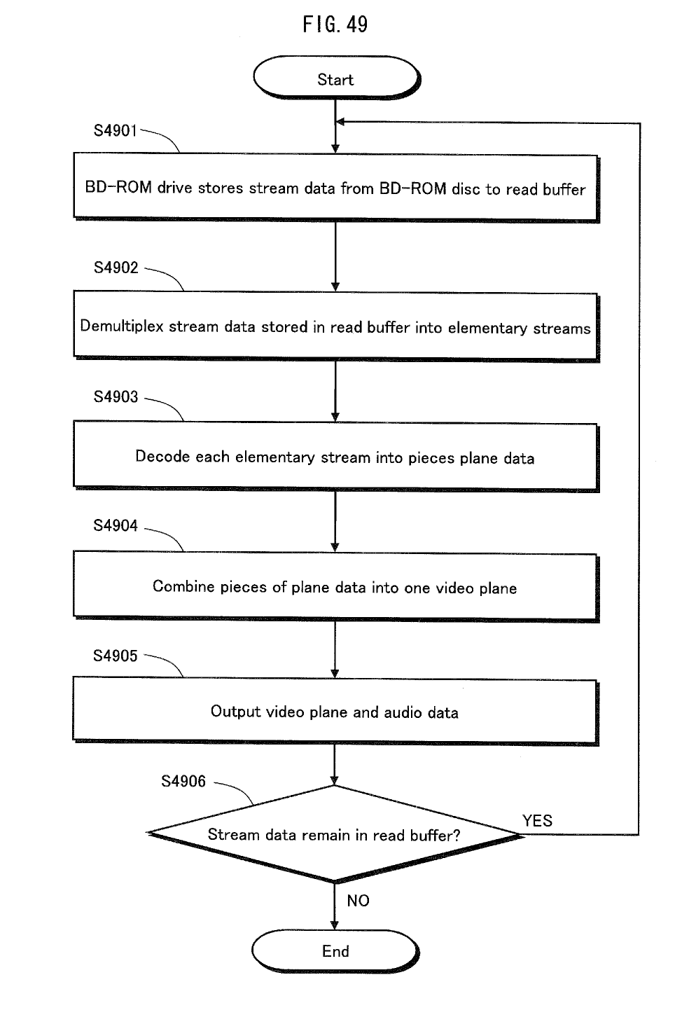

FIG. 49 is a flowchart of playback processing by the 2D playback device 4700 shown in FIG. 47. This processing is started when the playback device 102 is activated in 2D playback mode as a result of the selection shown in FIG. 46.

In step S4901, the 2D playback device 4700 controls the BD-ROM drive 4701 to read stream data from the BD-ROM disc 101 and stores the read data to the read buffer 4721. Thereafter, processing proceeds to step S4902.

In step S4902, the 2D playback device 4700 controls the system target decoder 4723 to read stream data from the read buffer 4721 and demultiplex the stream data into separate elementary streams. Thereafter, processing proceeds to step S4903.

In step S4903, the 2D playback device 4700 controls the system target decoder 4723 to decode the respective elementary streams. In particular, the primary video stream, secondary video stream, IG stream, and PG stream are decoded into a primary video plane, secondary video plane, IG plane, and PG plane, respectively. Furthermore, the primary audio and secondary audio streams are mixed. In addition, graphics data received from the program execution unit 4734 is converted into an image plane. Thereafter, processing proceeds to step S4904.

In step S4904, the 2D playback device 4700 controls the plane adder 4724 to combine the primary video plane, secondary video plane, IG plane, PG plane, and image plane, each of which is decoded by the system target decoder 4723, into one video plane. Thereafter, processing proceeds to step S4905.

In step S4905, the 2D playback device 4700 controls the HDMI communication unit 4725 to convert the video plane combined by the plane adder 4724, audio data mixed by the system target decoder 4723, control data received from the playback control unit 4735 all into serial signals and transmits the resulting signals to the display device 103 via the HDMI cable 122. In particular, the serial signals are generated in the format shown in FIG. 5A. In the format, the respective video planes are output at intervals of 1/24 seconds. Thereafter, processing proceeds to step S4906.

In step S4906, the 2D playback device 4700 checks whether there is any unprocessed stream data remaining in the read buffer 4721. When unprocessed data remains, processing is repeated from step S4901. When no unprocessed data remains, processing ends.

<<2D Playlist Playback Processing>>

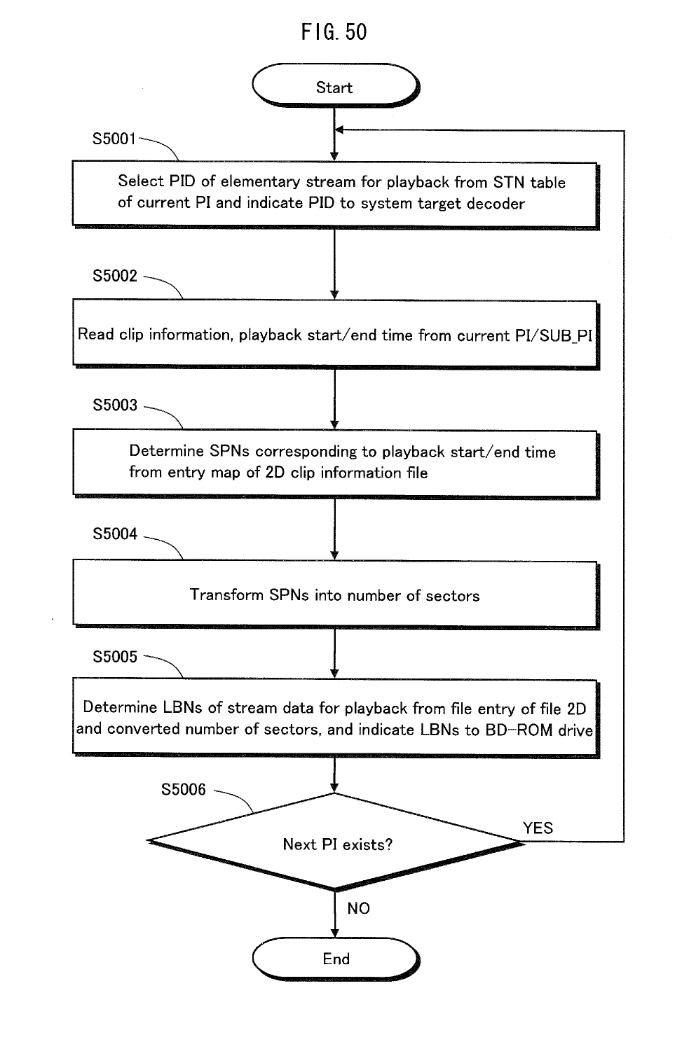

FIG. 50 is a flowchart of 2D playlist playback processing by a playback control unit 4735. 2D playlist playback processing is performed according to a 2D playlist file and is started by the playback control unit 4735 reading a 2D playlist file from the static scenario memory 4732.

In step S5001, the playback control unit 4735 first reads a single PI from a main path in the 2D playlist file and then sets the PI as the current PI. Next, from the STN table of the current PI, the playback control unit 4735 selects PIDs of elementary streams to be played back and specifies attribute information necessary for decoding the elementary streams. The selected PIDs and attribute information are indicated to the system target decoder 4723. The playback control unit 4735 further specifies a SUB_PI associated with the current PI from the sub-paths in the 2D playlist file. Thereafter, processing proceeds to step S5002.

In step S5002, the playback control unit 4735 reads reference clip information, a PTS #1 indicating a playback start time IN1, and a PTS #2 indicating a playback end time OUT1 from the current PI. From this reference clip information, a 2D clip information file corresponding to the file 2D to be played back is specified.

Furthermore, when a SUB_PI exists that is associated with the current PI, similar information is also read from the SUB_PI. Thereafter, processing proceeds to step S5003.

In step S5003, the playback control unit 4735 refers to the entry map in the 2D clip information file to retrieve from the file 2D the SPN #1 and SPN #2 that correspond to the PTS #1 and PTS #2. The pair of PTSs indicated by the SUB_PI are also converted to a pair of SPNs. Thereafter, processing proceeds to step S5004.

In step S5004, from the SPN #1 and the SPN #2, the playback control unit 4735 calculates a number of sectors corresponding to each of the SPN #1 and the SPN #2. Specifically, the playback control unit 4735 first obtains the product of each of the SPN #1 and the SPN #2 multiplied by the data amount per source packet, i.e. 192 bytes. Next, the playback control unit 4735 obtains a quotient by dividing each product by the data amount per sector, i.e. 2048 bytes: N1=SPN #1×192/2048, N2=SPN #2×192/2048. The quotients N1 and N2 are the same as the total number of sectors, in the main TS, recorded in portions previous to the source packets to which SPN #1 and SPN #2 are allocated, respectively. The pair of SPNs converted from the pair of PTSs indicated by the SUB_PI is similarly converted to a pair of numbers of sectors. Thereafter, processing proceeds to step S5005.

In step S5005, the playback control unit 4735 specifies, from the numbers of sectors N1 and N2 obtained in step S5004, LBNs of the top and end of the 2D extent group to be played back. Specifically, with reference to the file entry of the file 2D to be played back, the playback control unit 4735 counts from the top of the sector group in which the 2D extent group is recorded so that the LBN of the (N1+1)^{th} sector=LBN #1, and the LBN of the (N2+1)^{th} sector=LBN #2. The playback control unit 4735 further specifies a range from the LBN #1 to the LBN #2 to the BD-ROM drive 4701. The pair of numbers of sectors converted from the pair of PTSs indicated by the SUB_PI is similarly converted to a pair of LBNs and specified to the BD-ROM drive 4701. As a result, from the sector group in the specified range, a source packet group belonging to a 2D extent group is read in aligned units. Thereafter, processing proceeds to step S5006.

In step S5006, the playback control unit 4735 checks whether an unprocessed PI remains in the main path. When an unprocessed data remains, processing is repeated from step S5001. When no unprocessed data remains, processing ends.

<System Target Decoder>

FIG. 51 is a functional block diagram of a system target decoder 4723. As shown in FIG. 51, the system target decoder 4723 includes a source depacketizer 5110, ATC counter 5120, first 27 MHz clock 5130, PID filter 5140, STC counter (STC1) 5150, second 27 MHz clock 5160, primary video decoder 5170, secondary video decoder 5171, PG decoder 5172, IG decoder 5173, primary audio decoder 5174, secondary audio decoder 5175, image processor 5180, primary video plane memory 5190, secondary video plane memory 5191, PG plane memory 5192, IG plane memory 5193, image plane memory 5194, and audio mixer 5195.

The source depacketizer 5110 reads source packets from the read buffer 4721, extracts the TS packets from the read source packets, and transfers the TS packets to the PID filter 5140. Furthermore, the source depacketizer 5110 synchronizes the time of the transfer with the time shown by the ATS of each source packet. Specifically, the source depacketizer 5110 first monitors the value of the ATC generated by the ATC counter 5120. In this case, the value of the ATC depends on the ATC counter 5120 and is incremented in accordance with a pulse of a clock signal from the first 27 MHz clock 5130. Subsequently, at the instant the value of the ATC matches the ATS of a source packet, the source depacketizer 5110 transfers the TS packets extracted from the source packet to the PID filter 5140. By adjusting the time of transfer in this way, the mean transfer rate of TS packets from the source depacketizer 5110 to the PID filter 5140 does not surpass the value RTS specified by the system rate 3211 in the 2D clip information file 1031 shown in FIG. 32.

The PID filter 5140 first monitors a PID that includes each TS packet outputted by the source depacketizer 5110. When the PID matches a PID specified in advance by the playback control unit 4735, the PID filter 5140 selects the TS packet and transfers it to the decoder 5170-5175 appropriate for decoding of the elementary stream indicated by the PID. For example, if a PID is 0x1011, the TS packets are transferred to the primary video decoder 5170. TS packets with PIDs ranging from 0x1B00-0x1B1F, 0x1100-0x111F, 0x1A00-0x1A1F, 0x1200-0x121F, and 0x1400-0x141F are transferred to the secondary video decoder 5171, primary audio decoder 5174, secondary audio decoder 5175, PG decoder 5172, and IG decoder 5173, respectively.

The PID filter 5140 further detects a PCR from TS packets using the PIDs of the TS packets. At each detection, the PID filter 5140 sets the value of the STC counter 5150 to a predetermined value. Then, the value of the STC counter 5150 is incremented in accordance with a pulse of the clock signal of the second 27 MHz clock 5160. In addition, the value to which the STC counter 5150 is set is indicated to the PID filter 5140 from the playback control unit 4735 in advance. The decoders 5170-5175 each use the value of the STC counter 5150 as the STC. Specifically, the decoders 5170-5175 first reconstruct the TS packets received from the PID filter 5140 into PES packets. Next, the decoders 5170-5175 adjust the timing of the decoding of data included in the PES payloads in accordance with the times indicated by the PTSs or the DTSs included in the PES headers.

As shown in FIG. 51, the primary video decoder 5170 includes a transport stream buffer (TB) 5101, multiplexing buffer (MB) 5102, elementary stream buffer (EB) 5103, compressed video decoder (DEC) 5104, and decoded picture buffer (DPB) 5105.

The TB 5101, MB 5102, and EB 5103 are each a buffer memory and use an area of a memory element internally provided in the primary video decoder 5170. Alternatively, some or all of the buffer memories may be separated in discrete memory elements. The TB 5101 stores the TS packets received from the PID filter 5140 as they are. The MB 5102 stores PES packets reconstructed from the TS packets stored in the TB 5101. Note that when the TS packets are transferred from the TB 5101 to the MB 5102, the TS header is removed from each TS packet. The EB 5103 extracts encoded VAUs from the PES packets and stores the VAUs therein. A VAU includes a compressed picture, i.e. an I picture, B picture, or P picture. Note that when data is transferred from the MB 5102 to the EB 5103, the PES header is removed from each PES packet.

The DEC 5104 is a hardware decoder specifically for decoding of compressed pictures and is composed of an LSI that includes, in particular, a function to accelerate the decoding. The DEC 5104 decodes a picture from each VAU in the EB 5103 at the time shown by the DTS included in the original PES packet. During decoding, the DEC 5104 first analyzes the VAU header to specify the compression encoding method used to compress the pictures stored therein and the stream attribute, selecting a decoding method in accordance with this information. Examples of the compression encoding methods include MPEG-2, MPEG-4 AVC, and VC1. Furthermore, the DEC 5104 transmits the decoded and thus uncompressed picture to the DPB 5105.

Like the TB 5101, MB 5102, and EB 5103, the DPB 5105 is a buffer memory that uses an area of a built-in memory element in the primary video decoder 5170. Alternatively, the DPB 5105 may be located in a memory element separate from the other buffer memories 5101, 5102, and 5103. The DPB 5105 temporarily stores the decoded pictures. When a P picture or B picture is to be decoded by the DEC 5104, the DPB 5105 retrieves reference pictures, in response to an instruction from the DEC 5104, from among stored decoded pictures. The DPB 5105 then provides the reference pictures to the DEC 5104. Furthermore, the DPB 5105 writes the stored pictures into the primary video plane memory 5190 at the time shown by the PTSs included in the original PES packets.

The secondary video decoder 5171 includes the same structure as the primary video decoder 5170. The secondary video decoder 5171 first decodes the TS packets of the secondary video stream received from the PID filter 5140 into uncompressed pictures. Subsequently, the secondary video decoder 5171 writes the uncompressed pictures into the secondary video plane memory 5191 at the time shown by the PTSs included in the PES packets.

The PG decoder 5172 decodes the TS packets received from the PID filter 5140 into uncompressed graphics objects and writes the uncompressed graphics objects to the PG plane memory 5192 at the time shown by the PTSs included in the PES packets. Details of the write processing are provided below.

The IG decoder 5173 decodes the TS packets received from the PID filter 5140 into uncompressed graphics object. The IG decoder 5173 further writes the uncompressed graphics object to the IG plane memory 5193 at the time shown by the PTSs included in the PES packets restored from the TS packets. Details on these processes are the same as in the PG decoder 5172.

The primary audio decoder 5174 first stores the TS packets received from the PID filter 5140 in a buffer provided therein. Subsequently, the primary audio decoder 5174 removes the TS header and the PES header from each TS packet in the buffer, and decodes the remaining data into uncompressed LPCM audio data. Furthermore, the primary audio decoder 5174 transmits the resultant audio data to the audio mixer 5195 at the time shown by the PTS included in the original PES packet. The primary audio decoder 5174 selects the decoding method for compressed audio data in accordance with the compression encoding method and stream attributes for the primary audio stream included in the TS packets. Compression encoding methods include, for example, AC-3 and DTS.

The secondary audio decoder 5175 has the same structure as the primary audio decoder 5174. The secondary audio decoder 5175 first reconstructs PES packets from the TS packets of the secondary audio stream received from the PID filter 5140 and then decodes the data included in the PES payloads into uncompressed LPCM audio data. Subsequently, the secondary audio decoder 5175 transmits the uncompressed LPCM audio data to the audio mixer 5195 at the times shown by the PTSs included in the PES headers. The secondary audio decoder 5175 selects the decoding method for compressed audio data in accordance with the compression encoding method and stream attributes for the secondary audio stream included in the TS packets. Examples of the compression encoding methods include Dolby Digital Plus and DTS-HD LBR.

The audio mixer 5195 receives uncompressed audio data from both the primary audio decoder 5174 and the secondary audio decoder 5175 and then mixes the received data. The audio mixer 5195 also transmits the synthesized sound yielded by mixing audio data to, for example, the internal speaker 103A of the display device 103.

The image processor 5180 receives graphics data, i.e. PNG or JPEG raster data, from the program execution unit 4734. Upon receiving the graphics data, the image processor 5180 renders the graphics data and writes the graphics data to the image plane memory 5194.

### <<Decoding Processing by PG Decoder>>

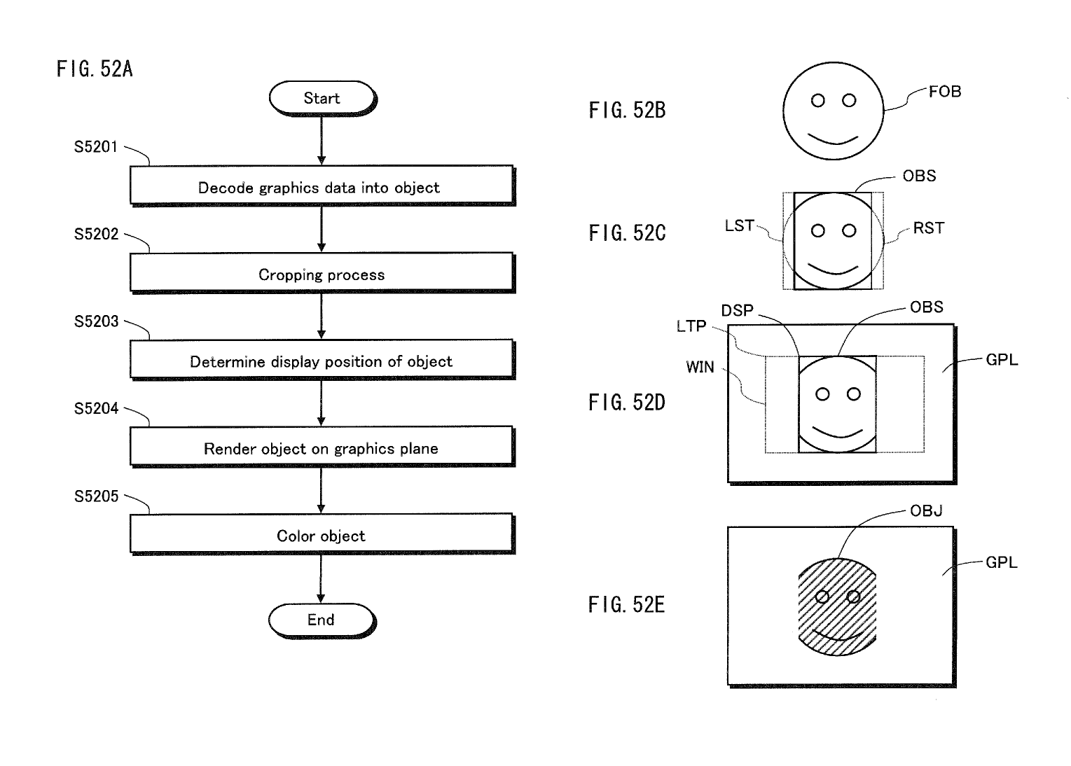

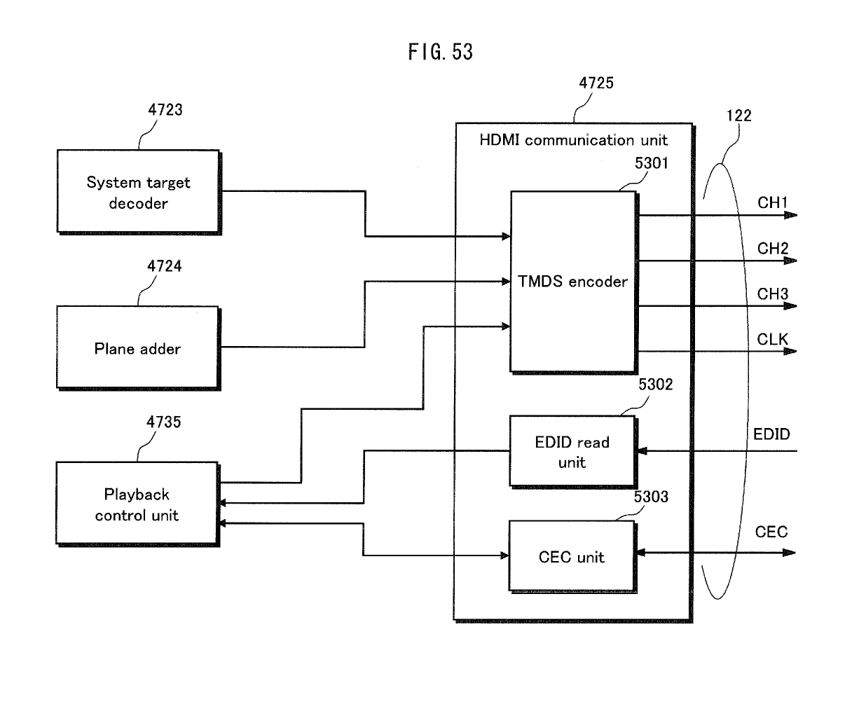

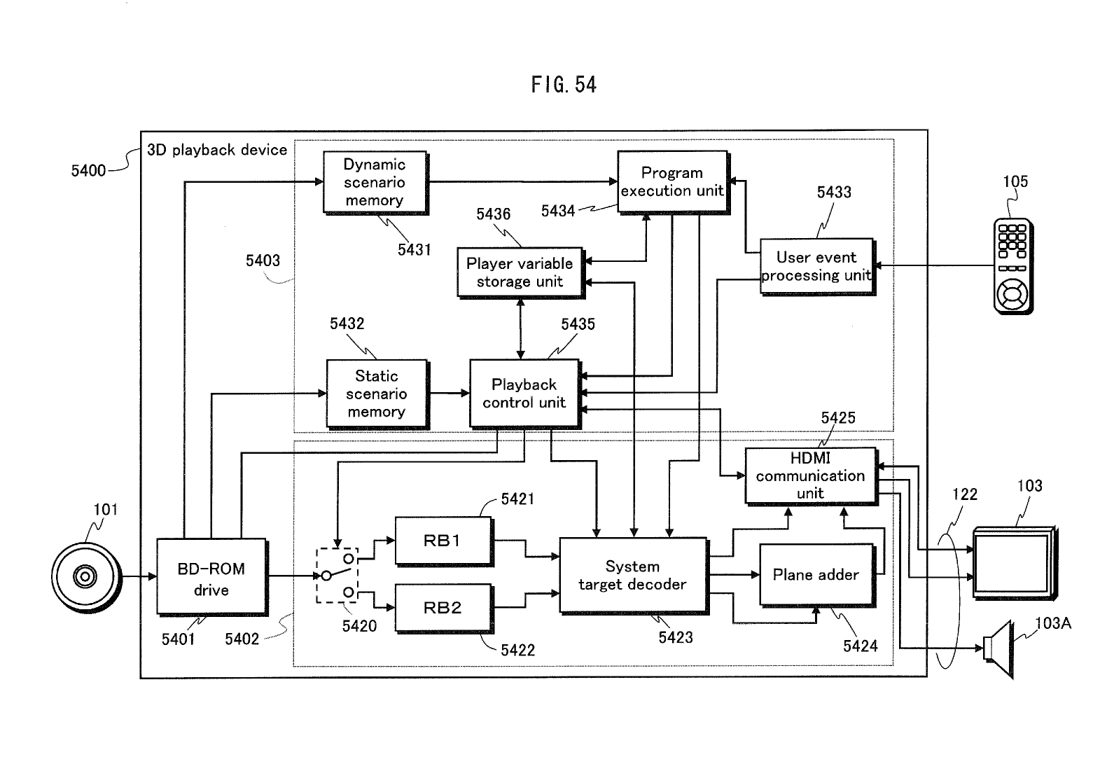

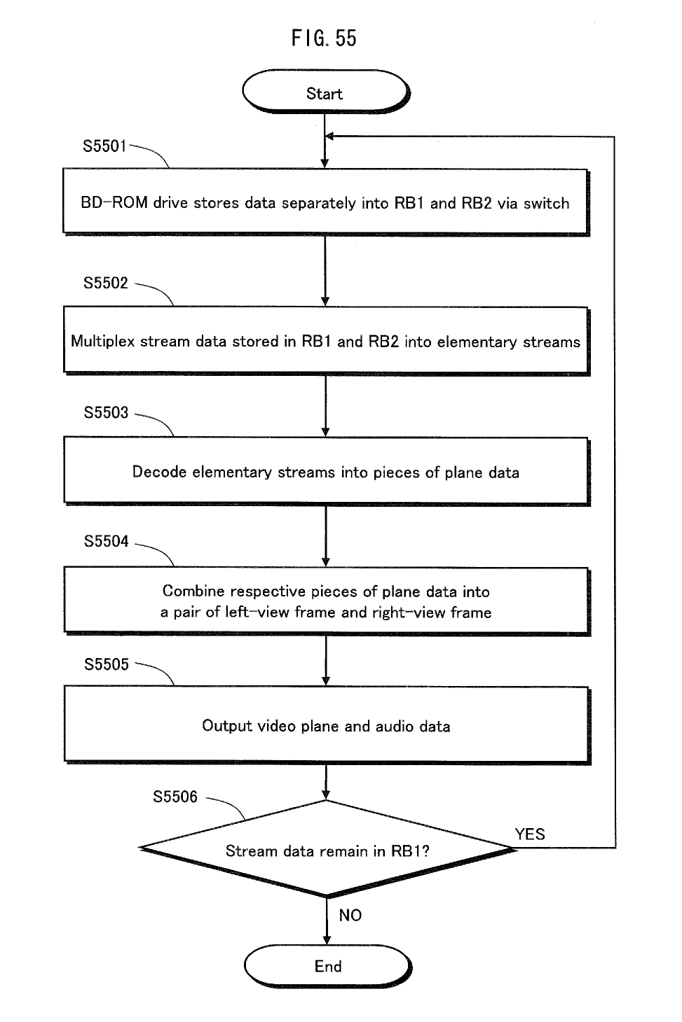

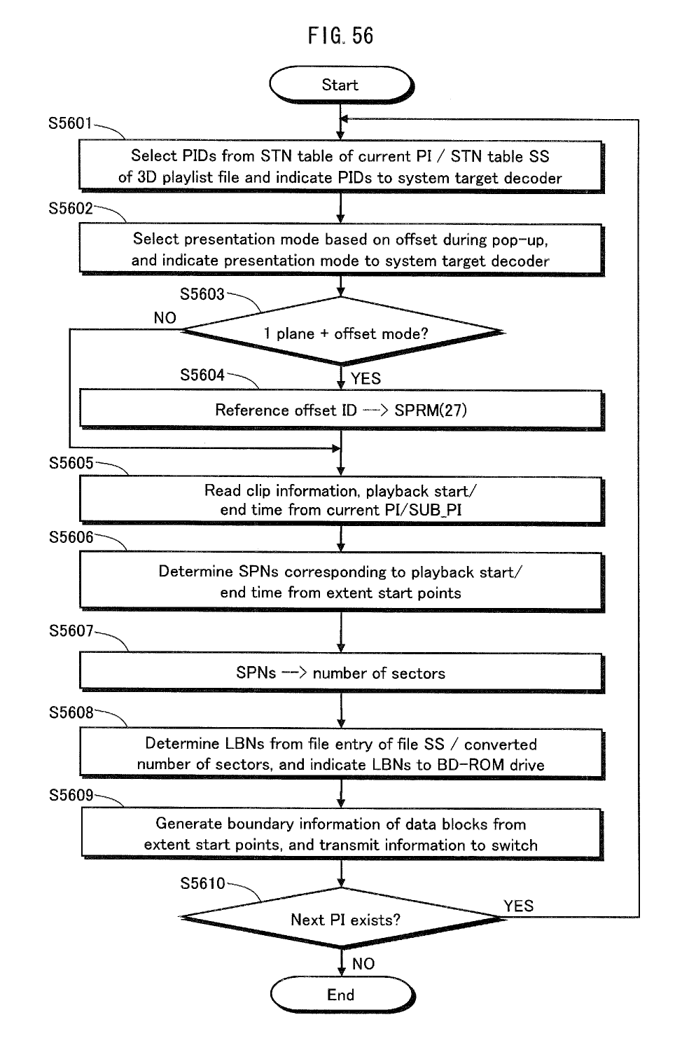

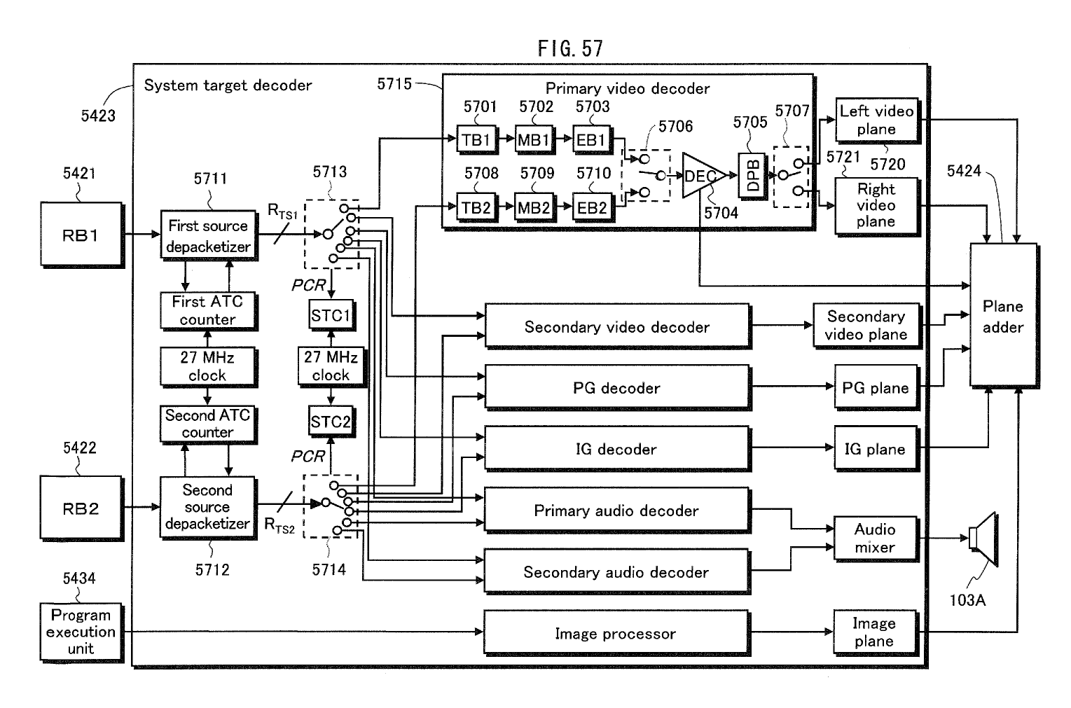

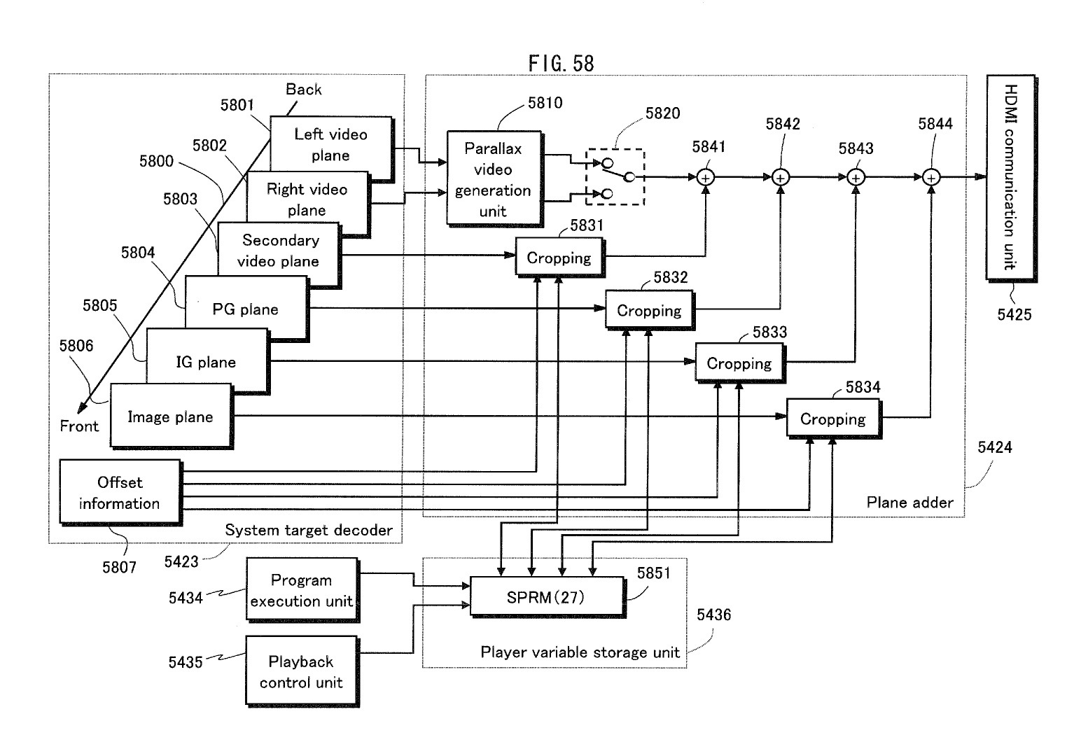

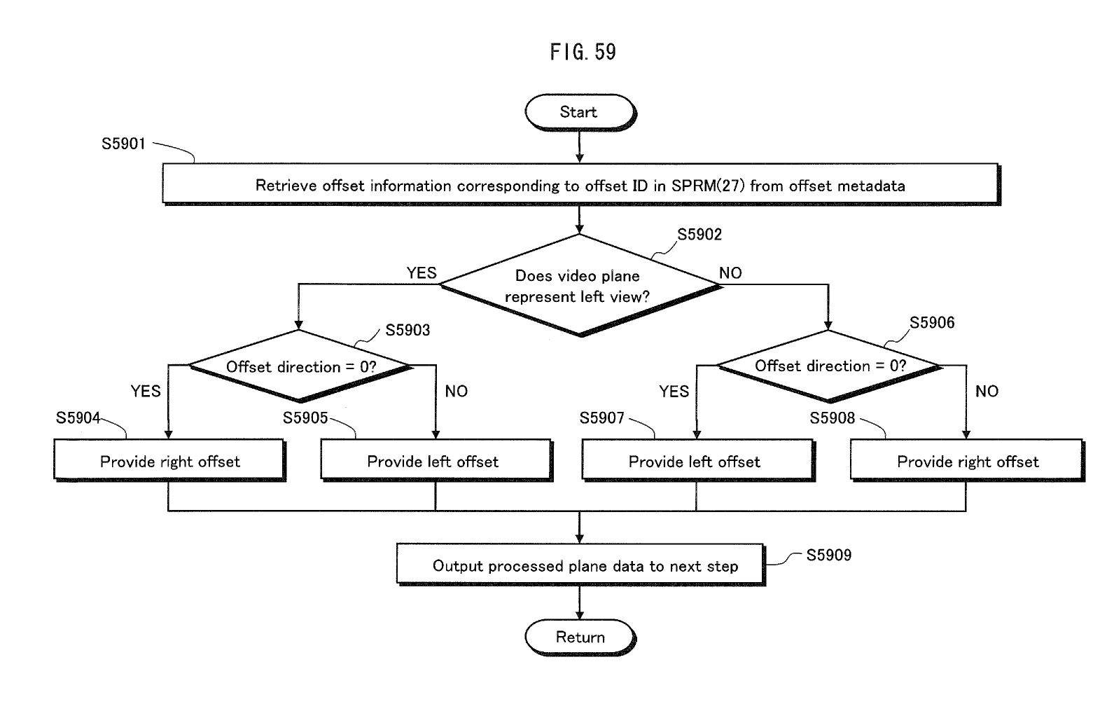

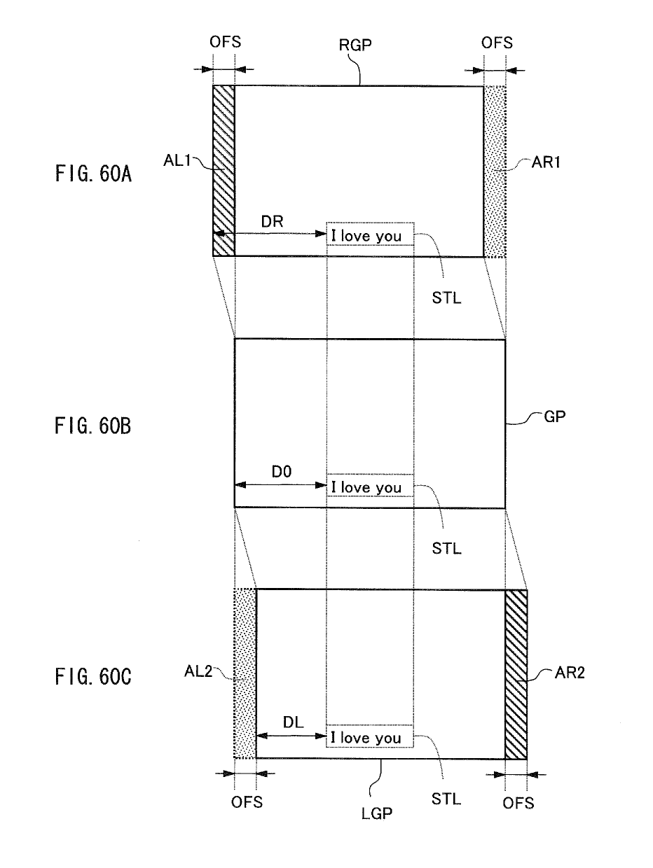

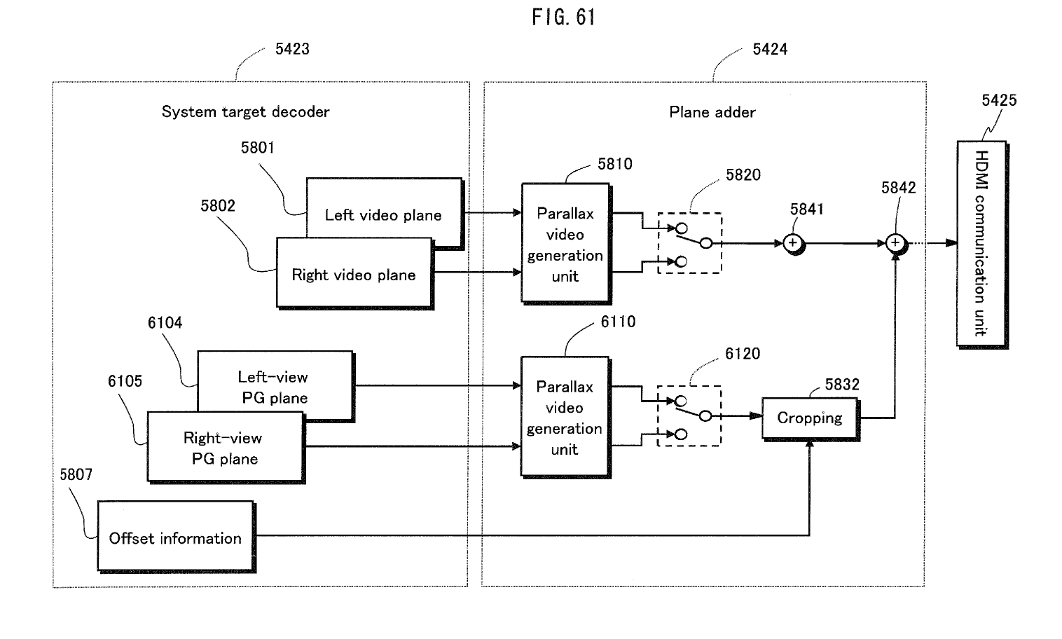

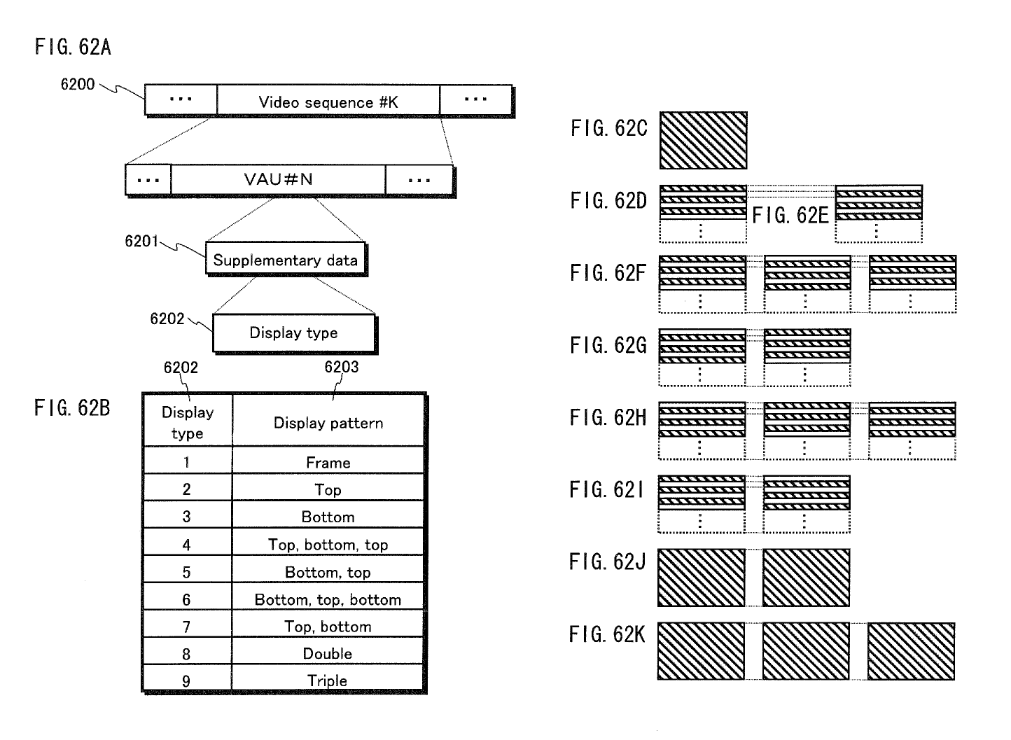

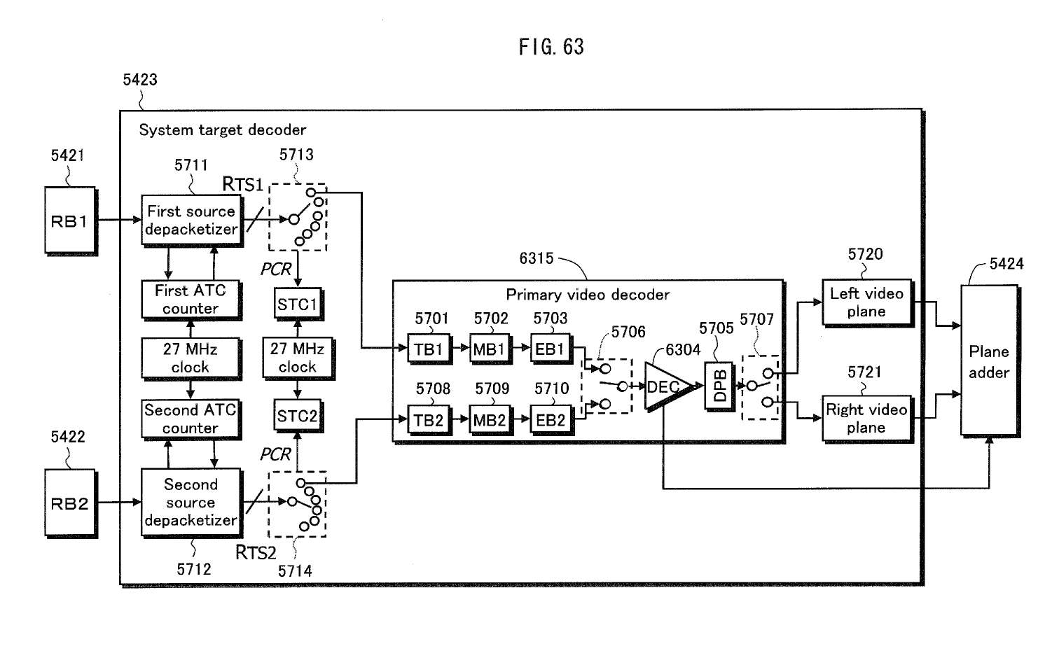

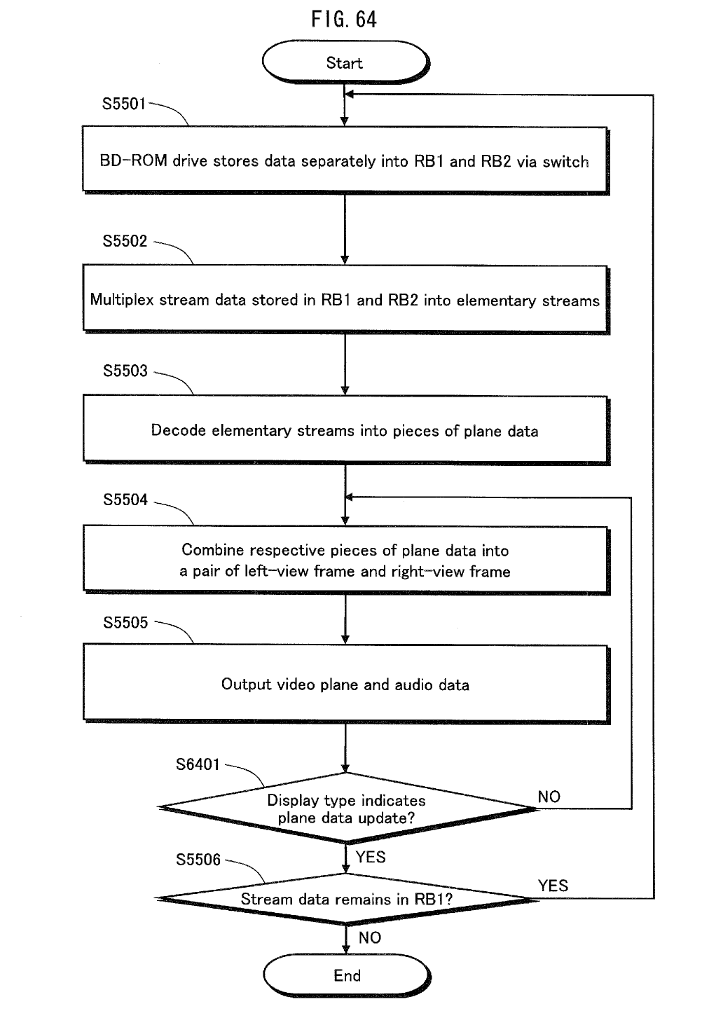

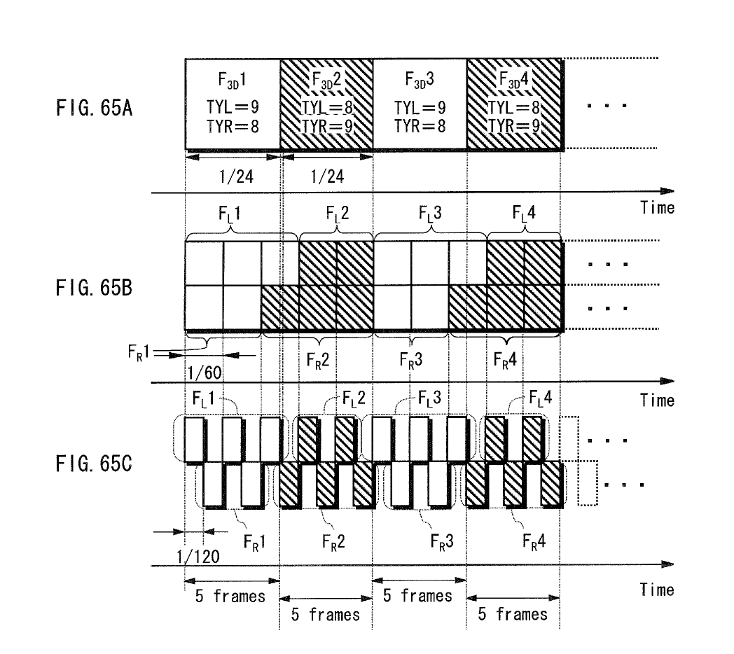

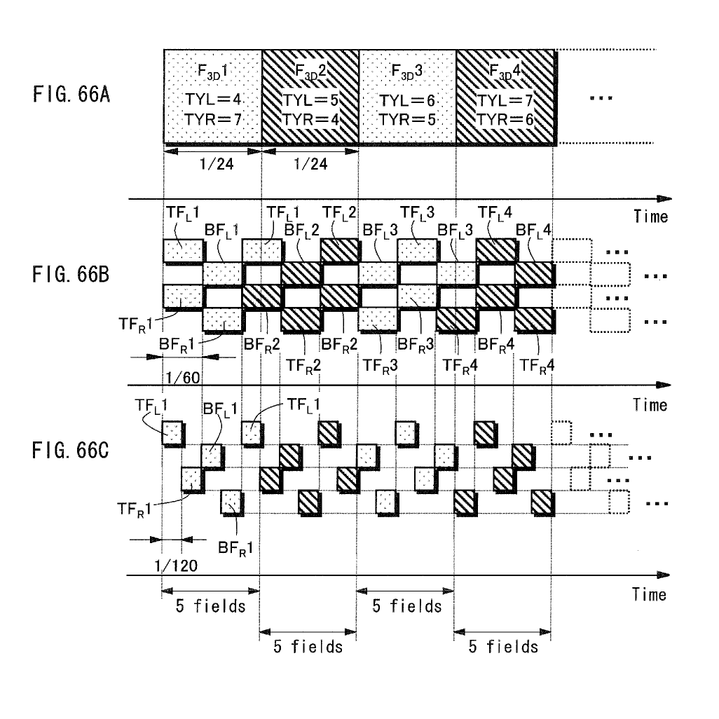

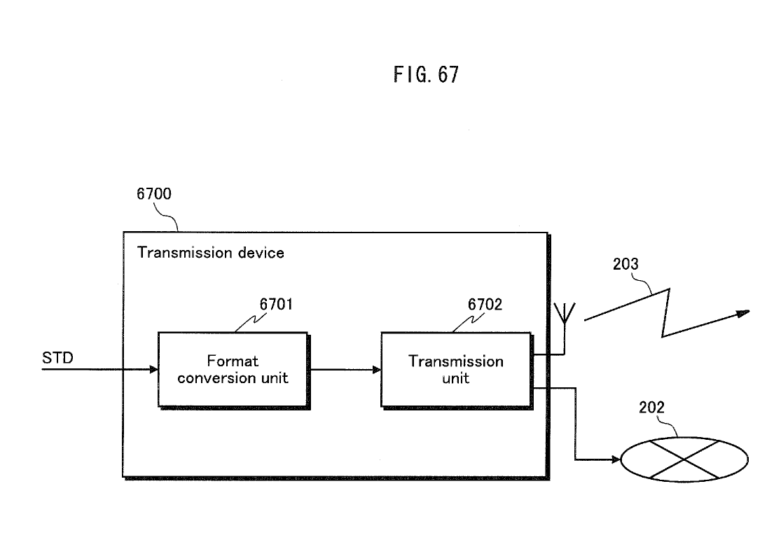

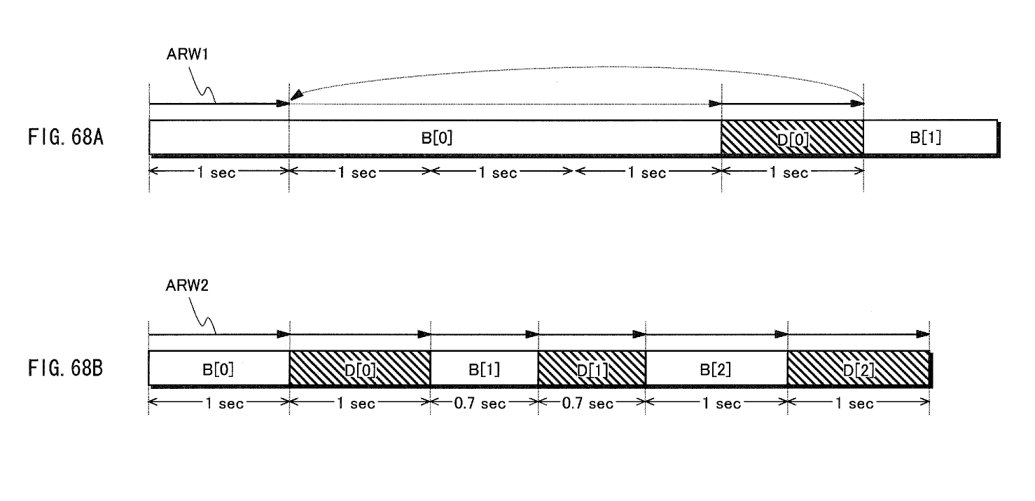

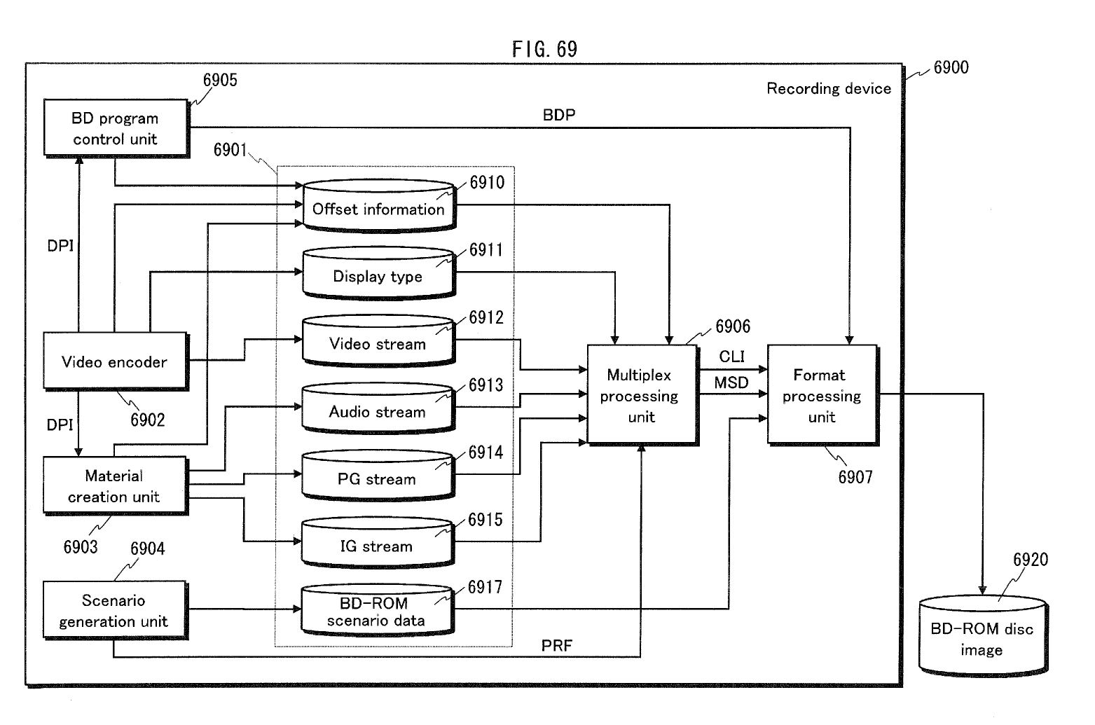

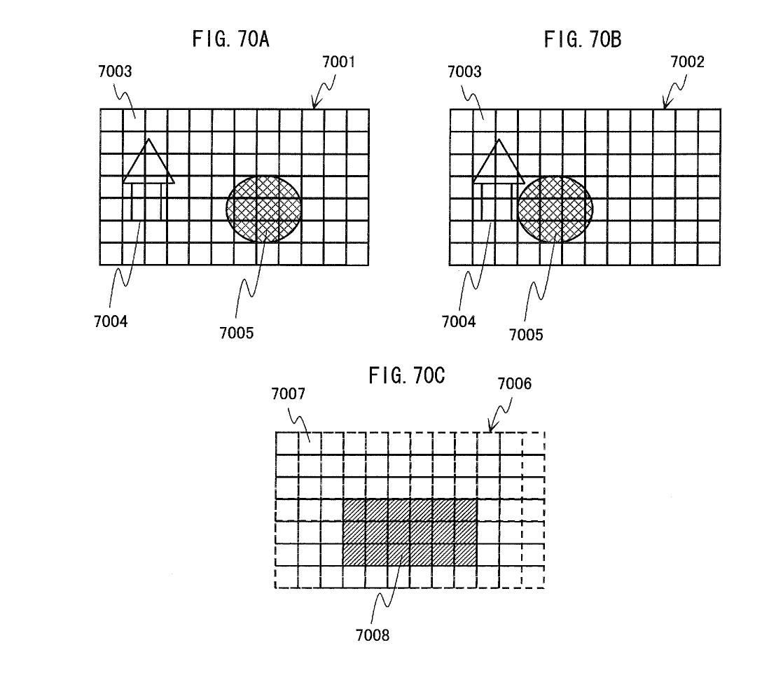

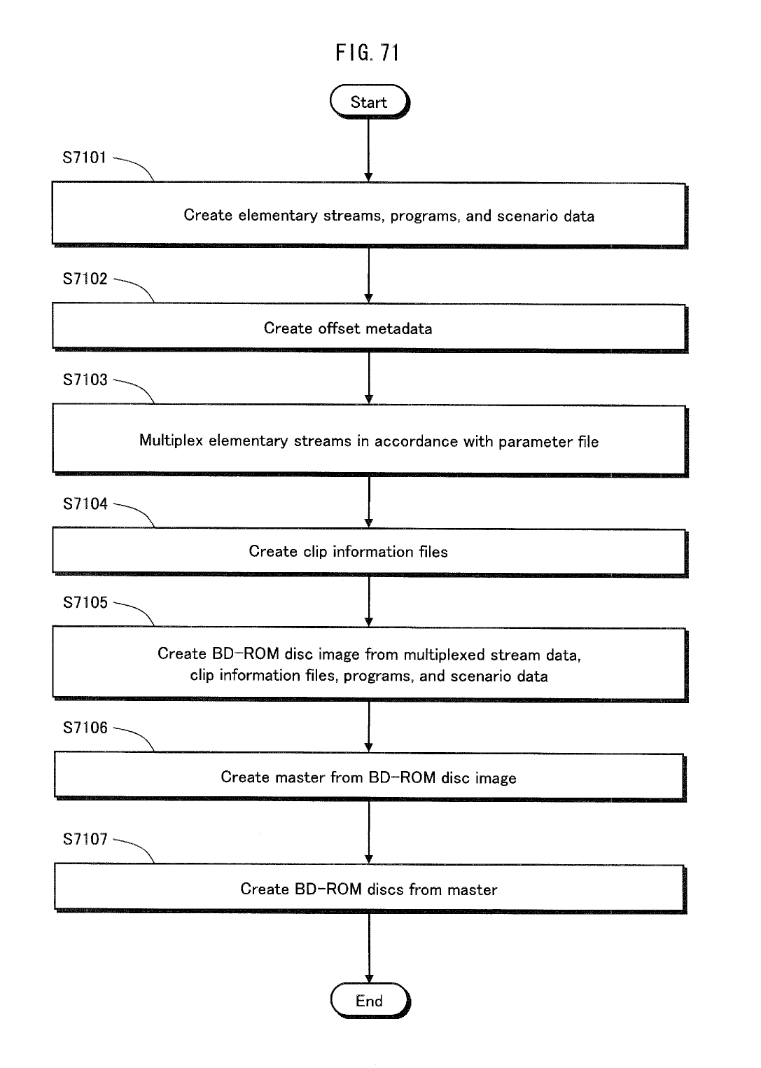

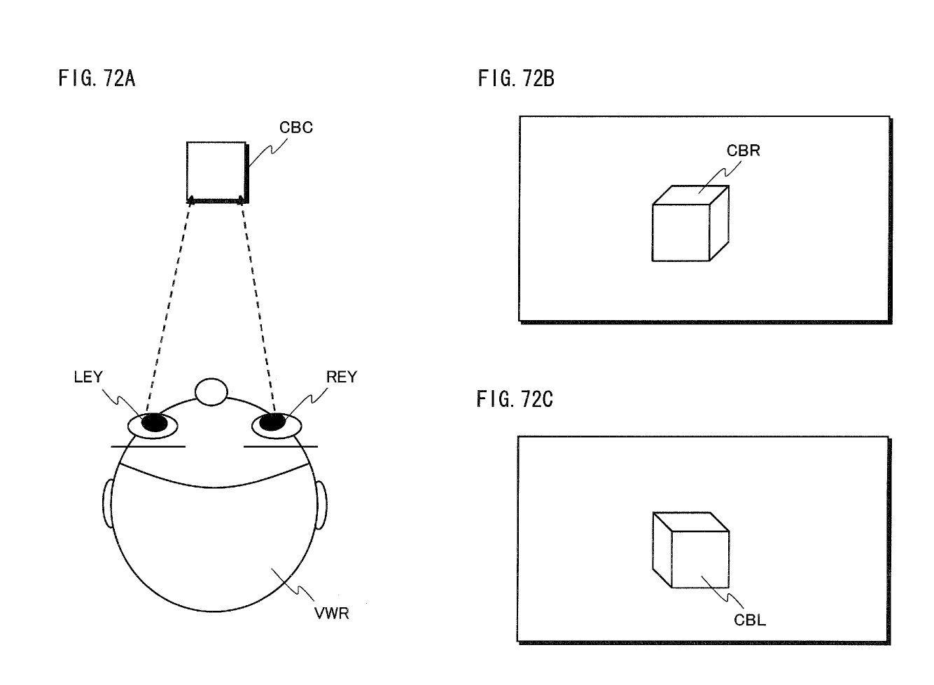

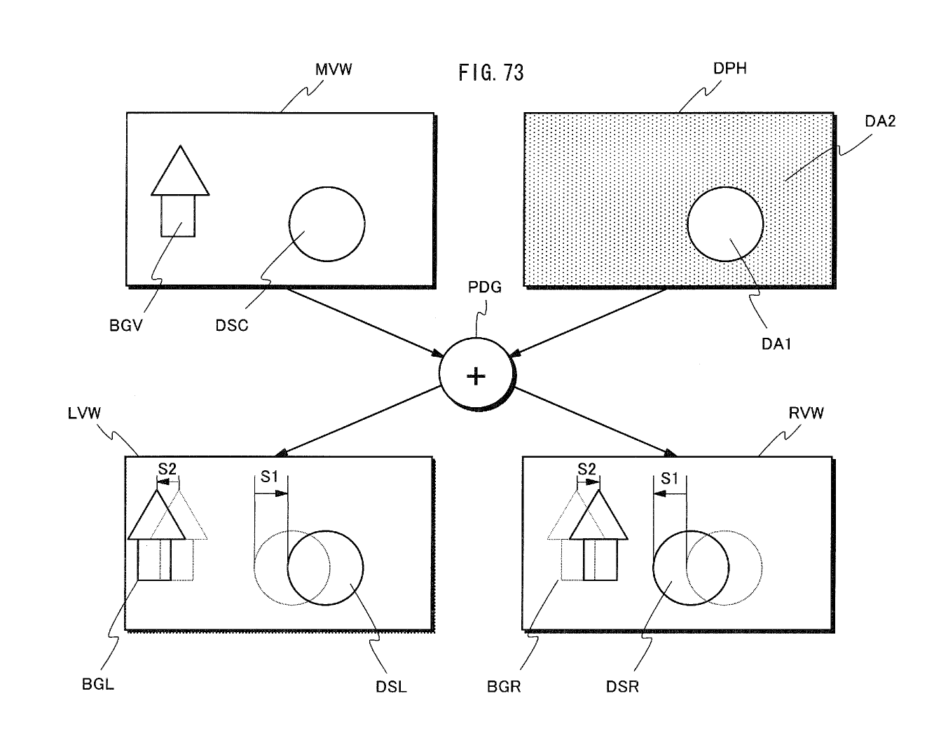

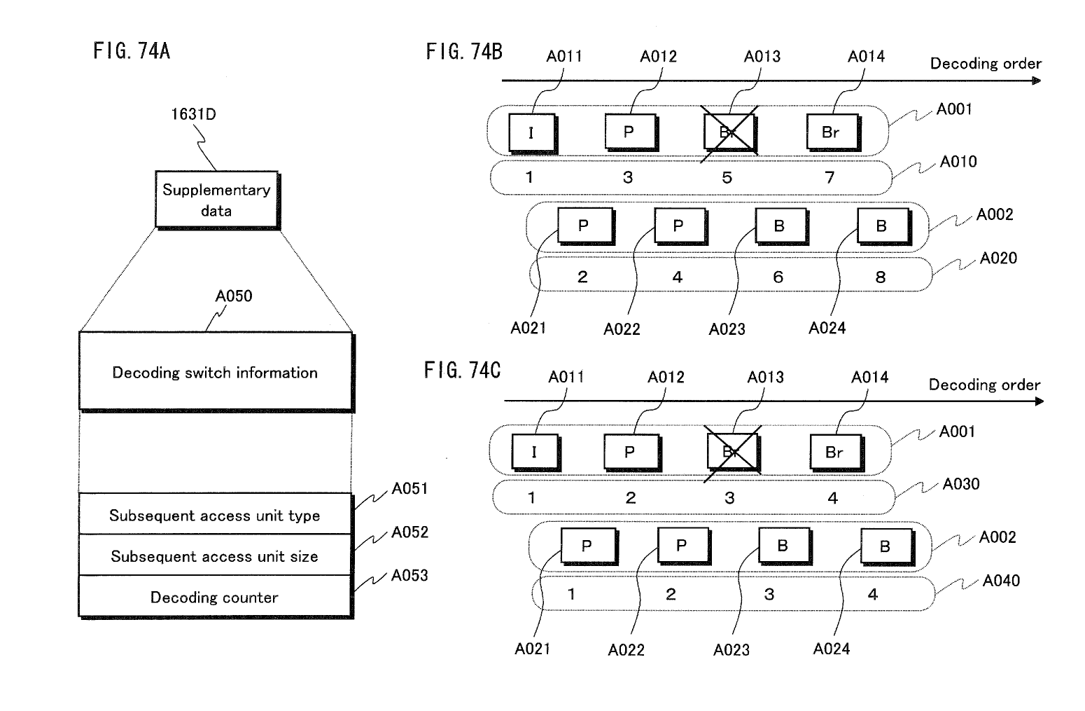

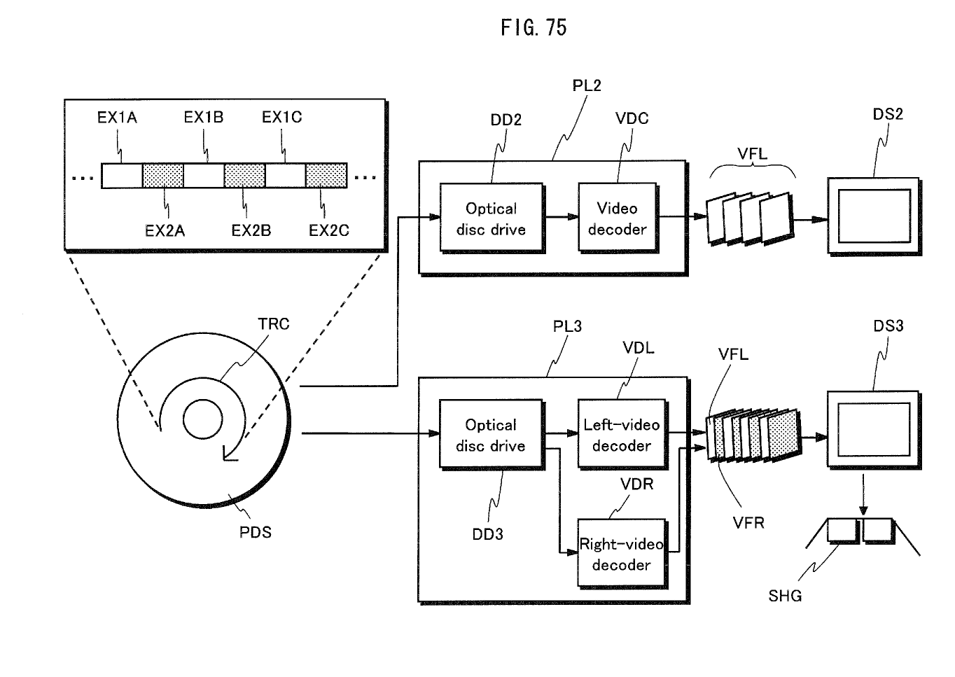

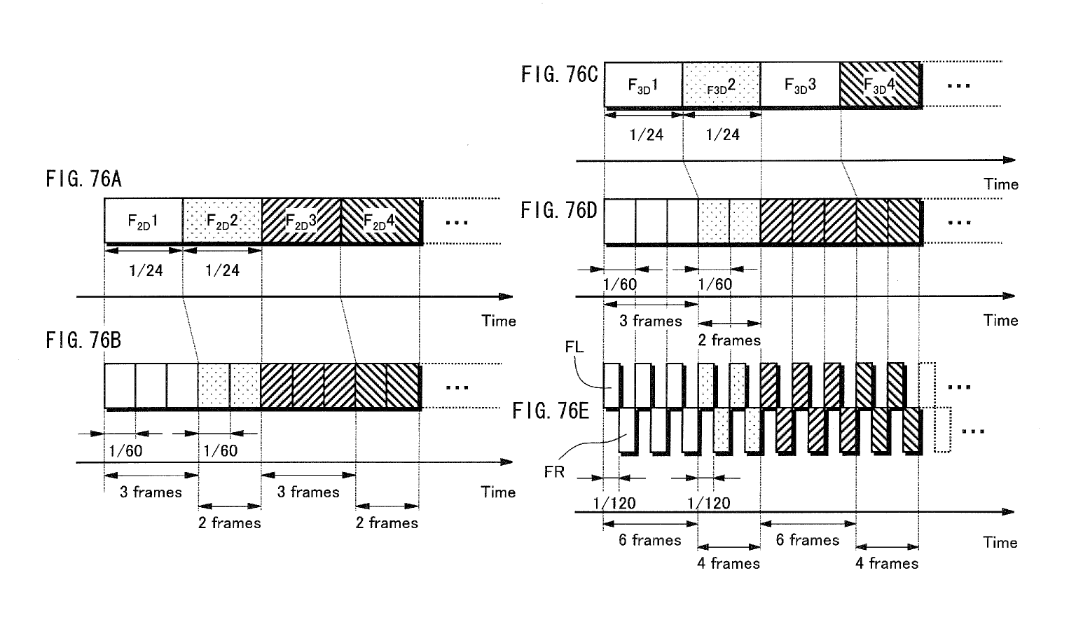

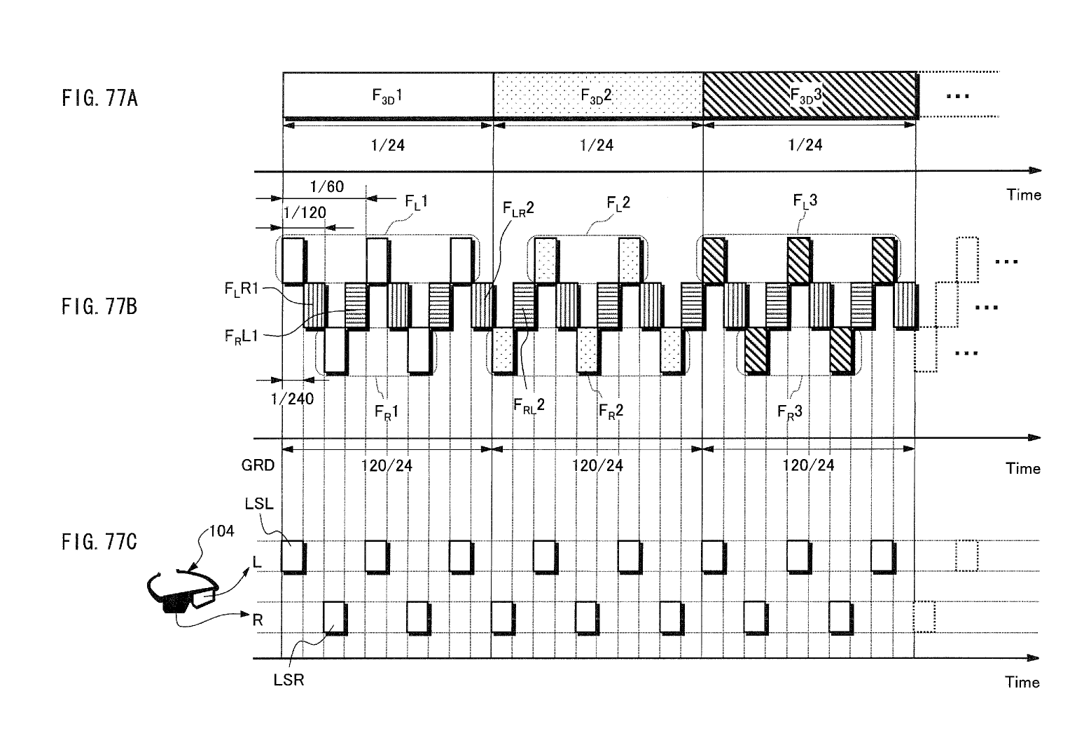

FIG. 52A is a flowchart of processing whereby the PG decoder 5172 decodes a graphics object from one data entry in the PG stream. The processing is started when the PG decoder 5172 receives from the PID filter 5140 a group of TS packets constituting one data entry shown in FIG. 14. FIGS. 52B-52E are schematic diagrams showing the graphics object changing as the processing shown in FIG. 52A proceeds.

In step S5201, the PG decoder 5172 first identifies an ODS having the same object ID as the reference object ID 1405 in the PCS. Next, the PG decoder 5172 decodes a graphics object from the identified ODS, and writes the decoded graphics object into the object buffer. Here, the “object buffer” is a buffer memory embedded in the PG decoder 5172. The “smile mark” FOB shown in FIG. 52B is an example of the graphics object written into the object buffer.

In step S5202, the PG decoder 5172 performs the cropping process in accordance with the cropping information 1402 in the PCS, extracts a part of the graphics object from the graphics object, and writes the extracted part into the object buffer. FIG. 52C shows that strips LST and RST are removed from the left-hand and right-hand ends of the smile mark FOB, and the remaining part OBJ is written into the object buffer.

In step S5203, the PG decoder 5172 first identifies a WDS having the same window ID as the reference window ID 1403 in the PCS. Next, the PG decoder 5172 determines a display position of the graphics object in the graphics plane from a window position 1412 indicated by the identified WDS and an object display position 1401 in the PCS. In FIG. 52D, the top left position of the window WIN in the graphics plane GPL and the top left position DSP of the graphics object OBJ are determined.

In step S5204, the PG decoder 5172 writes the graphics object held in the object buffer into the display position determined in step S5203. When doing so, the PG decoder 5172 determines a range in which the graphics object is rendered by using a window size 1413 indicated by the WDS. In FIG. 52D, the graphics object OBJ is written into the graphics plane GPL in the range of window WIN starting from the top left position DSP.

In step S5205, the PG decoder 5172 first identifies a PDS having the same pallet ID as the reference object ID 1404 in the PCS. Next, the PG decoder 5172, by using CLUT 1422 in the PDS, determines color coordinate values to be indicated by each piece of pixel data in the graphics object OBJ. In FIG. 52E, the color of each pixel in the graphics object OBJ have been determined. In this way, processing of rendering a graphics object included in one data entry is completed. Steps S5201-S5205 are executed by the time indicated by the PTS included in the same PES packet as the graphics object.

<HDMI Communication Unit>

FIG. 53 is a functional block diagram showing a structure of the HDMI communication unit 4725. The HDMI communication unit 4725 is connected to the display device 103, in particular to the HDMI communication unit 211 shown in FIG. 3, with the HDMI cable 122. With the above connection, the HDMI communication unit 4725 relays stream data outputted from the system target decoder 4723 and the plane adder 4724 to the display device 103. Furthermore, the HDMI communication unit 4725 relays data to be exchanged between the playback control unit 4735 and display device 103. As shown in FIG. 53, the HDMI communication unit 4725 includes a TMDS encoder 5301, EDID read unit 5302, and CEC unit 5303.

The TMDS encoder 5301 transmits serial signals carrying video data, audio data, auxiliary data, and control signal to the display device 103 through the TMDS channels CH1, CH2, CH3 and CLK in the HDMI cable 122. In particular, the TMDS encoder 5301 converts 8-bit pixel data pieces specifying the respective colors of R, G and B, 4-bit audio data, 4-bit auxiliary data (info-frame), and a 2-bit control signal (containing horizontal sync signal and vertical sync signal) all into 10-bit data sequences and outputs the resulting 10-bit data sequences through the respective data channels CH1-CH3. In particular, the TMDS encoder 5301 generates the serial signals in the format shown in FIG. 5A. Furthermore, the TMDS encoder 5301 outputs the respective video planes at the intervals of 1/24 seconds.

The EDID read unit 5302 is connected to the EDID storage unit 302 shown in FIG. 3, via the display data channel DDC available within the HDMI cable 122. The EDID read unit 5302 reads EDID representing the functions, characteristics and states of the display device 103 from the EDID storage unit 302. In addition, the EDID read unit 5302 performs HDCP authentication with the signal processing unit 220 shown in FIG. 3 through the display data channel DDC.

The CEC unit 5303 exchanges CEC messages with the CEC unit 303 shown in FIG. 3, via the CEC line CEC available within the HDMI cable 122. In particular, the CEC unit 5303 converts information that the playback device 102 receives from the remote control 105 into a CEC message and issues the CEC message to the signal processing unit 220. Reversely, the CEC unit 5303 is notified by the signal processing unit 220 of a CEC message indicating information that the display device 103 receives from the remote control 105.

<Structure of 3D Playback Device>

When playing back 3D video image content from the BD-ROM disc 101, the playback device 102 in 3D playback mode operates as a 3D playback device. The fundamental part of the device's structure is identical to the 2D playback device shown in FIGS. 47, 51, and 53. Therefore, the following is a description of sections of the structure of the 3D playback device that are extended or modified. Details on the fundamental parts of the 3D playback device can be found in the above description of the 2D playback device. The 3D playback device also uses the same structure as the 2D playback device for 2D playlist playback processing. Accordingly, the details on this structure can be found in the description of the 2D playback device. The following description assumes playback processing of 3D video images in accordance with 3D playlist files, i.e. 3D playlist playback processing.

FIG. 54 is a functional block diagram of a 3D playback device 5400. The 3D playback device 5400 includes a BD-ROM drive 5401, playback unit 5402, and control unit 5403. The playback unit 5402 includes a switch 5420, first read buffer (RB1) 5421, a second read buffer (RB2) 5422, system target decoder 5423, plane adder 5424, and HDMI communication unit 5425. The control unit 5403 includes a dynamic scenario memory 5431, static scenario memory 5432, user event processing unit 5433, program execution unit 5434, playback control unit 5435, and player variable storage unit 5436. The playback unit 5402 and the control unit 5403 are each implemented on a different integrated circuit. Alternatively, however, both the units may be integrated into a single integrated circuit. In particular, the dynamic scenario memory 5431, static scenario memory 5432, user event processing unit 5433, and program execution unit 5434 have an identical structure with the 2D playback device shown in FIG. 47. Accordingly, details thereof can be found in the above description of the 2D playback device.

When instructed by the program execution unit 5434 or other unit to perform 3D playlist playback processing, the playback control unit 5435 reads a PI from the 3D playlist file stored in the static scenario memory 5432 in order, setting the read PI as the current PI. Each time the playback control unit 5435 sets a current PI, it sets operation conditions on the system target decoder 5423 and the plane adder 5424 in accordance with the STN table of the PI and the STN table SS in the 3D playlist file. Specifically, the playback control unit 5435 selects the PID of the elementary stream for decoding and transmits the PID, together with the attribute information necessary for decoding the elementary stream, to the system target decoder 5423. If a PG stream or IG stream is included in the elementary stream indicated by the selected PID, the playback control unit 5435 specifies the reference offset ID 4201 allocated to the stream data, setting the reference offset ID 4201 to the SPRM(27) in the player variable storage unit 5436. The playback control unit 5435 also selects the presentation mode of each piece of plane data in accordance with the offset during pop-up 4311 indicated by the STN table SS, indicating the selected presentation mode to the system target decoder 5423 and plane adder 5424.

Next, in accordance with the current PI, the playback control unit 5435 indicates the range of the LBNs in the sector group recorded in the extent SS to be read to the BD-ROM drive 5401 via the procedures in the description of FIG. 34E. Meanwhile, the playback control unit 5435 refers to the extent start points in the clip information file stored in the static scenario memory 5432 to generate information indicating the boundary of the data blocks in each extent SS. Hereinafter, the information is referred to as “data block boundary information”. The data block boundary information indicates, for example, the number of source packets from the top of the extent SS to each boundary. The playback control unit 5435 then transmits this information to the switch 5420.

The player variable storage unit 5436 includes the SPRMs, like the player variable storage unit 4736 in the 2D playback device. However, unlike FIG. 48, SPRM(24) includes the first flag, and SPRM(25) includes the second flag, as shown in FIG. 46. In this case, when the SPRM(24) is “0”, the playback device 102 only supports playback of 2D video images, and when the SPRM(24) is “1”, the playback device 102 also supports playback of 3D video images. When the SPRM(25) is “0”, “1” or “2”, the playback device 102 is in L/R mode, depth mode, or 2D playback mode, respectively. The SPRM(27) includes a storage area for a reference offset ID 4201 assigned to each plane. In particular, the SPRM(27) includes an area for storing any of four types of reference offset IDs. The reference offset IDs are one for a PG plane (PG_ref_offset_id), one for an IG plane (IG_ref_offset_id), one for a secondary video plane (SV_ref_offset_id), and one for an image plane (IM_ref_offset_id).

The BD-ROM drive 5401 includes the same structural elements as the BD-ROM drive 4701 of the 2D playback device shown in FIG. 47. Upon receiving an indication from the playback control unit 5435 of a range of LBNs, the BD-ROM drive 5401 reads data from the sectors on the BD-ROM disc 101 as indicated by the range. In particular, a source packet group belonging to an extent in the file SS, i.e. belonging to an extent SS, are transmitted from the BD-ROM drive 5401 to the switch 5420. Each extent SS includes one or more pairs of a base-view and dependent-view data block, as shown in FIG. 23. These data blocks have to be transferred to the RB1 5421 and RB2 5422 in parallel. Accordingly, the BD-ROM drive 5401 is required to have at least the same access speed as the BD-ROM drive 4701 in the 2D playback device.

The switch 5420 receives extents SS from the BD-ROM drive 5401. In addition, the switch 5420 receives, from the playback control unit 5435, data block boundary information relating to those extents SS. Furthermore, the switch 5420 extracts base-view extents and dependent-view extents from the extents SS with the use of the data block boundary information and sends the extracted base-view extents to the RB1 5421 and the extracted dependent-view extents to the RB2 5422.

The RB1 5421 and RB2 5422 are each a buffer memory that use a memory element in the playback unit 5402. In particular, different areas in a single memory element are used as the RB1 5421 and RB2 5422. Alternatively, the different memory elements may be used as the RB1 5421 and RB2 5422. The RB1 5421 and RB2 5422 receive to store base-view extents and dependent-view extents from the switch 5420 respectively.

In 3D playlist playback processing, the system target decoder 5423 first receives, from the playback control unit 5435. PIDs for stream data to be decoded as well as attribute information necessary for decoding the stream data. The system target decoder 5423 then reads source packets alternately from base-view extents stored in the RB1 5421 and dependent-view extents stored in the RB2 5422. Next, the system target decoder 5423 separates, from each source packet, elementary streams indicated by the PIDs received from the playback control unit 5435 and decodes the elementary streams. The system target decoder 5423 then writes the decoded elementary streams in internal plane memory according to the type thereof. The base-view video stream is written in the left-video plane memory, and the dependent-view video stream is written in the right-video plane memory. On the other hand, the secondary video stream is written in the secondary video plane memory, the IG stream in the IG plane memory, and the PG stream in the PG plane memory. As in the PG stream etc. shown in FIGS. 11B and 11C, a stream other than a video stream may be composed of a pair of base-view and dependent-view video stream data. In that case, a pair of plane memories is provided for the stream data, so that both the left-view and right-view plane data pieces are separately rendered on the respective planes. The system target decoder 5423 additionally renders graphics data from the program execution unit 5434, such as JPEG, PNG, etc. raster data, and writes this data in the image plane memory.

The system target decoder 5423 associates the output mode of plane data from the left-video and right-video plane memories with B-D presentation mode and B-B presentation mode as follows. When the playback control unit 5435 indicates B-D presentation mode, the system target decoder 5423 alternately outputs plane data from the left-video and right-video plane memories. In particular, the system target decoder 5423 sends the left-view plane and right-view plane to the plane adder 5424 at 1/48 sec intervals. On the other hand, when the playback control unit 5435 indicates B-B presentation mode, the system target decoder 5423 outputs plane data from only the left-video or right-video plane memory twice per frame while maintaining the operation mode in 3D playback mode. That is each piece of plane data is output twice at 1/48 sec intervals.

The system target decoder 5423 associates the output mode of plane data received from the graphics plane and secondary video plane memories with 2 plane mode, 1 plane+offset mode, and 1 plane+zero offset mode as follows. The graphics plane memory includes PG plane memory, IG plane memory, and image plane memory.

When the playback control unit 5435 indicates 2 plane mode, the system target decoder 5423 alternately outputs base-view plane and dependent-view plane from the respective plane memories to the plane adder 5424.

When the playback control unit 5435 indicates 1 plane+offset mode, the system target decoder 5423 outputs 2D plane data from the respective plane memories to the plane adder 5424. In parallel with the above operation, the system target decoder 5423 reads the offset metadata 1910 from a VAU at the top of each video sequence, each time such a VAU is read from the dependent-view video stream. In the playback section of the video sequence, the system target decoder 5423 first specifies the PTS stored in the same PES packet along with each VAU and specifies the frame number represented by the compressed picture data of that VAU. The system target decoder 5423 then reads the offset information associated with the frame number from the offset metadata and transmits the offset information to the plane adder 5424 at the time indicated by the specified PTS.

When the playback control unit 5435 indicates 1 plane+zero offset mode, the system target decoder 5423 outputs 2D plane data from the respective plane memories to the plane adder 5424. In parallel with the above operation, the system target decoder 5423 sends the plane adder 5424 the offset information with the offset value set to “0”.

The plane adder 5424 receives each type of plane data from the system target decoder 5423 and superimposes these pieces of plane data into one piece of plane data (frame or field). In particular, in L/R mode, left-video plane data represents a left-view video plane, and right-view plane data represents a right-view video plane. Accordingly, the plane adder 5424 superimposes other plane data representing the left view on the left-video plane data and superimposes other plane data representing the right view on the right-video plane data. In depth mode, on the other hand, the right-video plane represents a depth map of video images represented by the left-video plane. Accordingly, the plane adder 5424 first generates pairs of right-view and left-view video planes from both the video planes. The combination processing performed thereafter is basically the same as the processing performed in L/R mode.

When receiving an indication of 1 plane+offset mode from the playback control unit 5435 as the presentation mode for the secondary video plane or graphics plane (PG plane, IG plane, or image plane), the plane adder 5424 performs offset control on the plane data. In particle, the plane adder 5424 first reads a reference offset ID that corresponds to the plane data from the SPRM(27) in the player variable storage unit 5436. Next, the plane adder 5424 refers to the offset information received from the system target decoder 5423 to retrieve offset information belonging to the offset sequence 1913 indicated by the received reference offset ID. That is, the plane adder 5424 retrieves an offset direction 1922 and offset value 1923. The plane adder 5424 then uses the offset value thus retrieved to perform offset control on the corresponding graphics plane. As a result, the plane adder 5424 generates a pair of left-view plane and right-view plane from one piece of plane data and combines the left view and right view with corresponding video planes.

When receiving an indication of 1 plane+zero offset mode from the playback control unit 5435, the plane adder 5424 sets the offset value for each plane data to “0” without referencing SPRM(27). As a result, the plane adder 5424 temporarily stops offset control for the respective pieces of plane data. Accordingly, the same plane data is combined with both the left-view and right-view video planes.

When receiving an indication of 2 plane mode from the playback control unit 5435, the plane adder 5424 receives pairs of base-view plane and dependent-view plane from the system target decoder 5423. In L/R mode, the base-view plane represents a left-view plane, and dependent-view plane represents a right-view video plane. Therefore, the plane adder 5424 combines the base-view plane with the left-video plane and the dependent-view plane with the right-video plane. In depth mode, on the other hand, the dependent-view plane represents a depth map of video images represented by the base-view plane. Accordingly, the plane adder 5424 first generates a pair of left-view and right-view planes from a pair of base-view and dependent-view planes and then performs the processing to combine the pair with the video planes.

In addition to the above-stated processing, the plane adder 5424 converts the output format of the combined plane data into a format that complies with the display method of 3D video images adopted in a device such as the display device 103 to which the data is output. If an alternate-frame sequencing method is adopted in the device, for example, the plane adder 5424 outputs the combined plane data pieces as one video plane (frame or one field). In this case, the plane adder 5424 alternately outputs the combined left-view plane and right-view plane to the HDMI communication unit 5425 at the intervals of 1/48 seconds. On the other hand, if a method that uses a lenticular lens is adopted in the device, the plane adder 5424 combines a pair of left-view and right-view planes into one video plane with use of internal buffer memory. Specifically, the plane adder 5424 temporarily stores and holds in the buffer memory the left-view plane that has been combined first. Subsequently, the plane adder 5424 combines the right-view plane, and further combines the resultant data with the left-view plane held in the buffer memory. During combination, the left-view and right-view planes are each divided into small rectangular areas that are long and thin in a vertical direction, and the small rectangular areas are arranged alternately in the horizontal direction in one frame or one field so as to re-constitute the frame or the field. In this manner, a pair of left-view and right-view planes is combined into one video plane. In this case, the plane adder 5424 outputs the combined video plane to the HDMI communication unit 5425 at the intervals of 1/24 sec.

The HDMI communication unit 5425 receives the video data thus combined from the plane adder 5424, receives audio data from the system target decoder 5423, and receives control data from the playback control unit 5435. Furthermore, the HDMI communication unit 5425 converts the received data into serial signals in the HDMI format and transmits the thus converted signals to the display device 103 through the TMDS channel in the HDMI cable 122. In particular, the HDMI communication unit 5425 generates the serial signals in the format shown in FIG. 5A. At this point, each pair of a left-view plane L and right-view plane R constituting a frame of 3D video images is arranged a side-by-side method shown in FIG. 5B in the active display area VACT×HACT shown in FIG. 5A. Alternatively, each pair may be arranged in the active display area VACT×HACT in any of the methods shown in FIGS. 5C-5E. In any method, the HDMI communication unit 5425 outputs the left-view plane and right-view plane at the time intervals of 1/24 seconds. Additionally, the HDMI communication unit 5425 exchanges CEC messages with the display device 103 via the HDMI cable 122. Furthermore, the HDMI communication unit 5425 reads EDID from the display device 103 via the display data channel DDC and performs HDCP authentication on the display device 103 to inquire as to whether or not the display device 103 supports playback of 3D video images.

<Playback Processing of 3D Playback Device>

FIG. 55 is a flowchart of playback processing by the 3D playback device 5400 shown in FIG. 54. This processing is started when the playback device 102 is activated in 3D playback mode as a result of the selection shown in FIG. 46.

In step S5501, the 3D playback device 5400 first controls the BD-ROM drive 5401 to read stream data from the BD-ROM disc 101. Then, the 3D playback device 5400 uses the switch 5420 to extract base-view extents and dependent-view extents from the stream data and stores the extracted extents to corresponding one of the RB1 5421 and RB2 5422. Thereafter, processing proceeds to step S5502.

In step S5502, the 3D playback device 5400 controls the system target decoder 5423 to read base-view extents from the RB1 5421 and dependent-view extents from the RB2 5422. The 3D playback device 5400 then demultiplexes the extents into separate elementary streams. Thereafter, processing proceeds to step S5503.

In step S5503, the 3D playback device 5400 controls the system target decoder 5423 to decode the respective elementary streams. In particular, the primary video stream decoded from the base-view extents and dependent-view extents are decoded into a base-view video plane and dependent-view video plane. In addition, the secondary video stream, IG stream, and PG stream are decoded into a secondary video plane, IG plane, and PG plane, respectively. Furthermore, the primary audio stream and secondary audio stream are mixed. In addition, graphics data received from the program execution unit 5434 is converted into an image plane. Thereafter, processing proceeds to step S5504.

In step S5504, the 3D playback device 5400 first controls the plane adder 5424 to convert a pair of base-view video plane and a dependent-view video plane having been decoded by the system target decoder 5423, into a pair of a left-view plane and a right-view plane. The 3D playback device 5400 then controls the plane adder 5424 to combine the secondary video plane, IG plane, PG plane, and image plane into each of the left-view plane and right-view plane. At this point, the plane adder 5424 may provide offset to the secondary video plane, IG plane, PG plane or image plane to convert the plane into a pair of a left-view plane and a right-view plane. Thereafter, processing proceeds to step S5505.

In step S5505, the 3D playback device 5400 controls the HDMI communication unit 5425 to convert the video plane combined by the plane adder 5424, audio data mixed by the system target decoder 5423, control data received from the playback control unit 5435 all into serial signals and to transmit the resulting signal signals to the display device 103 via the HDMI cable 122. In particular, the serial signals are generated in the format shown in FIG. 5A. At this point, each pair of the left-view plane L and right-view plane R is arranged in the active display area VACT×HACT in the side-by-side method shown in FIG. 5B. Alternatively, each pair may be arranged in the active display area VACT×HACT in any of the methods shown in FIGS. 5C-5E. In any method, the left-view plane and right-view plane are output at the time intervals of 1/24 seconds. Thereafter, processing proceeds to step S5506.

In step S5506, the 3D playback device 5400 checks whether or not any unprocessed base-view extents left in the RB1 5421. When unprocessed extents remain, processing is repeated from step S5501. When no unprocessed extents remain, processing ends.

<<3D Playlist Playback Processing>>

FIG. 56 is a flowchart of 3D playlist playback processing by a playback control unit 5435. 3D playlist playback processing is started by the playback control unit 5435 reading a 3D playlist file from the static scenario memory 5432.

In step S5601, the playback control unit 5435 first reads a single PI from a main path in the 3D playlist file and then sets the PI as the current PI. Next, from the STN table of the current PI, the playback control unit 5435 selects PIDs of elementary streams to be played back and specifies attribute information necessary for decoding the elementary streams. The playback control unit 5435 further selects, from among the elementary streams corresponding to the current PI in the STN table SS4130 in the 3D playlist file, a PID of elementary streams that are to be added to the elementary streams to be played back, and playback control unit 5435 specifies attribute information necessary for decoding these elementary streams. The selected PIDs and attribute information are indicated to the system target decoder 5423. The playback control unit 5435 additionally specifies, from among sub-paths in the 3D playlist file, a SUB_PI to be referenced at the same time as the current PI, specifying this SUB_PI as the current SUB_PI. Thereafter, processing proceeds to step S5602.

In step S5602, the playback control unit 5435 selects the display mode for each piece of plane data based on the offset during pop-up 4311 indicated by the STN table SS and indicates the display mode to the system target decoder 5423 and the plane adder 5424. In particular, when the value of the offset during pop-up is “0”, B-D presentation mode is selected as the video plane presentation mode, and 2 plane mode or 1 plane+offset mode is selected as the presentation mode for the graphics plane. On the other hand, when the value of the offset during pop-up is “1”, B-B presentation mode is selected as the video plane presentation mode, and 1 plane+zero offset mode is selected as the presentation mode for the graphics plane. Thereafter, processing proceeds to step S5603.

In step S5603, it is checked as to whether or not 1 plane+offset mode is selected as the presentation mode of the graphics plane. If 1 plane+offset mode is selected, processing proceeds to step S5604. On the other hand, if 2 plane mode or 1 plane+zero offset mode is selected, processing proceeds to step S5605.

In step S5604, offset information needs to be extracted from the dependent-view video stream since 1 plane+offset mode has been selected. Accordingly, the playback control unit 5435 refers to the STN table of the current PI and retrieves the PG stream or IG stream from among the elementary streams indicated by the selected PIDs. Furthermore, the playback control unit 5435 specifies the reference offset ID allocated to the pieces of stream data, setting the reference offset ID to the SPRM(27) in the player variable storage unit 5436. Thereafter, processing proceeds to step S5605.

In step S5605, the playback control unit 5435 reads reference clip information, a PTS #1 indicating a playback start time IN1, and a PTS #2 indicating a playback end time OUT1 from the current PI and the SUB_PI. From this reference clip information, a clip information file corresponding to each of the file 2D and the file DEP to be played back is specified. Thereafter, processing proceeds to step S5606.

In step S5606, with reference to the entry map in each of the clip information files specified in step S5605, the playback control unit 5435 retrieves the SPN #1 and SPN #2 in the file 2D, and the SPN #11 and SPN #12 in the file DEP, corresponding to the PTS #1 and the PTS #2, as shown in FIG. 44. By using the extent start points of each clip information file, the playback control unit 5435 further calculates, from the SPN #1 and the SPN #11, the number of source packets SPN #21 from the top of the file SS to the playback start position. The playback control unit 5435 also calculates, from the SPN #2 and the SPN #12, the number of source packets SPN #22 from the top of the file SS to the playback end position. Specifically, the playback control unit 5435 first retrieves, from among SPNs shown by extent start points of the 2D clip information files, a value “Am” that is the largest value less than or equal to SPN #1, and retrieves, from among the SPNs shown by extent start points of dependent-view clip information files, a value “Bm” that is the largest value less than or equal to the SPN #11. Next, the playback control unit 5435 obtains the sum of the retrieved SPNs Am+Bm and sets the sum as SPN #21. Next, the playback control unit 5435 retrieves, from among SPNs shown by the extent start points of the 2D clip information files, a value “An” that is the smallest value that is larger than the SPN #2. The playback control unit 5435 also retrieves, from the SPNs of the extent start points of the dependent-view clip information files, a value “Bn” that is the smallest value that is larger than the SPN #12. Next, the playback control unit 5435 obtains the sum of the retrieved SPNs An+Bn and sets the sum as SPN #22. Thereafter, processing proceeds to step S5607.

In step S5607, the playback control unit 5435 converts the SPN #21 and the SPN #22, determined in step S5606, into a pair of numbers of sectors N1 and N2. Specifically, the playback control unit 5435 first obtains the product of SPN #21 and the data amount per source packet, i.e. 192 bytes. Next, the playback control unit 5435 divides this product by the data amount per sector, i.e. 2048 bytes: SPN #21×192/2048. The resulting quotient is the same as the number of sectors N1 from the top of the file SS to immediately before the playback start position. Similarly, from the SPN #22, the playback control unit 5435 calculates SPN #22×192/2048. The resulting quotient is the same as the number of sectors N2 from the top of the file SS to immediately before the playback end position. Thereafter, processing proceeds to step S5608.

In step S5608, the playback control unit 5435 specifies, from the numbers of sectors N1 and N2 obtained in step S5607, LBNs of the top and end of the extent SS group to be played back. Specifically, with reference to the file entry of the file SS to be played back, the playback control unit 5435 counts from the top of sector group in which the extent SS group is recorded so as to specify the LBN of the (N1+1)^{th} sector=LBN #1, and the LBN of the (N2+1)^{th} sector=LBN #2. The playback control unit 5435 further specifies a range from the LBN #1 to the LBN #2 to the BD-ROM drive 5401. As a result, from the sector group in the specified range, a source packet group belonging to an extent SS group is read in aligned units. Thereafter, processing proceeds to step S5609.

In step S5609, referring to the extent start points of the clip information file used in step S5606, the playback control unit 5435 generates data block boundary information relating to the extent SS group, transmitting the data block boundary information to the switch 5420. As a specific example, assume that the SPN #21 indicating the playback start position is the same as the sum of SPNs indicating the extent start points, An+Bn, and that the SPN #22 indicating the playback end position is the same as the sum of SPNs indicating the extent start points, Am+Bm. In this case, the playback control unit 5435 obtains a sequence of differences between SPNs from the respective extent start points, A(n+1)−An, B(n+1)−Bn, A(n+2)−A(n+1), B(n+2)−B(n+1), . . . , Am−A(m−1), and Bm−B(m−1), and transmits the sequence to the switch 5420 as the data block boundary information. As shown in FIG. 34E, this sequence indicates the number of source packets of data blocks included in the extent SS. The switch 5420 counts, from zero, the number of source packets of the extents SS received from the BD-ROM drive 5401. Each time the count is the same as the difference between SPNs indicated by the data block boundary information, the switch 5420 switches the destination of output of the source packets between RB1 5421 and RB2 5422 and resets the count to zero. As a result, {B(n+1)−Bn} source packets from the top of the extent SS are output to the RB2 5422 as the first dependent-view extent, and the following {A(n+1)−An} source packets are transmitted to the RB1 5421 as the first base-view extent. Thereafter, dependent-view extents and base-view extents are extracted from the extent SS alternately in the same way, alternating each time the number of source packets received by the switch 5420 is the same as the difference between SPNs indicated by the data block boundary information.

In step S5610, the playback control unit 5435 checks whether an unprocessed PI remains in the main path. When unprocessed extents remain, processing is repeated from step S5601. When no unprocessed extents remain, processing ends.

<System Target Decoder>

FIG. 57 is a functional block diagram of a system target decoder 5423. The components shown in FIG. 57 differ from the components of the system target decoder 4723 in the 2D playback device shown in FIG. 51 in the following two points: (1) the input system from the read buffers to the decoders has a duplex configuration; and (2) the primary video decoder supports 3D playback mode, whereas the secondary video decoder, PG decoder, and IG decoder support 2 plane mode. That is, each of the video decoder is capable of alternately decoding base-view and dependent-view video streams. In particular, each decoder supporting 2 plane mode may be composed of separate portions, one for decoding base-view plane and the other for decoding dependent-view plane. On the other hand, the primary audio decoder, secondary audio decoder, audio mixer, image processor, and plane memories are the same as those in the 2D playback device shown in FIG. 51. Accordingly, among the structural elements shown in FIG. 57, those differing from the structural elements shown in FIG. 51 are described below, and description of the common structural elements can be found in the description given with reference to FIG. 51. Furthermore, since the video decoders each have a similar structure, only the structure of the primary video decoder 5715 is described below. This description is also valid for the structure of other video decoders.

The first source depacketizer 5711 reads source packets from the RB1 5421, furthermore retrieving TS packets included in the source packets and transmitting the TS packets to the first PID filter 5713. The second source depacketizer 5712 reads source packets from the RB2 5422, furthermore retrieving TS packets included in the source packets and transmitting the TS packets to the second PID filter 5714. Each of the source depacketizers 5711 and 5712 further synchronizes the time of transfer the TS packets with the time shown by the ATS of each source packet. This synchronization method is the same method as the source depacketizer 5110 shown in FIG. 51. Accordingly, details thereof can be found in the description provided for FIG. 51. With this sort of adjustment of transfer time, the mean transfer rate R_{TS1} of TS packets from the first source depacketizer 5711 to the first PID filter 5713 does not exceed the system rate indicated by the 2D clip information file. Similarly, the mean transfer rate R_{TS2} of TS packets from the second source depacketizer 5712 to the second PID filter 5714 does not exceed the system rate indicated by the dependent-view clip information file.

The first PID filter 5713 compares the PID of each TS packet received from the first source depacketizer 5711 with the selected PID. The playback control unit 5435 designates the selected PID beforehand in accordance with the STN table in the 3D playlist file. When the two PIDs match, the first PID filter 5713 transfers the TS packets to the decoder assigned to the PID. For example, if a PID is 0x1011, the TS packets are transferred to TB15701 in the primary video decoder 5715. On the other hand, TS packets with PIDs ranging from 0x1B00-0x1B1F, 0x1100-0x111F, 0x1A00-0x1A1F, 0x1200-0x121F, and 0x1400-0x141F are transferred to the secondary video decoder, primary audio decoder, secondary audio decoder, PG decoder, and IG decoder, respectively.

The second PID filter 5714 compares the PID of each TS packet received from the second source depacketizer 5712 with the selected PID. The playback control unit 5435 designates the selected PID beforehand in accordance with the STN table SS in the 3D playlist file. When the two PIDs match, the second PID filter 5714 transfers the TS packets to the decoder assigned to the PID. For example, if a PID is 0x1012 or 0x1013, the TS packets are transferred to TB2 5708 in the primary video decoder 5715. On the other hand, TS packets with PIDs ranging from 0x1B20-0x1B3F, 0x1220-0x127F, and 0x1420-0x147F are transferred to the secondary video decoder, PG decoder, and IG decoder, respectively.

The primary video decoder 5715 includes a TB1 5701, MB1 5702, EB1 5703, TB2 5708, MB2 5709, EB2 5710, buffer switch 5706, DEC 5704, DPB 5705, and picture switch 5707. The TB1 5701, MB1 5702, EB1 5703, TB2 5708, MB2 5709, EB2 5710, and DPB 5705 are all buffer memories. Each of these buffer memories uses an area of a memory element included in the primary video decoder 5715. Alternatively, some or all of these buffer memories may be separated on different memory elements.

The TB1 5701 receives TS packets that include a base-view video stream from the first PID filter 5713 and stores the TS packets as they are. The MB1 5702 stores PES packets reconstructed from the TS packets stored in the TB1 5701. The TS headers of the TS packets are removed at this point. The EB1 5703 extracts and stores encoded VAUs from the PES packets stored in the MB1 5702. The PES headers of the PES packets are removed at this point.

The TB2 5708 receives TS packets that include a dependent-view video stream from the second PID filter 5714 and stores the TS packets as they are. The MB2 5709 stores PES packets reconstructed from the TS packets stored in the TB2 5708. The TS headers of the TS packets are removed at this point. The EB2 5710 extracts and stores encoded VAUs from the PES packets stored in the MB2 5709. The PES headers of the PES packets are removed at this point.

The buffer switch 5706 transfers the headers of the VAUs stored in the EB 1 5703 and the EB2 5710 in response to a request from the DEC 5704. Furthermore, the buffer switch 5706 transfers the compressed picture data for the VAUs to the DEC 5704 at the times indicated by the DTSs included in the original TS packets. In this case, the DTSs are equal between a pair of pictures belonging to the same 3D VAU between the base-view video stream and dependent-view video stream. Accordingly, for a pair of VAUs that have the same DTS, the buffer switch 5706 first transmits the VAU stored in the EB1 5703 to the DEC 5704.

Like the DEC 5104 shown in FIG. 51, the DEC 5704 is a hardware decoder specifically for decoding of compressed pictures and is composed of an LSI that includes, in particular, a function to accelerate the decoding. The DEC 5704 decodes the compressed picture data transferred from the buffer switch 5706 in order. During decoding, the DEC 5704 first analyzes each VAU header to specify the compressed picture, compression encoding method, and stream attribute stored in the VAU, selecting a decoding method in accordance with this information. Examples of the compression encoding methods include MPEG-2, MPEG-4 AVC, and VC1. Furthermore, the DEC 5704 transmits the decoded and thus uncompressed picture to the DPB 5705.

Each time the DEC 5704 reads the VAU at the top of one video sequence in the dependent-view video stream, the DEC 5704 also reads the offset metadata from the VAU. In the playback section of the video sequence, the DEC 5704 first specifies the PTS stored in the same PES packet along with the VAU and specifies the number of the frame represented by the compressed picture data of the VAU. The DEC 5704 then reads the offset information associated with the frame number from the offset metadata and transmits the offset information to the plane adder 5424 at the time indicated by the specified PTS.

The DPB 5705 temporarily stores the decoded and thus uncompressed pictures. When the DEC 5704 decodes a P picture or a B picture, the DPB 5705 retrieves reference pictures from among the stored, uncompressed pictures in response to a request from the DEC 5704 and supplies the retrieved reference pictures to the DEC 5704.

The picture switch 5707 writes the uncompressed pictures from the DPB 5705 to either the left-video plane memory 5720 or the right-video plane memory 5721 at the time indicated by the PTS included in the original TS packet. In this case, the PTSs are equal between a base-view picture and a dependent-view picture belonging to the same 3D VAU. Accordingly, for a pair of pictures that have the same PTS and that are stored by the DPB 5705, the picture switch 5707 first writes the base-view picture in the left-video plane memory 5720 and then writes the dependent-view picture in the right-video plane memory 5721.

<Plane Adder in 1 Plane+Zero Offset Mode>

FIG. 58 is a functional block diagram of the plane adder 5424 in 1 plane+offset mode or 1 plane+zero offset mode. As shown in FIG. 58, the plane adder 5424 includes a parallax video generation unit 5810, switch 5820, four cropping units 5831-5834, and four adders 5841-5844.

The parallax video generation unit 5810 receives a left-video plane 5801 and a right-video plane 5802 from the system target decoder 5423. In the playback device 102 in L/R mode, the left-video plane 5801 represents the left-view video plane, and the right-video plane 5802 represents the right-view video plane. At this point, the parallax video generation unit 5810 transmits the respective video planes 5801 and 5802 as they are to the switch 5820. On the other hand, in the playback device 102 in depth mode, the left-video plane 5801 represents the video plane for 2D video images, and the right-video plane 5802 represents a depth map for the 2D video images. In this case, the parallax video generation unit 5810 first calculates the binocular parallax for each element in the 2D video images using the depth map. Next, the parallax video generation unit 5810 processes the left-video plane 5801 to shift the presentation position of each element in the video plane for 2D video images to the left or right according to the calculated binocular parallax. This generates a pair of a left-view video plane and a right-view video plane. Furthermore, the parallax video generation unit 5810 outputs the pair of video planes thus generated to the switch 5820 as a pair of left-video plane and right-video plane.

When the playback control unit 5435 indicates B-D presentation mode, the switch 5820 transmits the left-video plane 5801 and right-video plane 5802 with the same PTS to the first adder 5841 in that order. When the playback control unit 5435 indicates B-B presentation mode, the switch 5820 transmits one of the left-video plane 5801 and right-video plane 5802 with the same PTS twice per frame to the first adder 5841, discarding the other plane.

When the playback control unit 5435 indicates 1 plane+offset mode, the first cropping unit 5831 performs the following offset control on the secondary video plane 5803. The first cropping unit 5831 first receives offset information 5807 from the system target decoder 5423. At this point, the first cropping unit 5831 reads the reference offset ID corresponding to the secondary video plane from the SPRM(27) 5851 in the player variable storage unit 5436. Next, the first cropping unit 5831 retrieves the offset information belonging to the offset sequence indicated by the reference offset ID from the offset information 5807 received from the system target decoder 5423. After that, the first cropping unit 5831 refers to the offset information to perform offset control on the secondary video plane 5803. As a result, the secondary video plane 5803 is converted into a pair of pieces of plane data representing a left view and right view. Furthermore, the secondary video plane representing a left view and right view is alternately output to the first adder 5841.

Generally, the playback control unit 5435 updates the value of the SPRM(27) 5851 each time the current PI changes. Additionally, the program execution unit 5434 may set the value of the SPRM(27) 5851 in accordance with a movie object or BD-J object.

Similarly, the second cropping unit 5832 converts the PG plane 5804 into PG planes representing a left view and right view. The PG planes are then alternately output to the second adder 5842. Similarly, the third cropping unit 5833 converts the IG plane 5805 into a pair of IG planes representing a left view and right view. The IG planes are then alternately output to the third adder 5843. Similarly, the fourth cropping unit 5834 converts the image plane 5806 into image planes representing a left view and right view. The image planes are then alternately output to the fourth adder 5844.

When the playback control unit 5435 indicates 1 plane+zero offset mode, the first cropping unit 5831 transmits the secondary video plane 5803 twice as is to the first adder 5841, without performing offset control for the secondary video plane 5803. The same description applies to the other cropping units 5832-5834.

The first adder 5841 receives a video plane from the switch 5820 and a secondary video plane from the first cropping unit 5831. At this point, the first adder 5841 superimposes each pair of the video plane and secondary video plane thus received and transmits the result to the second adder 5842. The second adder 5842 receives a PG plane from the second cropping unit 5832, superimposes this PG plane on the plane data received from the first adder 5841, and transmits the result to the third adder 5843. The third adder 5843 receives an IG plane from the third cropping unit 5833, superimposes this IG plane on the plane data received from the second adder 5842, and transmits the result to the fourth adder 5844. The fourth adder 5844 receives an image plane from the fourth cropping unit 5834, superimposes this image plane on the plane data received from the third adder 5843, and outputs the result to the HDMI communication unit 5425. The adders 5841-5844 each make use of alpha blending when superimposing plane data. In this way, the secondary video plane 5803, PG plane 5804, IG plane 5805, and image plane 5806 are superimposed in the order shown by the arrow 5800 in FIG. 58 on the left-video plane 5801 or right-video plane 5802. As a result, the video images indicated by each piece of plane data are displayed on the screen of the display device 103 so that the left-video plane or right-video plane appears to overlap with the secondary video plane, IG plane, PG plane, and image plane in that order.

### <<Flowchart of Offset Control>>

FIG. 59 is a flowchart of offset control by the cropping units 5831-5834. Each of the cropping units 5831-5834 begins offset control upon receiving offset information 5807 from the system target decoder 5423. In the following description, it is assumed that the second cropping unit 5832 performs offset control on the PG plane data 5804. The other cropping units 5831, 5833, and 5834 perform similar processing respectively on the secondary video plane 5803, IG plane 5805, and image plane 5806.

In step S5901, the second cropping unit 5832 first receives PG plane 5804 from the system target decoder 5423. At this point, the second cropping unit 5832 reads the reference offset ID for the PG plane from the SPRM(27) 5851. Next, the second cropping unit 5831 retrieves the offset information belonging to the offset sequence indicated by the reference offset ID from the offset information 5807 received from the system target decoder 5423. Thereafter, processing proceeds to step S5902.

In step S5902, the second cropping unit 5832 checks whether the video plane selected by the switch 5820 represents a left view or right view. If the video plane represents a left view, processing proceeds to step S5903. If the video plane represents a right view, processing proceeds to step S5906.

In step S5903, the second cropping unit 5832 checks the value of the retrieved offset direction. Hereinafter, the following is assumed: if the offset direction value is “0”, the 3D graphics image appears closer to the viewer than the screen, and if the offset direction value is “1”, the image appears further back than the screen. If the offset direction value is “0”, processing proceeds to step S5904. If the offset direction value is “1”, processing proceeds to step S5905.

In step S5904, the video plane represents a left view and the offset direction indicates a direction closer toward the viewer from the screen. Accordingly, the second cropping unit 5832 provides a right offset to the PG plane data 5804. In other words, the position of each piece of pixel data included in the PG plane data 5804 is shifted to the right by the offset value. Thereafter, processing proceeds to step S5909.

In step S5905, the video plane represents a left view and the offset direction indicates a direction further back than the screen. Accordingly, the second cropping unit 5832 provides a left offset to the PG plane data 5804. In other words, the position of each piece of pixel data included in the PG plane data 5804 is shifted to the left by the offset value. Thereafter, processing proceeds to step S5909.

In step S5906, the second cropping unit 5832 checks the value of the retrieved offset direction. If the offset direction value is “0”, processing proceeds to step S5907. If the offset direction value is “1”, processing proceeds to step S5908.

In step S5907, the video plane represents a right view and the offset direction indicates a direction closer toward the viewer from the screen. Accordingly, the second cropping unit 5832 provides a left offset to the PG plane data 5804, contrary to step S5904. In other words, the position of each piece of pixel data included in the PG plane data 5804 is shifted to the left by the offset value. Thereafter, processing proceeds to step S5909.

In step S5908, the video plane represents a right view and the offset direction indicates a direction further back than the screen. Accordingly, the second cropping unit 5832 provides a right offset to the PG plane data 5804, contrary to step S5905. In other words, the position of each piece of pixel data included in the PG plane data 5804 is shifted to the right by the offset value. Thereafter, processing proceeds to step S5909.

In step S5909, the second cropping unit 5832 outputs the processed PG plane 5804 to the third cropping unit 5834. Processing then terminates.

### <<Changes in Plane Data Via Offset Control>>

FIG. 60B is a schematic diagram showing a PG plane GP before the offset control by the second cropping unit 5832. As shown in FIG. 60B, the PG plane GP includes pixel data representing the subtitle “I love you”, i.e. subtitle data STL. This subtitle data STL is located at a distance D0 from the left edge of the PG plane data GP before offset control.

FIG. 60A is a schematic diagram showing the PG plane RGP with a right offset. With reference to FIG. 60A, when providing a right offset to the PG plane GP, the second cropping unit 5832 changes the position of each piece of pixel data in the PG plane GP from its original position to the right by a number of pixels OFS equal to the offset value. Specifically, the second cropping unit 5832 performs cropping to remove, from the right edge of the PG plane GP, pixel data included in a strip AR1 of a width OFS equal to the offset value. Next, the second cropping unit 5832 forms a strip AU of width OFS by adding pixel data to the left edge of the PG plane GP. The pixel data included in this strip AL1 is set as transparent. This process yields PG plane RGP to which a right offset has been provided. Subtitle data STL is actually located at a distance DR from the left edge of this PG plane RGP. This distance DR equals the original distance D0 plus the offset value OFS: DR=D0+OFS.

FIG. 60C is a schematic diagram showing the PG plane LGP with a left offset. With reference to FIG. 60C, when providing a left offset to the PG plane GP, the second cropping unit 5832 changes the position of each piece of pixel data in the PG plane GP from its original position to the left by a number of pixels OFS equal to the offset value. Specifically, the second cropping unit 5832 performs cropping to remove, from the left edge of the PG plane GP, pixel data included in a strip AL2 of a width OFS equal to the offset value. Next, the second cropping unit 5832 forms a strip AR2 of width OFS by adding pixel data to the right edge of the PG plane data GP. The pixel data included in this strip AR2 is set as transparent. This process yields PG plane LGP to which a left offset has been provided. Subtitle data STL is actually located at a distance DL from the left edge of this PG plane RGP. This distance DL equals the original distance D0 minus the offset value OFS: DL=D0−OFS.

<Plane Adder in 2 Plane+Zero Offset Mode>

FIG. 61 is a partial functional block diagram of the plane adder 5424 in 2 plane mode. As shown in FIG. 61, the plane adder 5424 in 2 plane mode includes a parallax video generation unit 5810, switch 5820, and first adder 5841, second adder 5842, and second cropping unit 5832, like the plane adder 5424 in 1 plane+offset mode shown in FIG. 58. Although not shown in FIG. 61, the plane adder 5424 in 2 plane mode additionally includes the other cropping units 5831, 5833, and 5834 and the other adders 5843 and 5844 shown in FIG. 58. The plane adder 5424 in 2 plane mode further includes a second parallax video generation unit 6110 and a second switch 6120 as units for input of PG planes 5804 and 5805. Although not shown in FIG. 61, each input unit for secondary video plane, IG plane, and image plane also includes similar structural elements.

The second parallax video generation unit 6110 receives a left-view PG plane 6104 and right-view PG plane data 6105 from the system target decoder 5423. In the playback device 102 in L/R mode, the left-view PG plane 6104 and the right-view PG plane 6105 literally represent a left-view PG plane and a right-view PG plane, respectively. Accordingly, the second parallax video generation unit 6110 transmits the pieces of plane data 6104 and 6105 as they are to the second switch 5820. On the other hand, in the playback device 102 in depth mode, the left-view PG plane 6104 represents the PG plane of 2D graphics images, and the right-view PG plane 6105 represents a depth map corresponding to the 2D graphics images. Accordingly, the second parallax video generation unit 6110 first calculates the binocular parallax for each element in the 2D graphics images using the depth map. Next, the second parallax video generation unit 6110 processes the left-view PG plane data 6104 to shift the presentation position of each element in the 2D graphics image in the PG plane to the left or right in accordance with the calculated binocular parallax. This generates a pair of a left-view PG plane and right-view PG plane. Furthermore, the second parallax video generation unit 6110 outputs this pair of PG planes to the second switch 6120.

The second switch 6120 outputs the left-view PG plane 6104 and the right-view PG plane 6105, which have the same PTS, to the second cropping unit 5832 in this order. The second cropping unit 5832 outputs the respective PG planes 6104 and 6105 as they are to the second adder 5842. The second adder 5842 superimposes the PG planes 6104 and 6105 on the plane data received from the first adder 5841, and transmits the result to the third adder 5843. As a result, the left-view PG plane 6104 is superimposed on the left-video plane 5801, where the right-view PG plane 6105 is superimposed on the right-video plane 5802.

The second cropping unit 5832 in 2 plane mode may refer to the offset information 5807 to perform offset control on the left-view PG plane 6104 or right-view PG plane 6105. The offset control provides the following advantages. In L/R mode, instead of the left-view PG stream in the sub-TS, the PG stream in the main TS (hereinafter, abbreviated as “2D PG stream”) may be used as the left-view PG plane. Note, however, that one graphics image represented by the 2D PG stream may be used also as a 2D video image, so that the presentation position is normally set to be constant. On the other hand, the presentation position of each graphics image represented by the right-view PG stream is set to shift to the left or right in accordance with the change in the depth of a corresponding 3D graphics image. Accordingly, in order to change the depth without shifting 3D graphics images to the left or right, the center between the left view and right view needs to be kept constant. Therefore, for playback of 3D graphics images, offset is provided to the graphics images represented by the 2D•PG stream to shift the presentation position to the left or right. As a result, the center between the left view and right view of graphics images is kept constant, so that the 3D graphics images appear without any shift in the horizontal direction. In this way, by using the 2D•PG stream as the left-view PG stream, the risk of causing the viewer to feel uncomfortable is prevented.

### Embodiment 2

Different from the home theater system according to Embodiment 1, a home theater system according to Embodiment 2 of the present invention causes the playback device 102 rather than the display device 103 to change frame rates. Apart from this point, the home theater system according to Embodiment 2 has the same structure and functions as Embodiment 1. Accordingly, the following is a description of modifications and extensions of the home theater system according to Embodiment 2 compared to the system according to Embodiment 1. Details on the parts of the home theater system similar to those of the system according to Embodiment 1 can be found in the description of Embodiment 1.

FIG. 62A is a schematic diagram showing VAU #N included in a video stream 6200 (where the letter N denotes an integer greater than or equal to 1). As shown in FIG. 16, the video stream 6200 is composed of a plurality of video sequences #K (where the letter K denotes an integer greater than or equal to 1) and each video sequence #K includes a plurality of VAU #N. Each VAU #N has the same structure as that shown in FIG. 16 and in particular includes supplementary data 6201. The supplementary data 6201 includes a display type 6202. For example, when the supplementary data 6201 corresponds to the “picture timing SEI” in MPEG-4 AVC, the display type 6202 then corresponds to the parameter “PicStruct”. Alternatively, the display type 6202 may be set in a SEI message as a piece of user data. Each of the base-view video stream and dependent-view video stream has the same structure as the video stream 6200.

The display type 6202 specifies the display pattern of a frame represented by VAU #N. FIG. 62B is a correspondence table between the possible values of the display type 6202 and display patterns 6203. FIGS. 62C-62K are schematic diagrams each showing one of the display patterns. As shown in FIG. 62B, the display type holds an integer value ranging from 1 to 9. Each integer value is associated with a different display pattern. The display type associated with the integer value “1” is “frame”. This display pattern indicates that an entire frame is displayed as shown in FIG. 62C. The display type associated with the integer value “2” is “top”. This display pattern indicates that odd-numbered lines of one frame are displayed as shown in FIG. 62D. The display type associated with the integer value “3” is “bottom”. This display pattern indicates that even-numbered lines of one frame are displayed as shown in FIG. 62E. The display type associated with the integer value “4” is “top, bottom, top”. This display pattern indicates, as shown in FIG. 62F, that the odd-numbered lines of one frame are displayed in the first one of three contiguous frame periods, the even-numbered lines of the frame are displayed in the second frame period, and then the odd-numbered lines of the frame are displayed in the last frame period. The display type associated with the integer value “5” is “bottom, top”. This display pattern indicates, as shown in FIG. 62G, that the even-numbered line of one frame are displayed in the first one of two contiguous frame periods and the odd-numbered lines of the frame are displayed in the second frame period. The display type associated with the integer value “6” is “bottom, top, bottom”. This display pattern indicates, as shown in FIG. 62H, that the even-numbered lines of one frame are displayed in the first one of three contiguous frame periods, the odd-numbered lines of the frame are displayed in the second frame period, and then the even-numbered lines of the frame are displayed in the last frame period. The display type associated with the integer value “7” is “top, bottom”. This display pattern indicates, as shown in FIG. 621, that the odd-numbered line of one frame are displayed in the first one of two contiguous frame periods and the even-numbered lines of the frame are displayed in the second frame period. The display type associated with the integer value “8” is “double”. This display pattern indicates, as shown in FIG. 62J, that the entirety of one frame is repeatedly displayed in two contiguous frame periods. The display type associated with the integer value “9” is “triple”. This display pattern indicates, as shown in FIG. 62K, that the entirety of one frame is repeatedly displayed in three contiguous frame periods.

FIG. 63 is a partial functional block diagram of a system of processing primary video streams in the system target decoder 5423. As compared with the processing system of Embodiment 1 shown in FIG. 57, a primary video decoder 6315 differs in the following functionality. Similarly to the DEC 5704 shown in FIG. 57, a DEC 6304 is a hardware decoder specifically for the processes of decoding compressed pictures. Different from the DEC 5704, however, the DEC 6304 interprets the display type 6202 from the supplementary data contained in each VAU and controls the picture switch 5707 according to the value of the display type 6202. As a result, the picture switch 5707 transfers uncompressed picture data from the DPB 5705 to one of the left-video plane memory 5720 and right-video plane memory 5721, according to the display pattern indicated by the display type 6202. Specifically, for example, when the display type indicates the display pattern “frame”, the picture switch 5707 transfers an entire frame. When the display type indicates the display pattern “top”, the picture switch 5707 transfers only odd-numbered lines of one frame. When the display type indicates the display pattern “top, bottom, top”, the picture switch 5707 transfers odd-numbered lines of one frame in the first one of three contiguous frame periods, even-numbered lines of the frame in the second frame period, and odd-numbered lines of the frame in the last frame period. When the display type indicates the display pattern “double”, the picture switch 5707 repeatedly transfers an entire frame in two contiguous frame periods. A similar description applies to the other display patterns.

The picture switch 5707 increases the frame rate to a sufficiently higher value than the original rate of 24 fps. For example, the frame rate is increased to 120 fps, 100 fps, or 180 fps. That is, the picture switch 5707 transfers pictures alternately to the respective primary video plane memories 5720 and 5721 at intervals sufficiently shorter than 1/24 seconds, for example at 1/120 seconds, 1/100 seconds, or 1/180 seconds. The plane adder 5424 combines left-view frames and right-view frames one by one at a rate comparable to that frame rate and passes the combined frames to the HDMI communication unit 5425. The HDMI communication unit 5425 sends the display device 103 a pair of a left-view frame and a right-view frame after converting the pair into one frame in the format shown in FIG. 4A by using one of the methods shown in FIGS. 4B-4E. The frame rate at that time is set to 60 fps, 50 fps, or 90 fps, for example. The display device 103 extracts the left-view frame and right-view frame from data of the one frame and alternately displays the extracted frames at twice as high as that frame rate, for example, at 120 fps, 100 fps or 180 fps.

FIG. 64 is a flowchart of playback processing performed by the 3D playback device using the system shown in FIG. 63. The flowchart differs from that shown in FIG. 55 in the addition of step S6401 in which update of plane data is determined according to the display type. The remaining steps are similar to those shown in FIG. 55 and thus details of such steps are found in the description about FIG. 55.

In step S6401, the DEC 6304 reads supplementary data from the VAU that contains video plane processed in step S5505 and interprets the display type 6202 from the supplementary data. Based on the value of the display type 6202, the DEC 6304 then determines whether or not to update the plane data held in the primary video plane memories 5720 and 5721. For example, when the display type indicates the display pattern “frame”, the plane data held in the primary video plane memories 5720 and 5721 needs to be updated to date representing the next frame. On the other hand, for example, when the display type indicates the display pattern “double”, the plane data already stored in the primary video plane memories 5720 and 5721 should be processed again. In this way, when the plane data needs to be updated, processing proceeds to step S5506. When the plane data should not be updated, processing is repeated from step S5504.

FIG. 65 are schematic diagrams showing change in frame rate when the playback device 102 is caused to output left-view frames and right-view frames at the frame rate=60 fps. As shown in FIG. 65A, the presentation time of 3D video frames F_{3D}k (k=1, 2, 3, 4 . . . ) in content are set to 1/24 seconds. Furthermore, from among 3D VAUs containing odd-numbered 3D video frames F_{3D}1, F_{3D}3, . . . , base-view VAUs are provided with the display type TYL=“9,” and dependent-view VAUs are provided with the display type TYR=“8.” On the other hand, from among 3D VAUs containing even-numbered 3D video frames F_{3D}2, F_{3D}4, . . . , base-view VAUs are provided with the display type TYL=“8,” and dependent-view VAUs are provided with the display type TYR=“9.”. When the display type=“8” or “9” is set, the picture switch 5707 repeatedly transfers the entirety of one frame from the DPB 5705 to an appropriate one of the primary video plane memories 5720 and 5721 twice or three times. As a result, for each odd-numbered 3D video frame F_{3D}k (k=1, 3, . . . ), the playback device 102 repeatedly transmits a left-view frame F_{L}k three times at the intervals of 1/60 seconds and a right-view frame F_{R}k twice at the intervals of 1/60 seconds as shown in FIG. 65B. On the other hand, for each even-numbered frame 3D video F_{3D}m (m=2, 4, . . . ), the playback device 102 transmits a left-view frame F_{L}m twice at the intervals of 1/60 seconds and a right-view frame F_{R}m at the intervals of 1/60 seconds. During the period when an odd-numbered 3D video frame F_{3D}k is replaced with an even-numbered frame F_{3D}(k+1), the left-view frame F_{L}k constituting the former frame F_{3D}k and the right-view frame F_{R}(k+1) constituting the latter frame F_{3D}(k+1) are multiplexed into one frame shown in FIG. 4A.

The display device 103 extracts a left-view frame F_{L}k and a right-view frame F_{R}k from one frame data received from the playback device 102. The display device 103 then alternately displays the received frames F_{L}k and F_{R}k at twice as high as the frame rate=60 fps at which the frames are sent from the playback device 102, i.e. at 120 fps. Consequently, as shown in FIG. 65C, during the presentation period of the first 3D video frame F_{3D}1, the first left-view frame F_{L}1 is repeatedly displayed three times and the first right-view frame F_{R}1 is repeatedly displayed twice; the frames F_{L}1 and F_{R}1 are alternately displayed at the intervals of 1/120 sec. During the presentation period of the second 3D video frame F_{3D}2, the second left-view frame F_{L}2 is repeatedly displayed twice and the second right-view frame F_{R}2 is repeatedly displayed three times; the frames F_{L}2 and F_{R}2 are alternately displayed at the intervals of 1/120 sec. A similar description applies to the presentation period of each of the third and forth 3D video frames F_{3D}3 and F_{3D}4. In this case, during the presentation period of each 3D video frame F_{3D}k, one of a left-view frame F_{L}k and a right-view frame F_{R}k is displayed three times while the other is displayed only twice. As described above, the number of display is different between the left-view frame F_{L}k and the right-view frame F_{R}k. However, a viewer sees as if a 3D video frame F3_{D}k is switched to the next frame each time five left-view frames F_{L}k and right-view frames F_{R}k are displayed in total. That is, the presentation time of any 3D video frame F_{3D}k is equal to 1/120 seconds×5 frames≈0.42 seconds. In this way, any 3D video frame has equal presentation time, and therefore the motion of 3D video images can be more smoothly expressed.

As can be seen from FIG. 7, the display type should be set in the following manner for ensuring the playback device 102 to transmit left-view frames and right-view frames at the frame rate=50 fps. First, each time the number of 3D video frames F_{3D}k counted from the top is incremented by 12 (k=1, 13, 25 . . . ), the display type TYL=“9” is set in a base-view VAU. On the other hand, each time the number of 3D video frames F_{3D}k counted from the 7^{th} frame is incremented by 12 (k=7, 19, 31 . . . ), the display type TYR=“9” is set in a dependent-view VAU. The display type TYL=“8” is set in all the other VAUs. With such settings, as shown in FIG. 7B, the following operation is performed each time the number of 3D video frames F_{3D}k counted from the top is incremented by “6” (k=1, 7, 13, 19, . . . ). During the presentation period of a 3D video frame F_{3D}k having such a number (k=1, 7, 13, 19, . . . ), one of a left-view frame F_{L}k and a right-view frame F_{R}k is displayed twice and the other is displayed three times; the frames F_{L}k and F_{R}k are alternately displayed at the intervals of 1/100 seconds. During the presentation period of each of the other 3D video frames F_{3D}m (m≠k), a left-view frame F_{L}k and a right-view frame F_{R}k are each displayed twice and alternately at the intervals of 1/100 seconds. As a result, as shown in FIG. 7B, each of the first 3D video frame F_{3D}1 and the 7^{th} 3D video frame F_{3D}7 has presentation time of 1/100 seconds×5 frames=0.05 seconds, which is longer than the presentation time of each remaining frame F_{3D}k (k=2, 3 . . . 6, 8), i.e. 1/100 seconds×4 frames=0.04 seconds. However, the difference in presentation time is reduced to as short as the presentation time of one left-view frame or right-view frame, which is 1/100 seconds=0.01 seconds, and therefore a viewer can hardly notice the difference in presentation time between adjacent 3D video frames F_{3D}k. In this way, any 3D video frame has substantially equal presentation time, and therefore the motion of 3D video images can be more smoothly expressed.

FIG. 65 illustrate an example in which the scanning method is assumed to be progressive scan. However, even if the scanning method is interlacing scan, the frame rate (field period) can be converted in a similar manner as described below.

FIG. 66 are schematic diagrams showing change in field period when the playback device 102 transmits left-view frames and right-view frames at the frame rate= 1/60 fps. As shown in FIG. 66A, the presentation time of 3D video frames F_{3D}k (k=1, 2, 3, 4 . . . ) in content are set to 1/24 sec. Furthermore, the display types TYL set in base-view VAUs change cyclically, “4”, “5”, “6”, “7”, “4”, “5” . . . , starting from the first 3D video frame F_{3D}1. Similarly, the display types TYR set in dependent-view VAUs change cyclically, “7”, “4”, “5”, “6”, “7”, “4” . . . , starting from the first 3D video frame F_{3D}1. When the display type=“4” is set, the picture switch 5707 transfers the odd-numbered lines of one frame, the even-numbered lines of the frame, and again the odd-numbered lines of the frame in order, from the DPB 5705 to one of the primary video plane memories 5720 and 5721. When the display type=“6” is set, the transfer order differs; the even-numbered lines of one frame, the odd-numbered lines of the frame, and again the even-numbered lines of the frame are transferred in order. When the display type=“5” is set, the picture switch 5707 transfers the odd-numbered lines of one frame and the even-numbered lines of the frame in order, from the DPB 5705 to one of the primary video plane memories 5720 and 5721. When the display type=“7” is set, the transfer order differs; the odd-numbered lines of one frame and then the even-numbered lines of the frame are transferred in order. As a result of the frame transfer by the picture switch 5707 in the manner described above, the playback device 102 divides each of a left-view frame and a right-view frame that constitute one 3D video frame F_{3D}k into top fields TF_{L}k and TF_{R}k and bottom fields BF_{L}k and BF_{R}k, as shown in FIG. 66B. Note that a top field is composed of odd-numbered lines of one frame, whereas a bottom field is composed of even-numbered lines of one frame.

As shown in FIG. 66B, to start with the first 3D video frame F_{3D}1, the playback device 102 first multiplexes the top field TF_{L}1 of the left-view frame and the top field TF_{R}1 of the right-view frame into one frame shown in FIG. 4A and transmits the multiplexed frame for 1/60 seconds. Next, the playback device 102 transmits the bottom fields BF_{L}1 and BF_{R}1 of the respective frames for 1/60 seconds in a similar manner. Subsequently, the playback device 102 multiplexes the top field TF_{L}1 of the left-view frame constituting the first 3D video frame F_{3D}1 and the top field TF_{R}2 of the right-view frame constituting the next 3D video frame F_{3D}2 into one frame shown in FIG. 4A and transmits the multiplexed frame for 1/60 seconds. Further, the playback device 102 transmits the bottom fields BF_{L}2 and BF_{R}2 of the left-view and right-view frames together constituting the second 3D video frame F_{3D}2 for 1/60 seconds, and subsequently transmits the top fields TF_{L}2 and TF_{R}2 of the respective frames for 1/60 seconds. Thereafter, the playback device 102 transmits a pair of bottom fields BF_{L}3 and BF_{R}3 and a pair of top fields TF_{L}3 and TF_{R}3 of the left-view and right-view frames constituting the third 3D video frame F_{3D}3 in order for 1/60 seconds each. The playback device 102 then transmits the bottom field BF_{L}3 of the left-view frame constituting the third 3D video frame F_{3D}3 and the bottom field BF_{R}4 of the right-view frame constituting the fourth 3D video frame F_{3D}4 for 1/60 seconds. The playback device 102 then transmits a pair of top fields TF_{L}3 and TF_{R}3 and a pair of bottom fields BF_{L}3 and BF_{R}3 of the left-view and right-view frames constituting the fourth 3D video frame F_{3D}4 in order for 1/60 seconds each. Similarly, the subsequent frames are transmitted on a field-by-field basis.

The display device 103 extracts a pair of top fields TF_{L}k and TF_{R}k or a pair of bottom fields BF_{L}k and BF_{R}k of a left-view frame and a right-view frame from one frame data received from the playback device 102. The display device 103 then alternately displays the received frames F_{L}k, F_{R}k, BF_{L}k, and BF_{R}k at twice as high as the frame rate=60 fps at which the frames are transmitted from the playback device 102, i.e. at 120 fps. Consequently, as shown in FIG. 66C, during the presentation period of the first 3D video frame F_{3D}1, the top field TF_{L}1 of the left-view frame, the top field TF_{R}1 of the right-view frame, the bottom field BF_{L}1 of the left-view frame, and the bottom field BF_{R}1 of the right-view frame are displayed in order for 1/120 seconds each. Subsequently, the top field TF_{L}1 of the left-view frame is displayed again for 1/120 seconds. During the presentation period of the second 3D video frame F_{3D}2, the top field TF_{R}2 of the right-view frame, the bottom field BF_{L}2 of the left-view frame, the bottom field BF_{R}2 of the right-view frame, and the top field TF_{R}2 of the left-view frame are displayed in order for 1/120 seconds each. Subsequently, the top field TF_{R}2 of the right-view frame is displayed again for 1/120 seconds. Similarly, during the presentation period of each of the third and fourth 3D video frames F_{3D}3 and F_{3D}4, top and bottom fields are alternately displayed once each and then the bottom field BF_{L}3 or BF_{R}4 is displayed again. In this case, a viewer sees as if a 3D video frame F_{3D}k is replaced with the next frame each time five fields of left-view and right-view frames are transmitted in total. That is, the presentation time of each 3D video frame F_{3D}k is equal to 1/120 seconds×5 frames≈0.42 seconds. In this way, each 3D video frame has substantially equal presentation time even if the scanning method is interlacing scan, and therefore the motion of 3D video images can be more smoothly expressed.

FIG. 66 illustrate an example in which the progressive scan illustrated in FIG. 65 is modified to interlacing scan. Similarly, the progressive scan illustrated in FIG. 7 may be modified to interlacing scan. Furthermore, by extending the display type, the progressive scan illustrated in FIG. 8 may be modified to interlacing scan.

<Modifications>

(A) As shown in FIGS. 6-8, when displaying a pair of left-view frame F_{L}k and right-view frame F_{R}k constituting one frame F_{3D}k (k=1, 2, 3, 4 . . . ) of 3D video images, the display device 103 according to the embodiments of the present invention displays the left-view frame F_{L}k first. Alternatively, the right-view frame F_{R}k may be displayed first. Specifically, the process of displaying the frame F_{3D}k of 3D video images shown in FIG. 9 may be modified by reversing the processing steps performed according to a determination result of step S93 as follows. When the determination in step S93 results in “Yes”, that is, when the frame number NF_{LR} of the left-view/right-view is an even number, step S94N is performed to display the right-view frame that is equal in the order from the first frame to the frame number NF_{3D} of 3D video images. When the determination in step S93 results in “No”, that is, when the frame number NF_{LR} of the left-view/right-view is an odd number, step S94Y is performed to display the left-view frame that is equal in the order from the first frame to the frame number NF_{3D} of 3D video images.

(B) In the patens shown in FIGS. 6-8, the left-view frame F_{L}k is switched immediately to the right-view frame F_{R}k, and vice versa. Alternatively, a period for frame switching may be additionally provided between the presentation periods of a left-view frame F_{L}k and right-view frame F_{R}k (hereinafter, such a period may be referred to as frame switching period). The “frame switching period” refers to a period provided when a specific frame is switched to the next frame and during such a period, the entire screen is darkened uniformly and pixel data of the next frame is written to the display panel. Provision of frame switching periods is effective to remove afterimages of the previous frame from the next frame (i.e. crosstalk).

FIG. 77A is a schematic diagram showing the presentation time of each 3D video frame F_{3D}k included in content. FIG. 77B is a schematic diagram showing a sequence of left-view frames F_{L}k and right-view frames F_{R}k (k=1, 2, 3 . . . ) that has a frame rate of 120 fps. The schematic diagram also shows frame switching periods F_{LR}k and F_{RL}k provided between the frames. FIG. 77C is a schematic diagram showing periods LSL and LSR during which the shutter glasses 104 controls the left and right lenses to be alternately transparent in sync with the periods F_{L}k, F_{R}k, F_{LR}k and F_{RL}k shown in FIG. 77B. As shown in FIG. 77A, the presentation time per 3D video frame F_{3D}k in the content is set to 1/24 seconds. To alternately display the left-view frames F_{L}k and right-view frame F_{R}k of the frame sequence F_{3D}k at the intervals of 1/120 seconds, the signal processing unit 220 controls the display unit 240 to alternately display the respective frames as shown in FIG. 77B and also controls the left/right signal transmitting unit 132 to alternately make the left and right lenses of the shutter glasses 104 transparent as shown in FIG. 77C. More specifically, the signal processing unit 220 first controls the display unit 240 to display the first left-view frame F_{L}1 for half the period of 1/120 seconds, i.e. for 1/240 seconds. In parallel, the signal processing unit 220 controls the left/right signal transmitting unit 132 to cause only the left lens of the shutter glasses 104 to be transparent. As a consequence, the first left-view frame F_{L}1 is perceived only by the left eye of the viewer. Next, the signal processing unit 220 provides the frame switching period F_{LR}1 for half the period of 1/120 seconds, i.e. for 1/240 seconds. During the switching period F_{LR}1, the display unit 240 writes pixel data of the first right-view frame F_{R}1 to the display panel 242. In parallel, the signal processing unit 220 controls the left/right signal transmitting unit 132 to cause both the lenses of the shutter glasses 104 to be non-transparent. Consequently, during the frame switching period F_{LR}1, no image on the display panel 242 is perceived by the viewer. The signal processing unit 220 may control the display unit 240 to turn off the backlight of the display panel 242. Next, the signal processing unit 220 controls the display unit 240 to display the first right-view frame F_{R}1 for 1/240 seconds. In parallel, the signal processing unit 220 controls the left/right signal transmitting unit 132 to cause only the right lens of the shutter glasses 104 to be transparent. As a consequence, the first right-view frame F_{R}1 is perceived only by the right eye of the viewer. Next, the signal processing unit 220 provides the frame switching period F_{RL}1 for 1/240 seconds. During the switching period F_{RL}1, the display unit 240 writes pixel data of the first left-view frame F_{L}1 to the display panel 242. In parallel, the signal processing unit 220 controls the left/right signal transmitting unit 132 to cause both the lenses of the shutter glasses 104 to be non-transparent. Consequently, during the frame switching period F_{RL}1, no image on the display panel 242 is perceived by the viewer. The above operations are repeated until the frame number NF_{SW} of the frame to be switched exceeds the switching grid GRD=120/24=5. In the example shown in FIG. 77, when the value of the frame number NF_{SW} reaches “6”, the frame to be switched is changed from the first right-view frame F_{R}1 to the second right-view frame F_{R}2. In this way, during the presentation period of the first frame F_{3D}1 of the 3D video images, the left-view frame F_{L}1 is displayed three times but the right-view frame F_{R}1 is displayed only twice. However, in the viewer's view, each frame F_{3D}k of 3D video images is switched to the next frame after a total of five frames of left-view and right-view frames F_{L}k and F_{R}k is presented. That is, the presentation time of each 3D video frame F_{3D}k is equal to 1/120 seconds×5 frames≈0.42 seconds.

In this way, even if frame switching periods are provided between the presentation periods of frames, the 3D video images are ensured to present smooth motions. The same holds with respect to the patterns shown in FIGS. 7 and 8. That is, by reducing the presentation period of each frame by half and providing frame switching periods each equal to a half the presentation period, the presentation times of frames of 3D video images are still made substantially uniform.

(C) As shown in FIGS. 7 and 8, the total number of times the left-view frame and right-view frame in one frame of 3D video images may be different from that of another frame. In such a case, a modification may be made to designate which frame of 3D video images is to be different in the total number of times. For example, in FIG. 7, the pattern of “5 frames→4 frames→4 frames . . . ” may be modified to the pattern of “4 frames→4 frames→ . . . →4 frames→5 frames→ . . . ”. In another example, in FIG. 8, the pattern of “8 frames→7 frames→8 frames→ . . . ” may be modified to the pattern of “7 frames→8 frames→7 frames→ . . . ”. Such a modification is realized by changing the processing of displaying frames of 3D video images shown in FIG. 9 in the following manner. Instead of step S96 of determining “whether the left-view/right-view frame number NF_{LR} is greater than or equal to the frame number NF_{SW}, of the frame to be switched (NF_{LR}≧NF_{SW}), it is determined “whether the value obtained by adding “1” to the frame number NF_{LR} is greater than or equal to the frame number NF_{SW} (NF_{LR}+1≧NF_{SW})”. If the determination results in “Yes, processing proceeds step S97. If “No”, processing is repeated from step S93.

(D) The embodiments of the present invention are described on the assumption that the frame rate FR_{3D} of 3D video images is equal to 24 fps. Strictly speaking, however, the frame rate FR_{3D} of 3D video images are often equal to 24000/1001=23.976 fps. In such a case, the pattern shown in FIG. 6 is duly realized by setting the frame rate of left-view frame F_{L}k and right-view frame F_{R}k to be equal to 59.94 fps×2. Similarly, the patterns shown in FIGS. 7 and 8 can be duly realized.

(E) As shown in FIG. 76D, the playback device 102 may send the left-view frame and right-view frame for the same number of times in each frame period of 3D video images at the intervals of 1/60 seconds, for example. In that case, the playback device 102 may notify the display device 103 of the display type of each frame via the HDMI cable 122. In that case, the display device 103 adjusts the timing of switching frames of 3D video images to be different between the left-view frame and right-view frame, according to the display type of a corresponding frame. For example, the presentation period of the first frame F_{3D}1 of 3D video images is switched to the presentation period of the next frame F_{3D}2 of the 3D video images, after the first left-view frame F_{L}1 is displayed for the third time. As a result, the first right-view frame F_{R}1 is displayed only twice. For the other frames of the 3D video images, the display device 103 performs similar control. As a result of such control, the left-view frames and right-view frames are displayed in the pattern shown in FIG. 65C. In a similar manner, the frame sequence shown in FIG. 76D can be displayed as the field sequence shown in FIG. 66C.

(F) With reference to FIG. 65A showing the 3D VAUs containing the frames F_{3D}1, 2, 3 . . . of 3D video images, it is noted that the display type TYL or TYR is set in VAUs of both the base view and dependent view. Alternatively, the display type may be set only in VAUs of the base view or of dependent view. In that case, the display type of the VAUs of the other view is set by the 3D playback device. For example, suppose that the display type TYL=“9” is set only in the VAUs of the base view. In that case, the 3D playback device sets the display type TYL of the left-view frames to “9” and also sets the display type TYR of the right-view frames to “8”. Conversely, suppose that the display type TYL=“8” is set only in the VAUs of base-view. In that case, the 3D playback device sets the display type TYL of the left-view frames to “8” and also sets the display type TYR of the right-view frames to “9”. Similarly, the 3D playback device may store in advance combinations of display types that would realize the patterns shown in FIGS. 66, 7, and 8. With reference to this information, the 3D playback device can determine the display type of the other of the left-view or right-view frames based on the display type set for either of the left-view or right-view frames.

(G) As shown in FIG. 62A, the display type embedded in a video stream may hold the value, for example, of “4” or “5”, which defines a display pattern in units of fields. In such a case, the display device 103 can analyze the field structure of the video stream according to the display type. In particular, the display device 103 can reconstruct the top field and bottom field back into one frame. Accordingly, the display device 103 can change the field-by-field basis display defined by a specific display type to the frame-by-frame basis display. In other words, the display device 103 can change the interlaced display to the progressive display.

(H) In the example shown in FIG. 1, the playback device 102 and the display device 103 are separate independent devices. Alternatively, the playback device 102 may be integrally combined with the display device 103. In addition, as shown in FIG. 2, the display device 103 may acquire stream data of 3D video images not only from the BD-ROM disc 101, but also from various recording media, including the memory card 201, external network 202, and broadcast wave 203. In such a case, the receiving unit 210 of the display device 103 includes interfaces appropriate for the respective media. In particular, the display device 103 has the same structure as the playback unit 5402 of the 3D playback device shown in FIG. 54 and decodes stream data acquired from each medium into left-view frames and right-view frames, etc.

(I) The display device 103 according to the embodiments of the present invention reproduces 3D video images according to the stream data read by the playback device 102 from the BD-ROM disc 101. Alternatively, the display device 103 may reproduce 3D video images according to stream data transmitted over the external network 202 or by the broadcast wave 203, as shown in FIG. 2. In such a case, the stream data is transmitted from a transmission device such as following.

FIG. 67 is a functional block diagram of a transmission device 6700. As shown in FIG. 67, the transmission device 6700 includes a format conversion unit 6701 and a transmitting unit 6702. The format conversion unit 6701 receives stream data STD from an external source and converts STD into a predetermined transmission format. The stream data STD has a data structure according to Embodiment 1 shown in FIGS. 11-19. The stream data STD may further include the supplementary data 6201 shown in FIG. 62A. The supplementary data 6201 indicates the display type 6202. The transmitting unit 6702 distributes the stream data converted by the format conversion unit 6701 on the broadcast wave 203 from an antenna or over the external network 202 such as the Internet.

(J) In L/R mode according to the embodiments of the present invention, the base-view video stream represents the left view, and the dependent-view video stream represents the right view. Conversely, however, the base-view video stream may represent the right view and the dependent-view video stream the left view. On the BD-ROM disc 101 according to the embodiments of the present invention, the base-view video stream and the dependent-view video stream are multiplexed in different TSs. Alternatively, the base-view video stream and the dependent-view video stream may be multiplexed into a single TS.

(K) The offset metadata shown in FIG. 19 is stored in the dependent-view video stream. Alternatively, offset metadata may be stored in the base-view video stream. In this case as well, the offset metadata is preferably stored in the supplementary data in the VAU located at the top of each video sequence. Furthermore, the 3D playlist file may be provided with a flag indicating whether the base-view video stream or the dependent-view video stream includes the offset metadata. This allows for an increase in the degree of freedom when creating each piece of stream data. Alternatively, the offset metadata may be stored in each VAU (i.e. each frame or field) instead of only being stored in the top VAU in each video sequence (i.e. each GOP). Alternatively, offset metadata may be set at arbitrary intervals, such as three frames or greater, for each content. In this case, it is preferable that offset metadata always be stored in the top VAU in each video sequence and that the interval between the offset metadata and the immediately prior offset metadata be restricted to three frames or greater. Accordingly, the playback device can reliably perform processing to change offset information in parallel with interrupt playback.

Instead of being stored in the video stream, offset metadata may be multiplexed in a main TS or a sub-TS as independent stream data. In this case, a unique PID is allocated to the offset metadata. The system target decoder refers to this PID to separate the offset metadata from other stream data. Thereafter, the offset metadata may first be preloaded into a dedicated buffer and later undergo playback processing. In this case, the offset metadata is stored at constant frame intervals. Accordingly, a PTS is not necessary for the offset metadata, thus reducing the data amount of the PES header. This reduces the capacity of the buffer for preloading. Note that the offset metadata may be stored in a playlist file.

(L) As shown in FIG. 23, the base-view data blocks and dependent-view data blocks are recorded in an interleaved arrangement on the BD-ROM disc 101. In general, the extent ATC times are the same between a pair of contiguous data blocks. For pairs of data blocks with equal extent ATC times, i.e. extent pairs, the playback period may also match, and the playback time of the video stream may be equal. In other words, the number of VAUs may be equal between these data blocks in any extent pair. The significance of such equality is explained below.

FIG. 68A is a schematic diagram showing a playback path when extent ATC times and playback times of the video stream differ between contiguous base-view data blocks and dependent-view data blocks. As shown in FIG. 68A, the playback time of the top base-view data block B[0] is four seconds, and the playback time of the top dependent-view data block D[0] is one second. In this case, the section of the base-view video stream that is necessary for decoding of the dependent-view data block D[0] has the same playback time as the dependent-view data block D[0]. Accordingly, to save read buffer capacity in the playback device, it is preferable, as shown by the arrow ARW1 in FIG. 68A, to have the playback device alternately read the base-view data block B[0] and the dependent-view data block D[0] by the same amount of playback time, for example one second at a time. In that case, however, as shown by the dashed lines in FIG. 68A, jumps occur during read processing. As a result, it is difficult to cause read processing to keep up with decoding processing, and thus it is difficult to stably maintain seamless playback.

FIG. 68B is a schematic diagram showing a playback path when the playback times of the video stream are equal for contiguous base-view and dependent-view data blocks. As shown in FIG. 68B, the playback time of the video stream between two contiguous data blocks may be the same. For example, for the pair of the top data blocks B[0] and D[0], the playback times of the video stream both equal one second, and the playback times of the video stream for the second pair of data blocks B[1] and D[1] both equal 0.7 seconds. In this case, during 3D playback mode, the playback device reads data blocks B[0], D[0], B[1], D[1], . . . in order from the top, as shown by arrow ARW2 in FIG. 68B. By simply reading these data blocks in order, the playback device can smoothly read the main TS and sub-TS alternately in the same increments of playback time. In particular, since no jump occurs during read processing, seamless playback of 3D video images can be stably maintained.

If the extent ATC time is actually the same between contiguous base-view and dependent-view data blocks, jumps do not occur during reading, and synchronous decoding can be maintained. Accordingly, even if the playback period or the playback time of the video stream are not equal, the playback device can reliably maintain seamless playback of 3D video images by simply reading data block groups in order from the top, as in the case shown in FIG. 68B.

The number of any of the headers in a VAU, as well as the number of PES headers, may be equal between data blocks in an extent pair. These headers are used to synchronize decoding between data blocks in an extent pair. Accordingly, if the number of headers is equal between data blocks in an extent pair, it is relatively easy to maintain synchronous decoding, even if the number of VAUs is not equal. Furthermore, unlike when the number of VAUs is equal, all of the data in the VAUs need not be multiplexed in the same data block. Therefore, there is a high degree of freedom for multiplexing stream data during the authoring process of the BD-ROM disc 101.

In other words, the number of VAUs may be equal between such data blocks in an extent pair. That is, the file base and file DEP may be set so that the extents EXT1[k] and EXT2[k], located at the same position in the respective files in the order from the top, have the same number of entry points. Whether jumps are present differs between 2D playback mode and 3D playback mode. When the number of entry points is equal between data blocks, however, the playback time is substantially equal. Accordingly, it is easy to maintain synchronous decoding regardless of jumps. Furthermore, unlike when the number of VAUs is equal, all of the data in the VAUs need not be multiplexed in the same data block. Therefore, there is a high degree of freedom for multiplexing stream data during the authoring process of the BD-ROM disc 101.

(M) An AV stream file representing 3D video images may additionally include a 3D descriptor in the PMT 2210 shown in FIG. 22. The “3D descriptors” are information on the playback format of 3D video images, are shared by the entire AV stream file, and particularly include 3D format information. The “3D format information” indicates the playback format, such as L/R mode or depth mode, of the 3D video images in the AV stream file. Furthermore, a 3D stream descriptor may be added to each piece of stream information 2203 included in the PMT 2210. Each “3D stream descriptor” indicates information on the playback format of 3D video images for each elementary stream included in the AV stream file. In particular, the 3D stream descriptors of the video stream include a 3D display type. The “3D display type” indicates whether the video images indicated by the video stream are a left view or a right view when the video images are displayed in L/R mode. The 3D display type also indicates whether the video images indicated by the video stream are 2D video images or depth maps when the video images are played back in depth mode. When the PMT 2210 thus includes information regarding the playback format of 3D video images, the playback system of these video images can acquire such information simply from the AV stream file. This sort of data structure is therefore useful when distributing 3D video image content via a broadcast wave.

(N) The dependent-view clip information file may include a predetermined flag in the video stream attribute information allocated to PID=0x1012, 0x1013 of the dependent-view video stream. When turned on, this flag indicates that the dependent-view video stream refers to the base-view video stream. Furthermore, the video stream attribute information may include information regarding the base-view video stream to which the dependent-view video stream refers. This information can be used to confirm the correspondence between video streams when verifying, via a predetermined tool, whether the 3D video image content has been created in accordance with a prescribed format.

In Embodiment 1 of the present invention, the size of base-view extents and dependent-view extents can be calculated from the extent start points included in the clip information file. Alternatively, a list of the sizes of the respective extents may be stored in, for example, the clip information file as part of the metadata.

(O) The 3D playlist file 1022 shown in FIG. 41 includes one sub-path 4102. Alternatively, the 3D playlist file may include a plurality of sub-paths. For example, if the sub-path type of one sub-path is “3D•L/R”, then the sub-path type of the other sub-path may be “3D•depth”. When 3D video images are played back in accordance with the 3D playlist file, the sub-path to be played back is switched between these two types of sub-paths, so that the playback device 102 can easily switch between L/R mode and depth mode. In particular, such switching can be performed more rapidly than switching the 3D playlist file itself.

Alternatively, the 3D playlist file may include a plurality of sub-paths of the same sub-path type. For example, when 3D video images for the same scenes but with different binocular parallax are expressed based on differences with a common left view, a plurality of files DEP representing different right views are recorded on the BD-ROM disc 101. In this case, the 3D playlist file includes a plurality of sub-paths with the sub-path type “3D•L/R”. These sub-paths separately specify playback paths of different files DEP. When 3D video images are played back according to the 3D playlist file, the sub-path to be played back is promptly switched in response, for example, to a user operation, which ensures the binocular parallax to be changed without causing any substantial interruption in 3D video images. This configuration easily allows the user to select 3D video images with a desired binocular parallax.

In the 3D playlist file 1022 shown in FIG. 41, the base-view video stream is registered in the STN table in the main path 4101, and the dependent-view video stream is registered in the STN table SS 4130 in the extension data 4103. Alternatively, the dependent-view video stream may be registered in the STN table. In that case, the STN table may include a flag indicating which of the base view and the dependent view is represented by the registered video stream.

According to Embodiment 1 of the present invention, 2D playlist files and 3D playlist files are stored separately in the BD-ROM disc 101. Alternatively, in a similar manner to the extension data 4103, the sub-path 4102 shown in FIG. 41 may be recorded in an area that is referenced only by the playback device 102 in the 3D playback mode. In that case, the 3D playlist files as they are can be used as the 2D playlist files since there is no risk that the sub-path 4102 causes the playback device 102 in the 2D playback mode to malfunction. As a result, the authoring of the BD-ROM disc is simplified.

(P) The index file 1011 shown in FIG. 45 includes a 3D existence flag 4520 and a 2D/3D preference flag 4530 that is shared by all titles. Alternatively, the index file may set a different 3D existence flag or 2D/3D preference flag for each title.

(Q) In the 3D playback device, in addition to the setting of parental level in SPRM(13), 3D parental level may be set in SPRM(30). The 3D parental level indicates the minimum age of viewers of 3D playback device for which viewing of 3D video images is permitted and is used for parental control of viewing of 3D video titles recorded on the BD-ROM disc 101. Similarly to the value of the SPRM(13), the user of the 3D playback device sets the value of SPRM(30) via, for example, an OSD of the 3D playback device. The following is an example of how the 3D playback device performs parental control on each title of 3D video images. The 3D playback device first reads, from the BD-ROM disc 101, the restricted age for viewing of 2D video images and compares this age with the value of the SPRM(13). The restricted age indicates the minimum age of viewers for which viewing of the title in 2D playback mode is permitted. If the restricted age is greater than the value of the SPRM(13), the 3D playback device stops playback of the title. If this age is equal to or less than the value of the SPRM(13), the 3D playback device then reads, from the BD-ROM disc 101, the restricted age for which viewing of a title in the 3D playback mode is permitted and compares this age with the value of the SPRM(30). The restricted age indicates the minimum age of viewers for which viewing of the title in 3D playback mode is permitted. If the restricted age is equal to or less than the value of the SPRM(30), the 3D playback device plays back the title in 3D playback mode. If the restricted age is greater than the value of the SPRM(30), the 3D playback device plays back the title in 2D playback mode. In this way, the difference in viewer's interpupillary distance by the age taken into account, it is possible to realize a parental control so that, for example, “children whose ages are less than a predetermined value can view 3D video images only as 2D video images”. Preferably the parental control is performed when it is determined that “the display device supports playback of 3D video images” in the processing of selecting a playlist file for playback shown in FIG. 46, namely when the determination in step S4605 results in “Yes”. Note that a value indicating permission/prohibition of 3D playback mode may be set in SPRM(30) instead of the restricted age, and the 3D playback device may determine whether the 3D playback mode is valid or invalid in accordance with the value.

(R) In the 3D playback device, a value indicating “which of 2D playback mode and 3D playback mode is to be prioritized” may be set in SPRM(31). A user of the 3D playback device sets the value of the SPRM(31) via, for example, an OSD of the 3D playback device. In step S4603 in the processing of selecting a playlist file for playback shown in FIG. 46, the 3D playback device refers to the SPRM(31) as well as the 2D/3D preference flag. When both the SPRM(31) and 2D/3D preference flag indicate the 2D playback mode, the 3D playback device selects the 2D playback mode. When both the SPRM(31) and 2D/3D preference flag indicate the 3D playback mode, the 3D playback device proceeds to step S4605 to perform the HDCP authentication, without displaying the playback mode selection screen. As a result, when the display device supports the 3D video images, the 3D playback device selects the 3D playback mode. When the SPRM(31) and 2D/3D preference flag indicate different playback modes, the 3D playback device executes step S4604, i.e. displays the playback mode selection screen to have the user select a playback mode. Alternatively, the 3D playback device may have the application program select a playback mode. In this way, even if the 2D/3D preference flag is set in the 3D video content, it is possible to have the user select a playback mode only when the playback mode indicated by the 2D/3D preference flag does not match the playback mode indicated by the SPRM(31) which is the playback mode having been set by the user in advance.

An application program such as a BD-J object may select a playback mode by referring to the SPRM(31). Furthermore, the application program may determine the initial state of the menu to be displayed on the selection screen depending on the value of the SPRM(31), when causing a user to select a playback mode at step S4604. For example, when the value of the SPRM(31) indicates that the 2D playback mode has a high priority, the menu is displayed in the state in which a cursor is positioned on a button for selecting the 2D playback mode; when the value of the SPRM(31) indicates that the 3D playback mode has a high priority, the menu is displayed in the state in which the cursor is positioned on a button for selecting the 3D playback mode. Alternatively, when the 3D playback device has a function to manage the accounts of a plurality of users such as a father, a mother, and a child, the 3D playback device may set a value to the SPRM(31) depending on the account of a user who is logged in at the current time.

The value of the SPRM(31) may indicate “which of 2D playback mode and 3D playback mode is to be always set”, in addition to “which of 2D playback mode and 3D playback mode is to be prioritized”. When the value of the SPRM(31) indicates “2D playback mode is to be always set”, the 3D playback device always selects the 2D playback mode irrespectively of the value of the 2D/3D preference flag. In that case, the value of the SPRM(25) is set to indicate the 2D playback mode. When the value of the SPRM(31) indicates “3D playback mode is to be always set”, the 3D playback device performs the HDCP authentication without displaying the playback mode selection screen irrespectively of the value of the 2D/3D preference flag. In that case, the value of the SPRM(25) is set to indicate the 3D playback mode (L/R mode or depth mode). In this way, even if the 2D/3D preference flag is set in the 3D video content, it is possible to allow the playback mode having been set by the user in advance to be always prioritized.

### Embodiment 3

The following describes, as Embodiment 3 of the present invention, a device and method for recording data on the recording media of Embodiments 1 and 2 of the present invention. The recording device described here is called an authoring device. The authoring device is generally located at a creation studio and used by authoring staff to create movie content to be distributed. First, in response to operations by the authoring staff, the recording device converts movie content into AV stream files using a predetermined compression encoding method. Next, the recording device generates a scenario. A “scenario” is information defining how each title included in the movie content is to be played back. Specifically, a scenario includes dynamic scenario information and static scenario information. Then, the recording device generates a volume image for a BD-ROM disc from the AV stream files and scenario. Lastly, the recording device records the volume image on the recording medium.

FIG. 69 is a functional block diagram of a recording device 6900. As shown in FIG. 69, the recording device 6900 includes a database unit 6901, video encoder 6902, material creation unit 6903, scenario generation unit 6904, BD program creation unit 6905, multiplex processing unit 6906, and format processing unit 6907.

The database unit 6901 is a nonvolatile storage device embedded in the recording device and is in particular a hard disk drive (HDD). Alternatively, the database unit 6901 may be an external HDD connected to the recording device, or a nonvolatile semiconductor memory device internal or external to the recording device.

The video encoder 6902 receives video data, such as uncompressed bit map data, from the authoring staff and compresses the received video data in accordance with a compression encoding method such as MPEG-4 AVC or MPEG-2. This process converts primary video data into a primary video stream and secondary video data into a secondary video stream. In particular, 3D video image data is converted into a pair of a base-view video stream and a dependent-view video stream, as shown in FIG. 15, using a multiview coding method such as MVC. In other words, the video frame sequence representing the left view is converted into a base-view video stream via inter-picture predictive encoding on the pictures in these video frames. On the other hand, the video frame sequence representing the right view is converted into a dependent-view video stream via predictive encoding on not only the pictures in these video frames, but also the base-view pictures. Note that the video frames representing the right view may be converted into a base-view video stream, and the video frames representing the left view may be converted into a dependent-view video stream. The converted video streams 6912 are stored in the database unit 6901.

During the process of inter-picture predictive encoding, the video encoder 6902 detects motion vectors between individual images in the left view and right view and calculates depth information of each 3D video image based on the detected motion vectors. FIGS. 70A and 70B are schematic diagrams respectively showing a picture in a left view and a right view used to display one scene of 3D video images, and FIG. 70C is a schematic diagram showing depth information calculated from these pictures by the video encoder 6902.

The video encoder 6902 compresses left-view and right-view pictures using the redundancy between the pictures. In other words, the video encoder 6902 compares both uncompressed pictures on a per-macroblock basis, i.e. per matrices of 8×8 or 16×16 pixels, so as to detect a motion vector for each image in the two pictures. Specifically, as shown in FIGS. 70A and 70B, a left-view picture 7001 and a right-view picture 7002 are first each divided into a matrix of macroblocks 7003. Next, the areas occupied by the image data in picture 7001 and picture 7002 are compared for each macroblock 7003, and a motion vector for each image is detected based on the result of the comparison. For example, the area occupied by image 7004 showing a “house” in picture 7001 is substantially the same as that in picture 7002. Accordingly, a motion vector is not detected from these areas. On the other hand, the area occupied by image 7005 showing a “circle” in picture 7001 is substantially different from the area in picture 7002. Accordingly, a motion vector of the image 7005 is detected from these areas.

The video encoder 6902 uses the detected motion vector to compress the pictures 7001 and 7002. On the other hand, the video encoder 6902 uses the motion vector to calculate the binocular parallax of the each image, such as the “house” image 7004 and “circle” image 7005. The video encoder 6902 further calculates the depth of each image from the image's binocular parallax. The information indicating the depth of each image may be organized into a matrix 7006 the same size as the matrix of the macroblocks in pictures 7001 and 7002, as shown in FIG. 70C. In this matrix 7006, blocks 7007 are in one-to-one correspondence with the macroblocks 7003 in pictures 7001 and 7002. Each block 7007 indicates the depth of the image shown by the corresponding macroblocks 7003 by using, for example, a depth of 8 bits. In the example shown in FIG. 70, the depth of the image 7005 of the “circle” is stored in each of the blocks in an area 7008 in the matrix 7006. This area 7008 corresponds to the entire areas in the pictures 7001 and 7002 that represent the image 7005.

The video encoder 6902 may set the display type 6202 shown in FIG. 62B for each of the left-view and right-view video frames. The display type 6911 of each frame is stored in the database unit 6901.

When encoding a secondary video stream from 2D video image data, the video encoder 6902 may also create offset information 6910 for a secondary video plane in accordance with operations by the authoring staff. The generated offset information 6910 is stored in the database unit 6901.

The material creation unit 6903 creates elementary streams other than video streams, such as an audio stream 6913, PG stream 6914, and IG stream 6915 and stores the created streams into the database unit 6901. For example, the material creation unit 6903 receives uncompressed LPCM audio data from the authoring staff, encodes the uncompressed LPCM audio data in accordance with a compression encoding method such as AC-3, and converts the encoded LPCM audio data into the audio stream 6913. The material creation unit 6903 additionally receives a subtitle information file from the authoring staff and creates the PG stream 6914 in accordance with the subtitle information file. The subtitle information file defines image data or text data for showing subtitles, display timings of the subtitles, and visual effects to be added to the subtitles, such as fade-in and fade-out. Furthermore, the material creation unit 6903 receives bit map data and a menu file from the authoring staff and creates the IG stream 6915 in accordance with the bit map data and the menu file. The bit map data shows images that are to be displayed on a menu. The menu file defines how each button on the menu is to be transitioned from one status to another and defines visual effects to be added to each button.

In response to operations by the authoring staff, the material creation unit 6903 furthermore creates offset information 6910 corresponding to the PG stream 6914 and IG stream 6915. In this case, the material creation unit 6903 may use the depth information DPI generated by the video encoder 6902 to adjust the depth of the 3D graphics video images with the depth of the 3D video images. In this case, when the depth of the 3D video images changes greatly per frame, the material creation unit 6903 may further process a series of offset values created with use of the depth information DPI in the low-path filter to decrease the change per frame. The offset information 6910 thus generated is stored in the database unit 6901.

The scenario generation unit 6904 creates BD-ROM scenario data 6917 in response to an instruction received from the authoring staff via GUI and then stores the created BD-ROM scenario data 6917 in the database unit 6901. The BD-ROM scenario data 6917 defines methods of playing back the elementary streams 6912-6916 stored in the database unit 6901. Of the file group shown in FIG. 10, the BD-ROM scenario data 6917 includes the index file 1011, the movie object file 1012, and the playlist files 1021-1023. The scenario generation unit 6904 further creates a parameter file PRF and transfers the created parameter file PRF to the multiplex processing unit 6906. The parameter file PRF defines, from among the elementary streams 6912-6915 stored in the database unit 6901, stream data to be multiplexed into the main TS and sub-TS.

The BD program creation unit 6905 provides the authoring staff with a programming environment for programming BD-J objects and Java application programs. The BD program creation unit 6905 receives a request from a user via GUI and creates each program's source code according to the request. The BD program creation unit 6905 further creates a BD-J object file 1051 from the BD-J objects and compresses the Java application programs in the JAR file 1061. The program files BDP are transferred to the format processing unit 6907.

In this context, it is assumed that a BD-J object is programmed in the following way: the BD-J object causes the program execution unit 5434 shown in FIG. 54 to transfer graphics data for GUI to the system target decoder 5423. Furthermore, the BD-J object causes the system target decoder 5423 to process graphics data as image plane data and to output image plane data to the plane adder 5424 in 1 plane+offset mode. In this case, the BD program creation unit 6905 may create offset information 6910 corresponding to the image plane and store the offset information 6910 in the database unit 6901. The BD program creation unit 6905 may use the depth information DPI generated by the video encoder 6902 when creating the offset information 6910.

In accordance with the parameter file PRF, the multiplex processing unit 6906 multiplexes each of the elementary streams 6912-6915 stored in the database unit 6901 to form a stream file in MPEG-2 TS format. More specifically, as shown in FIG. 12, each of the elementary streams 6912-6915 is first converted into a source packet sequence, and the source packets included in each sequence are multiplexed into a single piece of stream data. In this way, the main TS and sub-TS are created. These pieces of multiplexed stream data MSD are output to the format processing unit 6907.

Furthermore, the multiplex processing unit 6906 creates the offset metadata based on the offset information 6910 stored in the database unit 6901. As shown in FIG. 19, the created offset metadata 1910 is stored as the supplementary data 1901 in the top VAU in each video sequence included in the dependent-view video stream. Note that the multiplex processing unit 6906 may process each piece of graphics data to adjust the arrangement of the graphics elements in the left and right video image frames. Consequently, the multiplex processing unit 6906 prevents the 3D graphics images represented by each graphics plane from being displayed as overlapping in the same visual direction as 3D graphics images represented by the other graphics planes. Alternatively, the multiplex processing unit 6906 may adjust the offset value for each graphics plane so that the depths of 3D graphics images do not overlap. On the other hand, the multiplex processing unit 6906 may store the display type 6911, which is stored in the database unit 6901, in the supplementary data 6201 included in each VAU of the base-view video stream and dependent-view video stream as shown in FIG. 62A.

Additionally, the multiplex processing unit 6906 creates a 2D clip information file and a dependent-view clip information file via the following four steps (I) to (IV). (I) Create entry maps 3230 shown in FIG. 33 for the file 2D and file DEP. (II) Using each file's entry map, the extent start points 3242 and 3420 shown in FIGS. 34A and 34B are created. At this point, extent ATC times are aligned between contiguous data blocks. Furthermore, it designs the arrangement of extents so that the sizes of 2D extents, base-view extents, and dependent-view extents satisfy predetermined conditions 1 and 2. (III) Extract the stream attribute information 3220 shown in FIG. 32 from each elementary stream to be multiplexed into the main TS and sub-TS. (IV) As shown in FIG. 32, a combination of an entry map 3230, 3D metadata 3240, and stream attribute information 3220 is associated with a piece of clip information 3210. Each clip information file CLI is thus created and transmitted to the format processing unit 6907.

The format processing unit 6907 creates a BD-ROM disc image 6920 of the directory structure shown in FIG. 10 from (i) the BD-ROM scenario data 6917 stored in the database unit 6901, (ii) a group of program files BDP such as BD-J object files created by the BD program creation unit 6905, and (iii) multiplexed stream data MSD and clip information files CLI generated by the multiplex processing unit 6906. In this directory structure, UDF is used as the file system.

When creating file entries for each of the files 2D, files DEP, and files SS, the format processing unit 6907 refers to the entry maps and 3D metadata included in the 2D clip information files and dependent-view clip information files. The SPN for each entry point and extent start point is thereby used in creating each allocation descriptor. In particular, the value of the LBN and the extent size to be represented by each allocation descriptor are determined so as to express an interleaved arrangement of data blocks like the one shown in FIG. 23. As a result, each base-view data block is shared by a file SS and file 2D, and each dependent-view data block is shared by a file SS and file DEP.

<Recording Method of BD-ROM Disc Image>

FIG. 71 is a flowchart of a method for recording movie content on a BD-ROM disc using the recording device 6900 shown in FIG. 69. This method begins, for example, when power to the recording device 6900 is turned on.

In step S7101, the elementary streams, programs, and scenario data to be recorded on a BD-ROM disc are created. In other words, the video encoder 6902 creates a video stream 6912. The material creation unit 6903 creates an audio stream 6913, PG stream 6914, and IG stream 6915. The scenario generation unit 6904 creates BD-ROM scenario data 6917. These created pieces of data 6912-6917 are stored in the database unit 6901. On the other hand, the video encoder 6902 creates offset information 6910 and display type 6911 and stores these pieces of information in the database unit 6901. The material creation unit 6903 creates offset information 6910 and stores this information in the database unit 6901. The scenario generation unit 6904 creates a parameter file PRF and transfers this file to the multiplex processing unit 6906. The BD program creation unit 6905 creates a group of program files BDP, which include a BD-J object file and a JAR file, and transfers this group BDP to the format processing unit 6907. The BD program creation unit 6905 also creates offset information 6910 and stores this information in the database unit 6901. Thereafter, processing proceeds to step S7102.

In step S7102, the multiplex processing unit 6906 creates offset metadata based on the offset information 6910 stored in the database unit 6901. The created offset metadata is stored in the dependent-view video stream as the supplementary data 1901. Thereafter, processing proceeds to step S7103.

In step S7103, the multiplex processing unit 6906 reads the elementary streams 6912-6915 from the database unit 6901 in accordance with the parameter file PRF and multiplexes these streams into a stream file in MPEG2-TS format. Thereafter, processing proceeds to step S7104.

In step S7104, the multiplex processing unit 6906 creates a 2D clip information file and a dependent-view clip information file. In particular, during creation of the entry map and extent start points, the extent ATC time is aligned between contiguous data blocks. Furthermore, the 2D extents, base-view extents, and dependent-view extents are designed to satisfy predetermined conditions 1 and 2.

Thereafter, processing proceeds to step S7105.

In step S7105, the format processing unit 6907 creates a BD-ROM disc image 6920 from the BD-ROM scenario data 6917, group of program files BDP, multiplexed stream data MDS, and clip information file CLI. Thereafter, processing proceeds to step S7106.

In step S7106, the BD-ROM disc image 6920 is converted into data for BD-ROM pressing. Furthermore, this data is recorded on a master BD-ROM disc. Thereafter, processing proceeds to step S7107.

In step S7107, BD-ROM discs 101 are mass produced by pressing the master obtained in step S7106. Processing thus concludes.

### <<Supplementary Explanation>>

<Principle of 3D Video Image Playback>

Playback methods of 3D video images are roughly classified into two categories: methods using a holographic technique, and methods using parallax video.

A method using a holographic technique is characterized by allowing the viewer to perceive objects in video as stereoscopic by giving the viewer's visual perception substantially the same information as optical information provided to visual perception by human beings of actual objects. A technical theory for utilizing these methods for moving video display has been established. However, it is extremely difficult to construct, with present technology, a computer that is capable of real-time processing of the enormous amount of calculation required for moving video display and a display device having super-high resolution of several thousand lines per 1 mm. Accordingly, at the present time, the realization of these methods for commercial use is hardly in sight.

“Parallax video” refers to a pair of 2D video images shown to each of the viewer's eyes for the same scene, i.e. the pair of a left view and a right view. A method using parallax video is characterized by playing back the left-view and right-view of a single scene so that the viewer sees each view in only one eye, thereby allowing the user to perceive the scene as stereoscopic.

FIGS. 72A, 72B, and 72C are schematic diagrams illustrating the principle behind playback of 3D video images (stereoscopic video images) in a method using parallax video images. FIG. 72A is a top view of the viewer VWR looking at a cube CBC placed directly in front of the viewer's face. FIGS. 72B and 72C are schematic diagrams showing the outer appearance of the cube CBC as a 2D video image as perceived respectively by the left eye LEY and the right eye REY of the viewer VWR. As is clear from comparing FIG. 72B and FIG. 72C, the outer appearances of the cube CBC as perceived by the eyes are slightly different. The difference in the outer appearances, i.e. the binocular parallax allows the viewer VWR to recognize the cube CBC as three-dimensional. Thus, according to a method using parallax video, left and right 2D video images with different viewpoints are first prepared for a single scene. For example, for the cube CBC shown in FIG. 72A, the left view of the cube CBC shown in FIG. 72B and the right view shown in FIG. 72C are prepared. In this context, the position of each viewpoint is determined by the binocular parallax of the viewer VWR. Next, each 2D video image is played back so as to be perceived only by the corresponding eye of the viewer VWR. Consequently, the viewer VWR recognizes the scene played back on the screen, i.e. the video image of the cube CBC, as stereoscopic. Unlike methods using a holography technique, methods using parallax video thus have the advantage of requiring preparation of 2D video images from merely two viewpoints.

Several concrete methods for how to use parallax video have been proposed. From the standpoint of how these methods show left and right 2D video images to the viewer's eyes, the methods are divided into alternate frame sequencing methods, methods that use a lenticular lens, two-color separation methods, etc.

In the alternate frame sequencing method, left and right 2D video images are alternately displayed on a screen for a predetermined time, while the viewer watches the screen using shutter glasses. Each lens in the shutter glasses is formed by a liquid crystal panel, for example. The lenses pass or block light in a uniform and alternate manner in synchronization with switching of the 2D video images on the screen. That is, each lens functions as a shutter that periodically blocks an eye of the viewer. More specifically, while a left-video image is displayed on the screen, the shutter glasses make the left-side lens transmit light and the right-hand side lens block light. Conversely, while a right-video image is displayed on the screen, the shutter glasses make the right-side lens transmit light and the left-side lens block light. As a result, the viewer sees afterimages of the right and left-video images overlaid on each other and thus perceives a single 3D video image.

According to the alternate-frame sequencing method, as described above, right and left-video images are alternately displayed in a predetermined cycle. For example, when 24 video frames are displayed per second for playing back normal 2D video images, 48 video frames in total for both right and left eyes need to be displayed for 3D video images. Accordingly, a display device capable of quickly executing rewriting of the screen is preferred for this method.

In a method using a lenticular lens, a right-video frame and a left-video frame are respectively divided into vertically long and narrow rectangular shaped small areas. The small areas of the right-video frame and the small areas of the left-video frame are alternately arranged in a horizontal direction on the screen and displayed at the same time. The surface of the screen is covered by a lenticular lens. The lenticular lens is a sheet-shaped lens constituted from multiple long and thin hog-backed lenses arranged in parallel. Each hog-backed lens lies in the longitudinal direction on the surface of the screen. When the viewer sees the left and right-video frames through the lenticular lens, only the viewer's left eye perceives light from the display areas of the left-video frame, and only the viewer's right eye perceives light from the display areas of the right-video frame. The viewer thus sees a 3D video image from the binocular parallax between the video images respectively perceived by the left and right eyes. Note that according to this method, another optical component having similar functions, such as a liquid crystal device, may be used instead of the lenticular lens. Alternatively, for example, a longitudinal polarization filter may be provided in the display areas of the left image frame, and a lateral polarization filter may be provided in the display areas of the right image frame. In this case, the viewer sees the screen through polarization glasses. In the polarization glasses, a longitudinal polarization filter is provided for the left lens, and a lateral polarization filter is provided for the right lens. Consequently, the right and left-video images are each perceived only by the corresponding eye, thereby allowing the viewer to perceive 3D video images.

In a method using parallax video, in addition to being constructed from the start by a combination of left and right-video images, the 3D video content can also be constructed from a combination of 2D video images and a depth map. The 2D video images represent 3D video images projected on a hypothetical 2D screen, and the depth map represents the depth of each pixel in each portion of the 3D video images as compared to the 2D screen. When the 3D content is constructed from a combination of 2D video images with a depth map, the 3D playback device or display device first constructs left and right-video images from the combination of 2D video images with a depth map and then creates 3D video images from these left and right-video images using one of the above-described methods.

FIG. 73 is a schematic diagram showing an example of constructing a left-view LVW and a right-view RVW from the combination of a 2D video image MVW and a depth map DPH. As shown in FIG. 73, a circular plate DSC is shown in the background BGV of the 2D video image MVW. The depth map DPH indicates the depth for each pixel in each portion of the 2D video image MVW. According to the depth map DPH, in the 2D video image MVW, the display area DA1 of the circular plate DSC is closer to the viewer than the screen, and the display area DA2 of the background BGV is deeper than the screen. The parallax video generation unit PDG in the playback device first calculates the binocular parallax for each portion of the 2D video image MVW using the depth of each portion indicated by the depth map DPH. Next, the parallax video generation unit PDG shifts the presentation position of each portion in the 2D video image MVW to the left or right in accordance with the calculated binocular parallax to construct the left-view LVW and the right-view RVW. In the example shown in FIG. 73, the parallax video generation unit PDG shifts the presentation position of the circular plate DSC in the 2D video image MVW as follows: the presentation position of the circular plate DSL in the left-view LVW is shifted to the right by half of its binocular parallax, S1, and the presentation position of the circular plate DSR in the right-view RVW is shifted to the left by half of its binocular parallax, S1. In this way, the viewer perceives the circular plate DSC as being closer than the screen. Conversely, the parallax video generation unit PDG shifts the presentation position of the background BGV in the 2D video image MVW as follows: the presentation position of the background BGL in the left-view LVW is shifted to the left by half of its binocular parallax, S2, and the presentation position of the background BGR in the right-view RVW is shifted to the right by half of its binocular parallax, S2. In this way, the viewer perceives the background BGV as being deeper than the screen.

A playback system for 3D video images with use of parallax video is in general use, having already been established for use in movie theaters, attractions in amusement parks, and the like. Accordingly, this method is also useful for implementing home theater systems that can play back 3D video images. In the embodiments of the present invention, among methods using parallax video, an alternate-frame sequencing method or a method using polarization glasses is assumed to be used. However, apart from these methods, the present invention can also be applied to other, different methods, as long as they use parallax video. This will be obvious to those skilled in the art from the above explanation of the embodiments.

<File System on the BD-ROM Disc>

When UDF is used as the file system for the BD-ROM disc 101, the volume area 1002B shown in FIG. 10 generally includes areas in which a plurality of directories, a file set descriptor, and a terminating descriptor are respectively recorded. Each “directory” is a data group composing the directory. A “file set descriptor” indicates the LBN of the sector in which a file entry for the root directory is stored. The “terminating descriptor” indicates the end of the recording area for the file set descriptor.

Each directory shares a common data structure. In particular, each directory includes a file entry, directory file, and a subordinate file group.

The “file entry” includes a descriptor tag, Information Control Block (ICB) tag, and allocation descriptor. The “descriptor tag” indicates that the type of the data that includes the descriptor tag is a file entry. For example, when the value of the descriptor tag is “261”, the type of that data is a file entry. The “ICB tag” indicates attribute information for the file entry itself. The “allocation descriptor” indicates the LBN of the sector on which the directory file belonging to the same directory is recorded.

The “directory file” typically includes a plurality of each of a file identifier descriptor for a subordinate directory and a file identifier descriptor for a subordinate file. The “file identifier descriptor for a subordinate directory” is information for accessing the subordinate directory located directly below that directory. This file identifier descriptor includes identification information for the subordinate directory, directory name length, file entry address, and actual directory name. In particular, the file entry address indicates the LBN of the sector on which the file entry of the subordinate directory is recorded. The “file identifier descriptor for a subordinate file” is information for accessing the subordinate file located directly below that directory. This file identifier descriptor includes identification information for the subordinate file, file name length, file entry address, and actual file name. In particular, the file entry address indicates the LBN of the sector on which the file entry of the subordinate file is recorded. The “file entry of the subordinate file”, as described below, includes address information for the data constituting the actual subordinate file.

By tracing the file set descriptors and the file identifier descriptors of subordinate directories/files in order, the file entry of an arbitrary directory/file recorded on the volume area 1002B can be accessed. Specifically, the file entry of the root directory is first specified from the file set descriptor, and the directory file for the root directory is specified from the allocation descriptor in this file entry. Next, the file identifier descriptor for the directory immediately below the root directory is detected from the directory file, and the file entry for that directory is specified from the file entry address therein. Furthermore, the directory file for that directory is specified from the allocation descriptor in the file entry. Subsequently, from within the directory file, the file entry for the subordinate directory or subordinate file is specified from the file entry address in the file identifier descriptor for that subordinate directory or subordinate file.

“Subordinate files” include extents and file entries. The “extents” are a generally multiple in number and are data sequences whose logical addresses, i.e. LBNs, are consecutive on the disc. The entirety of the extents comprises the actual subordinate file. The “file entry” includes a descriptor tag, ICB tag, and allocation descriptors. The “descriptor tag” indicates that the type of the data that includes the descriptor tag is a file entry. The “ICB tag” indicates attribute information for the file entry itself. The “allocation descriptors” are provided in a one-to-one correspondence with each extent and indicate the arrangement of each extent on the volume area 1002B, specifically the size of each extent and the LBN for the top of the extent. Accordingly, by referring to each allocation descriptor, each extent can be accessed. Also, the two most significant bits of each allocation descriptor indicate whether an extent is actually recorded on the sector for the LBN indicated by the allocation descriptor. Specifically, when the two most significant bits are “0”, an extent has been assigned to the sector and has been actually recorded thereat. When the two most significant bits are “1”, an extent has been assigned to the sector but has not been yet recorded thereat.

Like the above-described file system employing a UDF, when each file recorded on the volume area is divided into a plurality of extents, the file system for the volume area also generally stores the information showing the locations of the extents, as with the above-mentioned allocation descriptors, in the volume area. By referring to the information, the location of each extent, particularly the logical address thereof, can be found.

<Decoding Switch Information>

FIG. 74A is a schematic diagram showing a data structure of a decoding switch information A050. The decoding switch information A050 is included in the pieces of supplementary data 1631D and 1632D in VAUs in the base-view video stream and the dependent-view video stream shown in FIG. 16. However, in VAU #1 located at the top of each GOP in the dependent-view video stream, the decoding switch information A050 is stored in supplementary data that is different from the supplementary data 1632D containing the offset metadata. The pieces of supplementary data 1631D and 1632D, in particular in MPEG-4 AVC and MVC, correspond to “SEI” that is a kind of NAL unit. The decoding switch information A050 is information to cause the decoder in the playback device 102 to easily specify the next VAU to decode. As described below, the decoder alternately decodes the base-view video stream and the dependent-view video stream in units of VAUs. When doing so, the decoder generally specifies the next VAU to be decoded in alignment with the time shown by the DTS assigned to each VAU. Many types of decoders, however, continue to decode VAUs in order, ignoring the DTS. For such decoders, it is preferable for each VAU to include decoding switch information A050 in addition to a DTS.

As shown in FIG. 74A, the decoding switch information A050 includes a subsequent access unit type A051, subsequent access unit size A052, and decoding counter A053. The subsequent access unit type A051 indicates whether the next VAU to be decoded belongs to a base-view video stream or a dependent-view video stream. For example, when the value of the subsequent access unit type A051 is “1”, the next VAU to be decoded belongs to a base-view video stream, and when the value of the subsequent access unit type A051 is “2”, the next VAU to be decoded belongs to a dependent-view video stream. When the value of the subsequent access unit type A051 is “0”, the current VAU is located at the end of the stream targeted for decoding, and the next VAU to be decoded does not exist. The subsequent access unit size A052 indicates the size of the next VAU that is to be decoded. By referring to the subsequent access unit size A052, the decoder in the playback device 102 can specify the size of a VAU without analyzing its actual structure. Accordingly, the decoder can easily extract VAUs from the buffer. The decoding counter A053 shows the decoding order of the VAU to which it belongs. The order is counted from a VAU that includes an I picture in the base-view video stream.

FIG. 74B is a schematic diagram showing an example of decoding counters A010 and A020 allocated to each picture in a base-view video stream A001 and a dependent-view video stream A002. As shown in FIG. 74B, the decoding counters A010 and A020 are incremented alternately between the two video streams A001 and A002. For example, for VAU A011 that includes an I picture in the base-view video stream A001, a value of “1” is assigned to the decoding counter A010. Next, a value of “2” is assigned to the decoding counter A020 for the VAU A021 that includes the next P picture to be decoded in the dependent-view video stream A002. Furthermore, a value of “3” is assigned to the decoding counter A010 for the VAU A012 that includes the next P picture to be decoded in the base-view video stream A001. By assigning values in this way, even when the decoder in the playback device 102 fails to read one of the VAUs due to some error, the decoder can immediately specify the missing picture using the decoding counters A010 and A020. Accordingly, the decoder can perform error processing appropriately and promptly.

In the example shown in FIG. 74B, an error occurs during the reading of the third VAU A013 in the base-view video stream A001, and the Br picture is missing. During decoding processing of the P picture contained in the second VAU A022 in the dependent-view video stream A002, however, the decoder has read the decoding counter A020 for this VAU A022 and retained the value. Accordingly, the decoder can predict the decoding counter A010 for the next VAU to be processed. Specifically, the decoding counter A020 in the VAU A022 that includes the P picture is “4”. Therefore, the decoding counter A010 for the next VAU to be read can be predicted to be “5”. The next VAU that is actually read, however, is the fourth VAU A014 in the base-view video stream A001, whose decoding counter A010 is “7”. The decoder can thus detect that it failed to read a VAU. Accordingly, the decoder can execute the following processing: “skip decoding processing of the B picture extracted from the third VAU A023 in the dependent-view video stream A002, since the Br picture to be used as a reference is missing”. In this way, the decoder checks the decoding counters A010 and A020 during each decoding process. Consequently, the decoder can promptly detect errors during reading of VAUs and can promptly execute appropriate error processing. As a result, the decoder can prevent noise from contaminating the playback video.

FIG. 74C is a schematic diagram showing another example of the decoding counters A030 and A040 allocated to each picture in a base-view video stream A001 and a dependent-view video stream A002. As shown in FIG. 74B, the decoding counters A030 and A040 are incremented alternately between the two video streams A001 and A002. Therefore, the decoding counters A030 and A040 are the same for a pair of pictures in the same 3D VAU. In this case, when the decoder has decoded one VAU in the base-view video stream A001, it can predict that “the decoding counter A030 is the same as the decoding counter A040 for the next VAU to be decoded in the dependent-view video stream A002”. Conversely, when the decoder has decoded a VAU in the dependent-view video stream A002, it can predict that “the decoding counter A030 for the next VAU to be decoded in the base-view video stream A001 is the same as the decoding counter A040 plus one”. Accordingly, at any point in time, the decoder can promptly detect an error in reading a VAU using the decoding counters A030 and A040 and can promptly execute appropriate error processing. As a result, the decoder can prevent noise from contaminating the playback video.

In the system target decoder 5423 shown in FIG. 57, the DEC 5704 may refer to the decoding switch information A050 to sequentially decode pictures from the respective VAUs, irrespective of their DTSs. Additionally, the buffer switch 5706 may cause the DEC 5704 to return the decoding switch information A050 in the VAU. In such a case, the buffer switch 5706 can determine if it should transfer the next VAU from the EB1 5703 or EB2 5710 by referring to the decoding switch information A050.

<Data Distribution Via Broadcasting or Communication Circuit>

The recording medium according to Embodiments 1 and 2 of the present invention may be, in addition to an optical disc, a general removable medium available as a package medium, such as a portable semiconductor memory device, including an SD memory card. Also, Embodiments 1 and 2 describe an example of an optical disc in which data has been recorded beforehand, namely, a conventionally available read-only optical disc such as a BD-ROM or a DVD-ROM. However, the embodiments of the present invention are not limited in this way. For example, when a terminal device writes 3D video content that has been distributed via broadcasting or a network onto a conventionally available writable optical disc such as a BD-RE or a DVD-RAM, arrangement of the extents according to Embodiments 1 and 2 may be used. The terminal device may be incorporated in a playback device or may be a device different from the playback device.

<Playback of Semiconductor Memory Card>

The following describes a data read unit of a playback device in the case where a semiconductor memory card is used as the recording medium according to Embodiments 1 and 2 of the present invention instead of an optical disc.

The part of the playback device that reads data from an optical disc is composed of, for example, an optical disc drive. Conversely, the part of the playback device that reads data from a semiconductor memory card is composed of an exclusive interface (I/F). Specifically, a card slot is provided with the playback device, and the I/F is mounted in the card slot. When the semiconductor memory card is inserted into the card slot, the semiconductor memory card is electrically connected with the playback device via the I/F. Furthermore, the data is read from the semiconductor memory card to the playback device via the I/F.

<Copyright Protection Technique for Data Stored in BD-ROM Disc>

The mechanism for protecting copyright of data recorded on a BD-ROM disc is now described as an assumption for the following supplementary explanation.

From a standpoint, for example, of improving copyright protection or confidentiality of data, there are cases in which a part of the data recorded on the BD-ROM is encrypted. The encrypted data is, for example, a video stream, an audio stream, or other stream. In such a case, the encrypted data is decoded in the following manner.

The playback device has recorded thereon beforehand a part of data necessary for generating a “key” to be used for decoding the encrypted data recorded on the BD-ROM disc, namely, a device key. On the other hand, the BD-ROM disc has recorded thereon another part of the data necessary for generating the “key”, namely, a media key block (MKB), and encrypted data of the “key”, namely, an encrypted title key. The device key, the MKB, and the encrypted title key are associated with one another, and each are further associated with a particular ID written into a BCA 1001 recorded on the BD-ROM disc 101 shown in FIG. 10, namely, a volume ID. When the combination of the device key, the MKB, the encrypted title key, and the volume ID is not correct, the encrypted data cannot be decoded. In other words, only when the combination is correct, the above-mentioned “key”, namely the title key, can be generated. Specifically, the encrypted title key is first decrypted using the device key, the MKB, and the volume ID. Only when the title key can be obtained as a result of the decryption, the encrypted data can be decoded using the title key as the above-mentioned “key”.

When a playback device tries to play back the encrypted data recorded on the BD-ROM disc, the playback device cannot play back the encrypted data unless the playback device has stored thereon a device key that has been associated beforehand with the encrypted title key, the MKB, the device, and the volume ID recorded on the BD-ROM disc. This is because a key necessary for decoding the encrypted data, namely a title key, can be obtained only by decrypting the encrypted title key based on the correct combination of the MKB, the device key, and the volume ID.

In order to protect the copyright of at least one of a video stream and an audio stream that are to be recorded on a BD-ROM disc, a stream to be protected is encrypted using the title key, and the encrypted stream is recorded on the BD-ROM disc. Next, a key is generated based on the combination of the MKB, the device key, and the volume ID, and the title key is encrypted using the key so as to be converted to an encrypted title key. Furthermore, the MKB, the volume ID, and the encrypted title key are recorded on the BD-ROM disc. Only a playback device storing thereon the device key to be used for generating the above-mentioned key can decode the encrypted video stream and/or the encrypted audio stream recorded on the BD-ROM disc using a decoder. In this manner, it is possible to protect the copyright of the data recorded on the BD-ROM disc.

The above-described mechanism for protecting the copyright of the data recorded on the BD-ROM disc is applicable to a recording medium other than the BD-ROM disc. For example, the mechanism is applicable to a readable and writable semiconductor memory device and in particular to a portable semiconductor memory card such as an SD card.

<Recording Data on a Recording Medium Through Electronic Distribution>

The following describes processing to transmit data, such as an AV stream file for 3D video images (hereinafter, “distribution data”), to the playback device according to Embodiment 1 of the present invention via electronic distribution and to cause the playback device to record the distribution data on a semiconductor memory card. Note that the following operations may be performed by a specialized terminal device for performing the processing instead of the above-mentioned playback device. Also, the following description is based on the assumption that the semiconductor memory card that is a recording destination is an SD memory card.

The playback device includes the above-described card slot. An SD memory card is inserted into the card slot. The playback device in this state first transmits a transmission request of distribution data to a distribution server on a network. At this point, the playback device reads identification information of the SD memory card from the SD memory card and transmits the read identification information to the distribution server together with the transmission request. The identification information of the SD memory card is, for example, an identification number specific to the SD memory card and, more specifically, is a serial number of the SD memory card. The identification information is used as the above-described volume ID.

The distribution server has stored thereon pieces of distribution data. Distribution data that needs to be protected by encryption such as a video stream and/or an audio stream has been encrypted using a predetermined title key. The encrypted distribution data can be decrypted using the same title key.

The distribution server stores thereon a device key as a private key common with the playback device. The distribution server further stores thereon an MKB in common with the SD memory card. Upon receiving the transmission request of distribution data and the identification information of the SD memory card from the playback device, the distribution server first generates a key from the device key, the MKB, and the identification information and encrypts the title key using the generated key to generate an encrypted title key.

Next, the distribution server generates public key information. The public key information includes, for example, the MKB, the encrypted title key, signature information, the identification number of the SD memory card, and a device list. The signature information includes for example a hash value of the public key information. The device list is a list of devices that need to be invalidated, that is, devices that have a risk of performing unauthorized playback of encrypted data included in the distribution data. The device list specifies the device key and the identification number for the playback device, as well as an identification number or function (program) for each element in the playback device such as the decoder.

The distribution server transmits the distribution data and the public key information to the playback device. The playback device receives the distribution data and the public key information and records them in the SD memory card via the exclusive I/F of the card slot.

Encrypted distribution data recorded on the SD memory card is decrypted using the public key information in the following manner, for example. First, three types of checks (1) to (3) are performed as authentication of the public key information. These checks may be performed in any order.

(1) Does the identification information of the SD memory card included in the public key information match the identification number stored in the SD memory card inserted into the card slot?

(2) Does a hash value calculated based on the public key information match the hash value included in the signature information?

(3) Is the playback device excluded from the device list indicated by the public key information? Specifically, is the device key of the playback device excluded from the device list?

If at least any one of the results of the checks (1) to (3) is negative, the playback device stops decryption processing of the encrypted data. Conversely, if all of the results of the checks (1) to (3) are affirmative, the playback device authorizes the public key information and decrypts the encrypted title key included in the public key information using the device key, the MKB, and the identification information of the SD memory card, thereby obtaining a title key. The playback device further decrypts the encrypted data using the title key, thereby obtaining, for example, a video stream and/or an audio stream.

The above mechanism has the following advantage. If a playback device, compositional elements, and a function (program) that have the risk of being used in an unauthorized manner are already known when data is transmitted via the electronic distribution, the corresponding pieces of identification information are listed in the device list and are distributed as part of the public key information. On the other hand, the playback device that has requested the distribution data inevitably needs to compare the pieces of identification information included in the device list with the pieces of identification information of the playback device, its compositional elements, and the like. As a result, if the playback device, its compositional elements, and the like are identified in the device list, the playback device cannot use the public key information for decrypting the encrypted data included in the distribution data even if the combination of the identification number of the SD memory card, the MKB, the encrypted title key, and the device key is correct. In this manner, it is possible to effectively prevent distribution data from being used in an unauthorized manner.

The identification information of the semiconductor memory card is desirably recorded in a recording area having high confidentiality included in a recording area of the semiconductor memory card. This is because if the identification information such as the serial number of the SD memory card has been tampered with in an unauthorized manner, it is possible to realize an illegal copy of the SD memory card easily. In other words, if the tampering allows generation of a plurality of semiconductor memory cards having the same identification information, it is impossible to distinguish between authorized products and unauthorized copy products by performing the above check (1). Therefore, it is necessary to record the identification information of the semiconductor memory card on a recording area with high confidentiality in order to protect the identification information from being tampered with in an unauthorized manner.

The recording area with high confidentiality is structured within the semiconductor memory card in the following manner, for example. First, as a recording area electrically disconnected from a recording area for recording normal data (hereinafter, “first recording area”), another recording area (hereinafter, “second recording area”) is provided. Next, a control circuit exclusively for accessing the second recording area is provided within the semiconductor memory card. As a result, access to the second recording area can be performed only via the control circuit. For example, assume that only encrypted data is recorded on the second recording area and a circuit for decrypting the encrypted data is incorporated only within the control circuit. As a result, access to the data recorded on the second recording area can be performed only by causing the control circuit to store therein an address of each piece of data recorded in the second recording area. Also, an address of each piece of data recorded on the second recording area may be stored only in the control circuit. In this case, only the control circuit can identify an address of each piece of data recorded on the second recording area.

In the case where the identification information of the semiconductor memory card is recorded on the second recording area, then when an application program operating on the playback device acquires data from the distribution server via electronic distribution and records the acquired data in the semiconductor memory card, the following processing is performed. First, the application program issues an access request to the control circuit via the memory card I/F for accessing the identification information of the semiconductor memory card recorded on the second recording area. In response to the access request, the control circuit first reads the identification information from the second recording area. Then, the control circuit transmits the identification information to the application program via the memory card I/F. The application program transmits a transmission request of the distribution data together with the identification information. The application program further records, in the first recording area of the semiconductor memory card via the memory card I/F, the public key information and the distribution data received from the distribution server in response to the transmission request.

Note that it is preferable that the above-described application program check whether the application program itself has been tampered with before issuing the access request to the control circuit of the semiconductor memory card. The check may be performed using a digital certificate compliant with the X.509 standard. Furthermore, it is only necessary to record the distribution data in the first recording area of the semiconductor memory card, as described above. Access to the distribution data need not be controlled by the control circuit of the semiconductor memory card.

<Application to Real-Time Recording>

Embodiment 3 of the present invention is based on the assumption that an AV stream file and a playlist file are recorded on a BD-ROM disc using the prerecording technique of the authoring system, and the recorded AV stream file and playlist file are provided to users. Alternatively, it may be possible to record, by performing real-time recording, the AV stream file and the playlist file on a writable recording medium such as a BD-RE disc, a BD-R disc, a hard disk, or a semiconductor memory card (hereinafter, “BD-RE disc or the like”) and provide the user with the recorded AV stream file and playlist file. In such a case, the AV stream file may be a transport stream that has been obtained as a result of real-time decoding of an analog input signal performed by a recording device. Alternatively, the AV stream file may be a transport stream obtained as a result of partialization of a digitally input transport stream performed by the recording device.

The recording device performing real-time recording includes a video encoder, an audio encoder, a multiplexer, and a source packetizer. The video encoder encodes a video signal to convert it into a video stream. The audio encoder encodes an audio signal to convert it into an audio stream. The multiplexer multiplexes the video stream and audio stream to convert them into a digital stream in the MPEG-2 TS format. The source packetizer converts TS packets in the digital stream in MPEG-2 TS format into source packets. The recording device stores each source packet in the AV stream file and writes the AV stream file on the BD-RE disc or the like.

In parallel with the processing of writing the AV stream file, the control unit of the recording device generates a clip information file and a playlist file in the memory and writes the files on the BD-RE disc or the like. Specifically, when a user requests performance of recording processing, the control unit first generates a clip information file in accordance with an AV stream file and writes the file on the BD-RE disc or the like. In such a case, each time a head of a GOP of a video stream is detected from a transport stream received from outside, or each time a GOP of a video stream is generated by the video encoder, the control unit acquires a PTS of an I picture positioned at the head of the GOP and an SPN of the source packet in which the head of the GOP is stored. The control unit further stores a pair of the PTS and the SPN as one entry point in an entry map of the clip information file. At this time, an “is_angle_change” flag is added to the entry point. The is_angle_change flag is set to “on” when the head of the GOP is an IDR picture, and “off” when the head of the GOP is not an IDR picture. In the clip information file, stream attribute information is further set in accordance with an attribute of a stream to be recorded. In this manner, after writing the AV stream file and the clip information file into the BD-RE disc or the like, the control unit generates a playlist file using the entry map in the clip information file, and writes the file on the BD-RE disc or the like.

<Managed Copy>

The playback device according to the embodiments of the present invention may write a digital stream recorded on the BD-ROM disc 101 on another recording medium via a managed copy. “Managed copy” refers to a technique for permitting copy of a digital stream, a playlist file, a clip information file, and an application program from a read-only recording medium such as a BD-ROM disc to a writable recording medium only in the case where authentication via communication with the server succeeds. This writable recording medium may be a writable optical disc, such as a BD-R, BD-RE, DVD-R, DVD-RW, or DVD-RAM, a hard disk, or a portable semiconductor memory element such as an SD memory card, Memory Stick™, Compact Flash™, Smart Media™ or Multimedia Card™. A managed copy allows for limitation of the number of backups of data recorded on a read-only recording medium and for charging a fee for backups.

When a managed copy is performed from a BD-ROM disc to a BD-R disc or a BD-RE disc and the two discs have an equivalent recording capacity, the bit streams recorded on the original disc may be copied in order as they are.

If a managed copy is performed between different types of recording media, a trans code needs to be performed. This “trans code” refers to processing for adjusting a digital stream recorded on the original disc to the application format of a recording medium that is the copy destination. For example, the trans code includes the process of converting an MPEG-2 TS format into an MPEG-2 program stream format and the process of reducing a bit rate of each of a video stream and an audio stream and re-encoding the video stream and the audio stream. During the trans code, an AV stream file, a clip information file, and a playlist file need to be generated in the above-mentioned real-time recording.

<Method for Describing Data Structure>

Among the data structures in Embodiment 1 of the present invention, a repeated structure “there is a plurality of pieces of information having a predetermined type” is defined by describing an initial value of a control variable and a cyclic condition in a “for” sentence. Also, a data structure “if a predetermined condition is satisfied, predetermined information is defined” is defined by describing, in an “if” sentence, the condition and a variable to be set at the time when the condition is satisfied. In this manner, the data structure described in Embodiment 1 is described using a high level programming language. Accordingly, the data structure is converted by a computer into a computer readable code via the translation process performed by a compiler, which includes “syntax analysis”, “optimization”, “resource allocation”, and “code generation”, and the data structure is then recorded on the recording medium. By being described in a high level programming language, the data structure is treated as a part other than the method of the class structure in an object-oriented language, specifically, as an array type member variable of the class structure, and constitutes a part of the program. In other words, the data structure is substantially equivalent to a program. Therefore, the data structure needs to be protected as a computer related invention.

<Management of Playlist File and Clip Information File by Playback Program>

When a playlist file and an AV stream file are recorded on a recording medium, a playback program is recorded on the recording medium in an executable format. The playback program makes the computer play back the AV stream file in accordance with the playlist file. The playback program is loaded from a recording medium to a memory element of a computer and is then executed by the computer. The loading process includes compile processing or link processing. By these processes, the playback program is divided into a plurality of sections in the memory element. The sections include a text section, a data section, a bss section, and a stack section. The text section includes a code array of the playback program, an initial value, and non-rewritable data. The data section includes variables with initial values and rewritable data. In particular, the data section includes a file, recorded on the recording medium, that can be accessed at any time. The bss section includes variables having no initial value. The data included in the bss section is referenced in response to commands indicated by the code in the text section. During the compile processing or link processing, an area for the bss section is set aside in the computer's internal RAM. The stack section is a memory area temporarily set aside as necessary. During each of the processes by the playback program, local variables are temporarily used. The stack section includes these local variables. When the program is executed, the variables in the bss section are initially set at zero, and the necessary memory area is set aside in the stack section.

As described above, the playlist file and the clip information file are already converted on the recording medium into computer readable code. Accordingly, at the time of execution of the playback program, these files are each managed as “non-rewritable data” in the text section or as a “file accessed at any time” in the data section. In other words, the playlist file and the clip information file are each included as a compositional element of the playback program at the time of execution thereof. Therefore, the playlist file and the clip information file fulfill a greater role in the playback program than mere presentation of data.

### INDUSTRIAL APPLICABILITY

The present invention relates to a technology for display of stereoscopic video images and as described above, performs frame rate conversation. It is therefore apparent that the present invention is industrially applicable.

### REFERENCE SIGNS LIST

F_{3D}k (k=1, 2, 3, 4, . . . ) frame sequence of 3D video images
F_{L}k left-view frame sequence
F_{R}k right-view frame sequence
GRD switching grid

1. A display device for displaying stereoscopic video images on a screen, comprising:
a receiving unit operable to receive stream data including left views and right views of the stereoscopic video images;
a signal processing unit operable to alternately extract left-view frames and right-view frames from the stream data and send the extracted frames; and
a display unit operable to display each frame sent from the signal processing unit on the screen for a predetermined time period, wherein
the signal processing unit repeatedly sends the display unit one of the left-view frames a first number of times and one of the right-view frames a second number of times, during one frame period of the stereoscopic video images represented by the stream data, and
the signal processing unit determines the first number of times and the second number of times based on a first frame rate divided by a second frame rate so that the first number of times differs from the second number of times with respect to at least one frame period of the stereoscopic video images, the first frame rate being a frame rate at which the display unit displays the left-view frames and the right-view frames, and the second frame rate being a frame rate of the stereoscopic video images represented by the stream data.

2. The display device according to claim 1, wherein
the signal processing unit determines the first number of times and the second number of times so that a time difference between one frame period and a next frame period of the stereoscopic video images is smaller than a time period in which a pair of one of the left-view frames and one of the right-view frames is displayed.

3. The display device according to claim 2, wherein
the signal processing unit determines the first number of times and the second number of times so that one frame period and a next frame period of the stereoscopic video images are equal in time length.

4. The display device according to claim 1, wherein
the signal processing unit calculates a quotient of the first frame rate divided by the second frame rate, and
whenever a total number of times one of the left-view frames and one of the right-view frames are outputted reaches an integral multiple of the quotient, or whenever the total number of times plus one reaches an integral multiple of the quotient, the signal processing unit selects, as frames to be outputted, one of the left-view frames and one of the right-view frames that constitute a next frame of the stereoscopic video images.

5. A method for displaying stereoscopic video images on a screen, comprising:
receiving stream data including left views and right views of the stereoscopic video images;
alternately extracting left-view frames and right-view frames from the stream data; and
displaying each frame extracted from the stream data on the screen for a predetermined time period, wherein
one of the left-view frames is repeatedly displayed a first number of times and one of the right-view frames is repeatedly displayed a second number of times during one frame period of the stereoscopic video images represented by the stream data, and
the first number of times and the second number of times are determined based on a first frame rate divided by a second frame rate so that the first number of times differs from the second number of times with respect to at least one frame period of the stereoscopic video images, the first frame rate being a frame rate at which the left-view frames and the right-view frames are displayed, and the second frame rate being a frame rate of the stereoscopic video images represented by the stream data.

6. A recording medium on which stream data is recorded, the stream data including left views and right views of stereoscopic video images and control information, wherein
the control information includes a first portion indicating a display type of each of left-view frames and a second portion indicating a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images, and
with respect to at least one frame period of the stereoscopic video images, the first number of times is set to be different from the second number of times.

7. The recording medium according to claim 6, wherein
the first number of times and the second number of times are set so that a time difference between one frame period and a next frame period of the stereoscopic video images is smaller than a time period in which a pair of one of the left-view frames and one of the right-view frames is displayed.

8. The recording medium according to claim 7, wherein
the first number of times and the second number of times are set so that one frame period and a next frame period of the stereoscopic video images are equal in time length.

9. A transmission device for transmitting stream data that includes left views and right views of stereoscopic video images and control information, the transmission device comprising:
a format conversion unit operable to convert the stream data into a predetermined transmission format, and
a transmitting unit operable to transmit the stream data converted into the predetermined transmission format, wherein
the control information includes a first portion indicating a display type of each of left-view frames and a second portion indicating a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images, and
with respect to at least one frame period of the stereoscopic video images, the first number of times is set to be different from the second number of times.

10. The transmission device according to claim 9, wherein
the first number of times and the second number of times are set so that a time difference between one frame period and a next frame period of the stereoscopic video images is smaller than a time period in which a pair of one of the left-view frames and one of the right-view frames is displayed.

11. The transmission device according to claim 10, wherein
the first number of times and the second number of times are set so that one frame period and a next frame period of the stereoscopic video images are equal in time length.

12. A method for transmitting stream data that includes right views and left views of stereoscopic video images and control information, the method comprising:
converting the stream data into a predetermined transmission format; and
transmitting the stream data converted into the predetermined transmission format, wherein
the control information includes a first portion indicating a display type of each of left-view frames and a second portion indicating a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images, and
with respect to at least one frame period of the stereoscopic video images, the first number of times is set to be different from the second number of times.

13. A playback device for playing back stereoscopic video images, comprising:
an input unit operable to acquire stream data including left views and right views of stereoscopic video images and control information;
a decoding unit operable to decode left-view frames and right-view frames from the stream data and alternately send the left-view frames and the right-view frames thus decoded;
a format conversion unit operable to receive a pair of one of the left-view frames and one of the right-view frames from the decoding unit and convert the pair into a predetermined output format; and
an output unit operable to output frames in the predetermined output format, wherein
the control information includes a display type of each of left-view frames and a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images,
with respect to at least one frame period of the stereoscopic video images, the first number of times is set to be different from the second number of times,
the decoding unit repeatedly sends the format conversion unit the left-view frames the first numbers of times defined by the respective display types for the left-view frames, and
the decoding unit repeatedly sends the format conversion unit the right-view frames the second numbers of times defined by the respective display types for the right-view frames.

14. The playback device according to claim 13, wherein
the first number of times and the second number of times are set so that a time difference between one frame period and a next frame period of the stereoscopic video images is smaller than a time period in which a pair of one of the left-view frames and one of the right-view frames is displayed.

15. The playback device according to claim 14, wherein
the first number of times and the second number of times are set so that one frame period and a next frame period of the stereoscopic video images are equal in time length.

16. A method for controlling a playback device to play back stereoscopic video images, comprising:
controlling the playback device to acquire stream data that includes left views and right views of the stereoscopic video images and control information;
controlling a decoding unit of the playback device to decode left-view frames and right-view frames from the stream data and alternately send the left-view frames and the right-view frames thus decoded;
controlling a format conversion unit of the playback device to receive a pair of one of the left-view frames and one of the right-view frames from the decoding unit and convert the pair into a predetermined output format; and
controlling the playback device to output frames in the predetermined output format, wherein
the control information includes a display type of each of left-view frames and a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images,
with respect to at least one frame period of the stereoscopic video images, the first number of times is set to be different from the second number of times, and
the playback device is so controlled that:
the decoding unit repeatedly sends the format conversion unit the left-view frames the first numbers of times defined by the respective display types for the left-view frames; and
the decoding unit repeatedly sends the format conversion unit the right-view frames the second numbers of times defined by the respective display types for the right-view frames.

17. A display device for displaying stereoscopic video images on a screen, comprising:
a receiving unit operable to receive stream data including left views and right views of the stereoscopic video images and control information;
a signal processing unit operable to alternately extract left-view frames and right-view frames from the stream data and send the extracted frames; and
a display unit operable to display each frame sent from the signal processing unit on the screen for a predetermined time period; wherein
the control information includes a display type of each of left-view frames and a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images,
with respect to at least one frame period of the stereoscopic video images, the first number of times is set to be different from the second number of times,
the receiving unit repeatedly sends the signal processing unit the left-view frames the first numbers of times defined by the respective display types for the left-view frames, and
the receiving unit repeatedly sends the signal processing unit the right-view frames the second numbers of times defined by the respective display types for the right-view frames.

18. The display device according to claim 17, wherein
the first number of times and the second number of times are set so that a time difference between one frame period and a next frame period of the stereoscopic video images is smaller than a time period in which a pair of one of the left-view frames and one of the right-view frames is displayed.

19. The display device according to claim 18, wherein
the first number of times and the second number of times are set so that one frame period and a next frame period of the stereoscopic video images are equal in time length.

20. A method for controlling a display device to display stereoscopic video images, comprising:
controlling the display device to receive stream data that includes left views and right views of the stereoscopic video images and control information;
controlling a signal processing unit of the display device to alternately extract left-view frames and right-view frames from the stream data and send the extracted frames; and
controlling the display device to display each frame sent from the signal processing unit on a screen of the display device for a predetermined time period, wherein
the control information includes a display type of each of left-view frames and a display type of each of right-view frames,
the display type of each of the left-view frames defines a first number of times indicating the number of times each of the left-view frames is to be repeatedly displayed on the screen for a predetermined time length during one frame period of the stereoscopic video images,
the display type of each of the right-view frames defines a second number of times indicating the number of times each of the right-view frames is to be repeatedly displayed on the screen for a predetermined time length during one frame period of the stereoscopic video images,
with respect to at least one frame period of the stereoscopic video images, the first number of times is set to be different from the second number of times, and
the display device is so controlled that:
a receiving unit repeatedly sends the signal processing unit the left-view frames the first numbers of times defined by the respective display types for the left-view frames; and
the receiving unit repeatedly sends the signal processing unit the right-view frames the second numbers of times defined by the respective display types for the right-view frames.
